(19) United States
(12) Patent Application Publication
(10) Pub. No.: US 2024/0132347 A1
(43) Pub. Date: Apr. 25, 2024

(54) SYSTEMS AND METHODS FOR PROCESSING AMMONIA

(71) Applicant: AMOGY INC., Brooklyn, NY (US)

(72) Inventors: Boris SHELUDKO, Brooklyn, NY (US); Jongwon CHOI, Brooklyn, NY (US); Young Suk JO, Brooklyn, NY (US); Gregory Robert JOHNSON, Brooklyn, NY (US); Hyunho KIM, Brooklyn, NY (US); Samuel DULL, Brooklyn, NY (US); Tomas RICCIARDULLI, Brooklyn, NY (US)

(21) Appl. No.: 18/508,997

(22) Filed: Nov. 14, 2023

Related U.S. Application Data
(63) Continuation of application No. PCT/US2023/077414, filed on Oct. 20, 2023.
Application No. PCT/US2023/077414 is a continuation of application No. 18/475,917, filed on Sep. 27, 2023.
Application No. 18/475,917 is a continuation of application No. 18/065,915, filed on Dec. 14, 2022, now Pat. No. 11,795,055.
Application No. PCT/US2023/077414 is a continuation of application No. 18/066,163, filed on Dec. 14, 2022, now Pat. No. 11,866,328.
(60) Provisional application No. 63/418,251, filed on Oct. 21, 2022.
(60) Provisional application No. 63/427,245, filed on Nov. 22, 2022.
(60) Provisional application No. 63/418,249, filed on Oct. 21, 2022.
(60) Provisional application No. 63/427,286, filed on Nov. 22, 2022.
(60) Provisional application No. 63/519,742, filed on Aug. 15, 2023.
(60) Provisional application No. 63/427,540, filed on Nov. 23, 2022.
(60) Provisional application No. 63/432,805, filed on Dec. 15, 2022.

(51) Int. Cl. C01B 3/04; B01J 21/06; B01J 23/10; B01J 23/42; B01J 23/44; B01J 23/46; C01B 3/56; H01M 8/04014; H01M 8/0606; H01M 8/22

(52) U.S. Cl. CPC C01B 3/047; B01J 21/066; B01J 23/10; B01J 23/42; B01J 23/44; B01J 23/462; C01B 3/56; H01M 8/04022; H01M 8/0606; H01M 8/222; C01B 2203/042; C01B 2203/0465; C01B 2203/066

(57) ABSTRACT

The present disclosure provides a catalyst, methods of manufacturing the catalyst, and methods for using the catalyst for ammonia decomposition to produce hydrogen and nitrogen. The catalyst may comprise an electrically conductive support with a layer of one or more metal oxides adjacent to the support and at least one active metal adjacent to the layer. Methods are disclosed for deposition of metal oxide and active metal, drying and heat treatment. The method of using the catalyst may comprise bringing ammonia in contact with the catalyst in a reactor. The catalyst may be configured to be heated to a target temperature in less than about 60 minutes, by passing an electrical current through the catalyst. The method of using the catalyst may comprise bringing the catalyst in contact with ammonia at about 400 to 900° C., to generate a reformate stream with a conversion efficiency of greater than about 70%.

### CROSS REFERENCE

This application is a continuation of International Patent Application No. PCT/US2023/077414, filed on Oct. 20, 2023, which claims priority to U.S. patent application Ser. No. 18/475,917, filed on Sep. 27, 2023, which is a continuation of U.S. patent application Ser. No. 18/065,915, filed on Dec. 14, 2022, which in turn claims the benefit of U.S. Provisional Application No. 63/418,251, filed Oct. 21, 2022, and U.S. Provisional Application No. 63/427,245, filed Nov. 22, 2022, each of which is incorporated herein by reference in its entirety, for all purposes. International Patent Application No. PCT/US2023/077414 also claims priority to U.S. patent application Ser. No. 18/066,163, filed on Dec. 14, 2022, which in turn claims the benefit of U.S. Provisional Application No. 63/418,249, filed Oct. 21, 2022, and U.S. Provisional Application No. 63/427,286, filed Nov. 22, 2022, each of which is incorporated herein by reference in its entirety, for all purposes. International Patent Application No. PCT/US2023/077414 also claims the benefit of U.S. Provisional Patent Application No. 63/519,742, filed Aug. 15, 2023, U.S. Provisional Application No. 63/427,540, filed Nov. 23, 2022, and U.S. Provisional Application No. 63/432,805, filed Dec. 15, 2022, each of which is incorporated herein by reference in its entirety, for all purposes.

### BACKGROUND

Various systems may be operated using a fuel source. The fuel source may have a specific energy corresponding to an amount of energy stored or extractable per unit mass of fuel. The fuel source may be provided to the various systems to enable such systems to generate energy and/or deliver power (e.g., for movement or transportation purposes).

Ammonia is an attractive alternative energy fuel source, especially because it does not contain carbon. Ammonia can be burned in an internal combustion engine, although a supplemental fuel (e.g., hydrogen) is often necessary to provide acceptable combustion characteristics. Ammonia can also be used as a hydrogen carrier, and it can undergo catalytic oxidation to yield nitrogen and hydrogen (which may then be used to power a fuel cell). However, many alternative fuels (including ammonia) have similar limitations in terms of having lower energy density or conversion efficiency than conventional fossil fuels, resulting in some reluctance of the markets to move to cleaner power plants.

### SUMMARY

Hydrogen can be leveraged as a clean energy source to power various systems. Hydrogen can provide a distinct advantage over other types of fuel such as diesel, gasoline, or jet fuel, which have specific energies of about 45 megajoules per kilogram (MJ/kg) (heat), or lithium-ion batteries, which have a specific energy of about 0.95 MJ/kg (electrical). In contrast, hydrogen has a specific energy of over 140 MJ/kg (heat). As such, 1 kg of hydrogen can provide the same amount of energy as about 3 kg of gasoline or kerosene. Thus, hydrogen as a fuel source can help to reduce the amount of fuel (by mass) needed to provide a comparable amount of energy as other traditional sources of fuel. Further, systems that use hydrogen as a fuel source (e.g., as a combustion reactant) generally produce benign or nontoxic byproducts such as water while producing minimal or near zero harmful emissions such as carbon dioxide or nitrous oxide emissions, thereby reducing the environmental impacts of various systems (e.g., modes of transportation) that use hydrogen as a fuel source.

Recognized herein are various limitations with conventional catalysts used to extract hydrogen from ammonia (e.g., through an ammonia decomposition process or reaction). Ammonia decomposition may also be referred to as ammonia dehydrogenation, ammonia cracking, ammonia reforming, ammonia splitting, ammonia break down, ammonia stripping, ammonia conversion, or ammonia dissociation. Ammonia decomposition can be a highly structure-dependent reaction, and the ability to control the morphology and/or the physical or chemical properties of the active metal nanoparticles used to decompose ammonia molecules may be limited when using conventional catalyst fabrication methods. As such, efficient use of active metal nanoparticles is difficult, and conventional catalysts often comprise an increased active metal nanoparticle content. Further, the nanoparticles may not be highly dispersed, which can reduce the efficiency of the catalyst. Conventional catalysts may also exhibit low heat transfer rates, which is undesirable for endothermic ammonia decomposition reactions. Conventional catalysts may also lack stability at high temperatures, in the presence of impurities in industrial grade ammonia, or under mechanical perturbations, and may not be able to withstand harsh reaction conditions or maintain the necessary physical and chemical properties needed to efficiently crack ammonia. Some conventional catalysts may comprise bead, extrudate or pellet type catalyst supports, but when catalyst materials are compressed into these form factors, the inside materials of the pellet may not be fully utilized, which can be wasteful and inefficient. As used herein, the morphology of the active metal nanoparticle support may correspond to a size, shape, aspect ratio, pore structure, pore size, pore shape, pore volume, pore density, pore size distribution, grain structure, grain size, grain shape, crystal structure, flake size, or layered structure of the one or more active metal nanoparticles. As used herein, the physical or chemical property of the active metal nanoparticles may comprise a size, a size distribution, an aspect ratio, a facet distribution, an Arrhenius acidity or basicity, a Lewis acidity or basicity, or a hydrophilicity or hydrophobicity of the one or more active metal nanoparticles.

The present disclosure provides systems and methods for addressing at least the abovementioned shortcomings noted for conventional catalysts. Some aspects of the present disclosure are directed to improved catalyst materials, related systems and methods for fabricating such improved catalyst materials, and methods of using such improved catalyst materials. The improved catalyst materials may exhibit an improved morphology and/or physical or chemical property for the active metal nanoparticles used to facilitate ammonia decomposition. The physical or chemical property may comprise a surface chemistry or property of the one or more active metal nanoparticles. The improved catalyst materials may also exhibit an improved level of dispersion of the active metal nanoparticles. The improved catalyst materials may further maintain favorable physical and chemical properties under harsh reaction conditions, and may exhibit high thermal stability and improved heat transfer rates to enable efficient endothermic ammonia decomposition reactions.

The present disclosure further provides methods for fabricating catalysts comprising an improved material composition, active metal nanoparticle morphology, surface chemistry or property, and/or support-metal interactions. The fabrication methods disclosed herein may be implemented to produce catalyst materials with high thermal stability and improved heat transfer characteristics. The catalyst materials produced using the methods of the present disclosure can be used to decompose ammonia efficiently at lower reaction temperatures for a longer duration, compared to conventional catalysts, and may extract a greater amount of hydrogen per unit weight or volume of ammonia while reducing or eliminating the need for expensive and difficult-to-obtain active metals (e.g., lower or zero content of ruthenium or platinum group metals).

The present disclosure further provides one or more catalysts for processing ammonia. The one or more catalysts may comprise, for example, a modified pore structure and active metal nanoparticle morphology and/or surface chemistry or property. The catalyst materials of the present disclosure may have high thermal stability and improved heat transfer characteristics. The catalyst materials may be used to decompose ammonia efficiently at lower reaction temperatures, and may extract a greater amount of hydrogen per unit weight or volume of ammonia while using a lower concentration of active metals. In some cases, for the same amount of catalyst material used, more hydrogen may be produced. In some cases, the hydrogen may be produced at lower reaction temperatures.

In some aspects, the present disclosure is directed to a method for reforming ammonia, comprising: providing a reactor comprising a catalyst, wherein the catalyst is in electrical communication with a pair of electrodes, and wherein the catalyst comprises a conducting support, wherein the conducting support comprises a resistivity greater than about 50 microohm-centimeter (ohm-cm) and less than about 100 ohm-cm, applying a voltage across the pair of electrodes, thereby passing an electrical current through the catalyst to heat at least a portion of the catalyst from a first temperature to a second temperature in a time period of less than about 60 minutes, wherein the second temperature is greater than about 200° C. and less than about 700° C.; and contacting ammonia (NH₃) with the catalyst to generate hydrogen (H₂) and nitrogen (N₂) at an ammonia conversion efficiency of greater than about 70%.

In some instances, ammonia is contacted with the catalyst and the reactor generates hydrogen and nitrogen at an ammonia conversion efficiency of greater than about 90%.

In some cases, the ammonia is contacted with the catalyst at a GHSV of greater than about 1,000 and less than about 100,000 milliliters NH₃ per hour per milliliter (ml_{NH3} hr⁺¹ mL_{cat}⁻¹) of catalyst.

In some embodiments, the catalyst is heated from the first temperature to the second temperature in less than about 30 minutes.

In some cases, the first temperature is ambient temperature.

In some cases, the first temperature is about 25° C.

In some instances, the conducting support has a resistance greater than about 1 ohm.

In some cases, the current passes between the electrodes and through the catalyst for a distance of greater than about 1 centimeter (cm) and less than about 10 meters.

In some cases, the combined resistance of the catalyst and the electrodes is greater than about 0.1 ohm and less than about 100 ohm.

In some instances, the resistivity is the resistance of the catalyst multiplied by a cross-sectional area of the catalyst and divided by a distance that the current passes between the electrodes and through the catalyst.

In some instances, the resistivity of the conducting support is a resistivity at a temperature greater than about 15° C. and less than about 30° C.

In some embodiments, the electrical current comprises an electrical power per gram of catalyst of greater than about 5 Watt per gram (W/g) and less than about 500 W/g.

In some cases, the time period begins based on the electrical current starting to pass through the catalyst.

In some embodiments, the catalyst is a monolith.

In some instances, the catalyst comprises beads, pellets, or powder configured to form an electrical circuit between the electrodes.

In some instances, the conducting support comprises a ceramic material.

In some embodiments, the conducting support comprises silicon carbide (SiC), silicon (Si), or germanium (Ge).

In some cases, the conducting support comprises a carbon-based material.

In some cases, the carbon-based material comprises graphite or amorphous carbon.

In some instances, the conducting support comprises NiCrAl, FeCrAl, NiFeCrAl, or NiCr.

In some instances, the conducting support comprises a dopant comprising phosphorus (P), nitrogen (N), or boron (B).

In some embodiments, the catalyst further comprises a layer adjacent to the conducting support.

In some instances, the conducting support comprises SiC and the layer comprises alumina (Al₂O₃).

In some instances, the Al₂O₃ comprises alpha alumina, theta alumina, or gamma alumina.

In some embodiments, the catalyst further comprises active metal adjacent to the layer comprising Al₂O₃.

In some instances, the active metal comprises Ru, Ni, Rh, Ir, Co, Fe, Pt, Cr, Mo, Pd, or Cu.

In some embodiments, the active metal comprises Ru.

In some instances, the concentration of the Ru is greater than about 0.5 wt % and less than about 3 wt % with respect to a total weight of the catalyst comprising the support and the layer.

In some embodiments, the first electrode of the pair of electrodes is positioned in proximity to a first side of the reactor, wherein the second electrode of the pair of electrodes is positioned in proximity to a second side of the reactor, wherein the first side and the second side are positioned substantially opposite from each other.

In some instances, the pair of electrodes are adjacent to each other and in proximity to a side of the reactor.

In some embodiments, the voltage between the electrodes is reduced or ceased, based on the catalyst reaching the second temperature.

In some cases, the reactor is heated by combustion.

In some cases, the reactor is electrically heated, in addition to heating the catalyst by passing the current through the catalyst.

In some instances, the reactor further comprises a second catalyst.

In some cases, the second catalyst is mixed with the catalyst.

In some instances, the reactor comprises at least two zones, wherein the first zone comprises the catalyst and the second zone comprises the second catalyst.

In some cases, the voltage is provided from a battery.

In some cases, the voltage is provided from an electrical grid.

In some embodiments, power is generated by providing the H₂ to a fuel cell.

In some instances, the fuel cell comprises a proton exchange membrane fuel cell (PEMFC), a solid oxide fuel cell (SOFC), a molten carbonate fuel cell (MCFC), an alkaline fuel cell (AFC), an alkaline membrane fuel cell (AMFC), or a phosphoric acid fuel cell (PAFC).

In some cases, power is generated by providing the hydrogen to one or more combustion engines or turbines.

In some embodiments, the catalyst is heated to the second temperature, the second temperature being greater than about 600° C. and less than about 700° C., in a time period of less than 10 minutes; and contacting the NH₃ with the catalyst generates the H₂ and the N₂ at an ammonia conversion efficiency of greater than about 95%.

In some aspects, the present disclosure is directed to a method of manufacturing a catalyst for ammonia decomposition, wherein the catalyst comprises a conducting support, wherein the conducting support comprises a resistivity greater than about 50 microohm-cm and less than about 100 ohm-cm, wherein the method comprises: (a) submerging the conducting support in a slurry, the slurry comprising (i) a binder and (ii) alumina, to deposit a layer comprising alumina in, on, or adjacent to the conducting support, (b) removing the catalyst, comprising the conducting support and the layer, from the slurry; (c) drying the catalyst, comprising the conducting support and the layer; (d) heat treating the catalyst, comprising the conducting support and the layer, in a non-reducing atmosphere at a temperature greater than about 200° C. and less than about 1400° C.; (e) submerging the catalyst, comprising the conducting support and the layer, in a solution comprising an active metal precursor to deposit the active metal precursor in, on, or adjacent to the layer; and (f) heat treating the catalyst, comprising the conducting support, the layer and the active metal precursor, in a non-oxidizing atmosphere at a temperature greater than about 200° C. and less than about 1300° C. to convert the active metal precursor to active metal.

In some embodiments, the slurry comprises a pH greater than about 0.1 and less than about 3.

In some instances, the catalyst is a monolith.

In some instances, the binder is an alumina-derived sol-gel.

In some instances, the binder comprises boehmite, bayerite or gibbsite.

In some cases, the binder is a hydrocarbon-based binder.

In some cases, the hydrocarbon-based binder comprises polyvinyl alcohol (PVA), polyethylene glycol (PEG), polyurethane (PUR), or polyethylene imine (PEI).

In some embodiments, the conducting support is submerged in the slurry for a time period greater than about 1 second and less than about 10 minutes.

In some instances, the time period begins based on the conducting support being completely submerged under a surface of the slurry.

In some instances, the drying in (c) comprises blowing air over the catalyst comprising the conducting support and the layer.

In some cases, the drying in (c) comprises passing a flame or a combustion product gas adjacent or on the catalyst comprising the conducting support and the layer.

In some instances, the non-reducing atmosphere comprises air, O₂, N₂, CO₂, Ar, He, Kr, or Xe.

In some instances, the non-oxidizing atmosphere comprises at least one of: N₂, H₂, Ar, NH₃, CO, CO₂, He, Kr, and Xe.

In some embodiments, the alumina comprises alpha alumina, theta alumina or gamma alumina.

In some instances, the active metal precursor comprises Ru(NO)(NO₃)₃, Ru(NO₃)₃, RuCl₃, Ru₃(CO)₁₂, ruthenium(III) chloride hexa-ammoniate Ru(NH₃)₆Cl₃, cyclohexadiene ruthenium tricarbonyl ((CHD)Ru(CO)₃), butadiene ruthenium tricarbonyl ((BD)Ru(CO)₃), or dimethylbutadiene ruthenium tricarbonyl ((DMBD)Ru(CO)₃).

In some embodiments, the active metal comprises ruthenium (Ru).

In some instances, the concentration of Ru comprises greater than about 0.5 wt % and less than about 3 wt % with respect to a total weight of the catalyst comprising the semiconducting support and the layer.

In some embodiments, the solids in the slurry comprise the binder and the alumina powder, wherein the concentration of the solids comprises greater than about 20 wt % and less than about 60 wt % with respect to a total weight of the slurry.

In some instances, the conducting support comprises a ceramic material.

In some instances, the conducting support comprises silicon carbide (SiC), silicon (Si), or germanium (Ge).

In some cases, the conducting support comprises a carbon-based material.

In some cases, the carbon-based material comprises graphite or amorphous carbon.

In some cases, the conducting support comprises NiCrAl, FeCrAl, NiFeCrAl, or NiCr.

In some instances, the conducting support comprises a dopant comprising phosphorus (P), nitrogen (N), or boron (B).

In some aspects, the present disclosure is directed to a catalyst for ammonia decomposition, comprising: a conducting support wherein the conducting support comprises a resistivity greater than about 50 microohm-cm and less than about 100 ohm-cm; a layer in, on, or adjacent to the conducting support, wherein the layer comprises alumina, zirconia, iron oxide, magnesium oxide, manganese oxide, nickel oxide, silicon dioxide, titanium dioxide, vanadium dioxide, or zinc oxide; and an active metal adjacent to the layer, wherein the active metal comprises Ru, Ni, Rh, Ir, Co, Fe, Pt, Cr, Mo, Pd, or Cu.

In some embodiments, the catalyst is a monolith.

In some embodiments, the conducting support comprises SiC, the layer comprises the alumina, and the active metal comprises Ru.

In some instances, the alumina comprises alpha alumina, theta alumina, or gamma alumina.

In some instances, the concentration of Ru comprises greater than about 0.5 wt % and less than about 3 wt % with respect to a total weight of the catalyst comprising the support and the layer.

In some cases, the conducting support comprises a ceramic material.

In some instances, the conducting support comprises silicon carbide (SiC), silicon (Si), or germanium (Ge).

In some cases, the conducting support comprises a carbon-based material.

In some cases, the carbon-based material comprises graphite or amorphous carbon.

In some cases, the conducting support comprises NiCrAl, FeCrAl, NiFeCrAl, or NiCr.

In some cases, the conducting support comprises a dopant comprising phosphorus (P), nitrogen (N), or boron (B).

In some aspects, the present disclosure relates to a method of ammonia decomposition comprising: (a) providing a catalyst comprising a conducting support, wherein the conducting support comprises a resistivity greater than about 50 microohm-cm and less than about 100 ohm-cm; a layer adjacent to the conducting support, wherein the layer comprises alumina, zirconia, iron oxide, magnesium oxide, manganese oxide, nickel oxide, silicon dioxide, titanium dioxide, vanadium dioxide, or zinc oxide; and an active metal adjacent to the layer, wherein the active metal comprises Ru, Ni, Rh, Ir, Co, Fe, Pt, Cr, Mo, Pd, or Cu; and (b) bringing the catalyst in contact with ammonia at a temperature of from about 450° C. to about 700° C. to generate a reformate stream comprising hydrogen and nitrogen at an ammonia conversion efficiency of greater than about 70%.

In some instances, the catalyst is in electrical communication with a pair of electrodes and passing an electrical current through the catalyst heats the catalyst.

In some instances, the ammonia is contacted on the catalyst at a space velocity of from about 1 to about 50 liters per hour per gram of catalyst at a temperature of from about 450° C. to about 700° C.

In some cases, the ammonia is contacted on the catalyst at a gas hourly space velocity (GHSV) of from about 1 to about 50 liters per hour per mL of catalyst at a temperature of from about 450° C. to about 700° C.

In some instances, contacting the catalyst with ammonia to generate the reformate stream is an auto-thermal reforming process so that at least part of the reformate stream provides heat for the auto-thermal reforming process.

In some cases, at least part of the reformate stream comprises: (1) combustion to generate the heat, or (2) conversion by hydrogen-to-electricity conversion to generate the heat, thereby providing the heat for the auto-thermal reforming process.

In some embodiments, undecomposed ammonia in the reformate stream is removed by an ammonia filter.

In some embodiments, the ammonia filter comprises an adsorbent, a membrane separation module, or an ammonia scrubber.

In some instances, a pressure swing adsorption (PSA) module is used to remove nitrogen from the reformate stream.

In some cases, the ammonia is directed to a first reformer comprising the catalyst to generate the reformate stream; combusting the reformate stream in a combustion heater to heat a second reformer; and directing additional ammonia to the second reformer to generate additional hydrogen for the reformate stream, wherein a first portion of the reformate stream is combusted to heat the second reformer.

In some cases, the first reformer is heated using at least one of an electrical heater or combustion of the reformate stream.

In some instances, the method comprises directing ammonia to a reformer at an ammonia flow rate to generate the reformate stream; combusting a first portion of the reformate stream with oxygen at an oxygen flow rate in a combustion heater to heat the reformer; processing a second portion of the reformate stream in a hydrogen processing module; and based at least in part on a stimulus, performing one or more of: (i) changing the ammonia flow rate; (ii) changing a percentage of the reformate stream that is the first portion of the reformate stream; (iii) changing a percentage of the reformate stream that is the second portion of the reformate stream; or (iv) changing the oxygen flow rate.

In some embodiments, the method comprises directing ammonia to a reformer at an ammonia flow rate to generate the reformate stream; combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of: (i) changing the ammonia flow rate; (ii) changing the oxygen flow rate; (iii) changing a percentage of the reformate stream that is the second portion of the reformate stream; (iv) changing a percentage of the reformate stream that is the first portion of the reformate stream; or (v) changing a percentage of the reformate stream that is directed out of the combustion heater.

In some aspects, the present disclosure is directed to a method for reforming ammonia, comprising: contacting a gas comprising ammonia in reactor comprising a catalyst at a temperature ranging from about 400° C. to about 700° C. to generate a reformate stream comprising hydrogen (H₂) and nitrogen (N₂), at an ammonia conversion efficiency of at least about 70%, wherein the catalyst comprises: a conducting support, wherein the conducting support comprises a resistivity greater than about 50 microohm-centimeter (mohm-cm) and less than about 100 ohm-cm, wherein the catalyst is in electrical communication with a pair of electrodes; and, applying a voltage across the pair of electrodes, thereby passing an electrical current through the catalyst to heat at least a portion of the catalyst from a first temperature to a second temperature in a time period of less than about 60 minutes, wherein the second temperature is greater than about 200° C. and less than about 700° C.

In some embodiments, the ammonia generates hydrogen and nitrogen at an ammonia conversion efficiency of greater than about 90%.

In some embodiments, the ammonia is contacted with the catalyst at a space velocity of greater than about 1000 and less than about 100,000 milliliters NH₃ per hour per milliliter of catalyst.

In some embodiments, the catalyst is heated from the first temperature to the second temperature in less than about 30 minutes.

In some embodiments, the first temperature is ambient temperature.

In some embodiments, the first temperature is about 25° C.

In some embodiments, the conducting support has a resistance greater than about 1 ohm.

In some embodiments, the current passes between the electrodes and through the catalyst for a distance of greater than about 1 centimeter (cm) and less than about 10 meters.

In some embodiments, a combined resistance of the catalyst and the electrodes is greater than about 0.1 ohm and less than about 100 ohm.

In some embodiments, the resistivity is a resistance of the catalyst multiplied by a cross-sectional area of the catalyst and divided by a distance that the current passes between the electrodes and through the catalyst.

In some embodiments, the resistivity of the conducting support is a resistivity at a temperature greater than about 15° C. and less than about 30° C.

In some embodiments, the electrical current comprises an electrical power per gram of catalyst of greater than about 5 watt per gram (W/g) and less than about 500 W/g.

In some embodiments, the time period begins when the electrical current begins to pass through the catalyst.

In some embodiments, the catalyst is a monolith.

In some embodiments, the catalyst comprises beads, pellets, or powder configured to form an electrical circuit between the electrodes.

In some embodiments, the conducting support comprises a ceramic material.

In some embodiments, the conducting support comprises silicon carbide (SiC), silicon (Si), or germanium (Ge).

In some embodiments, the conducting support comprises a carbon-based material.

In some embodiments, the carbon-based material comprises graphite or amorphous carbon.

In some embodiments, the conducting support comprises NiCrAl, FeCrAl, NiFeCrAl, or NiCr.

In some embodiments, the conducting support comprises a dopant comprising phosphorus (P), nitrogen (N), or boron (B).

In some embodiments, the catalyst further comprises a layer adjacent to the conducting support.

In some embodiments, the conducting support comprises SiC and the layer comprises alumina (Al₂O₃).

In some embodiments, the Al₂O₃ comprises alpha-alumina, theta-alumina, or gamma-alumina.

In some embodiments, the catalyst further comprises an active metal adjacent to the layer comprising Al₂O₃.

In some embodiments, the active metal comprises Ru, Ni, Rh, Ir, Co, Fe, Pt, Cr, Mo, Pd, or Cu.

In some embodiments, the active metal comprises Ru.

In some embodiments, a concentration of the Ru is greater than about 0.5 wt % and less than about 3 wt % with respect to a total weight of the catalyst comprising the support and the layer.

In some embodiments, a first electrode of the pair of electrodes is positioned in proximity to a first side of the reactor, wherein a second electrode of the pair of electrodes is positioned in proximity to a second side of the reactor, wherein the first side and the second side are positioned substantially opposite from each other.

In some embodiments, the pair of electrodes are adjacent to each other and in proximity to a side of the reactor.

In some embodiments, the method further comprises reducing a voltage or ceasing to apply a voltage between the electrodes based on the catalyst reaching the second temperature.

In some embodiments, the method further comprises heating the reactor by combustion.

In some embodiments, the method further comprises electrically heating the reactor in addition to heating the catalyst by passing the current through the catalyst.

In some embodiments, the reactor further comprises a second catalyst.

In some embodiments, the second catalyst is mixed with the catalyst.

In some embodiments, the reactor comprises at least two zones, wherein a first zone comprises the catalyst and the second zone comprises the second catalyst.

In some embodiments, the voltage is provided from a battery.

In some embodiments, the voltage is provided from an electrical grid.

In some embodiments, the method further comprises generating power by providing the H₂ to a fuel cell.

In some embodiments, the fuel cell comprises a proton exchange membrane fuel cell (PEMFC), a solid oxide fuel cell (SOFC), a molten carbonate fuel cell (MCFC), an alkaline fuel cell (AFC), an alkaline membrane fuel cell (AMFC), or a phosphoric acid fuel cell (PAFC).

In some embodiments, the method further comprises generating power by providing the hydrogen to one or more combustion engines or turbines.

In some embodiments, the catalyst is heated to the second temperature, the second temperature being greater than about 600° C. and less than about 700° C., in a time period of less than 30 minutes; and contacting the NH₃ with the catalyst generates the H₂ and the N₂ at an ammonia conversion efficiency of greater than about 95%.

In some aspects, the present disclosure is directed to a method of manufacturing a catalyst for ammonia decomposition, wherein the catalyst comprises a conducting support, wherein the conducting support comprises a resistivity greater than about 50 microohm-cm and less than about 100 ohm-cm, wherein the method comprises:
(a) submerging the conducting support in a slurry, wherein the slurry comprises (i) a binder and (ii) alumina (Al₂O₃), to deposit a layer comprising the alumina adjacent to the conducting support,
(b) removing the catalyst, comprising the conducting support and the layer, from the slurry;
(c) drying the catalyst, comprising the conducting support and the layer;
(d) heat treating the catalyst, comprising the conducting support and the layer, in a non-reducing atmosphere at a temperature greater than about 200° C. and less than about 1400° C.;
(e) submerging the catalyst, comprising the conducting support and the layer, in a solution comprising an active metal precursor to deposit the active metal precursor adjacent to the layer; and
(f) heat treating the catalyst, comprising the conducting support, the layer and the active metal precursor, in a non-oxidizing atmosphere at a temperature greater than about 200° C. and less than about 1300° C. to convert the active metal precursor to an active metal.

In some embodiments, the slurry comprises a pH greater than about 0.1 and less than about 3.

In some embodiments, the catalyst is a monolith.

In some embodiments, the binder is an alumina-derived sol-gel.

In some embodiments, the binder comprises boehmite, bayerite, or gibbsite.

In some embodiments, the binder is a hydrocarbon-based binder.

In some embodiments, the hydrocarbon-based binder comprises polyvinyl alcohol (PVA), polyethylene glycol (PEG), polyurethane (PUR), or polyethylene imine (PEI).

In some embodiments, the conducting support is submerged in the slurry for a time period greater than about 1 second and less than about 10 minutes.

In some embodiments, the time period begins based on the conducting support being completely submerged under a surface of the slurry.

In some embodiments, the drying comprises blowing air over the catalyst comprising the conducting support and the layer.

In some embodiments, the drying comprises passing a flame or a combustion product gas adjacent or on the catalyst comprising the conducting support and the layer.

In some embodiments, the non-reducing atmosphere comprises air, O₂, N₂, CO₂, Ar, He, Kr, or Xe.

In some embodiments, the non-oxidizing atmosphere comprises N₂, H₂, Ar, NH₃, CO, CO₂, He, Kr, and Xe.

In some embodiments, the alumina comprises alpha alumina, theta alumina, or gamma alumina.

In some embodiments, the active metal precursor comprises Ru(NO)(NO₃)₃, Ru(NO₃)₃, RuCl₃, Ru₃(CO)₁₂, ruthenium(III) chloride hexa-ammoniate Ru(NH₃)₆Cl₃, cyclohexadiene ruthenium tricarbonyl ((CHD)Ru(CO)₃), butadiene ruthenium tricarbonyl ((BD)Ru(CO)₃), or dimethylbutadiene ruthenium tricarbonyl ((DMBD)Ru(CO)₃).

In some embodiments, the active metal comprises ruthenium (Ru).

In some embodiments, a concentration of the Ru comprises greater than about 0.5 wt % and less than about 3 wt % with respect to a total weight of the catalyst comprising the conducting support and the layer.

In some embodiments, solids in the slurry comprise the binder and the alumina, wherein a concentration of the solids comprises greater than about 20 wt % and less than about 60 wt % with respect to a total weight of the slurry.

In some embodiments, the conducting support comprises a ceramic material.

In some embodiments, the conducting support comprises silicon carbide (SiC), silicon (Si), or germanium (Ge).

In some embodiments, the conducting support comprises a carbon-based material.

In some embodiments, the carbon-based material comprises graphite or amorphous carbon.

In some embodiments, the conducting support comprises NiCrAl, FeCrAl, NiFeCrAl, or NiCr.

In some embodiments, the conducting support comprises a dopant comprising phosphorus (P), nitrogen (N), or boron (B).

In some aspects, the present disclosure is directed to a catalyst for ammonia decomposition, comprising: a conducting support wherein the conducting support comprises a resistivity greater than about 50 microohm-cm and less than about 100 ohm-cm; a layer adjacent to the conducting support, wherein the layer comprises alumina, zirconia, iron oxide, magnesium oxide, manganese oxide, nickel oxide, silicon dioxide, titanium dioxide, vanadium dioxide, or zinc oxide; and active metal adjacent to the layer, wherein the active metal comprises Ru, Ni, Rh, Ir, Co, Fe, Pt, Cr, Mo, Pd, or Cu.

In some embodiments, the catalyst is a monolith.

In some embodiments, the conducting support comprises SiC, the layer comprises the alumina, and the active metal comprises the Ru.

In some embodiments, the alumina comprises alpha alumina, theta alumina, or gamma alumina.

In some embodiments, a concentration of the Ru comprises greater than about 0.5 wt % and less than about 3 wt % with respect to a total weight of the catalyst comprising the support and the layer.

In some embodiments, the conducting support comprises a ceramic material.

In some embodiments, the conducting support comprises silicon carbide (SiC), silicon (Si), or germanium (Ge).

In some embodiments, the conducting support comprises a carbon-based material.

In some embodiments, the carbon-based material comprises graphite or amorphous carbon.

In some embodiments, the conducting support comprises NiCrAl, FeCrAl, NiFeCrAl, or NiCr.

In some embodiments, the conducting support comprises a dopant comprising phosphorus (P), nitrogen (N), or boron (B).

In some aspects, the present disclosure is directed to a method of ammonia decomposition comprising:

contacting a gas comprising ammonia on a catalyst at a temperature ranging from about 400° to about 700° C. to generate a reformate stream comprising hydrogen and nitrogen, at an ammonia conversion efficiency of at least about 70%, wherein the catalyst comprises: a conducting support, wherein the conducting support comprises a resistivity greater than about 50 microohm-cm and less than about 100 ohm-cm; a layer adjacent to the conducting support, wherein the layer comprises alumina, zirconia, iron oxide, magnesium oxide, manganese oxide, nickel oxide, silicon dioxide, titanium dioxide, vanadium dioxide, or zinc oxide; and an active metal adjacent to the layer, wherein the active metal comprises Ru, Ni, Rh, Ir, Co, Fe, Pt, Cr, Mo, Pd, or Cu.

In some embodiments, the catalyst is in electrical communication with a pair of electrodes and passing an electrical current through the catalyst heats the catalyst.

In some embodiments, in the ammonia is contacted on the catalyst at a space velocity of from about 1 to about 50 liters per hour per gram of catalyst at a temperature of from about 450° C. to about 700° C.

In some embodiments, the ammonia is contacted on the catalyst at a gas hourly space velocity (GHSV) of from about 1 to about 50 liters per hour per mL of catalyst at a temperature of from about 450° C. to about 700° C.

In some embodiments, contacting the catalyst with ammonia to generate the reformate stream is an auto-thermal reforming process so that at least part of the reformate stream provides heat for the auto-thermal reforming process.

In some embodiments, the at least part of the reformate stream comprises: (1) combustion to generate the heat, or (2) conversion by hydrogen-to-electricity conversion to generate the heat, thereby providing the heat for the auto-thermal reforming process.

In some embodiments, undecomposed ammonia in the reformate stream is removed by an ammonia filter.

In some embodiments, the ammonia filter comprises an adsorbent, a membrane separation module, or an ammonia scrubber.

In some embodiments, a pressure swing adsorption (PSA) module is used to remove nitrogen from the reformate stream.

In some embodiments, the method further comprises directing the ammonia to a first reformer comprising the catalyst to generate the reformate stream; combusting the reformate stream in a combustion heater to heat a second reformer; and directing additional ammonia to the second reformer to generate additional hydrogen for the reformate stream, wherein a first portion of the reformate stream is combusted to heat the second reformer.

In some embodiments, the first reformer is heated using at least one of an electrical heater or combustion of the reformate stream.

In some embodiments, the method comprises: directing the ammonia to a reformer at an ammonia flow rate to generate the reformate stream; combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

In some embodiments, the method comprises: directing the ammonia to a reformer at an ammonia flow rate to generate the reformate stream; combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

In some aspects, the present disclosure is directed to a catalyst for ammonia decomposition, comprising: a support comprising at least one of alumina, silica, carborundum, zeolite, ceria, zirconia, graphite oxide, carbon, graphene, carbon nanofibers or carbon nanotubes; a layer adjacent to the support, wherein the layer comprises the support material doped with an oxide of at least one of an alkali metal, an alkaline earth metal, or a rare earth metal; and one or more active metal particles adjacent to the layer, wherein the one or more active metal particles comprise at least one of Ru, Ni, Rh, Ir, Co, Fe, Pt, Cr, Mo, Pd, or Cu; and wherein the concentration of the active metal particles is at least about 0.1 wt % and not more than about 15 wt %.

In some embodiments, the support comprises zirconium and oxygen.

In some embodiments, the layer comprises Ce.

In some embodiments, the layer comprises a tetragonal network structure of zirconium, cerium, and oxygen.

In some embodiments, the layer comprises oxygen vacancies of at least about 0.1 mmol/g and not more than about 10 mmol/g.

In some embodiments, the layer comprises a density of acid sites of at least about 10 μmol/g and not more than about 1000 μmol/g.

In some embodiments, the layer comprises Ce³⁺ ions and Ce⁴⁺ ions, wherein a ratio of the Ce³⁺ ions to the Ce⁴⁺ ions is at least about 0.1:1 and not more than about 1:1.

In some embodiments, the layer comprises one or more promoters, wherein the molar ratio of the one or more promoters to Ce in the support is at least about 1:2 and not more than about 10:1.

In some embodiments, the layer comprises one or more promoters selected from alkali metals and alkaline earth metals; and wherein the one or more promoters are co-impregnated with the Ce.

In some embodiments, the active metal particles comprise ruthenium (Ru).

In some embodiments, the concentration of Ru is at least about 0.5 wt % and not more than about 10 wt %.

In some embodiments, the one or more active metal particles comprises nanoparticles of elemental Ru.

In some embodiments, at least one of the support or the layer comprises one or more promoters comprising at least one of K, Cs, or Rb.

In some embodiments, the layer comprises oxide nanoparticles of at least one of Ce, K, Cs and Rb.

In some embodiments, the layer comprises annealed nanoparticles of at least one of Ce, K, Cs, or Rb.

In some aspects, the present disclosure is directed to a method of producing a catalyst for ammonia decomposition, comprising:
(a) providing a support comprising at least one of alumina, silica, carborundum, zeolite, ceria, zirconia, graphite oxide, carbon, graphene, carbon nanofibers and carbon nanotubes or precursor(s) thereof;
(b) depositing a layer adjacent to the support, to form a doped support, wherein the layer comprises at least one of an alkali metal oxide or precursors thereof, an alkaline earth metal oxide or precursors thereof, or a rare earth metal oxide or precursor(s) thereof;
(c) depositing a precursor of one or more active metal particles adjacent to the layer, wherein the one or more active metal particles comprise at least one of Ru, Ni, Rh, Ir, Co, Fe, Pt, Cr, Mo, Pd, or Cu, wherein the concentration of the active metal particles is at least 0.1 wt % and not more than about 15 wt %; and
(d) maintaining the doped support at a temperature of at least about 200° C. and not more than about 1000° C. for a duration of at least about 0.1 hours and not more than about 168 hours in an atmosphere comprising hydrogen.

In some embodiments, (b) further comprises: maintaining the doped support at a temperature of at least about 20° C. and not more than about 150° C., for a duration of at least about 0.1 hours and not more than about 168 hours in vacuo, or in an atmosphere comprising air or an inert gas at a pressure below about 5 bar absolute.

In some embodiments, (b) further comprises maintaining the doped support at a temperature of at least about 600° C. and not more than about 1300° C. for a duration of at least about 0.1 hours and not more than about 168 hours, in a non-reducing atmosphere, comprising at least one of: air, N₂, CO₂, Ar, He, Kr, or Xe.

In some embodiments, (b) further comprises maintaining the doped support at a temperature of at least about 600° C. and not more than about 1300° C. for a duration of at least about 0.1 hours and not more than about 168 hours, in an inert, anoxic or non-oxidizing atmosphere, comprising at least one of: N₂, H₂, Ar, NH₃, CO, CO₂, He, Kr, or Xe.

In some embodiments, the support comprises zirconium and oxygen.

In some embodiments, the layer comprises Ce.

In some embodiments, the layer comprises a tetragonal network structure of zirconium, cerium, and oxygen.

In some embodiments, the catalyst comprises oxygen vacancies of at least about 0.1 mmol/g and not more than about 10 mmol/g.

In some embodiments, the catalyst comprises a density of acid sites of at least about 10 μmol/g and not more than about 1000 μmol/g.

In some embodiments, the layer comprises Ce³⁺ ions and Ce⁴⁺ ions, wherein a ratio of the Ce³⁺ ions to the Ce³⁺ ions is at least about 0.1:1 and not more than about 1:1.

In some embodiments, the layer comprises one or more promoters, wherein the molar ratio of the one or more promoters to Ce in the support is at least about 1:2 and not more than about 10:1.

In some embodiments, (b) further comprises incorporating one or more promoters selected from alkali metals and alkaline earth metals; and wherein the one or more promoters are co-impregnated with Ce.

In some embodiments, a molar ratio of the promoter to the active metal is at least about 1:2 and not more than about 10:1.

In some embodiments, the one or more promoters or promoter precursor(s) comprise at least one of K, Cs, or Rb.

In some embodiments, the one or more active metal particles comprise Ru and the concentration of Ru is at least about 0.5 wt % and not more than about 10 wt %.

In some embodiments, the precursor of the one or more active metal particles comprises at least one of Ru(NO)(NO₃)₃, Ru(NO₃)₃, RuCl₃, or Ru₃(CO)₁₂.

In some embodiments, the support or precursor(s) thereof comprise beads or pellets; wherein the beads or the pellets comprise at least one of (i) a diameter of at least about 0.1 mm and not more than about 10 mm, or (ii) a surface area per unit mass of at least about 50 m²/g and not more than about 500 m²/g.

In some aspects, the present disclosure is directed to a method of ammonia decomposition comprising: contacting a gas comprising ammonia on a catalyst at a temperature ranging from about 400° C. to about 700° C. to generate a reformate stream comprising hydrogen and nitrogen, at an ammonia conversion efficiency of at least about 70% and no more than about 99.9%, wherein the catalyst comprises: a support comprising at least one of alumina, silica, carborundum, zeolite, ceria, zirconia, graphite oxide, carbon, graphene, carbon nanofibers, or carbon nanotubes; a layer adjacent to the support, wherein the layer comprises the support material doped with an oxide of at least one of an alkali metal, an alkaline earth metal, or a rare earth metal; and one or more active metal particles deposited adjacent to the layer, wherein the one or more active metal particles comprise at least one of Ru, Ni, Rh, Ir, Co, Fe, Pt, Cr, Mo, Pd, or Cu; and wherein the concentration of the active metal particles is at least about 0.1 wt % and not more than about 15 wt %.

In some embodiments, the catalyst is brought into contact with the ammonia at a space velocity of at least about 1 liter per hour per gram of catalyst and not more than about 100 liters per hour per gram of catalyst.

In some embodiments, the method further comprises generating electricity by providing hydrogen produced by the catalyst to at least one fuel cell, wherein the at least one fuel cell comprises a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

In some embodiments, the method further comprises providing hydrogen produced by the catalyst for one or more combustion engines or turbines.

In some embodiments, the present disclosure is directed to a system configured to reform ammonia using the method of Embodiment 123.

In some embodiments, contacting the catalyst with ammonia to generate the reformate stream is an auto-thermal reforming process so that at least part of the reformate stream provides heat for the auto-thermal reforming process.

In some embodiments, the at least part of the reformate stream is at least one of: (1) combusted to generate the heat, or (2) converted by hydrogen-to-electricity conversion to generate the heat, thereby providing the heat for the auto-thermal reforming process.

In some embodiments, undecomposed ammonia in the reformate stream is removed by an ammonia filter.

In some embodiments, the ammonia filter comprises at least one of an adsorbent, a membrane separation module, or an ammonia scrubber.

In some embodiments, a pressure swing adsorption (PSA) module is used to remove nitrogen from the reformate stream.

In some embodiments, (b) comprises directing the ammonia to a first reformer to generate the reformate stream; wherein the method comprises combusting the reformate stream in a combustion heater to heat a second reformer; and directing additional ammonia to the second reformer to generate additional hydrogen for the reformate stream, wherein a first portion of the reformate stream is combusted to heat the second reformer.

In some embodiments, the first reformer is heated using at least one of an electrical heater or combustion of the reformate stream.

In some embodiments, (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

In some embodiments, (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

In some aspects, the present disclosure is directed to a catalyst for ammonia decomposition, comprising: a support comprising at least one of alumina, silica, carborundum, zeolite, ceria, zirconia, graphite oxide, carbon, graphene, carbon nanofibers and carbon nanotubes, and a layer adjacent to the support, wherein the layer comprises the support material doped with an oxide of at least one of an alkali metal, an alkaline earth metal, or a rare earth metal; and one or more active metal particles adjacent to the layer, wherein the one or more active metal particles comprises at least one of Ru, Ni, Rh, Ir, Co, Fe, Pt, Cr, Mo, Pd, or Cu; and wherein the concentration of the active metal particles is at least about 0.1, and not more than about 15 wt %.

In some embodiments, the support comprises aluminum and oxygen.

In some embodiments, the layer comprises at least one of theta-alumina (6-alumina) or gamma-alumina (γ-alumina).

In some embodiments, the layer comprises a perovskite phase.

In some embodiments, the layer comprises La at a concentration of at least about 0.1, and not more than about 50 mol %.

In some embodiments, the layer comprises La and Ce, wherein the molar ratio of the La to the Ce is at least about 10:90, and not more than about 90:10.

In some embodiments, at least one of the support or the layer further comprises a promoter comprising at least one of K, Cs, or Rb.

In some embodiments, a molar ratio of the promoter to the active metal particles is at least about 1:2, and not more than about 10:1.

In some embodiments, the active metal particles comprise ruthenium (Ru).

In some embodiments, the concentration of Ru is at least about 0.5, and not more than about 10 wt %.

In some embodiments, the layer comprises nanoparticles of elemental Ru.

In some embodiments, the layer comprises oxide nanoparticles of at least one of La, Ce, K, Cs or Rb.

In some embodiments, the layer comprises annealed nanoparticles of at least one of La, Ce, K, Cs or Rb.

In some aspects, the present disclosure is directed to a method of producing a catalyst for ammonia decomposition, comprising:
(a) providing a support comprising at least one of alumina, silica, carborundum, zeolite, ceria, zirconia, graphite oxide, carbon, graphene, carbon nanofibers, or carbon nanotubes or precursor(s) thereof;
(b) depositing a layer adjacent to the support comprising at least one of an alkali metal oxide or precursors thereof, an alkaline earth metal oxide or precursors thereof, or a rare earth metal oxide or precursor(s) thereof, to form a doped support;
(c) depositing a precursor of one or more active metal particles adjacent to the layer, wherein the one or more active metal particles comprise at least one of Ru, Ni, Rh, Ir, Co, Fe, Pt, Cr, Mo, Pd, or Cu, wherein the concentration of the active metal particles is at least about 0.1 wt % and not more than about 15 wt %; and
(d) maintaining the doped support at a temperature of at least about 200° C. and not more than about 1300° C. for a duration of at least about 0.1 hour and not more than about 168 hours in an atmosphere comprising hydrogen.

In some embodiments, (b) further comprises: maintaining the doped support at a temperature of at least about 20° C. and not more than about 150° C., for a duration of at least about 0.1 hour and not more than about 168 hours in vacuo, or in an inert, anoxic or non-oxidizing atmosphere below 5 bar absolute pressure.

In some embodiments, (b) further comprises maintaining the doped support at a temperature of at least about 300° C. and not more than about 1300° C. for a duration of at least about 0.1 hour and not more than about 168 hours, in a non-reducing atmosphere, comprising at least one of: air, N₂, CO₂, Ar, He, Kr, or Xe.

In some embodiments, (b) further comprises maintaining the doped support at a temperature of at least about 300° C. and not more than about 1300° C. for a duration of at least about 0.1 hour and not more than about 168 hours, in an inert, anoxic or non-oxidizing atmosphere, comprising at least one of: N₂, H₂, Ar, NH₃, CO, CO₂, He, Kr, or Xe.

In some embodiments, the support comprises aluminum and oxygen.

In some embodiments, the layer comprises at least one of theta alumina (θ-alumina) or gamma alumina (γ-alumina).

In some embodiments, the layer comprises a perovskite phase.

In some embodiments, the layer comprises La at a concentration of at least about 0.1 and not more than about 50 mol %.

In some embodiments, the layer comprises La and Ce, wherein a molar ratio of the La to the Ce is at least about 10:90 and not more than about 90:10.

In some embodiments, the layer comprises depositing one or more promoters or promoter precursor(s); wherein the one or more promoters or promoter precursor(s) comprise at least one of K, Cs, or Rb.

In some embodiments, the layer further comprises a molar ratio of the one or more promoters or promoter precursor(s) to the one or more active metal particles comprising at least about 1:2 and not more than about 10:1.

In some embodiments, the one or more active metal particles further comprise ruthenium (Ru).

In some embodiments, a concentration of Ru comprises at least about 0.5 wt % and not more than about 10 wt %.

In some embodiments, (c) the precursor of the one or more active metal particles comprises at least one of Ru(NO)(NO₃)₃, Ru(NO₃)₃, RuCl₃, Ru₃(CO)₁₂, Ru(NH₃)₆Cl₃ (ruthenium(III) chloride hexaammoniate), (CHD)Ru(CO)₃ (cyclohexadiene ruthenium tricarbonyl), (BD)Ru(CO)₃ (butadiene ruthenium tricarbonyl), or (DMBD)Ru(CO)₃ (dimethylbutadiene ruthenium tricarbonyl).

In some embodiments, (a) the support or precursor(s) thereof comprise beads or pellets; wherein the beads or the pellets comprise at least one of (i) a diameter of at least about 0.1 mm and not more than about 10 mm, or (ii) a surface area per unit mass of at least about 50 m²/g and not more than about 500 m²/g.

In some aspects, the present disclosure is directed to a method of ammonia decomposition comprising: contacting a gas comprising ammonia on a catalyst at a temperature ranging from about 400° C. to about 700° C. to generate a reformate stream comprising hydrogen and nitrogen, at an ammonia conversion efficiency of at least about 70% and no more than about 99.9%, wherein the catalyst comprises: a support comprising at least one of alumina, silica, carborundum, zeolite, ceria, zirconia, graphite oxide, carbon, graphene, carbon nanofibers and carbon nanotubes, and a layer adjacent to the support, wherein the layer comprises the support material doped with an oxide of at least one of an alkali metal, an alkaline earth metal and a rare earth metal; and one or more active metal particles adjacent to the layer, wherein the one or more active metal particles comprise at least one of Ru, Ni, Rh, Ir, Co, Fe, Pt, Cr, Mo, Pd, or Cu; and wherein the concentration of the active metal particles is at least about 0.1, and not more than about 15 wt %; and

(b) bringing the catalyst in contact with ammonia at a temperature of at least about 400° C. and not more than about 700° C. to generate a reformate stream comprising hydrogen and nitrogen at an ammonia conversion efficiency of at least about 70% and at most about 99.9%.

In some embodiments, the ammonia is contacted on the catalyst at a space velocity of at least about 1 and not more than about 100 liters of ammonia per hour per gram of catalyst.

In some embodiments, the method further comprises generating electricity by providing hydrogen produced by the catalyst to at least one fuel cell, wherein the at least one fuel cell comprises a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

In some embodiments, the method further comprises generating power or electricity by providing hydrogen produced by the catalyst to one or more combustion engines or turbines.

In some embodiments, a system is configured to reform ammonia using the method of Embodiment 168.

In some embodiments, contacting the catalyst with ammonia to generate the reformate stream is an auto-thermal reforming process so that at least part of the reformate stream provides heat for the auto-thermal reforming process.

In some embodiments, the at least part of the reformate stream is at least one of: (1) combusted to generate the heat, or (2) converted by hydrogen-to-electricity conversion to generate the heat, thereby providing the heat for the auto-thermal reforming process.

In some embodiments, undecomposed ammonia in the reformate stream is removed by an ammonia filter.

In some embodiments, the ammonia filter comprises at least one of an adsorbent, a membrane separation module, or an ammonia scrubber.

In some embodiments, a pressure swing adsorption (PSA) module is used to remove nitrogen from the reformate stream.

In some embodiments, (b) comprises directing the ammonia to a first reformer to generate the reformate stream; wherein the method comprises combusting the reformate stream in a combustion heater to heat a second reformer; and directing additional ammonia to the second reformer to generate additional hydrogen for the reformate stream, wherein a first portion of the reformate stream is combusted to heat the second reformer.

In some embodiments, the first reformer is heated using at least one of an electrical heater or combustion of the reformate stream.

In some embodiments, (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

In some embodiments, (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

In some aspects, the present disclosure is directed to a catalyst for ammonia decomposition, comprising: a support comprising at least one of: alumina, silica, carborundum, zeolite, ceria, zirconia, graphite oxide, carbon, graphene, carbon nanofibers or carbon nanotubes, and a layer adjacent to the support, wherein the layer comprises the support material doped with an oxide comprising at least one of: an alkaline earth metal, Zn, Fe, or Mn; and one or more active metal particles in, on, or adjacent to the layer, wherein the one or more active metal particles comprise at least one of: Ru, Ni, Rh, Ir, Co, Fe, Pt, Cr, Mo, and Pd.

In some embodiments, the support comprises aluminum and oxygen.

In some embodiments, at least one of the support or the layer comprises at least one of alpha-alumina (α-alumina), theta-alumina (0-alumina), or gamma-alumina (γ-alumina).

In some embodiments, the layer comprises a spinel phase.

In some embodiments, the concentration of the one or more active metal particles ranges from about 0.1 wt % to about 15 wt % with respect to the weight of the catalyst.

In some embodiments, the layer comprises at least one of Mg, Ca, Sr, Ba, Zn, Fe, or Mn, wherein a concentration of the at least one of Mg, Ca, Sr, Ba, Zn, Fe, or Mn ranges from about 0.1 mol % to about 80 mol %.

In some embodiments, the support and the layer comprise a modified support comprising an ASTM D7084 (determination of bulk crush strength of catalysts and catalyst carriers) crush strength of at least about 4000 psi (peak stress).

In some embodiments, the one or more active metal particles comprise ruthenium (Ru).

In some embodiments, the concentration of Ru ranges from about 0.5 to about 10 wt %.

In some embodiments, the one or more active metal particles comprises Ru nanoparticles.

In some embodiments, the layer comprises oxide nanoparticles comprising at least one of Mg, Ca, Sr, Ba, Zn, Fe, or Mn.

In some embodiments, the layer comprises annealed nanoparticles comprising at least one of Mg, Ca, Sr, Ba, Zn, Fe, or Mn.

In some embodiments, the catalyst comprises an ASTM D7084 crush strength of at least about 400 psi (peak stress).

In some embodiments, the catalyst is substantially free of promoter.

In some embodiments, the catalyst is substantially free of support surface modifier.

In some aspects, the present disclosure is directed to a method of producing a catalyst for ammonia decomposition, comprising:
(a) providing a support comprising at least one of: alumina, silica, carborundum, zeolite, ceria, zirconia, graphite oxide, carbon, graphene, carbon nanofibers and carbon nanotubes or precursor(s) thereof;
(b) depositing at least one of an alkaline earth metal oxide or precursors thereof, iron oxide or precursor(s) thereof, manganese oxide or precursor(s) thereof, or zinc oxide or precursor(s) thereof, to form a layer in, on, or adjacent to the support, so that the support comprises a doped support comprising the layer and the support;
(c) depositing an oxide or precursor of one or more active metal particles adjacent to the doped support, wherein the one or more active metal particles comprise at least one of: Ru, Ni, Rh, Ir, Co, Fe, Pt, Cr, Mo, Pd, or Cu, wherein a concentration of the one or more active metal particles ranges from about 0.1 to about 15 wt %; and
(d) maintaining the doped support at a temperature of about 300° C. to about 1300° C. for a duration of about 0.1 to about 168 hours in an atmosphere comprising hydrogen.

In some embodiments, the support comprises aluminum and oxygen.

In some embodiments, the layer comprises at least one of alpha-alumina (α-alumina), theta alumina (θ-alumina) or gamma alumina (γ-alumina).

In some embodiments, the layer comprises a spinel phase.

In some embodiments, the alkaline earth metal comprises at least one of Mg, Ca, Sr or Ba, and wherein a concentration of the oxide of at least one of Mg, Ca, Sr, Ba, Zn, Fe, or Mn ranges from about 0.1 to about 80 mol %.

In some embodiments, the support and the layer comprise a modified support comprising an ASTM D7084 crush strength of at least about 4000 psi (peak stress).

In some embodiments, the one or more active metal particles comprise ruthenium (Ru).

In some embodiments, the precursor of Ru comprises at least one of Ru(NO)(NO₃)₃, Ru(NO₃)₃, RuCl₃, or Ru₃(CO)₁₂.

In some embodiments, the concentration of the Ru ranges from about 0.5 to about 10 wt %.

In some embodiments, (b) further comprises: maintaining the doped support at a temperature from about 20° C. to about 150° C., for a duration of about 0.1 hours to about 168 hours in vacuo, or in an inert or a non-oxidizing atmosphere, wherein a pressure of the non-oxidizing atmosphere ranges from about 0.1 bar absolute pressure to about 5 bar absolute pressure.

In some embodiments, (b) further comprises maintaining the doped support at a temperature of about 300° C. to about 1300° C. for a duration of from about 0.1 hours to about 168 hours, in a non-reducing atmosphere comprising at least one member of the group of: air, O₂, N₂, CO₂, Ar, He, Kr, or Xe.

In some embodiments, (b) further comprises maintaining the doped support at a temperature of about 300° C. to about 1300° C. for a duration of from about 0.1 hours to about 168 hours, in an inert, anoxic, or non-oxidizing atmosphere comprising at least one member of the group of: N₂, CO₂, CO, H₂, Ar, He, Kr, or Xe.

In some embodiments, the catalyst comprises an ASTM D7084 crush strength of at least about 400 psi (peak stress).

In some embodiments, the method does not comprise adding a promoter to the catalyst.

In some embodiments, the method does not comprise adding a support surface modifier to the catalyst.

In some embodiments, the support or precursor(s) thereof comprise beads or pellets; wherein the beads or the pellets comprise at least one of (i) a diameter of from about 0.1 to about 10 millimeters (mm), or (ii) a surface area per unit mass of from about 50 to about 1200 m²/g.

In some aspects, the present disclosure is directed to a method of ammonia decomposition comprising: contacting a gas comprising ammonia on a catalyst at a temperature ranging from about 400° C. to about 700° C. to generate a reformate stream comprising hydrogen and nitrogen, at an ammonia conversion efficiency of at least about 70% and no more than about 99.9%, wherein the catalyst comprises: a support comprising at least one of: alumina, silica, carborundum, zeolite, ceria, zirconia, graphite oxide, carbon, graphene, carbon nanofibers, or carbon nanotubes; a layer adjacent to the support, wherein the layer comprises the support material doped with an oxide comprising at least one of: an alkaline earth metal, Zn, Fe, or Mn; and one or more active metal particles adjacent to the layer, wherein the one or more active metal particles comprise at least one of: Ru, Ni, Rh, Ir, Co, Fe, Pt, Cr, Mo, Pd, or Cu; wherein a concentration of the one or more active metal particles ranges from about 0.1 wt % to about 15 wt %.

In some embodiments, the ammonia is contacted on the catalyst at a space velocity of from about 1 to about 50 liters per hour per gram of catalyst at a temperature of from about 450° C. to about 700° C.

In some embodiments, the ammonia is contacted on the catalyst at a gas hourly space velocity (GHSV) of from about 1 to about 50 liters per hour per mL of catalyst at a temperature of from about 450° C. to about 700° C.

In some embodiments, the method further comprises contacting the catalyst with ammonia to generate the reformate stream is an auto-thermal reforming process so that at least part of the reformate stream provides heat for the auto-thermal reforming process.

In some embodiments, the at least part of the reformate stream is at least one of: (1) combusted to generate the heat, or (2) converted by hydrogen-to-electricity conversion to generate the heat, thereby providing the heat for the auto-thermal reforming process.

In some embodiments, undecomposed ammonia in the reformate stream is removed by an ammonia filter.

In some embodiments, the ammonia filter comprises at least one of an adsorbent, a membrane separation module, or an ammonia scrubber.

In some embodiments, a pressure swing adsorption (PSA) module is used to remove nitrogen from the reformate stream.

In some embodiments, the method further comprises generating electricity by directing the hydrogen to at least one fuel cell, wherein the at least one fuel cell comprises: a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

In some embodiments, the method further comprises directing the hydrogen to one or more combustion engines or turbines.

In some embodiments, the method further comprises directing the hydrogen to one or more fuel cells, combustion engines or turbines, to generate electricity and/or motive power.

In some embodiments, the catalyst is substantially free of a promoter or support surface modifier.

In some embodiments, a system is configured to reform ammonia using the method of Embodiment 210.

In some embodiments, (b) comprises directing the ammonia to a first reformer to generate the reformate stream; wherein the method comprises combusting the reformate stream in a combustion heater to heat a second reformer; and directing additional ammonia to the second reformer to generate additional hydrogen for the reformate stream, wherein a first portion of the reformate stream is combusted to heat the second reformer.

In some embodiments, the first reformer is heated using at least one of an electrical heater or combustion of the reformate stream.

In some embodiments, (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

In some embodiments, (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

In some aspects, the present disclosure is directed to a catalyst comprising: a support comprising alumina and a layer adjacent to the support, wherein the layer comprises the support doped with an oxide of a rare earth metal, wherein the rare earth metal comprises at least one of lanthanum (La) or cerium (Ce);

wherein the layer comprises a mixed oxide of aluminum and the rare earth metal, and a concentration of the rare earth metal is at least about 1 and not more than about 15 mol % with respect to the layer and support; wherein the layer does not include a perovskite phase; and

one or more active metals adjacent to the layer, wherein the one or more active metals comprise at least one of ruthenium (Ru), platinum (Pt), or palladium (Pd); and wherein a concentration of the one or more active metals is at least about 0.1, and not more than about 10 wt % with respect to a weight of the catalyst.

In some embodiments, the layer comprises theta alumina (θ-alumina) or gamma alumina (γ-alumina).

In some embodiments, the layer comprises the rare earth metal at a concentration of not more than about 10 mol % with respect to the layer and the support.

In some instances, the layer comprises the rare earth metal at a concentration of about 2 to about 8 mol % with respect to the layer and the support.

In some cases, the layer comprises the rare earth metal at a concentration of 3 to 7 mol % with respect to the layer and the support.

In some instances, the layer comprises the rare earth metal at a concentration of about 4 to about 6 mol % with respect to the layer and the support.

In some embodiments, the rare earth metal is lanthanum (La).

In some cases, the rare earth metal is cerium (Ce).

In some instances, the concentration of the one or more active metals is at least about 0.5 and not more than about 8 wt %, with respect to the weight of the catalyst.

In some embodiments, the concentration of the one or more active metals is at least about 0.5 and not more than about 3 wt %, with respect to the weight of the catalyst.

In some instances, the one or more active metals are nanoparticles.

In some embodiments, the nanoparticles comprise a reduced form of the one or more active metals, after the layer is contacted with a gas comprising hydrogen (H₂) at a temperature ranging from about 300° C. to about 800° C. for at least 1 hour and not more than 40 hours.

In some embodiments, the one or more active metals comprise Ru.

In some embodiments, the concentration of the Ru is not more than about 5 wt %.

In some instances, the layer does not comprise a perovskite phase.

In some embodiments, the catalyst does not comprise an alkali metal and an alkaline earth metal.

In some aspects, the present disclosure is directed to a method of producing a catalyst, comprising:
(a) using at least Al₂O₃ or precursors thereof to form a support comprising at least one of theta alumina (θ-alumina) or gamma alumina (γ-alumina), and (ii) using a rare earth metal comprising at least one of La₂O₃ or precursors thereof or CeO₂ or precursors thereof to produce a layer comprising a mixed oxide of aluminum and lanthanum or aluminum and cerium; and wherein a concentration of the rare earth metal is at least about 1 and not more than about 15 mol % with respect to the layer and support;
(b) depositing at least one precursor of one or more active metals adjacent to the layer, wherein the one or more active metals comprise at least one of ruthenium (Ru), platinum (Pt), or palladium (Pd), and wherein the concentration of the one or more active metals is at least about 0.1 wt % and not more than about 10 wt % with respect to a weight of the catalyst; and
(c) contacting the catalyst with a gas comprising hydrogen (H₂) at a temperature ranging from about 300° C. to about 800° C. for at least 1 hour and not more than 40 hours, to reduce the at least one precursor of the one or more active metals to an elemental state without converting the layer to form a perovskite phase.

In some instances, (a) further comprises maintaining the support at a temperature of at least about 300° C. and not more than about 800° C. for a duration of at least about 0.1 hour and not more than about 168 hours, in a non-reducing atmosphere, comprising at least one of: air, nitrogen (N₂), carbon dioxide (CO₂), argon (Ar), helium (He), krypton (Kr), or xenon (Xe).

In some cases, the layer comprises the rare earth metal at a concentration of not more than about 10 mol % with respect to the layer and support, and the catalyst comprises the one or more active metals at a concentration of not more than about 8 wt % with respect to the weight of the catalyst.

In some instances, the one or more active metals are nanoparticles.

In some embodiments, the one or more active metals comprise Ru, the precursor of the one or more active metals comprises ruthenium nitrosyl nitrate (Ru(NO)(NO₃)₃), and the concentration of Ru is not more than about 5 wt % with respect to the weight of the catalyst.

In some embodiments, incipient wetness impregnation is used to form the layer using the rare earth metal precursors.

In some embodiments, incipient wetness impregnation is used to deposit the at least one precursor of one or more active metals.

In some instances, the Al₂O₃ or precursor(s) thereof comprise beads or pellets, and wherein the beads or the pellets comprise at least one of (i) a diameter ranging from about 0.1 millimeters (mm) to about 10 mm, or (ii) a surface area per unit mass ranging from about 50 m²/g to about 500 m²/g.

In some cases, the catalyst does not comprise an alkali metal and an alkaline earth metal.

In some aspects, the present disclosure is directed to a method of ammonia decomposition comprising: contacting a gas comprising ammonia on a catalyst at a temperature ranging from about 450° C. to about 700° C. to generate a reformate stream comprising hydrogen and nitrogen, at an ammonia conversion efficiency from about 70% to about 99.9%, wherein the catalyst comprises:
a support comprising alumina and a layer adjacent to the support, wherein the layer comprises the support doped with an oxide of a rare earth metal; wherein the rare earth metal comprises at least one of lanthanum (La) or cerium (Ce); wherein the layer comprises a mixed oxide of aluminum and the rare earth metal, and a concentration of the rare earth metal is at least about 1 and not more than about 15 mol % with respect to the layer and support; and
one or more active metals adjacent to the layer, wherein the one or more active metals comprise at least one of ruthenium (Ru), platinum (Pt), or palladium (Pd); wherein a concentration of the one or more active metals is at least about 0.1, and not more than about 15 wt % with respect to the weight of the catalyst; and wherein the catalyst does not comprise an alkali metal or an alkaline earth metal.

In some instances, the layer comprises theta alumina (θ-alumina) or gamma alumina (γ-alumina).

In some cases, the layer comprises the rare earth metal at a concentration of not more than about 10 mol % with respect to the layer and support.

In some embodiments, the rare earth metal is La.

In some cases, the rare earth metal is Ce.

In some instances, the one or more active metals are nanoparticles.

In some embodiments, the nanoparticles comprise a reduced form of the one or more active metals, after the layer is contacted with a gas comprising hydrogen (H₂) at a temperature ranging from about 300° C. to about 800° C. for at least 1 hour and not more than 40 hours.

In some embodiments, the one or more active metals comprise Ru and the concentration of Ru is not more than about 5 wt %.

In some instances, the layer does not comprise a perovskite phase.

In some instances, the gas comprising ammonia is contacted on the catalyst at a space velocity of not more than about 100 liters per hour per gram of catalyst.

In some cases, the method includes generating electricity by providing the generated hydrogen to one or more fuel cells.

In some instances, the method includes contacting the gas comprising ammonia on the catalyst to generate the reformate stream is an auto-thermal reforming process so that at least part of the reformate stream provides heat for the auto-thermal reforming process.

In some embodiments, at least part of the reformate stream is at least one of: (1) combusted to generate the heat, or (2) converted by hydrogen-to-electricity conversion to generate the heat, thereby providing the heat for the auto-thermal reforming process.

In some cases, the method includes contacting the gas comprising ammonia on the catalyst comprises directing the ammonia to a first reformer to generate the reformate stream; wherein the method comprises combusting the reformate stream to heat a second reformer; and directing additional ammonia to the second reformer to generate additional reformate stream, wherein a first portion of the reformate stream, the additional reformate stream, or a combination thereof is combusted to heat the second reformer.

In some instances, the first reformer is heated using at least one of an electrical heater or combustion of the reformate stream.

In some cases, the method includes contacting the gas comprising ammonia on the catalyst comprises directing the ammonia to a reformer at an ammonia flow rate to generate the reformate stream, wherein the method further comprises: combusting a first portion of the reformate stream with oxygen at an oxygen flow rate in a combustion heater to heat the reformer; and processing a second portion of the reformate stream in a hydrogen processing module; and based at least in part on a stimulus, performing one or more of:
i. changing the ammonia flow rate;
ii. changing a percentage of the reformate stream that is the first portion of the reformate stream;
iii. changing a percentage of the reformate stream that is the second portion of the reformate stream; or
iv. changing the oxygen flow rate.

In some cases, the stimulus comprises:
x. a change in an amount of the hydrogen used by the hydrogen processing module;
y. a temperature of the reformer being outside of a target temperature range; or
z. a change in an amount or concentration of ammonia in the reformate stream.

In some embodiments, the hydrogen processing module comprises a fuel cell and the fuel cell provides an anode off-gas comprising hydrogen to the combustion heater.

In some instances, the method includes contacting the gas comprising ammonia on the catalyst comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
i. changing the ammonia flow rate;
ii. changing the oxygen flow rate;
iii. changing a percentage of the reformate stream that is the second portion of the reformate stream;
iv. changing a percentage of the reformate stream that is the first portion of the reformate stream; or
v. changing a percentage of the reformate stream that is directed out of the combustion heater.

In some cases, the hydrogen processing module comprises a fuel cell and the fuel cell provides an anode off-gas comprising hydrogen to the combustion heater.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates an example system for processing ammonia to generate hydrogen fuel, in accordance with some embodiments of the present disclosure.

FIG. 2 schematically illustrates an example method of hydrogen storage using liquid chemicals, in accordance with some embodiments of the present disclosure.

FIG. 3 schematically illustrates an example hydrogen extraction reformer comprising a heterogeneous catalyst, in accordance with some embodiments of the present disclosure.

FIG. 4 schematically illustrates an example process for modifying and enhancing a catalyst support, in accordance with some embodiments of the present disclosure.

FIG. 5 schematically illustrates an example process for processing a precursor material, in accordance with some embodiments of the present disclosure.

FIG. 6A schematically illustrates the effects of reducing a catalyst on ammonia conversion efficiency, in accordance with some embodiments.

FIG. 6B schematically illustrates the effects of thermally treating a catalyst on hydrogen generation or production rates, in accordance with some embodiments.

FIG. 6C schematically illustrates the effects of active metal promotion of a catalyst on ammonia conversion efficiency, in accordance with some embodiments.

FIG. 6D schematically illustrates the effects of doping catalysts on ammonia conversion efficiency, in accordance with some embodiments.

FIG. 6E schematically illustrates the effects of doping catalysts on ammonia conversion efficiency, in accordance with some embodiments.

FIG. 7 schematically illustrates a computer system that is programmed or otherwise configured to implement methods provided herein, in accordance with some embodiments of the present disclosure.

FIG. 8 illustrates a comparison of ammonia conversion efficiencies using various catalysts synthesized using different size alumina carriers, in accordance with some embodiments.

FIG. 9 provides examples of some approaches incorporated herein to fabricate a mixed support.

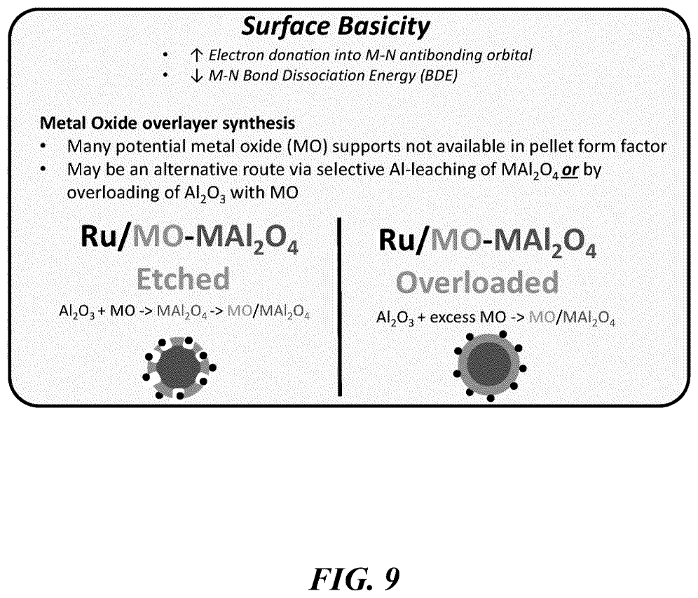

FIG. 10 illustrates the effect of metal oxides on ammonia conversion efficiency for catalysts prepared with composite supports.

FIG. 11 shows the mechanical strength (crush strength) of selected supports, modified supports and catalysts, in accordance with some embodiments.

FIG. 12 illustrates a comparison of catalysts prepared using different alumina supports, with and without addition of a rare earth metal, in accordance with some embodiments.

FIG. 13 illustrates the benefit of minimizing the amount of solvent during the wet impregnation procedure.

FIG. 14 illustrates the effect of impregnation solution volume on the conversion efficiency for various catalysts, in accordance with some embodiments.

FIG. 15 schematically illustrates the methodology for preparing a catalyst by oxidizing the surface of a silicon carbide monolith and depositing other metals and metal oxides onto the silicon dioxide surface.

FIG. 16 presents photographs showing the appearance of silicon carbide supports that have been subjected to electro-oxidation by resistive (Joule) heating.

FIG. 17 is a plot illustrating a comparison of ammonia conversion efficiencies for various catalysts with different surface treatments.

FIG. 18 is a plot illustrating a comparison of ammonia conversion efficiencies for various catalysts with various surface treatments and washcoat applications, in accordance with some embodiments of the present disclosure.

FIG. 19 is a plot illustrating a comparison of ammonia conversion efficiencies for a range of catalysts using washcoats to form layers of alpha-alumina or gamma-alumina on the surface of a monolith, in accordance with some embodiments of the present disclosure.

FIG. 20 is a plot illustrating a comparison of ammonia conversion efficiencies for a series of catalysts using various loadings of active metal and reduction temperatures, in accordance with some embodiments of the present disclosure.

FIG. 21 is a plot illustrating a comparison of ammonia conversion efficiencies for a series of catalysts brought to operating temperature by Joule heating or by heating in a furnace, in accordance with some embodiments of the present disclosure.

FIG. 22 is a plot illustrating rapid heating and high ammonia conversion efficiencies obtained for a Joule heated catalyst, in accordance with some embodiments of the present disclosure.

FIG. 23 is a plot illustrating a comparison of ammonia conversion efficiencies for two Joule heated catalysts aged over several heating and cooling cycles, in accordance with some embodiments of the present disclosure.

FIG. 24 illustrates a comparison of ammonia conversion efficiencies for various catalysts synthesized via reduction at different temperatures, in accordance with some embodiments.

FIG. 25 illustrates a comparison of ammonia conversion efficiencies for various catalysts synthesized using different gamma- and theta-alumina supports, in accordance with some embodiments.

FIG. 26 illustrates a comparison of ammonia conversion efficiencies for various catalysts synthesized using different ruthenium precursors, in accordance with some embodiments.

FIG. 27 illustrates a comparison of ammonia conversion efficiencies for various example catalysts fabricated using different combinations of materials and production methods, in accordance with some embodiments.

FIG. 28 illustrates a comparison of ammonia conversion efficiencies for various catalysts synthesized with different La and Ce ratios, in accordance with some embodiments.

FIG. 29 illustrates a comparison of ammonia conversion efficiencies for various catalysts having different La:Ce molar ratios and variations in ammonia conversion efficiencies based on changes in Ce content, in accordance with some embodiments.

FIG. 30 illustrates a comparison of ammonia conversion efficiencies for various catalysts having different La:Ce molar ratios and variations in ammonia conversion efficiencies based on different operating temperatures, in accordance with some embodiments.

FIG. 31 illustrates the effect of impregnation solution volume on the ammonia conversion efficiency of catalysts containing different amounts of rare earth metal, in accordance with some embodiments.

FIG. 32 illustrates the effect of impregnation solution volume on the ammonia conversion efficiency of catalysts containing different amounts of rare earth metals, in accordance with some embodiments.

FIG. 33 illustrates ammonia conversion efficiencies for catalysts comprising varying amounts of metal oxide on alumina, in accordance with some embodiments, compared with conversion rates of other alumina-supported catalysts previously disclosed.

FIG. 34 illustrates the effect of metal ratio on ammonia conversion efficiency for catalysts prepared with composite supports.

FIG. 35 shows the effect of the metal ratio on ammonia conversion efficiency for Ru catalysts prepared with composite supports.

FIG. 36 provides examples of some strategies contemplated herein to improve the ammonia conversion efficiency of Ru, in accordance with some embodiments.

FIG. 37 shows a comparison of hydrogen production rates of a catalyst of the present disclosure to conventional catalyst of the present disclosure to conventional catalysts, in accordance with some embodiments.

FIG. 38 shows a table describing the conditions at which the catalysts shown in FIG. 33 were tested, in accordance with some embodiments.

FIG. 39 shows ammonia conversion efficiencies of various catalysts as a function of temperature, in accordance with some embodiments.

FIG. 40 shows powder X-ray diffraction (pXRD) spectra of supports comprising varying amounts of ceria with zirconia, in accordance with some embodiments.

FIG. 41 shows pXRD spectra of supports comprising varying amounts of ceria with zirconia, in accordance with some embodiments.

FIG. 42 shows electron binding energy for electrons in the 3P_{3/2} orbital of ruthenium provided on the supports measured using X-Ray Photoelectron Spectroscopy (XPS), in accordance with some embodiments.

FIG. 43 shows Ce³⁺/Ce⁴⁺ ratio determined using XPS, in accordance with some embodiments.

FIGS. 44 and 45 show pXRD spectra of supports and catalysts annealed at various temperatures, in accordance with some embodiments.

FIG. 46 shows ammonia conversion efficiency of catalysts annealed at various temperatures, in accordance with some embodiments.

FIG. 47 shows ammonia conversion efficiencies of various catalysts as a function of temperature, in accordance with some embodiments.

FIGS. 48 and 49 show pXRD spectra of supports and catalysts, respectively, in accordance with some embodiments.

FIG. 50 shows ammonia conversion efficiency of various catalysts, in accordance with some embodiments.

FIG. 51 shows ammonia conversion efficiency of various catalysts with a potassium impregnation step varied in sequence between each catalyst, in accordance with some embodiments.

FIG. 52 shows electron binding energy for electrons in the 3P_{3/2} orbital of ruthenium provided on the supports measured using X-Ray Photoelectron Spectroscopy (XPS), in accordance with some embodiments.

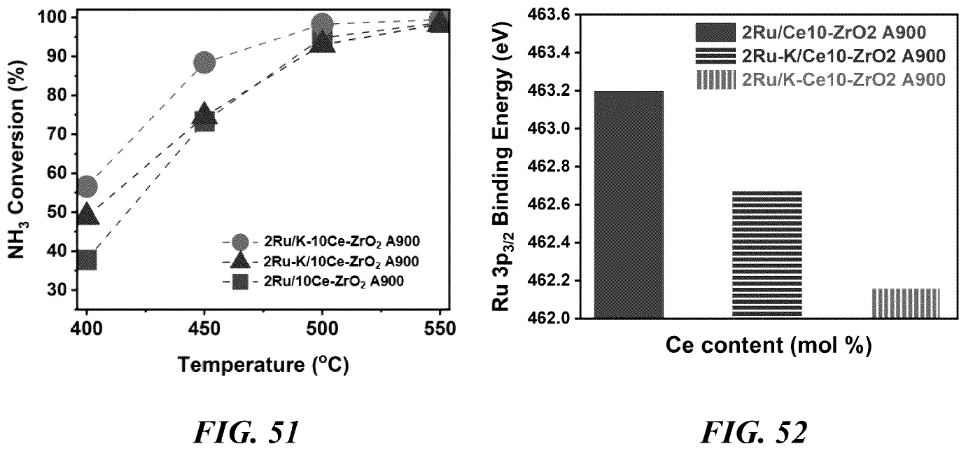

FIG. 53 is a block diagram illustrating an ammonia reforming system, in accordance with one or more embodiments of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It should be understood that any of the embodiments, configurations and/or components described with respect to a particular figure may be combined with other embodiments, configurations, and/or components described with respect to other figures.

The terminology used herein is for the purpose of describing particular embodiments only and is not intended to be limiting of example embodiments. As used herein, the singular forms “a,” “an” and “the” are intended to include the plural forms as well (and vice versa), unless the context clearly indicates otherwise. For example, “a,” “an,” and “the” may be construed as “one or more.”

The present disclosure may be divided into sections using headings. The headings should not be construed to limit the present disclosure, and are merely present for organization and clarity purposes.

Whenever the term “at least”, “at least about”, “greater than”, “greater than about”, “greater than or equal to”, or “greater than or equal to about” precedes the first numerical value in a series of two or more numerical values, the term “at least”, “at least about”, “greater than”, “greater than about”, “greater than or equal to”, or “greater than or equal to about” applies to each of the numerical values in that series of numerical values. For example, greater than or equal to 1, 2, or 3 is equivalent to greater than or equal to 1, greater than or equal to 2, or greater than or equal to 3.

Whenever the term “no more than”, “no more than about”, “not more than”, “not more than about”, “less than”, “less than about”, “less than or equal to”, or “less than or equal to about” precedes the first numerical value in a series of two or more numerical values, the term “not more than”, “no more than about”, “not more than”, “not more than about”, “less than,” or “less than or equal to about” applies to each of the numerical values in that series of numerical values. For example, less than or equal to 3, 2, or 1 is equivalent to less than or equal to 3, less than or equal to 2, or less than or equal to 1.

The terms “at least one of” and “one or more of” may be used interchangeably. The expressions “at least one of A and B” and “at least one of A or B” may be construed to mean at least A, at least B, or at least A and B (i.e., a set comprising A and B, which set may include one or more additional elements). The term “A and/or B” may be construed to mean only A, only B, or both A and B.

The expressions “at least about A, B, and C” and “at least about A, B, or C” may be construed to mean at least about A, at least about B, or at least about C. The expressions “at most about A, B, and C” and “at most about A, B, or C” may be construed to mean at most about A, at most about B, or at most about C.

The expression “between about A and B, C and D, and E and F” may be construed to mean between about A and about B, between about C and about D, and between about E and about F. The expression “between about A and B, C and D, or E and F” may be construed to mean between about A and about B, between about C and about D, or between about E and about F.

The expression “about A to B, C to D, or E to F” may be construed to mean between about A and about B, between about C and about D, or between about E and about F. The expression “about A to B, C to D, or E to F” may be construed to mean between about A and about B, between about C and about D, or between about E and about F.

The terms “substantially free of” and “essentially free of” are used herein interchangeably to mean that the entity being described can have a relatively small amount of the item that it is “essentially free of”. This small amount can be present passively or added deliberately. The threshold of what quantity constitutes “essentially free of” depends on the entity being described and can range from an undetectable amount, to a trace amount, to less than about 0.01%, 0.05%, 0.1%, 0.5%, 1%, or 5%. The threshold quantity can be low enough to not disrupt the essential properties of the entity being described. Similarly, if a method “does not comprise” adding a substance, that is used herein to mean that a substantial amount of the substance is not added, but may be present e.g., as an impurity, or is not added at a quantity sufficient to disrupt the essential properties of the entity being made.

The terms “decompose”, “dissociate”, “reform”, “crack”, “dehydrogenate”, “split”, “strip”, convert”, “break down” and their grammatical variations, may be construed interchangeably. For example, the expression “decomposition of ammonia” may be interchangeable with “dissociation of ammonia”, “reforming of ammonia”, “cracking of ammonia”, “dehydrogenation of ammonia”, “splitting of ammonia”, “stripping of ammonia”, “conversion of ammonia”, “break down of ammonia”, etc.

The term “reformer” refers to the containment vessel(s) in which the ammonia decomposition catalyst is located, and in which the ammonia decomposition reaction(s) occurs. The term “reformer” may be used interchangeably with other commonly-used chemistry and chemical engineering terminology, e.g.: “cracker”, “cracking unit”, “reactor”, “reaction unit”, “reforming unit”, “dehydrogenator”, “dehydrogenation unit”, “dissociator”, “dissociating unit”, “stripper”, “stripping unit”, “splitter”, “splitting unit”, “decomposer”, “decomposing”, “convertor”, “converting unit”, or conversion unit’, “breaker”, “breaker unit”, “breaking unit”, “break down unit”, or “breaking down unit”.

The terms “ammonia conversion” and “ammonia conversion efficiency,” and their grammatical variations, may be construed as a fraction of ammonia that is converted to hydrogen and nitrogen, and may be construed interchangeably. For example, “ammonia conversion” or “ammonia conversion efficiency” of 90% may represent 90% of ammonia being converted to hydrogen and nitrogen.

The term “turnover frequency” may be construed as the forward reaction rate of ammonia decomposition, measured either as ammonia consumption or hydrogen production normalized per unit catalyst per unit time (Amount_{ammonia or hydrogen} Amount_{cat}⁻¹ time⁻¹). Amount_{ammonia or hydrogen} may be measured as mmol_{ammonia or hydrogen}, mol_{ammonia or hydrogen}, g_{ammonia or hydrogen}, or mL_{ammonia or hydrogen}. Amount_{cat} may be measured as g_{cat}, g_{active metal}, g_{surface active metal}, g_{active sites}, mol_{cat}, mol_{active metal}, mol_{surface active metal}, or mol_{active sites}. Time may be measured as seconds, minutes, hours or days.

In some cases, the term “turnover frequency” may be construed as the net reaction rate of ammonia decomposition (i.e., forward reaction minus reverse reaction), measured either as ammonia consumption or hydrogen production normalized per unit catalyst per unit time (Amount_{ammonia or hydrogen} Amount_{cat}⁻¹ time⁻¹). Amount_{ammonia or hydrogen} may be measured as mmol_{ammonia or hydrogen}, mol_{ammonia or hydrogen}, g_{ammonia or hydrogen}, or mL_{ammonia or hydrogen}. Amount_{cat} may be measured as g_{cat}, g_{active metal}, g_{surface active metal}, g_{active sites}, mol_{cat}, mol_{active metal}, mol_{surface active metal}, or mol_{active sites}. Time may be measured as seconds, minutes, hours or days.

The terms “production rate” and “consumption rate” may be construed as the production or consumption of an element, a compound, or chemical species involved in the reaction, measured as a net rate=forward reaction−reverse reaction. The unit for “production rate” and “consumption rate” may be Amount_{ammonia or hydrogen} Amount_{cat}⁻¹ time⁻¹. Amount_{ammonia or hydrogen} may be measured as mmol_{ammonia or hydrogen}, mol_{ammonia or hydrogen}, g_{ammonia or hydrogen}, or mL_{ammonia or hydrogen}. Amount_{cat} may be measured as g_{cat}, g_{active metal}, g_{surface active metal}, g_{active sites}, mol_{cat}, mol_{active metal}, mol_{surface active metal}, or mol_{active sites}. Time may be measured as seconds, minutes, hours or days.

The term “space velocity” may be defined as the volumetric flow rate of the feed gas (e.g. ammonia) relative to the mass of the catalyst material, and may be expressed in units of liters (or milliliters) per hour of gas per gram of catalyst, e.g., L hr⁻¹ g⁻¹, L_{gas} hr⁻¹ g_{cat}⁻¹, L_{NH3} hr⁻¹ g_{cat}⁻¹, Lₐₘₘₒₙᵢₐ hr⁻¹ g_{cat}⁻¹, mL hr⁻¹ g⁻¹, mL_{gas} g_{cat}⁻¹, mL_{NH3} hr⁻¹ g_{cat}⁻¹, or mLₐₘₘₒₙᵢₐ hr⁻¹ g_{cat}⁻¹. The term “Gas Hourly Space Velocity” or GHSV may be defined as the volumetric flow rate of the feed gas (e.g. ammonia) relative to the volume of the catalyst material, and may be expressed in units of liters (or milliliters) per hour of gas per milliliter of catalyst, e.g., L hr⁻¹ mL⁻¹, L_{gas} hr⁻¹ ML_{cat}⁻¹, L_{NH3} hr⁻¹ ML_{cat}⁻¹, Lₐₘₘₒₙᵢₐ hr⁻¹ mL_{cat}⁻¹, mL hr⁻¹ mL⁻¹, mL_{gas} hr⁻¹ mL_{cat}⁻¹, mL_{NH3} hr⁻¹ mL_{cat}⁻¹, or mLₐₘₘₒₙᵢₐ hr⁻¹ ML_{cat}⁻¹.

The term “auto-thermal reforming” may be construed as a condition where an ammonia decomposition reaction (2NH₃→N₂+3H₂; an endothermic reaction) is heated by a hydrogen combustion reaction (2H₂+O₂→2H₂O; an exothermic reaction) using at least part of the hydrogen produced by the ammonia decomposition reaction itself.

In some cases, the term “auto-thermal reforming” may be construed as a condition where an ammonia decomposition reaction is heated by a hydrogen combustion reaction using at least part of hydrogen produced by the ammonia decomposition reaction itself, electrical heating, or a combination of both (which may result in an overall positive electrical and/or chemical energy output). For example, if “auto-thermal reforming” is performed using a hydrogen combustion reaction and/or electrical heating, the hydrogen produced from the ammonia decomposition reaction may be enough to provide the hydrogen combustion reaction with combustion fuel, and/or to provide electrical energy for the electrical heating via hydrogen-to-electricity conversion devices (e.g., fuel cell, combustion engine, etc.).

In some cases, the hydrogen provided for the hydrogen combustion reaction and/or the electrical heating may or may not use the hydrogen from the ammonia decomposition reaction (for example, the hydrogen may be provided by a separate hydrogen source, the electricity may be provided from batteries or a grid, etc.).

In this disclosure, the term “support” may refer to a base support, a composite support, a modified support, or a doped support, as described herein.

In some cases, a “base support” may comprise a relatively inert, thermally stable, mechanically strong material on which compounds may be deposited or impregnated to impart catalytic activity. In some cases, the base support material may comprise a powder, which may be processed into more useful forms for practical use. In some cases, the base support material may comprise a monolith or prefabricated beads, pellets, rods, or other engineered particle shapes. In some cases, the base support material may comprise low thermal and/or electrical resistivity. In some cases, the base support material may comprise high thermal and/or electrical resistivity. In some instances, a base support may be heated treated (e.g., calcined) before use, but not chemically treated.

In some cases, a “composite support” may comprise a base support that has been impregnated with a significant amount of at least one other compound or material, such that the at least one other compound or material comprises greater than about 30% (mole, mass, or volume) of the composite support. A composite support may comprise a monolith that has been washcoated (submerged in a washcoat slurry).

In some instances, a “modified support” may comprise a support or washcoated monolith that has been treated with elements or compounds in the process to improve its porosity and/or its surface characteristics. A modified support may comprise a base support or washcoated monolith that has been treated with an acid or a base, a liquid or a gas, to improve or modify its pore characteristics. A modified support may comprise a base support or washcoated monolith that has been impregnated with support surface modifiers, or precursors thereof, and heat treated to form improved or modified crystal structures or phases on the surface of the support. These crystal structures may comprise one or more perovskite, triclinic, monoclinic, orthorhombic, tetragonal, trigonal, hexagonal, and cubic phases. In some cases, the incorporation of a support surface modifier may comprise the formation of an amorphous surface phase.

In some embodiments, a “doped support” may refer to a base support, composite support, or modified support that has been treated with elements or compounds in the process to fabricate a catalyst based on the support. A doped support may have been impregnated with one or more metals or metal compounds to improve its characteristics as a catalyst. A doped support may comprise a washcoated monolith that has been impregnated with one or more metals or metal compounds to improve its characteristics as a catalyst. In some cases, a doped support may comprise additional elements and/or compounds to modify its thermal and/or electrical resistivity characteristics.

In this disclosure, the term “adjacent” may be construed as interchangeable with “in”, “on”, “against”, “next to”, “near”, “proximal to”, “contacting”, “in contact with”, “in physical contact with”, or “touching”. Therefore, expressions such as “adjacent to the support” may be understood to mean “in the support”, “on the support”, “next to the support”, “in contact with the support”, etc. The use of “adjacent” is intended to remove dependence on orientation or perspective of the support and indicate that, for example, material may be deposited on, in and throughout the structure of a porous or non-porous support material, substrate or monolith

In this disclosure, the term “resistivity” may be defined as the resistance of the catalyst, support material, or support monolith multiplied by a cross-sectional area of the catalyst, support material, or support monolith and divided by a distance that the current passes between the electrodes and through the catalyst, support material, or support monolith. The resistance of the catalyst, support material, or support monolith, and therefore its resistivity, may be measured at a temperature of from at least about 15° C. to no more than about 30° C. The resistance of the electrodes may be measured at a temperature of from at least about 15° C. to no more than about 30° C.

In this disclosure, designations are used to differentiate catalysts by indicating the use of certain active metals, promoters and dopants, with information related to their concentrations and heat treatment conditions. These designations are in the format: xA/P-HT2-mD-S HT1, or xA-P/mD-S HT1. In these designations, “x” represents the wt % of active metal “A”, “P” represents promoter “P”, “m” represents the mol % of dopant “D” incorporated onto support “S”. Components preceding the forward slash (“/”) may be regarded as being supported by components following the forward slash. “HT1” and “HT2” indicate first and second heat treatment steps applied to the support or doped support, before the active metal is applied to the catalyst. If “x” is missing from a catalyst designation, this may indicate that the catalyst comprises 1 wt % of active metal, “A”. If “m” is missing from the catalyst designation, this may indicate that the catalyst comprises 1 mol % of dopant, “D”. If “HT2” is missing from a designation, this may indicate that the catalyst was prepared without a second heat treatment step before incorporation of the active metal. If any of “A”, “P” or “D” are missing, this may indicate that the component they represent was not used. As an example, “5Ru/K-A700-Ce—ZrO₂ C900” may indicate that the catalyst comprises 5 wt % Ru on a modified ZrO₂ support comprising K and 1 mol % Ce, which was calcined at 900° C. after incorporation of Ce, and annealed at 700° C. after incorporation of K. As a further example, “Ru—K/5Ce—ZrO₂ A600” may indicate that the catalyst comprises 1 wt % Ru and K, deposited on a modified ZrO₂ support comprising 5 mol % Ce, which was annealed at 600° C., after incorporation of Ce.

The examples described herein are provided as embodiments to demonstrate the effectiveness of the disclosed catalyst compositions and methods of fabrication. Each of these catalysts were prepared according to the detailed preparation methods described herein.

In one aspect, the present disclosure provides a method of fabricating a catalyst for ammonia processing or decomposition, comprising: (a) providing a catalyst support; (b) thermally, chemically, physically, or electrochemically processing the catalyst support to alter a pore characteristic of the catalyst support; (c) depositing a composite support material on the catalyst support, wherein the composite support material comprises a morphology or a surface chemistry or property; and (d) depositing one or more active metals on at least one of the composite support material and the catalyst support, wherein the one or more active metals comprise one or more nanoparticles configured to conform to the morphology or the surface chemistry or property of the composite support material when subjected to a thermal or chemical treatment, thereby improving one or more active sites on the nanoparticles for ammonia processing or decomposition.

In some cases, the morphology comprises a pore structure, a pore size, a pore shape, a pore volume, a pore density, a pore size distribution, a grain structure, a grain size, a grain shape, a crystal structure, a flake size, or a layered structure. In some instances, the surface chemistry or property comprises an elemental composition, an Arrhenius acidity or basicity, a Lewis acidity or basicity, a surface hydroxyl group density, or a hydrophilicity or hydrophobicity. In some cases, thermally, chemically, physically, or electrochemically processing the catalyst support comprises subjecting the catalyst support to one or more thermal, chemical, physical, or electrochemical processes or treatments to improve one or more pores or a surface chemistry or property of the catalyst support. In some instances, improving the one or more pores comprises (i) modifying a size of the one or more pores, (ii) modifying a pore volume of the catalyst support, (iii) modifying the pore size distribution or (iv) modifying a pore density of the catalyst support. In some cases, improving the surface chemistry or property comprises modifying (i) an Arrhenius acidity or basicity, (ii) a Lewis acidity or basicity, (iii) a surface hydroxyl group density, or (iv) a surface hydrophilicity or hydrophobicity.

In some cases, the composite support material is deposited using physical vapor deposition or chemical vapor deposition. In some instances, the morphology or the surface chemistry or property of the composite support material conforms to a morphology or a surface chemistry or property of the catalyst support. In some cases, the one or more active metals are deposited using physical vapor deposition or chemical vapor deposition. In some instances, the method may further comprise thermally or chemically activating the one or more active metals. In some cases, thermally, physically, chemically, or electrochemically activating the one or more active metals induces a growth of one or more nanoparticles of the active metals. In some instances, the one or more nanoparticles are configured to grow while conforming to the morphology or the surface chemistry or property of the composite support material when thermally, physically, electrochemically, or chemically activated. In some cases, the method may further comprise combining the catalyst with one or more promoters to modify or improve a morphology, an active site, an electron density, an Arrhenius acidity or basicity, a Lewis acidity or basicity, or an electron state of the catalyst.

In some cases, the one or more promoters comprise sodium (Na), potassium (K), rubidium (Rb), cesium (Cs), magnesium (Mg), calcium (Ca), strontium (Sr), or barium (Ba). In some cases, the one or more active metals comprise ruthenium (Ru), nickel (Ni), rhodium (Rh), iridium (Ir), cobalt (Co), molybdenum (Mo), iron (Fe), platinum (Pt), chromium (Cr), palladium (Pd), or copper (Cu). In some cases, the catalyst support comprises aluminum oxide (Al₂O₃), magnesium oxide (MgO), cerium dioxide (CeO₂), silicon dioxide (SiO₂), yttrium oxide (Y₂O₃), zirconium oxide (ZrO₂), one or more zeolites, titanium dioxide (TiO₂), lanthanum oxide (La₂O₃), chromium oxide (Cr₂O₃), calcium oxide (CaO), strontium oxide (SrO), barium oxide (BaO), iron oxide (FeO, Fe₂O₃, Fe₃O₄), manganese oxide (MnO), or zinc oxide (ZnO). In some cases, the composite support material comprises a carbon-based material, a boron-based material, or a metal oxide. In some instances, the carbon-based material comprises graphite, activated carbon (AC), one or more carbon nanotubes (CNT), one or more carbon nanofibers (CNF), graphene oxide (GO), one or more carbon nanoribbons, or reduced graphene oxide (rGO). In some cases, the boron-based material comprises hexagonal boron nitride (hBN), boron nitride nanotubes (BNNT), or boron nitride nanosheets (BNNS). In some instances, the metal oxide comprises aluminum oxide (Al₂O₃), titanium dioxide (TiO₂), magnesium oxide (MgO), strontium oxide (SrO), barium oxide (BaO), lanthanum oxide (La₂O₃), cerium dioxide (CeO₂), yttrium oxide (Y₂O₃), one or more CeO₂ nanotubes, nanorods or nanocubes, mesoporous silica, zirconium dioxide (ZrO₂), chromium oxide (Cr₂O₃), or calcium oxide (CaO). In some cases, the composite support material may include yttria-stabilized zirconia (YSZ), hydrotalcite (Mg₂Al-LDO), a metal organic framework (MOF) (e.g., MIL-101), a zeolitic imidazolate framework (ZIF), an alkaline amide (NaNH₂, Ca(NH₂)₂, Mg(NH₂)₂), an inorganic electride (e.g., C12A7:e-), Halloysite nanotubes (HNT), ABO₃ Perovskite, AB₂O₄ Spinel, a mesoporous silicate (e.g., MCM-41), or any combination thereof.

In some instances, the method may further comprise thermally, physically, chemically or electrochemically treating a surface of the catalyst support material to improve a pore structure or a surface chemistry or property of the catalyst support material. In some cases, the one or more ammonia molecules are configured to bind or attach to the one or more active sites on the active metals for decomposition of the one or more ammonia molecules. In some instances, the positions, orientations, and/or density of the one or more active sites are determined based at least in part on the morphology and/or surface chemistry or property. In some cases, the catalyst support comprises a bead, a pellet, a powder, a thin film, a monolith, a foam, a reformer wall, a heating element, one or more wires, a mesh, engineered or corrugated sheet, or a porous solid material form factor. In some instances, the pore characteristic comprises a pore structure, a pore size, a pore size distribution, a pore shape, a pore volume, or a pore density. In some cases, the method may comprise altering a pore density of the catalyst support. In some instances, the method may comprise increasing the pore density of the catalyst support.

In another embodiment, the present disclosure provides a catalyst for ammonia processing, comprising: a catalyst support comprising one or more modified pore characteristics generated by thermal, physical, chemical, or electrochemical processing of the catalyst support; a composite support material provided on the catalyst support, wherein the composite support material comprises a morphology or a surface chemistry or property; and one or more active metals provided on or embedded in at least one of the composite support material and the catalyst support, wherein the one or more active metals comprise one or more nanoparticles configured to conform to the morphology or the surface chemistry or property of the composite support material when thermally, physically, chemically or electrochemically activated, thereby improving one or more active sites on the nanoparticles for ammonia processing or decomposition.

In some cases, the composite support material is deposited using physical vapor deposition or chemical vapor deposition. In some instances, the morphology or the surface chemistry or property of the composite support material conforms to a morphology or a surface chemistry or property of the catalyst support. In some cases, the one or more active metals are deposited using physical vapor deposition or chemical vapor deposition. In some instances, the one or more active metals are configured to conform to the morphology or the surface chemistry or property of the composite support material when thermally or chemically activated. In some cases, the one or more active metals are configured to grow when thermally, physically, chemically, or electrochemically activated. In some instances, the one or more nanoparticles are configured to grow while conforming to the morphology or the surface chemistry or property of the composite support material.

In some instances, the morphology or the surface chemistry or property is generated or improved by thermally, physically, chemically, or electrochemically treating a surface of the catalyst support material. In some cases, the one or more active metal nanoparticles comprise one or more active sites to which one or more ammonia molecules are configured to attach or bind for decomposition of the one or more ammonia molecules. In some instances, the positions, orientations, or density of the one or more active sites are determined based at least in part on the morphology or surface chemistry or property. In some instances, the catalyst support comprises a bead, a pellet, a powder, a thin film, a monolith, a foam, a reformer wall, a heating element, wires, a mesh, an engineered or corrugated sheet, or a porous solid material form factor.

### Reformer

In an aspect, the present disclosure provides a system for processing a source material. The system may comprise one or more reformers. The one or more reformers may comprise one or more catalysts. The one or more catalysts may be used to process a source material. The one or more catalysts may be improved to enhance the processing of the source material. The source material may comprise, for example, ammonia (NH₃). The source material may be processed to generate a fuel source. The fuel source may comprise, for example, hydrogen and/or nitrogen. The fuel source may be provided to one or more hydrogen fuel cells, which may be configured to use the fuel source to generate electrical energy. Such electrical energy may be used to power various systems, vehicles, and/or devices.

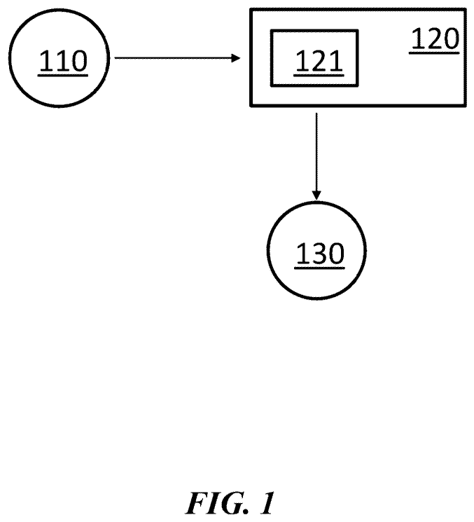

FIG. 1 schematically illustrates a block diagram of an example method for processing a source material to produce electrical energy. A source material 110 may be provided to a reformer 120. The source material 110 may comprise a compound comprising one or more hydrogen molecules. The compound may be, for example, ammonia or NH₃. In some cases, the compound may comprise a hydrocarbon CₓH_{y}, a substituted hydrocarbon CₓH_{y}A_{z} (where A is at least one non-metallic element other than carbon and hydrogen, and z is any integer greater than zero), or another hydrogen gas (e.g., borane) that may release hydrogen when exposed to a catalyst. The source material 110 may be provided to a reformer 120. The source material 110 may be in a gaseous state and/or a liquid state. The reformer 120 may be designed or configured to process the source material 110 using one or more catalysts 121 to extract, produce, or release a fuel source 130 from the source material 110. In some cases, processing the source material 110 may comprise heating the one or more catalysts 121 to extract, produce, or release the fuel source 130 from the source material 110. The fuel source 130 may comprise, but may not be limited to, hydrogen and/or nitrogen. The fuel source 130 may be provided to one or more fuel cells or one or more combustion engines for the generation of electrical energy or mechanical work. Such electrical energy may be used to power various system, vehicles, and/or devices, including, for example, terrestrial, aerial, or aquatic vehicles.

In some instances, the fuel source 130 may be provided to various chemical or industrial processes, including, but not limited to, steel or iron processing, combustion engines, combustion turbines, hydrogen storage, hydrogen for chemical processes, hydrogen fueling stations, etc. In some cases, the fuel source 130 can be supplied as a pilot, auxiliary, or main fuel to the combustion engines or combustion turbines.

As described above, one or more fuel cells may be used to generate electrical energy from the fuel source 130, which may comprise, but may not be limited to, hydrogen and/or nitrogen. In some cases, the one or more fuel cells may generate electricity through an electrochemical reaction between fuels. The fuels may comprise the hydrogen and/or the nitrogen in the fuel source 130. The electricity generated by the fuel cells may be used to power one or more systems, vehicles, or devices. In some instances, excess electricity generated by the fuel cells may be stored in one or more energy storage units (e.g., batteries) for future use. In some optional instances, the fuel cells may be provided as part of a larger fuel cell system. The fuel cell system may comprise an electrolysis module. Electrolysis of a byproduct of the one or more fuel cells (e.g., water) may allow the byproduct to be removed, through decomposition of the byproduct into one or more constituent elements (e.g., oxygen and/or hydrogen). Electrolysis of the byproduct can also generate additional fuel (e.g., hydrogen) for the fuel cell.

As described above, one or more combustion engines may be used to generate electrical energy or mechanical work from the fuel source 130, which may comprise, but may not be limited to, hydrogen and/or nitrogen. In some cases, the one or more combustion engines may generate mechanical work through combustion of one or more fuels. The mechanical work can be converted to electrical energy by one or more electrical generators. The fuels may comprise the hydrogen and/or the nitrogen in the fuel source 130. The electricity or mechanical work generated by the combustion engines may be used to power one or more systems, vehicles, or devices. In some instances, excess electricity or mechanical work generated by the combustion engines may be stored in one or more energy storage units (e.g., batteries) for future use. In some optional instances, the combustion engine may be provided as part of a larger engine or power generation system. The combustion engine system may comprise a combustion chamber. Electrolysis of a byproduct of the one or more combustion engines (e.g., water) may allow the byproduct to be removed, for example, through decomposition of the byproduct into one or more constituent elements (e.g., oxygen and/or hydrogen). Electrolysis of the byproduct can also generate additional fuel (e.g., hydrogen) for the combustion engine.

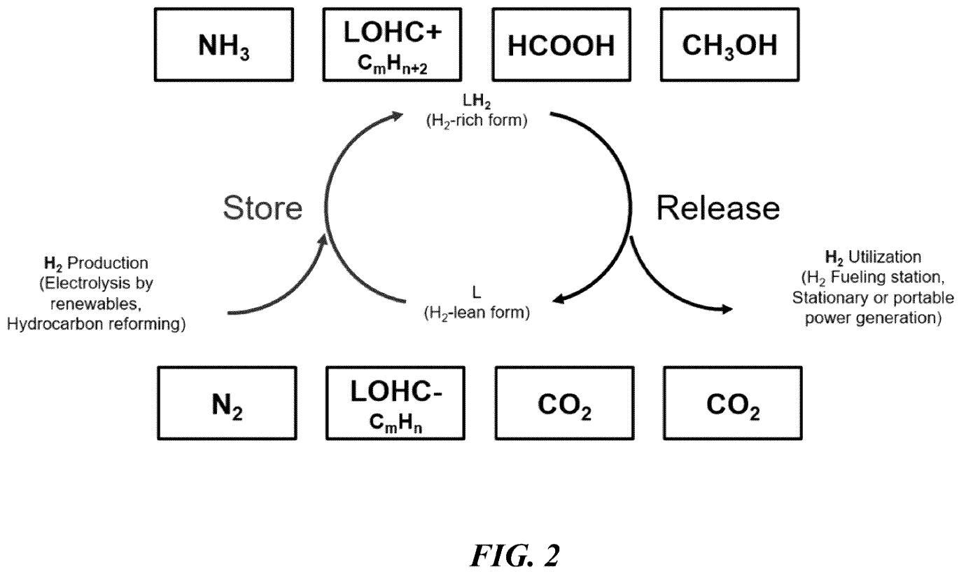

FIG. 2 schematically illustrates an example method of hydrogen storage using liquid chemicals, in accordance with some embodiments. Hydrogen, whether produced by electrolysis of renewables or through hydrocarbon reforming, may be stored using one or more liquid chemicals. In some instances, the one or more liquid chemicals may comprise, for example, ammonia, a liquid organic hydrogen carrier (LOHC), formic acid (HCOOH), or methanol (CH₃OH). The hydrogen may be stored in a hydrogen-rich form or a hydrogen-lean form. The one or more liquid chemicals comprising the hydrogen may be processed as described elsewhere herein to release the hydrogen stored in the liquid chemicals. Once released, the hydrogen may be used for power generation (e.g., stationary or portable power generation), or may be provided to a a hydrogen storage, hydrogen fueling station or hydrogen fueling site.

In some cases, ammonia may be used as a hydrogen carrier. A hydrogen carrier may comprise a fluid or liquid chemical that can be used to store hydrogen. The use of ammonia as an energy carrier provides the benefits of hydrogen fuel (e.g., high volumetric energy density) once the ammonia is broken down into hydrogen, while taking advantage of (a) ammonia's greater volumetric density compared to both gaseous and liquid hydrogen and (b) the ability to transport ammonia at standard temperatures and pressures without requiring complex and highly pressurized storage vessels like those typically used for storing and transporting hydrogen.

In some cases, hydrogenation may be used to store the hydrogen in one or more fluids or liquid chemicals (e.g., ammonia). Hydrogenation may refer to the treatment of materials or substances with molecular hydrogen (H₂) to add one or more pairs of hydrogen atoms to various constituent compounds (e.g., one or more unsaturated compounds) making up the materials or substances. Hydrogenation may be performed using a catalyst, which can allow the reaction to occur under normal conditions of temperature and/or pressure. In some cases, the Haber-Bosch process (an artificial nitrogen fixation process) may be used to produce ammonia. The process may be used to convert atmospheric nitrogen (N₂) to ammonia (NH₃) by a reaction with hydrogen (e.g., H₂ produced or obtained by electrolysis) using a metal catalyst under various reaction temperatures and pressures:

2NH₃↔N₂+3H₂

As described above, the Haber-Bosch process may be used to produce ammonia, which can be used as a hydrogen carrier. Using ammonia as a hydrogen carrier may provide several benefits, including easy storage at relatively standard conditions (0.8 MPa, 20° C. in liquid form), and convenient transportation. Ammonia also has a relatively high hydrogen content (17.7 wt %, 120 grams of H₂ per liter of liquid ammonia). Further, the production of ammonia using the Haber-Bosch process can be powered by renewable energy sources (e.g., solar photovoltaic or solar-thermal), which makes the production process environmentally safe and friendly, as N₂ is the only byproduct and there is no further emission of CO₂. Once the ammonia is produced, it may be processed (e.g., decomposed using a catalyst) to release the hydrogen through a dehydrogenation process. The released hydrogen may then be provided to one or more fuel cells, such as a proton-exchange membrane fuel cell (PEMFC) having a proton-conducting polymer electrolyte membrane, a polymer electrolyte membrane (PEM) fuel cell, a solid-oxide fuel cell (SOFC), or one or more combustion engines having one or more combustion chambers. PEMFCs may have relatively low operating temperatures and/or pressure ranges (e.g., from about 50 to 100° C.). A proton exchange membrane fuel cell can be used to transform the chemical energy liberated during the electrochemical reaction of hydrogen and oxygen into electrical energy, as opposed to the direct combustion of hydrogen and oxygen gases to produce thermal energy. PEMFCs can generate electricity and operate on the opposite principle to PEM electrolysis, which consumes electricity. Combustion engines can generate mechanical work or electricity via combustion of (i) hydrogen and oxygen gases or (ii) hydrogen, ammonia, and oxygen gases. The methods and systems disclosed herein may be implemented to achieve thermally efficient hydrogen production, and may be scaled for application to high energy density power systems.

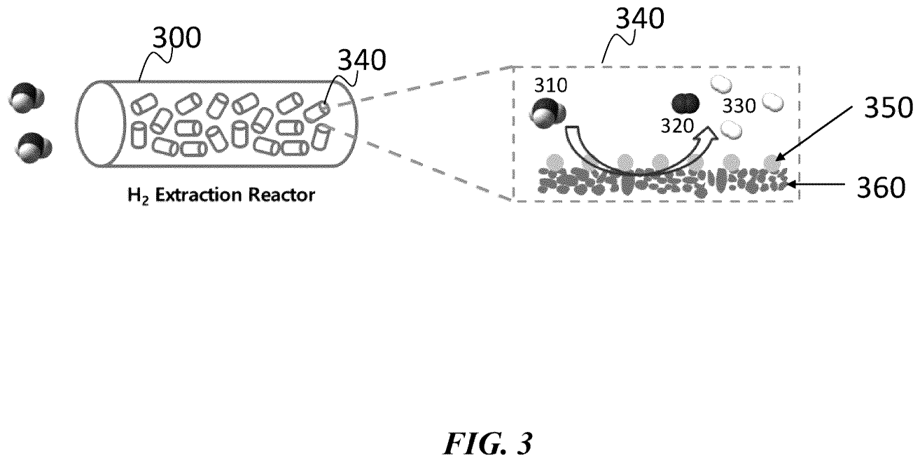

FIG. 3 schematically illustrates a hydrogen extraction reformer 300 for extracting hydrogen from ammonia. The extraction of hydrogen from ammonia may be accomplished using one or more catalysts 340. The one or more catalysts 340 may comprise a heterogenous catalyst. A heterogenous catalyst may comprise a catalyst having a different phase than that of the reactants 310 (e.g., NH₃) or products 320 and/or 330 (N₂ and/or H₂). The one or more catalysts 340 may comprise a plurality of metal nanoparticles 350 embedded in, on, or within a support material 360 (e.g., a composite support and/or a catalyst support as described elsewhere herein). The impregnation of the metal nanoparticles 350 into, onto, or within the support materials 360 may lower an activation energy barrier of the ammonia decomposition reaction, thereby allowing the one or more catalysts 340 to efficiently crack or decompose ammonia at lower reaction temperatures.

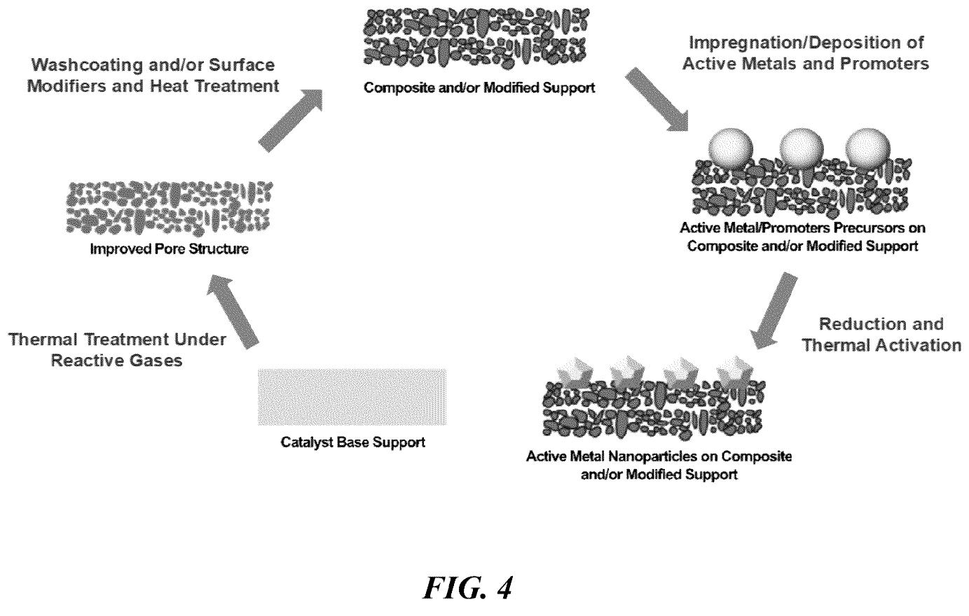

FIG. 4 schematically illustrates various types of enhancements and/or treatments for improving catalyst materials that may be used to crack ammonia. The catalysts may comprise, for example, any metal alloy comprising at least two metals or metalloids selected from: aluminum, boron, calcium, carbon, chromium, cobalt, copper, iron, gallium, germanium, indium, lanthanum, lithium, magnesium, manganese, molybdenum, nickel, niobium, palladium, platinum, potassium, rhenium, rhodium, silicon, sodium, thallium, tin, titanium, tungsten, vanadium, zinc and/or zirconium, e.g., Ni/Cr-a, Ni/Cr-a/Fe-b, Ni/Cr-a/Fe-b/V-c, or Ni/Cr-a/Fe-b/V-c/Al-d, where a, b, c and d each range from 0 to 100. A surface of the catalysts may be processed (e.g., by etching, alloying, overloading, leaching, and/or using one or more acidic treatments) to enhance the surface area and surface characteristics of the catalyst material. The catalysts may also undergo a catalyst coating operation (e.g., by impregnation, physical vapor deposition (PVD), or chemical vapor deposition (CVD)) and/or one or more heat treatment operations. In some cases, the processed catalyst material may comprise a catalyst coated material comprising one or more electrically resistive catalysts.

### Process and Pore Improvement

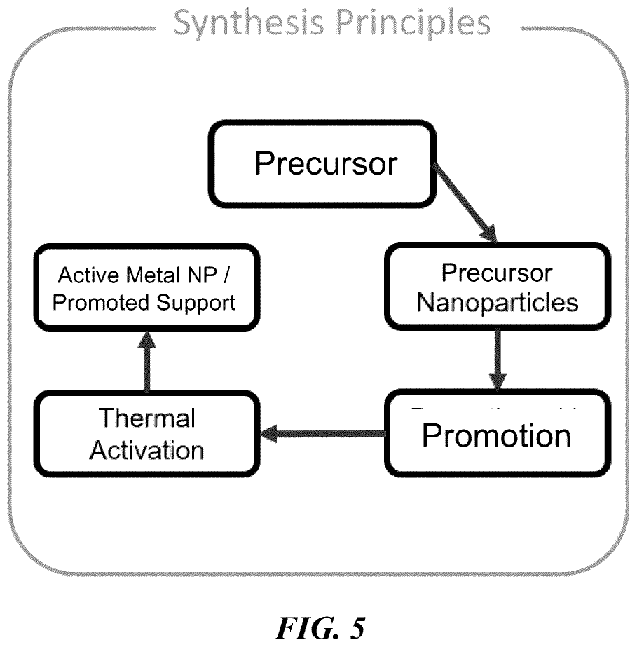

FIG. 5 schematically illustrates an example process for modifying and enhancing a catalyst support. A catalyst support may be provided. The catalyst support may comprise any one or more metals (e.g., aluminum), nonmetals, and/or metalloids. In some cases, the pores of the catalyst support material may be modified. Modifying the pores may comprise, for example, modifying a pore size, a pore density, a pore volume, or a location or distribution of the pores through an area or a volume of the catalyst support material. The pores may be modified chemically (e.g., using corrosive gases or liquid chemicals to selectively etch out pores) or physically (e.g., using one or more thermal treatments under various gases). In some cases, the thermal treatments may change a phase or a state of the catalyst support material, which may also change the pore size of the catalyst support material. In some cases, the pore sizes may be modified differently for different types of reactions or for different types of performance characteristics. In some cases, the thermal treatments may be accompanied by an exposure of the catalyst support material to one or more reactive gases. In some cases, the reactive gases may comprise gases containing one or more of nitrogen (e.g., NO, NO₂, N₂O, NH₃, HCN), sulfur (e.g., H₂S, SO₂), chlorine (e.g., CL₂, HCl), carbon (e.g., CO, CO₂, acetylene and other hydrocarbons), fluorine, or gases generated from plasma (e.g., ozone).

### Metal Foam Catalysts

In some cases, the catalysts may comprise one or more metal foam catalysts. The one or more catalysts may comprise, for example, a modified metal foam catalyst. The catalyst materials may be subjected to or may undergo one or more enhancements and/or treatments as shown and described elsewhere herein. In some cases, the catalyst may comprise a nickel chromium aluminum (NiCrAl) foam, a magnesium aluminum (MgAl) foam, an aluminum cerium lanthanum (AlCeLa) foam, or a cerium zirconium (CeZr) foam.

In some cases, at least one of the first catalyst and the second catalyst may comprise a metal foam catalyst. The metal foam catalyst may comprise nickel, iron, chromium, and/or aluminum. In some cases, the metal foam catalyst may comprise one or more alloys comprising nickel, iron, chromium, aluminum, magnesium, zirconium, cerium, cobalt, copper, molybdenum or lanthanum.

In some cases, the metal foam catalysts may comprise a catalytic coating of one or more powder, bead, pellet or monolithic catalysts. The catalytic coating may comprise a metal material, a promoter material, a dopant material, and/or a support material. The metal material may comprise, for example, ruthenium, nickel, rhodium, rhenium, iridium, cobalt, molybdenum, iron, platinum, chromium, palladium, manganese, tungsten, vanadium and/or copper. The promoter material may comprise, for example, sodium, potassium, rubidium, cesium, magnesium, calcium, strontium and/or barium. In some cases, the dopant may comprise, for example, magnesium, cerium, lanthanum, or other rare earth metals. In some cases, the support material may comprise, for example, at least one of Al₂O₃, alumina, MgO, magnesia, CeO₂, ceria, SiO₂, silica, TiO₂, titania, Y₂O₃, yttria, ZrO₂, zirconia, SiC, carborundum, silicon nitride (SiN, Si₃N₄), nierite, MgAl₂O₄, spinel, CaAl₂O₄, krotite, dmitryivanovitem CoAl₂O₄, cobalt aluminate, hexagonal boron nitride (hBN), one or more boron nitride nanotubes (BNNT), hexagonal boron carbon nitride (hBCN), one or more boron carbon nitride nanotubes (BCNNT) and/or one or more carbon nanotubes. In some instances, the support material may comprise, for example, zinc aluminate (ZnAl₂O₄), gahnite, ferrous aluminate (FeAl₂O₄), hercynite, manganese aluminate (MnAl₂O₄), galaxite, magnesium ferrous aluminate ((MgFe)Al₂O₄), pleonaste, calcium oxide (CaO), lime, quicklime, calcium hydroxide (Ca(OH)₂), slaked lime, calcium carbonate (CaCO₃), calcite, barium oxide (BaO), baria, barium carbonate (BaCO₃), strontium oxide (SrO), strontia, ferrous oxide (FeO), ferric oxide Fe₂O₃), zinc oxide (ZnO), or manganese oxide (MnO). In some cases, the support material may comprise at least one of AlₓO_{y}, MgₓO_{y} CeₓO_{y}, SiₓO_{y}, TiₓO_{y}, YₓO_{y}, ZrₓO_{y}, BₓN_{y}, SiₓC_{y}, SiₓN_{y}, and/or C. In some instances, the catalytic coating may comprise one or more ruthenium-based precursors. The one or more ruthenium-based precursors may comprise a soluble metal salt, for example, RuCl₃, Ru(NO)(NO₃)₃, or Ru₃(CO)₁₂. In any of the embodiments described herein, the metal foam catalyst may have an apparent electrical resistivity of at least about 8 micro ohm-meters (μΩm).

In some cases, the metal foam catalyst may be processed using one or more etching, alloying, leaching, or acidic treatments to enhance a surface area of the metal foam catalyst. In some cases, the metal foam catalyst may be heat treated. In some cases, the metal foam catalyst may be coated using a physical vapor deposition (PVD) treatment and/or a chemical vapor deposition (CVD) treatment.

### Catalysts Based on a Modified Support

In some cases, the metal foam catalyst may be processed using one or more etching, alloying, leaching, or acidic treatments to enhance a surface area of the metal foam catalyst. In some cases, the metal foam catalyst may be heat treated. In some cases, the metal foam catalyst may be coated using a physical vapor deposition (PVD) treatment and/or a chemical vapor deposition (CVD) treatment. In some embodiments, the one or more ammonia decomposition catalysts may comprise a metal material, a promoter material, a dopant material and/or a support material. In some cases, the metal material may comprise, for example, at least one of nickel, rhodium, rhenium, iridium, cobalt, molybdenum, iron, platinum, chromium, palladium, manganese, tungsten, vanadium, zinc and/or copper. In some cases, the promoter material may comprise, for example, at least one of sodium, potassium, rubidium, cesium, magnesium, calcium, strontium, and/or barium. In some cases, the support material may comprise at least one of AlₓO_{y}, MgₓO_{y} CeₓO_{y}, SiₓO_{y}, TiₓO_{y}, YₓO_{y}, ZrₓO_{y}, BₓN_{y}, SiₓC_{y}, SiₓN_{y}, and/or C. In some cases, the support material may comprise, for example, at least one of Al₂O₃, alumina, MgO, magnesia, CeO₂, ceria, SiO₂, silica, SiC, carborundum, TiO₂, titania, Y₂O₃, yttria, ZrO₂, zirconia, SiN, Si₃N₄, nierite, MgAl₂O₄, spinel, CaAl₂O₄, krotite, dmitryivanovite, CoAl₂O₄, hexagonal boron nitride (hBN), one or more boron nitride nanotubes (BNNT), hexagonal boron carbon nitride (hBCN), one or more boron carbon nitride nanotubes (BCNNT) and/or one or more carbon nanotubes.

### Active Metal Nanoparticles

One or more nanoparticles may be used to decompose the ammonia. The one or more nanoparticles may comprise an active metal configured to decompose or facilitate the decomposition of the ammonia. In some cases, the active metal nanoparticles may comprise, for example, ruthenium (Ru), platinum (Pt), palladium (Pd), iron (Fe), nickel (Ni), vanadium (V), molybdenum, (Mo), cobalt (Co), chromium (Cr), copper (Cu) or zinc (Zn). The nanoparticles may comprise one or more binding sites (also referred to herein as active sites) for ammonia to attach to. The binding sites may be determined based on a shape, a morphology, and/or a surface chemistry or property of the active metal nanoparticles. As described elsewhere herein, the morphology of the active metal nanoparticles may correspond to a size, shape, pore structure, pore size, pore shape, pore volume, pore density, pore size distribution, grain structure, grain size, grain shape, crystal structure, flake size, or layered structure of the one or more active metal nanoparticles. As described elsewhere herein, the physical or chemical property of the active metal nanoparticles may comprise an Arrhenius acidity or basicity, a Lewis acidity or basicity, an electron density, an electronic state, or a hydrophilicity or hydrophobicity of the one or more active metal nanoparticles. One or more ammonia particles may attach to the binding sites of the active metal nanoparticles. The active metal nanoparticles may be configured to break the nitrogen-hydrogen (N—H) bonds of ammonia. The morphology and/or surface chemistry or property of the active metal nanoparticles may enhance ammonia adsorption, the breakdown (or scission) of N—H bonds, and hydrogen and/or nitrogen desorption.

### Morphology

The morphology of the nanoparticles may be modified. The morphology may comprise a structure, a size, an aspect ratio, a facet distribution, and/or a shape of the nanoparticles. In some cases, the morphology may comprise a grain structure, grain sizes, and/or grain boundaries. In some cases, the morphology may correspond to a size, shape, pore structure, pore size, pore shape, pore volume, pore density, pore size distribution, grain structure, grain size, grain shape, crystal structure, flake size, or layered structure of the one or more active metal nanoparticles. The morphology of the nanoparticles may be customized or changed to modify the locations and/or the availability of the active sites on a molecular level. The binding sites or the active sites of the nanoparticles may be defined or determined in part based on the morphology of the nanoparticles.

### Surface Chemistry

The chemical and/or physical properties of the nanoparticles may be modified. The chemical and/or physical properties may comprise, for example, a surface chemistry or property of the one or more active metal nanoparticles. The physical and/or chemical property of the active metal nanoparticles may comprise, for example, an Arrhenius acidity or basicity, a Lewis acidity or basicity, an electron density, an electronic state, or a hydrophilicity or hydrophobicity of the one or more active metal nanoparticles. The surface chemistry or property of the nanoparticles may be customized or changed to modify the locations and/or the availability of the active sites on a molecular level. The binding sites or the active sites of the nanoparticles may be defined or determined in part based on the surface chemistry or properties of the nanoparticles.

### Form Factor

In some embodiments, the catalyst support material may comprise a porous material. In some instances, the catalyst support material may comprise a two-dimensional material. In some embodiments, the catalyst may be provided as a coating on a bead or a pellet. This may solve the issue of compressing powdered catalysts into a bead or a pellet form but not being able to use all of the catalyst material in the body of the bead or pellet. In some cases, the catalyst may be provided as a coating on a powder. In some instances, the catalyst may be provided as a mesh, an engineered or corrugated sheet, or as a coating on such constructions. In some cases, the catalyst may be provided as a coating on a porous monolith or a solid foam material. The coating may be improved with a predetermined amount of catalyst material to ensure that at least a threshold amount of the catalyst material is used. The threshold amount may be, for example, at least about 75, 80, 85, 90, 95, or 99% by weight or volume. A plurality of beads or pellets comprising a catalyst material coating may be used in combination with at least one reformer to decompose or crack ammonia in order to generate hydrogen.

### Fabrication of a Modified or Composite Support

In some embodiments, the surface of the catalyst support may be modified or coated. In some cases, the catalyst support material comprising the modified pore characteristics may be coated with an intermediate layer that can act as a platform for one or more active metals or active metal particles to grow. The intermediate layer can be used to change or influence a morphology of the active metal nanoparticles once the active metal nanoparticles are provided on the intermediate layer. In some cases, the intermediate layer may comprise a composite support material. The composite support material may be deposited on the catalyst support material using vapor deposition (e.g., chemical vapor deposition or physical vapor deposition). In some cases, the composite support material may be deposited on the catalyst support material by sputtering.

The composite support material may comprise a morphology and a physical or chemical property (e.g., a surface chemistry). The morphology and/or the physical or chemical properties of the composite support material layer may be used to change or influence the morphology and the physical or chemical properties of the active metal nanoparticles deposited on top of the composite support material. In some cases, the active metal nanoparticles may grow while conforming to the morphology and the physical or chemical properties of the composite support material layer.

In some cases, the catalyst support material may comprise a morphology and a physical or chemical property (e.g., a surface chemistry). The morphology and/or the physical or chemical properties of the catalyst support material layer may be used to change or influence the morphology and the physical or chemical properties of the active metal nanoparticles deposited on top of the catalyst support material or the composite support material. In some cases, the active metal nanoparticles may grow while conforming to the morphology and the physical or chemical properties of the catalyst support material and/or the composite support material layer.

In some cases, the catalyst support may comprise one or more properties or characteristics that may be improved or modified using one or more physical or chemical processes. The one or more properties or characteristics may comprise, for example, a morphology or a surface chemistry or property of the catalyst support. The morphology may comprise a pore structure, a pore size, a pore shape, a pore volume, a pore density, a pore size distribution, a grain structure, a grain size, a grain shape, a crystal structure, a flake size, or a layered structure. The surface chemistry or property may comprise an Arrhenius acidity or basicity, a Lewis acidity or basicity, a surface hydroxyl group density, or a hydrophilicity or hydrophobicity. In some cases, the morphology or the surface chemistry or property of the composite support material may conform to a morphology or a surface chemistry or property of the catalyst support. In some cases, the morphology or the surface chemistry or property of the active metal nanoparticles may conform to the morphology or the surface chemistry or property of the catalyst support material and/or the composite support material. In some cases, the morphology or the surface chemistry or property of the composite support material may conform to the morphology or the surface chemistry or property of the catalyst support material.

In some cases, CVD may be used to deposit a composite support material comprising boron nitride on the catalyst support. A thin layer of the composite support material may be deposited on a surface layer of the catalyst support. CVD may be used to create a network of the composite support material on the existing catalyst support and/or within one or more pores of the catalyst support material. In some cases, the composite support material may comprise various metal oxides (e.g., titanium oxide or one or more other two-dimensional (2D) or three-dimensional (3D) materials).

Depositing the composite support material as an additional layer on top of the catalyst support may be advantageous over the use of a powder form of the composite support material, since a powder form may be difficult to use in a reformer due to the resulting pressure drop. Although compressing the powder into a pellet form can solve pressure drop issues, the composite support materials within the body of the pellet may not be fully utilized, which is wasteful and inefficient. In some cases, a powder may refer to a granular substance comprising a significant portion of particles that comprise sizes less than 1 mm in a characteristic dimension. In some cases, the aspect ratio may be at least about 1:5, 1:4, 1:3, 1:2, 1:1, 2:1, 3:1, 4:1, 5:1, 10:1, 15:1, 20:1, 25:1, 30:1, 35:1, 40:1, or 45:1. In some cases, the aspect ratio may be not more than about 1:4, 1:3, 1:2, 1:1, 2:1, 3:1, 4:1, 5:1, 10:1, 15:1, 20:1, 25:1, 30:1, 35:1, 40:1, 45:1 or 50:1. In some cases, the significant portion may be at least about 5, 10, 20, 30, 40, 50, 60, 70, 80, 90, 95, or 99 by wt %, vol %, or % by count. In some embodiments, the significant portion may be not more than about 10, 20, 30, 40, 50, 60, 70, 80, 90, 95, or 99 by wt %, vol %, or % by count.

### Fabrication of High Surface Area Composite Supports

In some cases, this may involve the use of a pre-formed mixed metal, or mixed metal oxide, composite support. In some cases, this may require the preparation of a composite support, comprising the formation of a M/S, or a M1-M2/S, mixed metal alloy, mixed metal oxide, or mixed metal nitride layer adjacent to the support material, where M1 and M2 represent different metals and S represents the predominant metal in the support. In some embodiments, M, or M1 and M2, may comprise at least one alkaline earth metal. In some embodiments, M, or M1 and M2 may comprise at least one transition metal. In some embodiments, M, or M1 and M2, may comprise at least one rare earth metal. In some embodiments, M, or M1 and M2, may comprise spinel-forming metals. In some cases, M1 and M2 may comprise metals chosen from different groups selected from those listed herein (e.g., M1 may be an alkaline earth metal and M2 may be a transition metal). In some cases, the mixed metal alloy layer is formed during a heat treatment process. In some cases, the heat treatment process may comprise at least one of drying, calcination, annealing, or nitriding.

Various techniques may be used to form or deposit a M, or a M1 M2, layer on the support, as described herein. For this approach, it may be useful to deposit only as much material as necessary to form the desired alloy(s) with the support metal, otherwise it may be possible to form a protective barrier of the deposited metals, metal precursors or metal oxides which will resist further processing to generate the high surface area composite support. In some instances, it may be convenient and practical to use a wet impregnation or incipient wetness technique to deposit metal oxides or precursors on the support surface. In some cases, it may be beneficial to use the correct molarity of precursor solution(s) to achieve this, and not overload the support to reduce or eliminate the formation of free metal, metal oxide or metal nitride particles comprising M, or a mixture of M1 and M2, on top of the layer during a subsequent heat treatment step.

In some cases, the target may be for the doped or composite support to comprise about 50 mol % of the added metal(s). This would result in a molar ratio of about 1:1 for S and M, if only 1 metal was deposited on the support. If 2 metals are deposited, then a molar ratio of about 1:1 for S and (M1 and M2) may be the target, but the molar ratio or mass ratio of M1 and M2 (e.g., about 75:25) may depend on the desired composition of the alloy. In some cases, the target may be for the doped support to comprise about 50 wt % of the added metal(s) and this would result in mass ratio of about 1:1 for S and M, if only 1 metal was deposited on the support. If 2 metals are deposited, then a mass ratio of about 1:1 for S to (M1 and M2) may be the target, but the molar ratio or mass ratio of M1 to M2 (e.g., about 75:25) may depend on the desired composition of the alloy. If the amount of M, or M1 and M2, used is stoichiometric with the metal in the original support, then it is possible to form a layer on the support that comprises a mixed metal ally, mixed metal oxide, or mixed metal nitride with effectively undetectable free metal particles, metal oxides or metal nitrides of M, or M1 and M2.

### Etching

Once the composite support has been prepared, it may be subjected to further processing to modify the characteristics for improved catalyst performance (e.g., activity, selectivity, surface morphology). The generation of a high surface area composite support may involve the preferential removal of one or more metals using an etching process. Various techniques may be employed, such as photochemical, electrochemical, laser, plasma, low-energy ion, and wet chemical etching. Wet chemical etching is a relatively simple and economical technique, which may be suitable for small-scale laboratory and large-scale industrial processes. A wet etching solution may be selected to preferentially remove one or more of the metals from the support or modified support and generate or widen gaps, holes, and pores, and to create or increase inhomogeneities on the surface (e.g., areas of increased acidic or basic nature, and/or electron surplus or electron deficiency). The choice of solution may also depend on the composition of the metals desired to remain in the composite support and whether the solution may reduce or oxidize and dissolve the metal species, or if it will remain inert or form a protective layer that resists further chemical reactions and removal of material.

In some cases, the wet etching solution may comprise an aqueous alkaline solution, e.g., LiOH, NaOH, KOH, NH₃, tetramethyl ammonium hydroxide, and combinations thereof. In some cases, the wet etching solution may comprise an aqueous acidic solution, e.g., H₃PO₄, H₂SO₄, HCl, HNO₃, HF, HClO₄, acetic acid, formic acid, citric acid, oxalic acid, boric acid, tetrafluoro boric acid, and combinations thereof. In some cases, the wet etching solution may comprise an aqueous solution of a reducible or chelating species, e.g., FeCl₃, CuCl₂, SnCl₂, CuSO₄, NaHSO₄, NaCl, Na₂CO₃, NaNO₃, CrO₃, H₂O₂, potassium sodium tartrate, KNaC₄H₄O₆, sodium 3-nitrobenzene sulfonate, and combinations thereof. In some cases, the wet etching solution may comprise solubility improving additives, e.g., gluconates, polyalcohols, amines, fluidizers, leveling agents and complexing agents, and combinations thereof.

The choice of etching solution may be dependent on the composition of the material to be removed and the desired rate of removal. In some cases, a combination of nitric, phosphoric and acetic acids is understood to allow a relatively slow, but very controllable, removal of aluminum and/or aluminum oxide from composite materials. In some instances, the use of aqueous NaOH, KOH or NH₃ solutions allow for a much faster, but less controllable, removal of aluminum and/or aluminum oxide from composite materials. In some cases, the rate of removal of material may also be increased by raising temperature, concentration of active ingredients in solution, agitation of agitation of the solution, and by the use of additional agents as described herein. In some cases, the etching process may be conducted under raised pressure, if the temperature approaches or exceeds the boiling point of the solution under atmospheric conditions. In some cases, the use of an autoclave may enable any or all of the temperature, the pressure, the time duration or the concentration of the etching solution to be reduced.

In some instances, the concentration of the acid or base solution may be at least about 0.01, 0.05, 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, or 19.5M. In some instances, the concentration of the acid or base solution may be not more than about 0.05, 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20M. In some instances, the concentration of the acid or base solution may range from about 0.01 to about 20, 0.1 to 19, 0.5 to 18, 1 to 17, 2 to 16, 3 to 15, 4 to 14, 5 to 13, 5 to 12, 5 to 11, 5 to 10, 6 to 12, 6 to 11, 6 to 10, 6 to 9, 6 to 8, 6 to 7, 7 to 12, 7 to 11, 7 to 10, 7 to 9, 7 to 8, 8 to 12, 8 to 11, 8 to 10, 8 to 9, 9 to 12, 9 to 11, 9 to 10, 10 to 12, 10 to 11, or 11 to 12M.

In some cases, the temperature of the etching solution may be at least about 10, 15, 20, 25, 30, 25, 40, 45, 50, 55, 60, 65, 70, 75, 80, 85, 90, 95, 100, 105, 110, 115, 120, 125, 130, 135, 140, 145, 150, 155, 160, 165, 170, 175, 180, 190, 200, 210, 220, 230, 240, 250, 260, 270, 280 or 290° C. In some cases, the temperature of the etching solution may be not more than about 15, 20, 25, 30, 25, 40, 45, 50, 55, 60, 65, 70, 75, 80, 85, 90, 95, 100, 105, 110, 115, 120, 125, 130, 135, 140, 145, 150, 155, 160, 165, 170, 175, 180, 190, 200, 210, 220, 230, 240, 250, 260, 270, 280, 290 or 300° C. In some cases, the temperature of the etching solution may range from about 10 to about 300, 20 to 250, 30 to 200, 40 to 150, 40 to 140, 40 to 130, 40 to 120, 40 to 110, 40 to 100, 40 to 90, 40 to 80, 40 to 70, 40 to 60, 40 to 50, 50 to 150, 50 to 140, 50 to 130, 50 to 120, 50 to 110, 50 to 100, 50 to 90, 50 to 80, 50 to 70, 50 to 60, 60 to 150, 60 to 140, 60 to 130, 60 to 120, 60 to 110, 60 to 100, 60 to 90, 60 to 80, 60 to 70, 70 to 150, 70 to 140, 70 to 130, 70 to 120, 70 to 110, 70 to 100, 70 to 90, 70 to 80, 80 to 150, 80 to 140, 80 to 130, 80 to 120, 80 to 110, 80 to 100, 80 to 90, 90 to 150, 90 to 140, 90 to 130, 90 to 120, 80 to 110, 90 to 100, 100 to 150, 100 to 140, 100 to 130, 100 to 120, 100 to 110, 110 to 150, 110 to 140, 110 to 130, 110 to 120, 120 to 150, 120 to 140, 120 to 130, 130 to 150, 130 to 140, or 140 to 150° C.

In some instances, the composite support may be immersed in the etching solution for at least about 0.5, 1, 2, 4, 8, 12, 16, 20, 24, 28, 32, 36, 40, 44, 48, 52, 56, 60, 64, 68, 72, 76, 80, 84, 88, 92, 96, 108, 120, 132, 144, 156, 168, 192, 216, 240, 266, 290, or 312 hours. In some instances, the composite support may be immersed in the etching solution for not more than about 1, 2, 4, 8, 12, 16, 20, 24, 28, 32, 36, 40, 44, 48, 52, 56, 60, 64, 68, 72, 76, 80, 84, 88, 92, 96, 108, 120, 132, 144, 156, 168, 192, 216, 240, 266, 290, 312, or 336 hours. In some instances, the composite support may be immersed in the etching solution for a duration ranging from about 0.5 to about 336, 1 to 168, 2 to 144, 24 to 96, 24 to 84, 24 to 72, 24 to 68, 24 to 64, 24 to 60, 24 to 56, 24 to 52, 24 to 48, 24 to 44, 24 to 40, 24 to 36, 24 to 32, 24 to 28, 28 to 96, 28 to 84, 28 to 72, 28 to 68, 28 to 64, 28 to 60, 28 to 56, 28 to 52, 28 to 48, 28 to 44, 28 to 40, 28 to 36, 28 to 32, 32 to 96, 32 to 84, 32 to 72, 32 to 68, 32 to 64, 32 to 60, 32 to 56, 32 to 52, 32 to 48, 32 to 44, 32 to 40, 32 to 36, 36 to 96, 36 to 84, 36 to 72, 36 to 68, 36 to 64, 36 to 60, 36 to 56, 36 to 52, 36 to 48, 36 to 44, 36 to 40, 40 to 96, 40 to 84, 40 to 72, 40 to 68, 40 to 64, 40 to 60, 40 to 56, 40 to 52, 40 to 48, 40 to 44, 44 to 96, 44 to 84, 44 to 72, 442 to 68, 44 to 64, 44 to 60, 44 to 56, 44 to 52, 44 to 48, 48 to 96, 48 to 84, 48 to 72, 48 to 68, 48 to 64, 48 to 60, 48 to 56, 48 to 52, 52 to 96, 52 to 84, 52 to 72, 52 to 68, 52 to 64, 52 to 60, 52 to 56, 56 to 96, 56 to 84, 56 to 72, 56 to 68, 56 to 64, 56 to 60, 60 to 96, 60 to 84, 60 to 72, 60 to 68, 60 to 64, 64 to 96, 64 to 84, 64 to 72, 64 to 68, 68 to 96, 68 to 84, 68 to 72, 72 to 96, 72 to 84, or 84 to 96 hours.

In some cases, the composite support may be immersed in the etching solution at a pressure of at least about 1, 1.5, 2, 2.5, 3, 3.5, 4, 4.5, 5, 6, 7, 8, 9, 10, 15, 20, 25, 30, 35, 40, or 45 bar absolute pressure. In some cases, the composite support may be immersed in the etching solution at a pressure of not more than about 1.5, 2, 2.5, 3, 3.5, 4, 4.5, 5, 6, 7, 8, 9, 10, 15, 20, 25, 30, 35, 40, 45, or 50 bar absolute pressure. In some cases, the composite support may be immersed in the etching solution at a pressure ranging from about 1 to about 10, 1 to 9, 1 to 8, 1 to 7, 1 to 6, 1 to 5, 1 to 4.5, 1 to 4, 1 to 3.5, 1 to 3, 1 to 2.5, 1 to 2, 1 to 1.5, 1.5 to 10, 1.5 to 9, 1.5 to 8, 1.5 to 7, 1.5 to 6, 1.5 to 5, 1.5 to 4.5, 1.5 to 4, 1.5 to 3.5, 1.5 to 3, 1.5 to 2.5, 1.5 to 2, 2 to 10, 2 to 9, 2 to 8, 2 to 7, 2 to 6, 2 to 5, 2 to 4.5, 2 to 4, 2 to 3.5, 2 to 3, 2 to 2.5, 2.5 to 10, 2.5 to 9, 2.5 to 8, 2.5 to 7, 2.5 to 6, 2.5 to 5, 2.5 to 4.5, 2.5 to 4, 2.5 to 3.5, 2.5 to 3, 3 to 10, 3 to 9, 3 to 8, 3 to 7, 3 to 6, 3 to 5, 3 to 4.5, 3 to 4, 3 to 3.5, 3.5 to 10, 3.5 to 9, 3.5 to 8, 3.5 to 7, 3.5 to 6, 3.5 to 5, 3.5 to 4.5, 3.5 to 4, 4 to 10, 4 to 9, 4 to 8, 4 to 7, 4 to 6, 4 to 5, 4 to 4.5, 4.5 to 10, 4.5 to 9, 4.5 to 8, 4.5 to 7, 4.5 to 6, 4.5 to 5, 5 to 10, 5 to 9, 5 to 8, 5 to 7, 5 to 6, 6 to 10, 6 to 9, 6 to 8, 6 to 7, 7 to 10, 7 to 9, 7 to 8, 8 to 10, 8 to 9, or 9 to 10 bar absolute pressure.

### Addition of Active Metal

One or more active metals may be deposited on the catalyst support material or the composite support material. The active metals may be deposited using various methods, including, for example, CVD, PVD, sol-gel and wet impregnation. The active metals may be deposited on top of the composite support and also within the one or more modified pores of the catalyst support material as active metal nanoparticles. This may facilitate decomposition of any ammonia molecules that penetrate through the pores of the catalyst support. The deposition of the active metal nanoparticles on the composite support may also be referred to herein as an impregnation of the composite support with one or more active metal nanoparticles.

Once deposited on or within the catalyst support material and/or the composite support material, the active metal nanoparticles may grow according to a morphology and/or a physical or chemical property of the composite support material. In some cases, the composite support material may comprise a hexagonal shaped grain. The active metal nanoparticles may grow while maintaining a grain shape corresponding to the grain shape of the composite support material. In some cases, the active metal nanoparticles may grow while maintaining a hexagonal grain shape. The composite support material may provide a 2D structure or platform for active metal nanoparticle growth. The active metal nanoparticles may grow while conforming to a structure of the composite support material. In some instances, the composite support material may comprise boron nitride. The active metal nanoparticles may grow while maintaining the hexagonal morphology of the composite support material. In some cases, the catalyst may undergo one or more thermal treatments in a vacuum state (i.e., below atmospheric pressure) and/or in the presence of various gases such as hydrogen gas or ambient air. Such thermal treatments may be used to thermally activate the active metal nanoparticles embedded in the composite support structure to facilitate the change in the morphology and/or the physical or chemical properties of the active metal nanoparticles to conform to the morphology and/or the physical or chemical properties of the materials or particles (e.g., atoms or molecules) constituting the composite support.

Use of Promoters with Active Metals

In some cases, the composite material and/or the one or more active metal nanoparticles embedded in the composite material may be promoted (e.g., with a Group 1 or Group 2 metal) to change an electron state or an electron density of the active metal nanoparticles. As described above, the active metal nanoparticles may comprise, for example, ruthenium, cobalt or molybdenum. In some cases, the modified electron state or electron density may facilitate recombinative nitrogen desorption and/or N—H bond cleavage during an ammonia decomposition reaction.

The methods and processes disclosed herein for fabricating composite catalysts may be implemented to produce catalysts with one or more desirable properties or performance characteristics (e.g., efficient hydrogen production). The catalysts may lower the activation energy barrier for the ammonia decomposition reactions, and can facilitate reactions at lower temperatures while increasing throughput and enhancing the efficient utilization of precious metals. The presently disclosed methods and processes may be adapted and scaled for economical mass fabrication of high performance, highly efficient catalysts.

FIG. 5 shows an example method for synthesizing the one or more active metal nanoparticles. In some cases, the active metal nanoparticles may be fabricated from a precursor material (e.g., a precursor material comprising Ru, Co, or Mo). The active metal nanoparticles may be promoted with one or more alkali or alkaline earth metals. The promoters may comprise one or more substances (e.g., co-catalysts) that can be added to increase ammonia conversion efficiency or selectivity. The one or more active metal nanoparticles may undergo one or more thermal treatments that thermally activate the active metal nanoparticles so that the active metal nanoparticles undergo growth and a change in morphology or physical/chemical property to mirror the morphology and/or the physical or chemical properties of the composite support material in which or on which the active metal nanoparticles are deposited. The systems and methods described herein may be used to control the morphology, surface chemistry, and/or the dispersion of the active metal nanoparticles, and to control interactions between the active metal nanoparticles and the composite support or catalyst support. The systems and methods of the present disclosure may also be used to modify one or more active sites on the active metal nanoparticles for breaking down and decomposing or cracking one or more ammonia molecules.

The improved catalysts described herein may exhibit enhanced ammonia decomposition performance and increased ammonia conversion efficiencies. The ammonia conversion efficiency for the improved catalysts may be a function of reaction temperature. In some cases, the ammonia conversion efficiency may comprise at least about 90% at reaction temperatures of about 500° C. In some cases, the ammonia conversion efficiency may be greater than about 70% and less than about 99% at reaction temperature ranging from about 450° C. to about 600° C.

### Thermal and Chemical Treatment of Supports

In some embodiments, the catalyst fabrication methods may comprise a thermal treatment under reactive gases. Such thermal treatment may be used to modify the porosity of the support for improved mass transfer. Such thermal treatment may also be used to modify one or more properties of the support (e.g., the chemical composition, basicity or acidity of the support) for better surface modification results.

In some embodiments, the catalyst fabrication methods may comprise a surface modification and coating step. The surface modification and coating step may comprise an intermediate layer deposition by PVD or CVD. PVD or CVD may be used to coat a support geometry with a thin, uniform layer of functional materials. The coating layer may have a thickness that ranges from about at least about 1 nanometer to about 30,000 nanometers (30 microns). The functional materials may serve as a platform for nanoparticle growth. In some cases, the morphology and/or the physical or chemical properties of the functional materials may influence a growth and/or a morphology or a surface chemistry of the nanoparticles.

In some embodiments, the catalyst fabrication methods may comprise impregnation of active metal nanoparticles. The impregnation may comprise precursor impregnation with vacuum vapor deposition or incipient wet impregnation. This can allow for control of the precursor anchoring on the functional materials.

In some embodiments, the catalyst fabrication methods may comprise promoting and thermal, physical, chemical or electrochemical activation. Promoting may comprise impregnation of promoter materials (e.g., alkali metals and or alkaline-earth metals) into the active metal and/or composite support material to facilitate electron density modification and modification or improvement of a morphology or an active site of the catalyst. Thermal and/or chemical activation may also be used to modify the morphology of the active metal nanoparticles under a reducing environment (e.g., an environment comprising hydrogen gas) or in the presence of one or more noble gases.

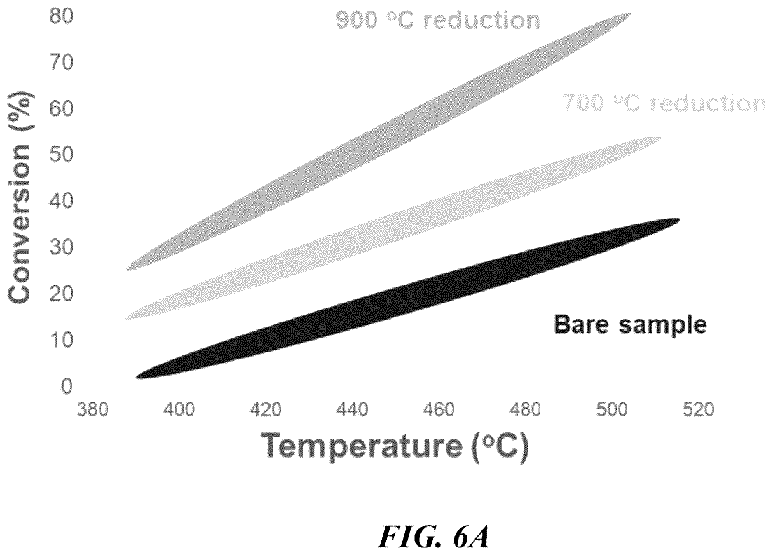

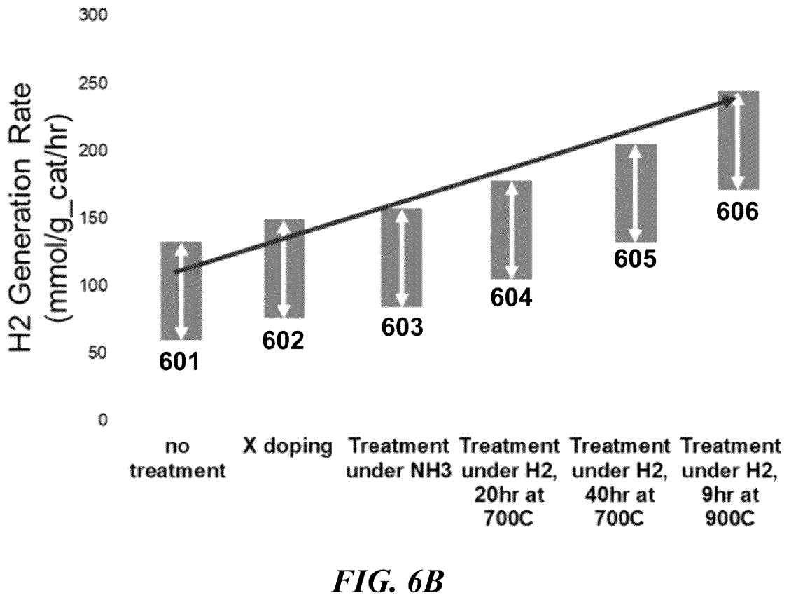

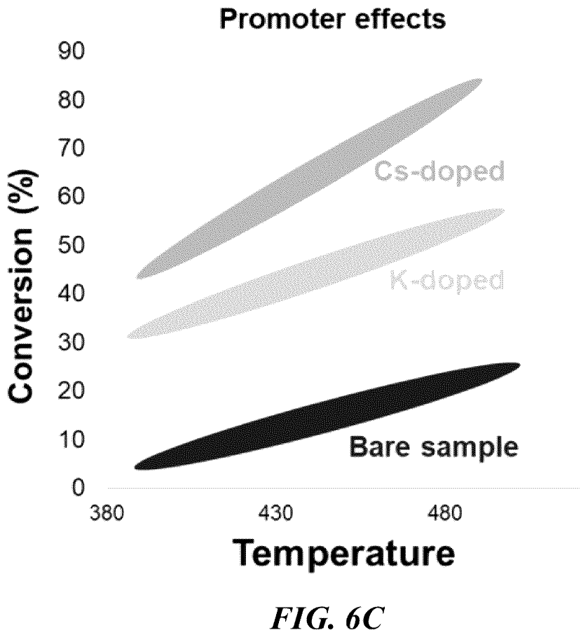

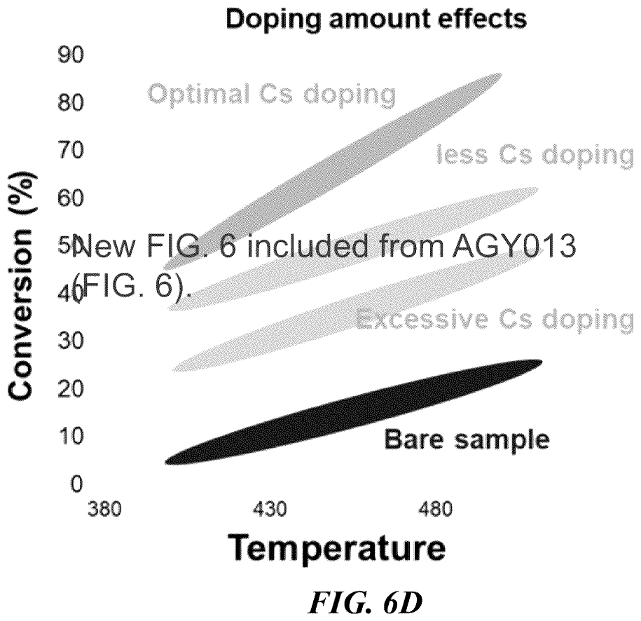

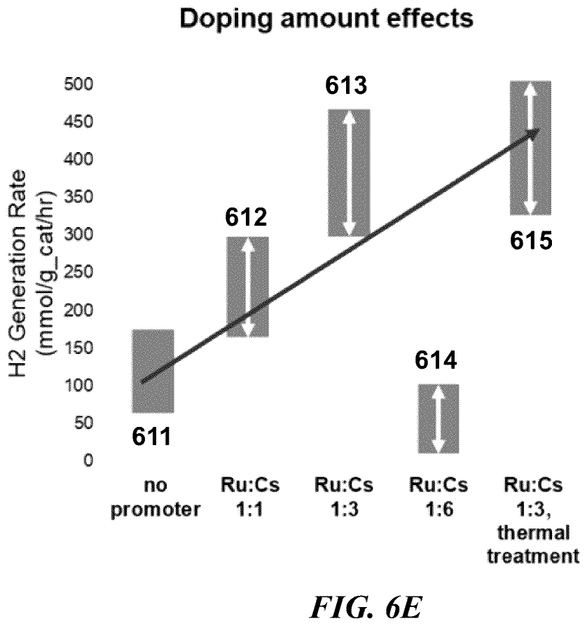

FIG. 6A schematically illustrates the effects of reducing Ru-alumina catalysts on ammonia conversion efficiency, in accordance with some instances of the present disclosure. The catalysts of the present disclosure may be doped, promoted and/or thermally treated in an appropriate manner to improve catalyst performance and ammonia conversion efficiency. Compared to a bare sample catalyst (i.e., a catalyst that has not undergone doping, promotion and/or thermal treatment), a catalyst that has been doped, promoted and thermally treated may exhibit a higher ammonia conversion efficiency. A higher temperature or treatment time may result in better performance of the catalyst. For example, a bare sample catalyst may exhibit up to about a 30% ammonia conversion efficiency at temperatures of about 500° C. Surprisingly, a catalyst that has been doped, promoted and thermally treated at 700° C. may exhibit at least about a 60% ammonia conversion efficiency or more at temperatures of about 500° C. Unexpectedly, a catalyst that has been doped, promoted and thermally treated at 900° C. may exhibit at least about an 80% ammonia conversion efficiency or more at temperatures of about 500° C.

Described herein is an example of the effect of reduction temperature and duration on hydrogen generation or production rates, in accordance with some embodiments. In some cases, catalyst performance maybe improved by a factor of about 2 or more, by higher temperature and/or longer duration thermal treatment under H₂. With reference to FIG. 6B, shown here is a base Ru-alumina catalyst 601, with no dopant or thermal treatment that may have a hydrogen generation rate that may be not more than about 125 mmol H₂ g_{cat}⁻¹ h⁻¹ (mmol of hydrogen per gram of catalyst material per hour). The base catalyst can be treated with a dopant (“X”) before the Ru is deposited 602, and this may have a hydrogen generation rate that is about 150 mmol_{H2} g_{cat}⁻¹ h⁻¹ Treatment in a NH₃ atmosphere may improve the base catalyst may hydrogen generation rate that is about 150 mmol_{H2} g_{cat}⁻¹ h⁻¹ 604. Alternatively, the base catalyst may be thermally treated in a H₂ atmosphere at 700° C. for 20 hours 606 or for 40 hours 608, or for 9 hours at 900° C. 610, increasing the hydrogen generation rates up to about 175, 200 and 250 mmol_{H2} g_{cat}⁻¹ respectively.

FIG. 6C schematically illustrates the effects of active metal promotion of catalysts on ammonia conversion efficiency, in accordance with some embodiments of the present disclosure. The catalysts of the present disclosure may be promoted with one or more alkaline metals. In some cases, cesium may be one of the most effective promoters for X-Al₂O₃ catalysts. However, in some cases, excessive promotor incorporation may deteriorate catalyst performance and hydrogen generation or production rates. As such, an improved promoter amount exists for catalyst materials. The catalysts of the present disclosure may be doped, promoted and/or thermally treated in an appropriate manner to improve catalyst performance and hydrogen generation or production rates.

In some embodiments, the catalysts may not contain alkali metals or alkaline earth metals. In some embodiments, the catalysts may be essentially free of alkali metals or alkaline earth metals. In some embodiments, the catalysts may not contain a promoter. In some embodiments, the catalysts may be essentially free of a promoter.

In some cases, a bare sample catalyst may exhibit an ammonia conversion efficiency of at most about 20% at temperatures of about 500° C. A catalyst that has been promoted with potassium may exhibit an ammonia conversion efficiency that is at least about 60% or more at temperatures of about 500° C. A catalyst that has been promoted with cesium may exhibit an ammonia conversion efficiency that is at least about 85% or more at temperatures of about 500° C.

FIG. 6D schematically illustrates the effects of doping base Ru-ammonia catalysts on ammonia conversion efficiency and hydrogen generation or production rate, in accordance with some embodiments. Surprisingly, a catalyst with more effective levels of promoter for the active metal content may exhibit an ammonia conversion efficiency that is at least about 85% or more at temperatures of about 500° C. On the other hand, catalysts with lower or higher promoter levels may have a reduced ammonia conversion efficiency (e.g., from about 20% to about 60% or less).

Described herein is an example of the effect of promoter concentration and molar ratio of active metal to the promoter, for some Ru-alumina catalysts. Compared to the base Ru-alumina catalyst, inclusion of promoter at a 1:1 molar ratio of active metal and promoter improved catalyst performance, compared to the same catalyst without promoter. As promoter concentration increases to a more effective molar ratio of active metal to promoter (e.g., 1:3), catalyst performance continues to improve. However, increasing the promoter concentration still further, catalyst performance unexpectedly reduces to below the base level. Surprisingly, additional thermal treatment may further improve catalyst performance when the more effective molar ratio of active metal and promoter is used.

With reference to FIG. 6E shown here is the base Ru-alumina catalyst 611, with no promoter or thermal treatment, that exhibits a hydrogen generation rate of not more than about 175 mmol_{H2} g_{cat}⁻¹ h⁻¹, 612. The base catalyst may be doped with a promoter (Cs) to achieve a molar ratio of Ru and Cs of 1:1, increasing the hydrogen generation rate up to about 300 mmol_{H2} g_{cat}⁻¹ h⁻¹, 612. The base catalyst may be doped with a higher concentration of promoter, to achieve a molar ratio of Ru and Cs of 1:3, 613, and may be further subjected to additional thermal treatment 615, resulting in hydrogen generation rates of up to about 460 and 500 mmol_{H2} g_{cat}⁻¹ h⁻¹, respectively. Increasing the concentration of promoter still further, to a molar ratio of Ru and Cs of 1:6, significantly reduces hydrogen rate to not more than about 100 mmol_{H2} g_{cat}⁻¹ h⁻¹, 614.

### Materials

In any of the embodiments described herein, the catalyst support materials may comprise, for example, a metal oxide-based support having one or more micropores or mesopores. In some cases, the support materials may comprise, for example, aluminum (Al), iron (Fe), carbon (C), silicon, (Si), titanium (Ti), tantalum (Ta), platinum (Pt), palladium (Pd), nickel (Ni), nickel-chromium (Ni—Cr), Nicralloy (Ni—Cr—Al), Fecralloy (Fe—Cr—Al—Y), Field's metal (In—Bi—Sn) based metal foams, monoliths, or engineered sheets, foils, or mesh designs. In some embodiments, the catalyst support material may comprise one or more of aluminum oxide (Al₂O₃), alumina, magnesium oxide (MgO), magnesia, magnesium aluminate (MgAl₂O₄), spinel, cerium dioxide (CeO₂), ceria, silicon dioxide (SiO₂), silica, silicon carbide (SiC), carborundum, yttrium oxide (Y₂O₃), yttria, one or more zeolites (e.g., MFI zeolite, MCM-41 zeolite, Y type zeolite, X type zeolite), titanium dioxide (TiO₂), titania, zirconium dioxide (ZrO₂), zirconia, lanthanum oxide (La₂O₃), lanthana, chromium oxide (Cr₂O₃), or chromia. In some instances, the catalyst support material may comprise one or more of AlₓO_{y}, MgₓO_{y} CeₓO_{y}, SiₓO_{y}, YₓO_{y}, TiₓO_{y}, ZrₓO_{y}, LaₓO_{y}, or CrₓO_{y}.

In any of the cases described herein, the composite coating materials may comprise a carbon-based material, a boron-based material, or a metal oxide. The carbon-based material may comprise, for example, activated carbon (AC), one or more carbon nanotubes (CNT), carbon nanofibers (CNF), graphene oxide (GO), graphite, one or more carbon nanoribbons, or reduced graphene oxide (rGO). The boron-based material may comprise, for example, hexagonal boron nitride (hBN), boron nitride nanotubes (BNNT), hexagonal boron carbon nitride (hBCN), boron carbon nitride nanotubes (BCNNT), boron nitride nanosheets (BNNS), or boron carbon nitride nanosheets (BCNNS). The metal oxide may comprise, for example, TiO₂, titania, MgO, magnesia, magnesium aluminate (MgAl₂O₄), spinel, La₂O₃, lanthana, CeO₂, ceria, Y₂O₃, yttria, one or more CeO₂ nanotubes, nanorods or nanocubes, mesoporous silica (e.g., KIT-6), ZrO₂, or zirconia. The metal oxide may comprise, for example, strontium oxide (SrO), strontium aluminate (SrAl₂O₄), barium oxide (BaO), barium aluminate (BaAl₂O₄), zinc aluminate (ZnAl₂O₄), gahnite, ferrous aluminate (FeAl₂O₄), hercynite, manganese aluminate (MnAl₂O₄), galaxite, magnesium ferrous aluminate ((MgFe)Al₂O₄), pleonaste, calcium oxide (CaO), lime, quicklime, calcium hydroxide (Ca(OH)₂), slaked lime, calcium carbonate (CaCO₃), calcite, ferrous oxide (FeO), zinc oxide (ZnO), or manganese oxide (MnO).

In any of the embodiments described herein, the active metals or the active metal nanoparticles may comprise, for example, ruthenium (Ru), nickel (Ni), cobalt (Co), iron (Fe), copper (Cu), molybdenum (Mo), zinc (Zn), iridium (Ir), rhenium (Re), platinum (Pt), or palladium (Pd). The one or more active metals may be fabricated from one or more precursor materials. The precursor materials may comprise, for example, ruthenium chloride (RuCl₃), ruthenium nitrosylnitrate (Ru(NO)(NO₃)₃), triruthenium dodecacarbonyl (Ru₃(CO)₁₂), ruthenium acetylacetonate (Ru(AcAc)₃), ruthenium nitrate (Ru(NO₃)₃), ruthenium hexamine chloride (Ru(NH₃)₆Cl₃), cyclohexadiene ruthenium tricarbonyl ((CHD)Ru(CO)₃), butadiene ruthenium tricarbonyl ((BD)Ru(CO)₃), or dimethyl butadiene ruthenium tricarbonyl ((DMBD)Ru(CO)₃), cobalt chloride (CoCl₂), iron acetylacetonate (Fe(AcAc)₂), copper nitrate (Cu(NO₃)₂), nickel nitrate (Ni(NO₃)₂), manganese nitrate (Mn(NO₃)₂), zinc sulfate (ZnSO₄), cobalt molybdate (CoMoO₄), chromium hexacarbonyl (Cr(CO)₆), or ammonium molybdate ((NH₄)₆Mo₇O₂₄).

As described above, in some cases one or more promoter(s) or promoting materials may be used to modify or enhance an electron density of the active metal nanoparticles and/or the composite support material. In any of the instances described herein, the one or more promoters or promoting materials may comprise, for example, cesium (Cs), rubidium (Rb), potassium (K), sodium (Na), barium (Ba), strontium (Sr), calcium (Ca), or magnesium (Mg). In some cases, excessive concentrations of promoter materials may deteriorate the catalyst performance and ammonia conversion efficiency (i.e., a more efficient and/or effective amount of doping material exists). As discussed above, the catalysts of the present disclosure may have one or more promoters added therein in appropriate amounts or relative concentrations to improve catalyst performance and ammonia conversion efficiency.

In some instances, one or more layers of a composite material may be coated on the catalyst support material. The composite material may comprise one or more layers of boron nitride or boron carbon nitride. The one or more layers may have a thickness of at most about 10 nanometers.

In some embodiments, the catalyst support with the layer of composite material deposited on the catalyst support may be impregnated with one or more active metal nanoparticles. In some cases, the active metal nanoparticles may be deposited on the composite layer, and the morphology of the active metal nanoparticles may be modified by subjecting the nanoparticles to one or more thermal treatment methods. In some cases, the nanoparticles may have a size ranging from about 1 nanometer to about 100 nanometers. In some cases, the dispersion of the nanoparticles may range from about 5% to about 80%. In some cases, the dispersion of the nanoparticles may range from about 10% to about 60%. As used herein, dispersion may refer to the number of active metal atoms that are exposed on a surface of the active metal nanoparticles relative to the total number of atoms constituting the catalyst or a surface area or volume of the catalyst. The active metal atoms that are exposed on a surface of the catalyst may be capable of binding with one or more ammonia molecules using one or more active sites (also referred to herein as binding sites) of the active metal nanoparticles. As described elsewhere herein, the active sites or binding sites of the active metal nanoparticles may be improved by subjecting the active metal nanoparticles to one or more thermal treatments that allow the active metal nanoparticles to adopt a morphology of the particles constituting the composite material layer.

In some embodiments, the improved catalysts disclosed herein may have a hydrogen production rate that is similar to, or greater than, the hydrogen production rate of conventional base transition metal catalysts. In some instances, the improved catalysts disclosed herein may have a hydrogen production rate that is greater than that of conventional ruthenium catalysts. The hydrogen production rate (which may be based on the active metal content of the improved catalysts) may be greater than that of conventional catalysts by a factor of at least about 1, 2, 3, 4, 5, 6, 7, 8, 9, 10, or more. In some cases, the improved catalysts may exhibit at least about a 70% conversion efficiency of ammonia to hydrogen at a temperature of at least about 200° C. and a Gas Hourly Space Velocity (GHSV) of under about 100 liters per hour per milliliter (mL) of catalyst (LNFB hr⁻¹ mL_{cat}⁻¹).

In some cases, the improved catalysts may exhibit at least about a 70% conversion efficiency of ammonia to hydrogen at a temperature of at least about 200° C. and a space velocity of under about 160 liters per hour per gram of catalyst (LNFB hr⁻¹ g_{cat}⁻¹). In some embodiments, the improved catalysts may exhibit at least about a 90% conversion efficiency of ammonia to hydrogen at no more than about 700° C. and a GHSV of at least about 1, 2, 4, 6, 8, 10, 15, 20, 25, 30, 35, 40, 45, 50, 60, 70, 80, or 90 L_{NH3} h⁻¹ mL_{cat}⁻¹. In some embodiments, the improved catalysts may exhibit at least about a 90% conversion efficiency of ammonia to hydrogen at no more than about 700° C. and a GHSV of at most about 2, 4, 6, 8, 10, 15, 20, 25, 30, 35, 40, 45, 50, 60, 70, 80, 90, or 100 L_{NH3} hr⁻¹ mLcat⁻¹.

In some cases, the improved catalysts may exhibit at least about a 90% conversion efficiency of ammonia to hydrogen at 450° C. and a space velocity of under 10 liters per hour per gram of catalyst (L_{gas} hr⁻¹ g_{cat}⁻¹). In some cases, the improved catalysts may exhibit at least about a 90% conversion efficiency of ammonia to hydrogen at 450° C. and a space velocity of at least about 1, 2, 4, 6, 8, 10, 12, 14, 15, 16, 18, 20, 22, 24, 26, 28, 30, 35, 40, 45, or 50 liters per hour per gram of catalyst (L_{gas} hr⁻¹ g_{cat}⁻¹). In some cases, the improved catalysts may exhibit at least about a 90% conversion efficiency of ammonia to hydrogen at 450° C. and a space velocity of at most about 2, 4, 6, 8, 10, 12, 14, 15, 16, 18, 20, 22, 24, 25, 26, 28, 30, 35, 40, 45, or 50 liters per hour per gram of catalyst (L_{gas} hr⁻¹ g_{cat}⁻¹).

In some cases, the improved catalysts may exhibit at least about a 90% conversion efficiency of ammonia to hydrogen at a temperature of at least about 490° C. and a space velocity of under about 16 liters per hour per gram of catalyst (L_{gas} hr⁻¹ g_{cat}⁻¹), or a Gas Hourly Space Velocity (GHSV) of under about 10 liters per hour per milliliter of catalyst (L_{gas} hr⁻¹ mL cat⁻¹). In some cases, the improved catalysts may exhibit a nitrogen desorption activation energy that is less than that of conventional ruthenium catalysts. In some cases, the improved catalysts may exhibit at least about a 90% conversion efficiency of ammonia to hydrogen at a temperature of at least about 490° C. and a space velocity of at least about 1, 2, 3, 4, 5, 6, 7, 8, 9, 10, 12, 14, 15, 16, 18, 20, 22, 24, 26, 28, 30, 35, 40, 45, or 50 L_{gas} hr⁻¹ g_{cat}⁻¹. In some cases, the improved catalysts may exhibit at least about a 90% conversion efficiency of ammonia to hydrogen at a temperature of at least about 490° C. and a space velocity of at most about 2, 3, 4, 5, 6, 7, 8, 9, 10, 15, 20, 25, 30, 35, 40, 45, or 50 L_{gas} hr⁻¹ g_{cat}⁻¹. In some cases, the improved catalysts may exhibit at least about a 90% conversion efficiency of ammonia to hydrogen at a temperature of at least about 490° C. and a GHSV of at least about 1, 2, 3, 4, 5, 6, 7, 8, 9, 10, 12, 14, 15, 16, 18, 20, 22, 24, 26, 28, 30, 35, 40, 45, or 50 L_{gas} hr⁻¹ hr⁻¹ mL_{cat}⁻¹. In some cases, the improved catalysts may exhibit at least about a 90% conversion efficiency of ammonia to hydrogen at a temperature of at least about 490° C. and a GHSV of at most about 2, 3, 4, 5, 6, 7, 8, 9, 10, 15, 20, 25, 30, 35, 40, 45, or 50 L_{gas} hr⁻¹ mL_{cat}⁻¹.

In some cases, the improved catalysts may produce hydrogen and nitrogen with an ammonia conversion efficiency of from about 70% to about 99% at a temperature of at least about 450° C. and a space velocity of from about 1 to about 50, 1 to 45, 1 to 40, 1 to 35, 1 to 30, 1 to 25, 1 to 20, 1 to 15, 1 to 10, 5 to 40, 5 to 35, 5 to 30, 5 to 25, 5 to 20, 5 to 15, 5 to 10, 10 to 40, 10 to 35, 10 to 30, 10 to 25, 10 to 20, 10 to 15, 15 to 40, 15 to 35, 15 to 30, 15 to 25, 15 to 20, 20 to 40, 20 to 35, 20 to 30 or 20 to 25 L_{gas} hr⁻¹ g_{cat}⁻¹. In some cases, the improved catalysts may exhibit at least about a 90% conversion efficiency of ammonia to hydrogen at a temperature of at least about 490° C. and a GHSV of 1 to about 50, 1 to 45, 1 to 40, 1 to 35, 1 to 30, 1 to 25, 1 to 20, 1 to 15, 1 to 10, 5 to 40, 5 to 35, 5 to 30, 5 to 25, 5 to 20, 5 to 15, 5 to 10, 10 to 40, 10 to 35, 10 to 30, 10 to 25, 10 to 20, 10 to 15, 15 to 40, 15 to 35, 15 to 30, 15 to 25, 15 to 20, 20 to 40, 20 to 35, 20 to 30 or 20 to 25 L_{gas} hr⁻¹ mL_{cat}⁻¹.

In some cases, the improved catalysts may exhibit a nitrogen desorption activation energy that is similar to, or less than, the nitrogen desorption activation energy of conventional base transition metal catalysts. In some cases, the improved catalysts may exhibit a nitrogen desorption activation energy that is less than that of conventional ruthenium catalysts.

In some cases, the improved catalysts may produce hydrogen and nitrogen with an ammonia conversion efficiency of from about 70% to about 99% at a temperature of at least about 200° C. and a space velocity of from about 1 to 160, 1 to 150, 1 to 140, 1 to 130, 1 to 120, 1 to 110, 1 to 100, 1 to 90, 1 to 80, 1 to 70, 1 to 60, 1 to 50, 1 to 45, 1 to 40, 1 to 35, 1 to 30, 1 to 25, 1 to 20, 1 to 15, 1 to 10, 5 to 160, 5 to 150, 5 to 140, 5 to 130, 5 to 120, 5 to 110, 5 to 100, 5 to 90, 5 to 80, 5 to 70, 5 to 60, 5 to 50, 5 to 45, 5 to 40, 5 to 35, 5 to 30, 5 to 25, 5 to 20, 5 to 15, 5 to 10, 10 to 160, 10 to 150, 10 to 140, 10 to 130, 10 to 120, 10 to 110, 10 to 100, 10 to 90, 10 to 80, 10 to 70, 10 to 60, 10 to 50, 10 to 45, 10 to 40, 10 to 35, 10 to 30, 10 to 25, 10 to 20, 10 to 15, 15 to 50, 15 to 40, 15 to 35, 15 to 30, 15 to 25, 15 to 20, 20 to 50, 20 to 40, 20 to 35, 20 to 30, 20 to 25, 25 to 50, 25 to 45, 25 to 35, or 25 to 30 L_{NH3} hr⁻¹ g_{cat}⁻¹. In some cases, the improved catalysts may exhibit at least about a 90% conversion efficiency of ammonia to hydrogen at a temperature of at least about 200° C. and a GHSV of from about 1 to about 100, 1 to 90, 1 to 80, 1 to 70, 1 to 60, 1 to 50, 1 to 45, 1 to 40, 1 to 35, 1 to 30, 1 to 25, 1 to 20, 1 to 15, 1 to 10, 5 to 100, 5 to 90, 5 to 80, 5 to 70, 5 to 60, 5 to 50, 5 to 45, 5 to 40, 5 to 35, 5 to 30, 5 to 25, 5 to 20, 5 to 15, 5 to 10, 10 to 100, 10 to 90, 10 to 80, 10 to 70, 10 to 60, 10 to 50, 10 to 45, 10 to 40, 10 to 35, 10 to 30, 10 to 25, 10 to 20, 10 to 15, 15 to 50, 15 to 40, 15 to 35, 15 to 30, 15 to 25, 15 to 20, 20 to 50, 20 to 40, 20 to 35, 20 to 30, 20 to 25, 25 to 50, 25 to 45, 25 to 35, or 25 to 30 L_{NH3} hr⁻¹ mL_{cat}⁻¹.

In some cases, the improved catalysts may exhibit a conversion efficiency of from about 70 to about 99% and a space velocity of from about 1 to 160 L_{NH3} hr⁻¹ g_{cat}⁻¹, at a temperature of at least about 200, 225, 250, 275, 300, 235, 350, 375, 400, 425, 450, 475, 500, 525, 550, 575, 600, 625, 650, or 675° C. In some cases, the improved catalysts may exhibit a conversion efficiency of from about 70 to about 99% and a space velocity of from about 1 to 160 L_{NH3} hr⁻¹ g_{cat}⁻¹, at a temperature of no more than about 225, 250, 275, 300, 235, 350, 375, 400, 425, 450, 475, 500, 525, 550, 575, 600, 625, 650, 675, or 700° C. In some cases, the improved catalysts may exhibit a conversion efficiency of from about 70 to about 99% and a space velocity of from about 1 to 160 L_{NH3} hr⁻¹ g_{cat}⁻¹, at a temperature of from about 200 to about 700, 200 to 650, 200 to 600, 200 to 550, 200 to 500, 200 to 450, 200 to 400, 250 to 700, 250 to 650, 250 to 600, 250 to 550, 250 to 500, 250 to 450, 300 to 700, 300 to 650, 300 to 600, 400 to 550, 300 to 500, 350 to 700, 350 to 650, 350 to 600, 350 to 550, 400 to 700, 400 to 650, 400 to 600, 450 to 700, 450 to 650, 450 to 600, 500 to 700, 550 to 650, 600 to 700, or 650 to 700° C.

In some cases, the improved catalysts may exhibit a conversion efficiency of from about 70 to about 99% and a GHSV of from about 1 to 100 L_{NH3} hr⁻¹ mL_{cat}⁻¹, at a temperature of at least about 200, 225, 250, 275, 300, 235, 350, 375, 400, 425, 450, 475, 500, 525, 550, 575, 600, 625, 650, or 675° C. In some cases, the improved catalysts may exhibit a conversion efficiency of from about 70 to about 99% and a GHSV of from about 1 to 100 L_{NH3} hr⁻¹ mL_{cat}⁻¹, at a temperature of no more than about 225, 250, 275, 300, 235, 350, 375, 400, 425, 450, 475, 500, 525, 550, 575, 600, 625, 650, 675, or 700° C. In some cases, the improved catalysts may exhibit a conversion efficiency of from about 70 to about 99% and a GHSV of from about 1 to 100 L_{NH3} hr⁻¹ mL_{cat}⁻¹, at a temperature of from about 200 to about 700, 200 to 650, 200 to 600, 200 to 550, 200 to 500, 200 to 450, 200 to 400, 250 to 700, 250 to 650, 250 to 600, 250 to 550, 250 to 500, 250 to 450, 300 to 700, 300 to 650, 300 to 600, 400 to 550, 300 to 500, 350 to 700, 350 to 650, 350 to 600, 350 to 550, 400 to 700, 400 to 650, 400 to 600, 450 to 700, 450 to 650, 450 to 600, 500 to 700, 550 to 650, 600 to 700, or 650 to 700° C.

### Reformer and Power Systems Using Improved Catalysts

The catalysts of the present disclosure may be used compatibly with various power systems (e.g., one or more reformers) for decomposing or cracking ammonia to generate hydrogen. The power systems may comprise, for example, one or more reformers that can perform a catalytic decomposition or cracking of ammonia to extract and/or produce hydrogen. Such reformers may be operated using heat energy. In some cases, the power system may comprise a combustor that generates heat energy to drive the operation of the reformer. In some cases, the heat energy may be generated from the combustion of a chemical compound (e.g., hydrogen or a hydrocarbon). In some cases, the reformer may comprise an outlet configured to direct one or more fluids (e.g., ammonia, nitrogen, and/or hydrogen) to another system or subsystem. In some cases, the outlet may be configured to direct hydrogen gas produced by the reformers to one or more fuel cells and/or to one or more combustion engines. In some cases, the outlet may be configured to direct at least part of the hydrogen gas produced by the reformer to one or more combustors to generate heat energy that can be used to power or heat the reformer (e.g., for autothermal heating or self-heating). In some cases, the outlet may be configured to direct hydrogen, nitrogen, and/or ammonia to at least one other reformer (e.g., for combustion of the hydrogen to heat the at least one other reformer).

### Use of Produced Hydrogen in Fuel Cells or Engines

The hydrogen generated using the improved catalysts of the present disclosure may be provided to one or more fuel cells or proton-exchange membrane fuel cells (PEMFC) to generate electrical energy. The hydrogen generated using the improved catalysts of the present disclosure may also be provided to one or more combustion engines to generate mechanical work or mechanical energy. The hydrogen that is generated and/or extracted using the reformer may be provided to one or more fuel cells or to one or more combustion engines, which may produce electrical energy or mechanical work to power one or more systems, sub-systems, or devices requiring electrical or mechanical energy to operate. In some cases, partially generated and/or extracted hydrogen and nitrogen from a reformer and at least a portion of the remaining ammonia mixture may be provided to one or more other reformers to enable a continuous reforming process. The partially generated and/or extracted hydrogen and nitrogen and the remaining ammonia may be part of a partially cracked stream of ammonia. The partially cracked stream of ammonia may be generated using a reformer having less than a 100% ammonia conversion efficiency (i.e., less than 100% of ammonia is converted to hydrogen and nitrogen). The partially cracked stream may be passed to one or more downstream reformers to minimize material waste and maximize an amount of ammonia that can be decomposed or cracked. In some cases, the hydrogen generated and/or extracted using the reformer may be provided to one or more other reformers. In such cases, the one or more other reformers may be configured to combust the hydrogen to generate additional thermal energy. Such additional thermal energy may be used to heat the one or more other reformers to facilitate a further catalytic decomposition or cracking of ammonia to extract and/or produce additional hydrogen.

### Resistance Heating of Catalyst in Reformer

In some cases, one or more reformers may be configured to heat up the improved catalysts directly using resistance heating (e.g., by passing a current through the catalyst itself or through the catalyst support). In such cases, the one or more reformers may comprise one or more electrodes for passing a current through the catalyst to heat the catalyst (e.g., by resistive heating or Joule heating). The one or more electrodes may comprise, for example, one or more metal (e.g., copper, steel, titanium, or carbon) electrodes. In other cases, the one or more reformers may be configured to heat up the improved catalysts by combusting hydrogen. The improved catalysts may be configured to decompose ammonia into hydrogen and/or nitrogen when heated by combustion or resistance heating.

In some cases, the one or more reformers may comprise one or more electrically conductive springs. The one or more electrically conductive springs may be provided adjacent to the improved catalysts disclosed herein. In some cases, the one or more electrically conductive springs may be provided on opposite ends of the catalyst. The one or more electrically conductive springs may be in physical, electrical, and/or thermal communication with the catalyst, the catalyst bed, and/or the one or more electrodes used to perform direct resistive heating of the catalyst. The one or more electrically conductive springs may be configured to reduce thermal stresses on the catalyst when the catalyst is subjected to thermal cycling. The one or more electrically conductive springs may be configured to accommodate thermal expansions during heating of the catalyst and thermal contractions during cooling of the catalyst. The one or more electrically conductive springs may lighten and/or redistribute the mechanical load on the catalyst bed so that the catalyst bed can withstand multiple thermal cycles without breaking or fracturing. In some cases, the one or more springs may be configured to alleviate thermal stresses on the catalyst due to a thermal expansion or a thermal contraction of the catalyst during one or more thermal cycling procedures. The one or more springs may comprise, for example, stainless steel, titanium, or copper springs. The use of the one or more electrically conductive springs may allow the one or more reformers to provide faster startup capabilities with reduced or minimal thermal stresses on the catalyst bed or monolith during rapid temperature changes.

### Electrically Conductive Catalysts

In some embodiments, the one or more reformers may comprise an electrically conductive (i.e., non-insulating) catalyst. In some instances, the electrically conductive catalyst may comprise at least one of an electrically conductive (i.e., non-insulating) support or an electrically conductive coating, layer, or particles, in, on, or adjacent to the surface of the support. In some instances, the electrically conductive catalyst may be brought to a minimum target operating temperature using resistive (Joule) heating. In some instances, the electrically conductive catalyst may be maintained at a target operating temperature or range, by Joule heating. In some cases, the electrically conductive catalyst may be brought to a minimum operating temperature by an internal or external heat source (e.g., electrical heating elements, induction heating, combustion gases, or heat exchanger). In some cases, the electrically conductive catalyst may be maintained at a target operating temperature, or range, by an internal or external heat source (e.g., electrical heating elements, induction heating, combustion gases, or heat exchanger).

In some embodiments, the electrically conductive catalyst may comprise the form of one or more monolith structures, or substrates. In some embodiments, the monolith structure and/or substrate may be formed by at least one of extrusion, 3D printing, or additive manufacturing. In some cases, the monolith structure may be formed from flat, folded, crimped, corrugated, or engineered sheets, wires, tubes or various designed shapes and forms. In some cases, the monolith structure may be constructed by alternating flat sheets and folded, crimped, corrugated, or engineered sheets. In some cases, the monolith structure may resemble at least one concentric spiral in cross-section. In some cases, the thickness of the flat, corrugated, or engineered sheets may comprise from about 0.02 to about 0.2, 0.02 to 0.15, 0.02 to 0.1, 0.02 to 0.05, 0.03 to 0.15, 0.03 to 0.1, 0.03 to 0.05. 0.05 to 0.15, or 0.05 to 0.1 mm.

In some cases, the monolith structure may comprise tubes or channels, with a honeycomb cell cross-section. In some instances, the cells of the honeycomb monolith structure may be circular, triangular, square, rectangular, pentagonal, hexagonal, or a more complex geometric shape. In some cases, the wall thickness of the cells in a honeycomb monolith structure may comprise from about 0.02 to about 0.2, 0.02 to 0.15, 0.02 to 0.1, 0.02 to 0.05, 0.03 to 0.15, 0.03 to 0.1, 0.03 to 0.05. 0.05 to 0.15, or 0.05 to 0.1 mm. In some instances, the dimension of the cells may enable a cell density from about 5 to about 100, 10 to 100, 20 to 100, 20 to 80, 20 to 60, 25 to 100, 25 to 75, 25 to 50, 40 to 100, 40 to 80, 50 to 100, 50 to 75, or 60 to 100 per square centimeter (cm⁻¹).

In some cases, the electrically heated catalyst may comprise the form of particles (e.g., powder, beads, pellets, or other engineered designs), configured to form an electrical circuit between a pair of electrodes. In some cases, the engineered designs may be, for example, at least one of a sphere, cube, hollow cube, solid cylinder, hollow cylinder, 4-hole cylinder, single ring, cross web, grooved cylinder, pall ring, intalox saddle, or berl saddle. Other, more intricate designs of catalyst particle may also be suitable. In some instances, the electrically conducting catalyst may comprise one or more beds (e.g., packed beds and/or fluidized beds) of particles.

In some instances, the one or more monolith structures and/or beds may be connected in electrical communication with each other. In some cases, the one or more monolith structures and/or catalyst beds may be connected to separate, or different, electrical circuits. In some cases, the one or more monolith structures and/or beds may be connected to the same electrical power source. In some cases, the one or more monolith structures and/or beds may be connected to separate, or different, power sources. In some instances, the one or more monolith structures and/or beds may be in electrical communication with a single temperature controller device. In some cases, the one or more monolith structures and/or beds may be in electrical communication with multiple temperature control devices. In some instances, the one or more monolith structures and/or beds may be heated together, simultaneously, or separately, and staged. In some instances, the one or more monolith structures and/or beds may be controlled to the same, or similar, minimum and/or target operating temperatures, or temperature range. In some cases, the one or more monolith structures and/or beds may be controlled to different minimum and/or target operating temperatures, or temperature ranges. In some cases, the one or more monolith structures and/or beds may be located in one section or compartment of a reformer, or in separate sections or compartments of a reformer. In some cases, the one or more monolith structures and/or beds may be located in the same zone or different zones of a reformer. In some instances, the zones in the reformer may be defined by the expected or intended composition of the gas, operating temperature, operating temperature range, composition and/or form factor of the catalyst, type of heating, electrical circuit, or the control system that is used.

In some embodiments, the monolith structure and/or catalyst particles may comprise a support fabricated from at least one ceramic, metallic, or hybrid material. In some embodiments, the support may comprise one or more ceramic materials (e.g., at least one of silicon carbide, silicon or germanium). In some cases, the support may comprise complex perovskite ceramic material. In some instances, the support may comprise carbon or a carbon-based material (e.g., at least one of graphite, graphene, amorphous carbon, or graphite oxide). In some cases, the support may comprise one or more metals or metal alloys (e.g., at least one of Ni, Cr, Fe, Al, NiCrAl, FeCrAl, NiFeCrAl, NiCr). In some instances, the support may comprise a non-stoichiometric ratio of a non-conducting compound to increase the concentration of a conducting element. In some cases, the support may comprise a conducting polymer. In some instances, the support may comprise a metal foam. In some cases, the electrically conductive coating may comprise carbon (graphite, graphene, nanoparticles or nanotubes), certain conducting metal oxides, or conducting ceramic materials. In some instances, the support or the coating may comprise one or more dopants (e.g., at least one of B, N, P) to modify conductivity or resistivity characteristics.

### Electrical Characteristics of the Catalyst and Support

For effective and efficient resistance (or Joule) heating, the electrically conducting catalyst, support material, or support monolith should possess suitable electrical characteristics. If the resistivity is too low (or conductivity is too high), then the applied voltage may result in a high current through the catalyst, support material, or support monolith, which may result in overheating, melting and deterioration. If the resistivity is too high (or conductivity is too low), then very high voltages will be needed to provide the necessary current, but it may be difficult to ensure that the current flows through a sufficient volume of the catalyst, support material, or support monolith to heat the catalyst evenly. Significantly uneven heating of the catalyst, support material, or support monolith may lead to the creation of hot spots, where the catalyst, support material, or support monolith is exposed to excessive temperatures and more rapid degradation, and/or cold spots, where the catalyst, support material, or support monolith is unable to reach the minimum temperature to deliver the required ammonia conversion efficiency. Significantly uneven heating of the catalyst, support material, or support monolith may reduce overall ammonia conversion efficiency or cause unpredictable catalyst behavior, and may reduce the ability of the control system to maintain the required performance to produce sufficient hydrogen to meet the power demand. Significantly uneven heating of the catalyst, support material, or support monolith may also reduce the effective lifetime of the catalyst, support material, or support monolith due to thermally induced stress fractures and breakdown of the structure into smaller particles or powder, increasing back pressure in the reformer.

### Electrical Resistivity of the Catalyst and Support

In some instances, the electrically conducting catalyst, support material or support monolith may comprise a resistivity of at least about 10, 25, 50, 100, 200, 300, 400, 500, 1000, 2000, 3000, 4000, 5000, 10000, 20000, 30000, 40000, 50000, 100000, or 500000 micro ohm-cm (μΩ·cm). In some instances, the electrically conducting catalyst, support material or support monolith may comprise a resistivity of not more than about 10, 25, 50, 100, 200, 300, 400, 500, 600, 700, 800, 900, 1000, 2000, 3000, 5000, 10000, 20000, 30000, 40000, 50000, 100000, 500000, or 1000000 micro ohm·cm (μΩ-cm). In some instances, the electrically conducting catalyst, support material or support monolith may comprise a resistivity from about 10 to about 1000000, 10 to 500000, 10 to 100000, 10 to 50000, 10 to 10000, 10 to 5000, 10 to 1000, 50 to 1000000, 50 to 500000, 50 to 100000, 50 to 50000, 50 to 10000, 50 to 5000, 50 to 1000, 100 to 1000000, 100 to 500000, 100 to 100000, 100 to 50000, 100 to 10000, 100 to 5000, 500 to 1000000, 500 to 500000, 500 to 100000, 500 to 50000, 500 to 10000, 500 to 5000, 1000 to 1000000, 1000 to 500000, 1000 to 100000, 1000 to 50000, 1000 to 10000, 1000 to 50000, 1000 to 10000, 1000 to 5000, 5000 to 1000000, 5000 to 500000, 5000 to 100000, 5000 to 50000, 5000 to 10000, 10000 to 1000000, 10000 to 500000, 10000 to 100000, 10000 to 50000, 50000 to 1000000, 50000 to 500000, 50000 to 100000, 100000 to 1000000, 100000 to 500000, or 500000 to 1000000 micro ohm-cm (μΩ·cm).

In some instances, the electrically conducting catalyst, support material or support monolith may comprise a resistivity of at least about 0.1, 0.5, 1, 2, 3, 4, 5, 10, 20, 30, 40, 50, 60, 70, 80, 90, 100, 110, 120, 130, or 140 ohm-cm (Ω·cm). In some instances, the electrically conducting catalyst, support material or support monolith may comprise a resistivity of not more than about 0.5, 1, 2, 3, 4, 5, 10, 20, 30, 40, 50, 60, 70, 80, 90, 100, 110, 120, 130, 140, or 150 ohm·cm (μΩ-cm). In some instances, the electrically conducting catalyst, support material or support monolith may comprise a resistivity from about 0.1 to about 150, 0.1 to 100, 0.1 to 50, 0.1 to 10, 0.5 to 150, 0.5 to 100, 0.5 to 50, 0.5 to 10, 1 to 150, 1 to 100, 1 to 50, 1 to 10, 2 to 50, 2 to 10, 3 to 50, 3 to 10, 4 to 50, 4 to 10, 5 to 150, 5 to 100, 5 to 50, 5 to 40, 5 to 30, 5 to 20, 5 to 10, 10 to 150, 10 to 100, 10 to 50, 10 to 40, 10 to 30, 10 to 20, 20 to 150, 20 to 100, 20 to 50, 30 to 150, 30 to 100, 30 to 60, 40 to 150, 40 to 100, 40 to 80, 50 to 150, 50 to 100, 60 to 150, 60 to 100, 70 to 150, 70 to 100, 80 to 150, 80 to 100, 90 to 150, 90 to 100, or 100 to 150 ohm·cm cm).

### Electrical Resistance of the Catalyst and Support

When connected in electrical communication to an applied voltage, the electrically conducting catalyst, support material, or support monolith may represent a resistance to the flow of electrical current.

In some cases, the resistance of the electrically conducting catalyst, support material, or support monolith may comprise at least about 0.01, 0.05, 0.1, 0.5, 1, 2, 3, 4, 5, 6, 7, 8, 9, 10, 15, 20, 25, 30, 35, 40, 45, 50, 55, 60, 65, 70, 80, or 90 ohms (a). In some cases, the resistance of the electrically conducting catalyst, support material, or support monolith may comprise not more than about 0.05, 0.1, 0.5, 1, 2, 3, 4, 5, 6, 7, 8, 9, 10, 15, 20, 25, 30, 35, 40, 45, 50, 55, 60, 65, 70, 80, 90 or 100 ohms (a). In some cases, the resistance of the electrically conducting catalyst, support material, or support monolith may comprise of from about 0.01 to about 100, 0.01 to 50, 0.01 to 10, 0.05 to 100, 0.05 to 50, 0.05 to 10, 0.1 to 100, 0.1 to 50, 0.1 to 10, 0.5 to 100, 0.5 to 50, 0.5 to 10, 1 to 100, 1 to 50, 1 to 10, 5 to 100, 5 to 50, 5 to 40, 5 to 30, 5 to 20, 5 to 10, 10 to 100, 10 to 90, 10 to 80, 10 to 70, 10 to 60, 10 to 50, 10 to 40, 10 to 30, 10 to 20, 15 to 100, 15 to 50, 15 to 40, 15 to 30, 15 to 20, 20 to 100, 20 to 80, 20 to 60, 20 to 50, 20 to 40, 20 to 30, 25 to 100, 25 to 90, 25 to 80, 25 to 70, 25 to 60, 25 to 50, 30 to 100, 30 to 90, 30 to 80, 30 to 70, 30 to 80, 30 to 50, 35 to 100, 35 to 90, 35 to 80, 35 to 70, 35 to 60, 40 to 100, 40 to 90, 40 to 80, 40 to 70, 40 to 60, 45 to 100, 45 to 90, 45 to 80, 50 to 100, 50 to 90, 50 to 80 or 50 to 70 ohms (a).

When connected in electrical communication with the electrodes, the electrically conducting catalyst, support material, or support monolith and the electrodes may represent a combined resistance to the flow of electrical current with an applied voltage.

In some instances, the combined resistance of the electrodes and the electrically conducting catalyst, support material or support monolith may comprise at least about 0.01, 0.05, 0.1, 0.5, 1, 5, 10, 15, 20, 25, 30, 35, 40, 45, 50, 55, 60, 65, 70, 80, 90, 100, 110, 120, 130, or 140 ohms (a). In some instances, the combined resistance of the electrodes and the electrically conducting catalyst, support material or support monolith may comprise not more than about 0.05, 0.1, 0.5, 1, 5, 10, 15, 20, 25, 30, 35, 40, 45, 50, 55, 60, 65, 70, 80, 90, 100, 110, 120, 130, 140 or 150 ohms (a). In some instances, the combined resistance of the electrodes and the electrically conducting catalyst, support material or support monolith may comprise of from about 0.01 to about 150, 0.05 to 120, 0.1 to 110, 0.1 to 100, 0.1 to 90, 0.1 to 80, 0.1 to 70, 0.1 to 65, 0.1 to 60, 0.1 to 55, 0.1 to 50, 0.1 to 45, 0.1 to 40, 0.1 to 35, 0.1 to 30, 0.1 to 25, 0.1 to 20, 0.1 to 15, 0.1 to 10, 0.1 to 5, 0.1 to 1, 0.5 to 110, 0.5 to 100, 0.5 to 90, 0.5 to 80, 0.5 to 70, 0.5 to 65, 0.5 to 60, 0.5 to 55, 0.5 to 50, 0.5 to 45, 0.5 to 40, 0.5 to 35, 0.5 to 30, 0.5 to 25, 0.5 to 20, 0.5 to 15, 0.5 to 10, 0.5 to 5, 0.5 to 1, 1 to 110, 1 to 100, 1 to 90, 1 to 80, 1 to 70, 1 to 65, 1 to 60, 1 to 55, 1 to 50, 1 to 45, 1 to 40, 1 to 35, 1 to 30, 1 to 25, 1 to 20, 1 to 15, 1 to 10, 1 to 5, 5 to 110, 5 to 100, 5 to 90, 5 to 80, 5 to 70, 5 to 65, 5 to 60, 5 to 55, 5 to 50, 5 to 45, 5 to 40, 5 to 35, 5 to 30, 5 to 25, 5 to 20, 5 to 15, 5 to 10, 10 to 110, 10 to 100, 10 to 90, 10 to 80, 10 to 70, 10 to 65, 10 to 60, 10 to 55, 10 to 50, 10 to 45, 10 to 40, 10 to 35, 10 to 30, 10 to 25, 10 to 20, 10 to 15, 15 to 110, 15 to 100, 15 to 90, 15 to 80, 15 to 70, 15 to 65, 15 to 60, 15 to 55, 15 to 50, 15 to 45, 15 to 40, 15 to 35, 15 to 30, 15 to 25, 15 to 20, 20 to 110, 20 to 100, 20 to 90, 20 to 80, 20 to 70, 20 to 65, 20 to 60, 20 to 55, 20 to 50, 20 to 45, 20 to 40, 20 to 35, 20 to 30, 20 to 25, 25 to 110, 25 to 100, 25 to 90, 25 to 80, 25 to 70, 25 to 65, 25 to 60, 25 to 55, 25 to 50, 25 to 45, 25 to 40, 25 to 35, 25 to 30, 30 to 110, 30 to 100, 30 to 90, 30 to 80, 30 to 70, 30 to 65, 30 to 60, 30 to 55, 30 to 50, 30 to 45, 30 to 40, 30 to 35, 35 to 110, 35 to 100, 35 to 90, 35 to 80, 35 to 70, 35 to 65, 35 to 60, 35 to 55, 35 to 50, 35 to 45, 35 to 40, 40 to 110, 40 to 100, 40 to 90, 40 to 80, 40 to 70, 40 to 65, 40 to 60, 40 to 55, 40 to 50, 40 to 45, 45 to 110, 45 to 100, 45 to 90, 45 to 80, 45 to 70, 45 to 65, 45 to 60, 45 to 55, 45 to 50, 50 to 110, 50 to 100, 50 to 90, 50 to 80, 50 to 70, 50 to 65, 50 to 60, 50 to 55, 55 to 110, 55 to 100, 55 to 90, 55 to 80, 55 to 70, 55 to 65, 55 to 60, 60 to 100, 60 to 110, 60 to 90, 60 to 80, 60 to 70, 60 to 65, 65 to 110, 65 to 100, 65 to 90, 65 to 80, 65 to 70, 70 to 110, 70 to 100, 70 to 90, 70 to 80, 80 to 110, 80 to 90, 90 to 110, 90 to 100, or 100 to 110 ohms (a).

### Electrical Power Supply to Catalyst

The conducting catalyst, support material, or support monolith requires a direct electrical supply to provide the power necessary to raise the temperature of the catalyst to a minimum necessary to achieve satisfactory ammonia conversion efficiency. In some cases, the electrical power may be delivered in the form of direct current or alternating current. In some cases, the electrical power may be supplied by at least one of a battery, a fuel cell, a generator, an engine, a turbine, a capacitor, a flywheel, or an electrical grid. In some cases, the electrical power may be supplemented or replaced by heat from combustion of gases (e.g., H₂ or NH₃).

In some cases, the power required may be related to the resistivity, specific heat capacity and size (mass or volume) of the catalyst, support material, or support monolith. In some cases, the power required may be related to the target temperature to be achieved (for the desired ammonia conversion efficiency), the starting temperature (e.g., ambient environment, or any temperature below the target temperature). In some cases, the power required may be related to the desired speed at which the target temperature should be reached, or the time period between the electrical power being turned on (current starting to pass through the catalyst, support material or support monolith) and the target temperature to be achieved. In some cases, the power required may depend on the presence, condition and/or composition of electrical and/or thermal insulation material adjacent to the conducting catalyst, support material, or support monolith, or adjacent to the inner and/or outer surface of the reformer.

In some instances, the electrical power provided to the conducting catalyst, support material, or monolith support may comprise at least about 1, 5, 10, 20, 50, 100, 150, 200, 250, 300, 350, 400, 450, 500, 600, 700, 800 or 900 Watts per gram of catalyst (W/g). In some instances, the electrical power provided to the conducting catalyst, support material, or monolith support may comprise not more than about 5, 10, 20, 50, 100, 150, 200, 250, 300, 350, 400, 450, 500, 600, 700, 800, 900, or 1000 Watts per gram of catalyst (W/g). In some instances, the electrical power provided to the conducting catalyst, support material, or monolith support may comprise of from about 1 to about 1000, 1 to 900, 1 to 800, 1 to 700, 1 to 600, 1 to 500, 1 to 400, 1 to 300, 1 to 200, 1 to 100, 5 to 1000, 5 to 900, 5 to 800, 5 to 700, 5 to 600, 5 to 500, 5 to 450, 5 to 400, 5 to 350, 5 to 300, 5 to 250, 5 to 200, 5 to 150, 5 to 100, 5 to 50, 5 to 20, 10 to 1000, 10 to 900, 10 to 800, 10 to 700, 10 to 600, 10 to 500, 10 to 450, 10 to 400, 10 to 350, 10 to 300, 10 to 250, 10 to 200, 10 to 150, 10 to 100, 10 to 50, 20 to 1000, 20 to 900, 20 to 800, 20 to 700, 20 to 600, 20 to 500, 20 to 450, 20 to 400, 20 to 350, 20 to 300, 20 to 250, 20 to 200, 20 to 150, 20 to 100, 20 to 50, 50 to 1000, 50 to 900, 50 to 800, 50 to 700, 50 to 600, 50 to 500, 50 to 450, 50 to 400, 50 to 350, 50 to 300, 50 to 250, 50 to 200, 50 to 150, 50 to 100, 100 to 1000, 100 to 900, 100 to 800, 100 to 700, 100 to 600, 100 to 500, 100 to 450, 100 to 400, 100 to 350, 100 to 300, 100 to 250, 100 to 200, 100 to 150, 150 to 1000, 150 to 900, 150 to 800, 150 to 700, 150 to 600, 150 to 500, 150 to 450, 150 to 400, 150 to 350, 150 to 300, 150 to 250, 150 to 200, 200 to 1000, 200 to 900, 200 to 800, 200 to 700, 200 to 600, 200 to 500, 200 to 450, 200 to 400, 200 to 350, 200 to 300, 200 to 250, 250 to 1000, 250 to 900, 250 to 800, 250 to 700, 250 to 600, 250 to 500, 250 to 450, 250 to 400, 250 to 350, 250 to 300, 300 to 1000, 300 to 900, 300 to 800, 300 to 700, 300 to 600, 300 to 500, 300 to 450, 300 to 400, 300 to 350, 350 to 1000, 350 to 900, 350 to 800, 350 to 700, 350 to 600, 350 to 500, 350 to 450, 350 to 400, 400 to 1000, 400 to 900, 400 to 800, 400 to 700, 400 to 600, 400 to 500, 400 to 450, 450 to 1000, 450 to 900, 450 to 800, 450 to 700, 450 to 600, 450 to 500, 500 to 1000, 500 to 900, 500 to 800, 500 to 700, 500 to 600, 600 to 1000, 600 to 900, 600 to 800, 600 to 700, 700 to 1000, 700 to 900, 700 to 800, 800 to 1000, 800 to 900, or 900 to 1000 Watts per gram of catalyst (W/g).

### Catalyst Temperature and Heating Time

In some embodiments, the conducting catalyst, support material or monolith may require heating from a first temperature to a second temperature, to achieve desired ammonia conversion efficiency. In some embodiments, the first temperature may be the ambient temperature of the surrounding environment. In some embodiments, the conducting catalyst, support material or monolith may be utilized as a start-up catalyst, or in a start-up reformer, in an ammonia conversion or hydrogen generation system. In some embodiments, the conducting catalyst, support material or monolith may be utilized as a fast start-up catalyst, or in a fast start-up reformer, in an ammonia conversion or hydrogen generation system. In some embodiments, the conducting catalyst, support material or monolith may be utilized as a catalyst, or in a reformer, to generate hydrogen for use in a combustion heated reactor and/or a hydrogen fuel cell in an ammonia conversion or hydrogen generation system. In some embodiments, the conducting catalyst, support material or monolith may be utilized as a catalyst in a combustion heated reformer, in an ammonia conversion or hydrogen generation system. In some instances, it is necessary for at least a portion of the catalyst, support material or support monolith to reach the second temperature to achieve the desired ammonia conversion efficiency. In some instances, it may be required for at least a portion of the catalyst to reach the second temperature within a defined amount of time, beginning from the electrical current starting to pass through the catalyst.

In some cases, the first temperature may comprise at least about −40, −35, −30, −25, −20, −15, −10, −5, 0, 5, 10, 15, 20, 25, 30, 35, 40, 45, 50, 60, 70, 80, 90, 100, 150, 200, 250, 300, 350, 400, 450, 500, 550, 600, or 650° C. In some cases, the first temperature may comprise not more than about −35, −30, −25, −20, −15, −10, −5, 0, 5, 10, 15, 20, 25, 30, 35, 40, 45, 50, 60, 70, 80, 90, 100, 150, 200, 250, 300, 350, 400, 450, 500, 550, 600, 650, or 700° C. In some cases, the first temperature may comprise of from about −40 to about 40, −35 to 40, −30 to 40, −25 to 40, −20 to 40, −15 to 40, −10 to 40, −10 to 35, −10 to 30, −10 to 25, −5 to 40, −5 to 35, −5 to 30, −5 to 25, 0 to 40, 0 to 35, 0 to 30, 0 to 25, 5 to 50, 5 to 45, 5 to 40, 5 to 35, 5 to 30, 5 to 25, 10 to 50, 10 to 45, 10 to 40, 10 to 35, 10 to 30, 10 to 25, 15 to 50, 15 to 45, 15 to 40, 15 to 35, 15 to 30, 15 to 25, 20 to 50, 20 to 45, 20 to 40, 20 to 35, 20 to 30, 20 to 25, 25 to 100, 25 to 60, 25 to 50, 25 to 40, 30 to 100, 30 to 75, 30 to 50, 30 to 40, 40 to 100, 40 to 60, 40 to 50, 50 to 150, 50 to 100, 100 to 200, 100 to 150, 150 to 300, 150 to 250, 150 to 200, 200 to 400, 200 to 350, 200 to 300, 200 to 250, 250 to 400, 250 to 350, 250 to 300, 300 to 500, 300 to 450, 300 to 400, 300 to 350, 350 to 550, 350 to 500, 350 to 450, 350 to 400, 400 to 600, 400 to 550, 400 to 500, 400 to 450, 450 to 650, 450 to 550, or 450 to 500° C.

In some instances, the second temperature may comprise at least about 100, 150, 200, 250, 300, 350, 400, 450, 500, 550, 600, 650, 700, 750, 800, or 850° C. In some instances, the second temperature may comprise not more than about 150, 200, 250, 300, 350, 400, 450, 500, 550, 600, 650, 700, 750, 800, 850, or 900° C. In some instances, the second temperature may comprise of from about 100 to about 800, 150 to 750, 200 to 700, 200 to 600, 200 to 500, 200 to 400, 300 to 800, 300 to 700, 300 to 600, 300 to 500, 300 to 400, 400 to 800, 400 to 700, 400 to 600, 400 to 500, 500 to 900, 500 to 800, 500 to 700, 500 to 650, 500 to 600, 500 to 550, 550 to 900, 550 to 800, 550 to 750, 550 to 700, 550 to 650, 550 to 600, 600 to 900, 600 to 800, 600 to 750, 600 to 700, 600 to 650, 650 to 900, 650 to 850, 650 to 800, 650 to 750, 650 to 700, 700 to 900, 700 to 850, 700 to 800, 700 to 750, 750 to 900, 750 to 850, 750 to 800, 800 to 900, 800 to 850, or 850 to 900° C.

In some cases, it may not be necessary for the full body, mass, volume, or measurable surface of the catalyst, support material, or support monolith to reach the second temperature, to achieve the desired ammonia conversion efficiency. In some cases, the desired ammonia conversion efficiency (e.g., from about 70% to about 99%) may be achieved when a portion of the catalyst, support material, or support monolith has reached the second temperature.

In some instances, the desired ammonia conversion efficiency (e.g., from about 70% to about 99%) can be achieved when a portion comprising at least about 1, 5, 10, 15, 20, 25, 30, 35, 40, 45, 50, 55, 60, 65, 70, 75, 80, 85, 90, 95, or 99% of the mass of the catalyst, support material or support monolith has reached the second temperature. In some instances, the desired ammonia conversion efficiency can be achieved when a portion comprising not more than about 5, 10, 15, 20, 25, 30, 35, 40, 45, 50, 55, 60, 65, 70, 75, 80, 85, 90, 95, 99, or 100% of the mass of the catalyst, support material or support monolith has reached the second temperature. In some instances, the desired ammonia conversion efficiency can be achieved when a portion comprising of from about 1 to about 100, 1 to 99, 1 to 95, 1 to 90, 1 to 80, 1 to 70, 1 to 60, 1 to 50, 1 to 40, 1 to 30, 1 to 20, 1 to 10, 5 to 100, 5 to 99, 5 to 95, 5 to 90, 5 to 80, 5 to 70, 5 to 60, 5 to 50, 5 to 40, 5 to 30, 5 to 20, 5 to 10, 10 to 100, 10 to 99, 10 to 95, 10 to 90, 10 to 80, 10 to 70, 10 to 60, 10 to 50, 10 to 40, 10 to 30, 10 to 20, 20 to 100, 20 to 99, 20 to 95, 20 to 90, 20 to 80, 20 to 70, 20 to 60, 20 to 50, 20 to 40, 20 to 30, 30 to 100, 30 to 99, 30 to 95, 30 to 90, 30 to 80, 30 to 70, 30 to 60, 30 to 50, 30 to 40, 40 to 100, 40 to 99, 40 to 95, 40 to 90, 40 to 80, 40 to 70, 40 to 60, 40 to 50, 50 to 100, 50 to 99, 50 to 95, 50 to 90, 50 to 80, 50 to 70, 50 to 60, 60 to 100, 60 to 99, 60 to 95, 60 to 90, 60 to 80, 60 to 70, 70 to 100, 70 to 99, 70 to 95, 70 to 90, 70 to 80, 80 to 100, 80 to 99, 80 to 95, 80 to 90, 90 to 100, 90 to 99, 90 to 95, 95 to 100, or 95 to 99% of the mass of the catalyst, support material or support monolith has reached the second temperature.

In some instances, the desired ammonia conversion efficiency (e.g., from about 70% to about 99%) can be achieved when a portion comprising at least about 1, 5, 10, 15, 20, 25, 30, 35, 40, 45, 50, 55, 60, 65, 70, 75, 80, 85, 90, 95, or 99% of the volume of the catalyst, support material or support monolith has reached the second temperature. In some instances, the desired ammonia conversion efficiency can be achieved when a portion comprising not more than about 5, 10, 15, 20, 25, 30, 35, 40, 45, 50, 55, 60, 65, 70, 75, 80, 85, 90, 95, 99, or 100% of the volume of the catalyst, support material or support monolith has reached the second temperature. In some instances, the desired ammonia conversion efficiency can be achieved when a portion comprising of from about 1 to about 100, 1 to 99, 1 to 95, 1 to 90, 1 to 80, 1 to 70, 1 to 60, 1 to 50, 1 to 40, 1 to 30, 1 to 20, 1 to 10, 5 to 100, 5 to 99, 5 to 95, 5 to 90, 5 to 80, 5 to 70, 5 to 60, 5 to 50, 5 to 40, 5 to 30, 5 to 20, 5 to 10, 10 to 100, 10 to 99, 10 to 95, 10 to 90, 10 to 80, 10 to 70, 10 to 60, 10 to 50, 10 to 40, 10 to 30, 10 to 20, 20 to 100, 20 to 99, 20 to 95, 20 to 90, 20 to 80, 20 to 70, 20 to 60, 20 to 50, 20 to 40, 20 to 30, 30 to 100, 30 to 99, 30 to 95, 30 to 90, 30 to 80, 30 to 70, 30 to 60, 30 to 50, 30 to 40, 40 to 100, 40 to 99, 40 to 95, 40 to 90, 40 to 80, 40 to 70, 40 to 60, 40 to 50, 50 to 100, 50 to 99, 50 to 95, 50 to 90, 50 to 80, 50 to 70, 50 to 60, 60 to 100, 60 to 99, 60 to 95, 60 to 90, 60 to 80, 60 to 70, 70 to 100, 70 to 99, 70 to 95, 70 to 90, 70 to 80, 80 to 100, 80 to 99, 80 to 95, 80 to 90, 90 to 100, 90 to 99, 90 to 95, 95 to 100, or 95 to 99% of the volume of the catalyst, support material or support monolith has reached the second temperature.

In some instances, the desired ammonia conversion efficiency (e.g., from about 70% to about 99%) can be achieved when a portion comprising at least about 1, 5, 10, 15, 20, 25, 30, 35, 40, 45, 50, 55, 60, 65, 70, 75, 80, 85, 90, 95, or 99% of the measurable surface of the catalyst, support material or support monolith has reached the second temperature. In some instances, the desired ammonia conversion efficiency can be achieved when a portion comprising not more than about 5, 10, 15, 20, 25, 30, 35, 40, 45, 50, 55, 60, 65, 70, 75, 80, 85, 90, 95, 99, or 100% of the measurable surface of the catalyst, support material or support monolith has reached the second temperature. In some instances, the desired ammonia conversion efficiency can be achieved when a portion comprising of from about 1 to about 100, 1 to 99, 1 to 95, 1 to 90, 1 to 80, 1 to 70, 1 to 60, 1 to 50, 1 to 40, 1 to 30, 1 to 20, 1 to 10, 5 to 100, 5 to 99, 5 to 95, 5 to 90, 5 to 80, 5 to 70, 5 to 60, 5 to 50, 5 to 40, 5 to 30, 5 to 20, 5 to 10, 10 to 100, 10 to 99, 10 to 95, 10 to 90, 10 to 80, 10 to 70, 10 to 60, 10 to 50, 10 to 40, 10 to 30, 10 to 20, 20 to 100, 20 to 99, 20 to 95, 20 to 90, 20 to 80, 20 to 70, 20 to 60, 20 to 50, 20 to 40, 20 to 30, 30 to 100, 30 to 99, 30 to 95, 30 to 90, 30 to 80, 30 to 70, 30 to 60, 30 to 50, 30 to 40, 40 to 100, 40 to 99, 40 to 95, 40 to 90, 40 to 80, 40 to 70, 40 to 60, 40 to 50, 50 to 100, 50 to 99, 50 to 95, 50 to 90, 50 to 80, 50 to 70, 50 to 60, 60 to 100, 60 to 99, 60 to 95, 60 to 90, 60 to 80, 60 to 70, 70 to 100, 70 to 99, 70 to 95, 70 to 90, 70 to 80, 80 to 100, 80 to 99, 80 to 95, 80 to 90, 90 to 100, 90 to 99, 90 to 95, 95 to 100, or 95 to 99% of the measurable surface of the catalyst, support material or support monolith has reached the second temperature.

In some embodiments, the ammonia conversion efficiency when at least a portion of the catalyst, support material or support monolith has reached the second temperature may comprise at least about 50, 55, 60, 65, 70, 75, 80, 85, 86, 87, 88, 89, 90, 91, 92, 93, 94, 95, 96, 97, 98, 99, 99.5, 99.6, 99.7, 99.8, or 99.9%. In some embodiments, ammonia conversion efficiency when at least a portion of the catalyst, support material or support monolith has reached the second temperature may comprise not more than about 55, 60, 65, 70, 75, 80, 85, 86, 87, 88, 89, 90, 91, 92, 93, 94, 95, 96, 97, 98, 99, 99.5, 99.6, 99.7, 99.8, 99.9 or 100%.

In some embodiments, ammonia conversion efficiency when at least a portion of the catalyst, support material or support monolith has reached the second temperature may comprise of from about 50 to about 100, 50 to 99, 55 to 95, 50 to 90, 60 to 99, 60 to 100, 60 to 99.9, 60 to 95, 60 to 90, 65 to 100, 65 to 99.9, 65 to 99, 65 to 95, 65 to 90, 70 to 100, 70 to 99.9, 70 to 99, 70 to 98, 70 to 97 70 to 96, 70 to 95, 70 to 94, 70 to 93, 70 to 92, 70 to 91, 70 to 90, 75 to 100, 50 to 99.9, 75 to 99, 75 to 98, 75 to 97 75 to 96, 75 to 95, 75 to 94, 75 to 93, 75 to 92, 75 to 91, 75 to 90, 80 to 100, 80 to 99.9, 80 to 99, 80 to 98, 80 to 97 80 to 96, 80 to 95, 80 to 94, 80 to 93, 80 to 92, 80 to 91, 80 to 90, 85 to 100, 85 to 99.9, 85 to 99, 85 to 98, 85 to 97 85 to 96, 85 to 95, 85 to 94, 85 to 93, 85 to 92, 85 to 91, 85 to 90, 90 to 100, 90 to 99.9, 90 to 99.8, 90 to 99.7, 90 to 99.6, 90 to 99.5, 90 to 99, 90 to 98, 90 to 97 90 to 96, 90 to 95, 91 to 100, 91 to 99.9, 91 to 99.5, 91 to 99, 91 to 98, 91 to 97, 91 to 96, 91 to 95, 92 to 100, 92 to 99.9, 92 to 99.5, 92 to 99, 92 to 98, 92 to 97, 92 to 96, 92 to 95, 93 to 100, 93 to 99.9, 93 to 99.5, 93 to 99, 93 to 98, 94 to 100, 94 to 99.9, 94 to 99.5, 94 to 99, 94 to 98, 95 to 100, 95 to 99.9, 95 to 99.8, 95 to 99.7, 95 to 99.6, 95 to 99.5, 95 to 99, or 95 to 98%

In some instances, the time to increase the temperature of at least a portion of the conducting catalyst, support material, or support monolith from the first temperature to the second temperature may comprise at least about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, or 55 minutes. In some instances, the time to increase the temperature of at least a portion of the conducting catalyst, support material, or support monolith from the first temperature to the second temperature may comprise not more than about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55 or 60 minutes.

In some instances, the time to increase the temperature of at least a portion of the conducting catalyst, support material, or support monolith from the first temperature to the second temperature may comprise of from about 0.1 to 60, 0.5 to 55, 1 to 50, 1 to 40, 1 to 30, 1 to 20, 1 to 10, 2 to 50, 2 to 40, 2 to 30, 2 to 20, 2 to 10, 3 to 50, 3 to 40, 3 to 30, 3 to 20, 3 to 10, 4 to 50, 4 to 40, 4 to 30, 4 to 20, 4 to 10, 5 to 50, 5 to 40, 5 to 30, 5 to 20, 5 to 10, 6 to 50, 6 to 40, 6 to 30, 6 to 20, 6 to 10, 7 to 50, 7 to 40, 7 to 30, 7 to 20, 7 to 10, 8 to 50, 8 to 40, 8 to 30, 8 to 20, 8 to 10, 9 to 50, 9 to 40, 9 to 30, 9 to 20, 9 to 10, 10 to 50, 10 to 40, 10 to 30, 10 to 25, 1 to 20, 10 to 15, 15 to 50, 15 to 40, 15 to 30, 15 to 25, 15 to 20, 20 to 50, 20 to 45, 20 to 40, 20 to 35, 20 to 30, 20 to 25, 25 to 50, 25 to 45, 25 to 40, 25 to 35, 25 to 30, 30 to 60, 30 to 55, 30 to 50, 30 to 45, 30 to 40, or 30 to 35 minutes.

In some cases, the current travels between the electrodes and through the catalyst for a distance of at least about 0.1, 0.5, 1, 2, 3, 4, 5, 6, 7, 8, 9, 10, 15, 20, 25, 30, 35, 40, 45, 50, 60, 70, 80, 90, 100, 125, 150, 175, 200, 225, 250, 275, 300, 400, 500, 600, 700, 800, 900, 1000, 1500, 2000, 2500, 3000, 3500, 4000, 4500, 5000, 6000, 7000, 8000, 9000, 10000, 11000, 12000, 13000, 14000, 15000, 16000, 17000, 18000, or 19000 cm. In some cases, the current travels between the electrodes and through the catalyst for a distance of not more than about 0.5, 1, 2, 3, 4, 5, 6, 7, 8, 9, 10, 15, 20, 25, 30, 35, 40, 45, 50, 60, 70, 80, 90, 100, 125, 150, 175, 200, 225, 250, 275, 300, 400, 500, 600, 700, 800, 900, 1000, 1500, 2000, 2500, 3000, 3500, 4000, 4500, 5000, 6000, 7000, 8000, 9000, 10000, 11000, 12000, 13000, 14000, 15000, 16000, 17000, 18000, 19000, or 20000 cm.

In some cases, the current travels between the electrodes and through the catalyst for a distance of from about 0.1 to about 20000, 0.1 to 15000, 0.1 to 10000, 0.1 to 5000, 0.5 to about 20000, 0.5 to 15000, 0.5 to 10000, 0.5 to 5000, 1 to about 20000, 1 to 15000, 1 to 10000, 1 to 5000, 1 to 4000, 1 to 3000, 1 to 2000, 1 to 1000, 2 to about 20000, 2 to 15000, 2 to 10000, 2 to 5000, 2 to 4000, 2 to 3000, 2 to 2000, 2 to 1000, 5 to about 20000, 5 to 15000, 5 to 10000, 5 to 5000, 5 to 4000, 5 to 3000, 5 to 2000, 5 to 1000, 5 to 500, 10 to about 20000, 10 to 15000, 10 to 10000, 10 to 5000, 10 to 4000, 10 to 3000, 10 to 2000, 10 to 1000, 10 to 500, 10 to 100, 15 to 15000, 15 to 10000, 15 to 5000, 15 to 4000, 15 to 3000, 15 to 2000, 15 to 1000, 15 to 500, 15 to 100, 20 to 10000, 20 to 5000, 20 to 4000, 20 to 3000, 20 to 2000, 20 to 1000, 20 to 500, 20 to 100, 30 to 10000, 30 to 5000, 30 to 4000, 30 to 3000, 30 to 2000, 30 to 1000, 30 to 500, 30 to 100, 50 to 10000, 50 to 5000, 50 to 4000, 50 to 3000, 50 to 2000, 50 to 1000, 50 to 500, 50 to 100, 100 to 10000, 100 to 5000, 100 to 4000, 100 to 3000, 100 to 2000, 100 to 1000, or 100 to 500 cm.

In some embodiments, the electrically conducting catalyst may be heated to a temperature of from about 600 to 700° C., by passing an electrical current through the catalyst for no more than about 10 minutes and decompose NH₃ to generate H₂ and N₂ with a conversion efficiency of at least about 90, 91, 92, 93, 94, 95, 96, 97, 98, 99 or 99.9%. In some embodiments, the electrically conducting catalyst may be heated to a temperature of from about 550 to 650° C., by passing an electrical current through the catalyst for no more than about 10 minutes and decompose NH₃ to generate H₂ and N₂ with a conversion efficiency of at least about 85, 86, 87, 88, 89, 90, 91, 92, 93, 94, 95, 96, 97, 98, 99, or 99.9%. In some embodiments, the electrically conducting catalyst may be heated to a temperature of from about 500 to 600° C., by passing an electrical current through the catalyst for no more than about 10 minutes and decompose NH₃ to generate H₂ and N₂ with a conversion efficiency of at least about 80, 81, 82, 83, 84, 85, 86, 87, 88, 89, 90, 91, 92, 93, 94, 95, 96, 97, 98, 99, or 99.9%. In some embodiments, the electrically conducting catalyst may be heated to a temperature of from about 450 to 550° C., by passing an electrical current through the catalyst for no more than about 10 minutes and decompose NH₃ to generate H₂ and N₂ with a conversion efficiency of at least about 75, 76, 77, 78, 79, 80, 81, 82, 83, 84, 85, 86, 87, 88, 89, 90, 91, 92, 93, 94, 95, 96, 97, 98, 99, or 99.9%.

### Hybrid Heating System

In some cases, the improved catalysts may undergo hybrid heating within a reformer. Such hybrid heating can improve heat transfer while minimizing heat loss and increasing startup time. A hybrid heating design can also reduce a weight and a volume of the reformer and improve thermal management characteristics of the system while providing an improved heat source for ammonia conversion.

In some cases, the improved catalysts may be heated using one or more heat sources. In some cases, the one or more heat sources may comprise two or more heat sources or heating units. In some cases, the two or more heat sources may be the same or similar. In some cases, the two or more heat sources may be different. For example, a first heat source may be configured for Joule heating, and a second heat source may be configured for combustion.

In some instances, the improved catalysts may be heated using a plurality of heating units. The plurality of heating units may comprise a first heating unit configured to heat at least a first portion of a catalyst by combusting hydrogen and a second heating unit configured to heat at least a second portion of the catalyst using electrical heating. The term “electrical heating,” as used herein, generally refers to heating performed at least in part by flowing electrons through a material (e.g., an electrical conduit). The electrical conduit may be a resistive load. In some examples, electrical heating may comprise Joule heating (i.e., heating that follows Ohm's law). Joule heating, also known as resistive, resistance, or Ohmic heating, may comprise passing an electric current through a material (e.g., the electrical resistor, the catalyst, the catalyst material, or the catalyst bed) to produce heat or thermal energy. In some cases, the catalyst may be used to generate hydrogen from a source material comprising the ammonia when the catalyst is heated using the plurality of heating units. In some instances, the first portion and the second portion may be the same portion of the catalyst. In other instances, the first portion and the second portion may be different portions of the catalyst. In some cases, the first portion and the second portion may overlap or partially overlap.

In some cases, a first heating unit of a reformer may be configured to heat a first portion of the catalyst based on a combustion of hydrogen gas generated using a secondary reformer. In some cases, the first heating unit may be configured to heat the first portion of the catalyst based on a combustion of unconsumed hydrogen gas from (i) one or more fuel cells in fluid communication with the reformer or (ii) a secondary reformer. In some cases, the second heating unit may be configured to heat a second portion of the catalyst by passing an electrical current through the second portion of the catalyst. In some cases, the first portion of the catalyst and the second portion of the catalyst may be contiguous (i.e., physically connected). In some cases, the first portion of the catalyst and the second portion of the catalyst may be separated by a third portion of the catalyst. The third portion of the catalyst may be positioned between the first and second portions of the catalyst. In some cases, the first and second portions of the catalyst may be in thermal communication with each other (e.g., either directly or indirectly via the third portion of the catalyst). In other cases, the first and second portions of the catalyst may not or need not be in thermal communication with each other.

In some cases, a heat load distribution between the first heating unit and the second heating unit may be adjustable to increase an ammonia conversion efficiency and/or to enhance a thermal efficiency of the reformer. The heat load distribution may comprise a heating power ratio corresponding to a ratio between a heating power of the first heating unit and a heating power of the second heating unit. The heating power of the first heating unit and the second heating unit may be adjusted in order to achieve a desired ammonia conversion efficiency and thermal efficiency. In some cases, the system may further comprise a controller or processor configured to control an operation of the first heating unit and the second heating unit to adjust the heat load distribution within the reformer module. In some cases, such adjustments in the heat load distribution may be implemented in real-time based on one or more sensor measurements (e.g., temperature measurements) or based on a performance of the reformer (e.g., ammonia conversion efficiency and/or thermal efficiency of the reformer). In some cases, one or more heating units with two or more heating zones may be used to control power and heat distribution within the one or more heating units. In some cases, the system may comprise a plurality of heating units. The plurality of heating units may comprise at least two or more heating units. In some cases, a heat load distribution between the at least two or more heating units may be adjustable to increase an ammonia conversion efficiency and to enhance a thermal reforming efficiency of the reformer. In some cases, each of the at least two or more heating units may have one or more heating zones in the reformer to allow for a continuous heat distribution within one or more regions in the reformer. In some cases, the at least two or more heating units may be configured to heat different zones in the reformer. In some cases, the at least two or more heating units may be configured to heat one or more same zones in the reformer.

### Configuration of Catalyst and Reformer System

In some embodiments, the catalyst is housed inside a reformer unit. The reformer unit may be designed in various shaped (typically, cylindrical), but may have at least two sides (a first side and a second side) that are substantially, or essentially, opposite from each other. For example, in some embodiments, the at least two sides are configured such that an electrical current can flow through the catalyst. In some embodiments the reformer comprises at least one pair of electrodes, comprising a first electrode and a second electrode. In some instances, the first electrode of the pair of electrodes may be positioned in proximity to the first side of the reactor. In some instances, a second electrode of the pair of electrodes may be positioned in proximity to the second side of the reactor. In some embodiments, the second electrode of the pair of electrodes may be positioned substantially opposite from the first side. For example, in some embodiments, the first and the second electrode of the pair of electrodes are configured such that an electrical current can flow through the catalyst. In some cases, the pair of electrodes may be adjacent to each other and in proximity to a side of the reactor. In some embodiments, a voltage may be applied between or across the electrodes, to effect a temperature change of the catalyst. In some embodiments, the voltage between or across the electrodes may be reduced or removed, based on or a voltage based on the catalyst reaching the second temperature. In some instances, the controller may cease to apply a voltage between or across the electrodes, based on the catalyst reaching the second temperature. In some embodiments, the voltage is provided from at least one of: a battery, a fuel cell, a solar panel, a wind turbine, a capacitor, a transformer, or an electrical distribution grid or network.

In some cases, the reformer may be heated by combustion. In some cases, the reformer may be heated electrically, separately to the catalyst. In some cases, the reformer may be heated electrically, in addition to the catalyst. In some instances, the reformer may include a second catalyst. In some instances, the second catalyst may have the same composition and/or form factor as the (first) catalyst. In some instances, the second catalyst may have a different composition and/or form factor to the (first) catalyst. In some cases, the second catalyst is in at least one of: physical, thermal, electrical or fluid contact with the (first) catalyst. In some cases, the second catalyst is not in physical, thermal, electrical or fluid contact with the (first) catalyst. In some instances, the second catalyst may be at least partially mixed with the (first) catalyst. In some embodiments, the reformer comprises at least two zones, wherein the first zone comprises the (first) catalyst and the second zone comprises the second catalyst.

### Computer Systems

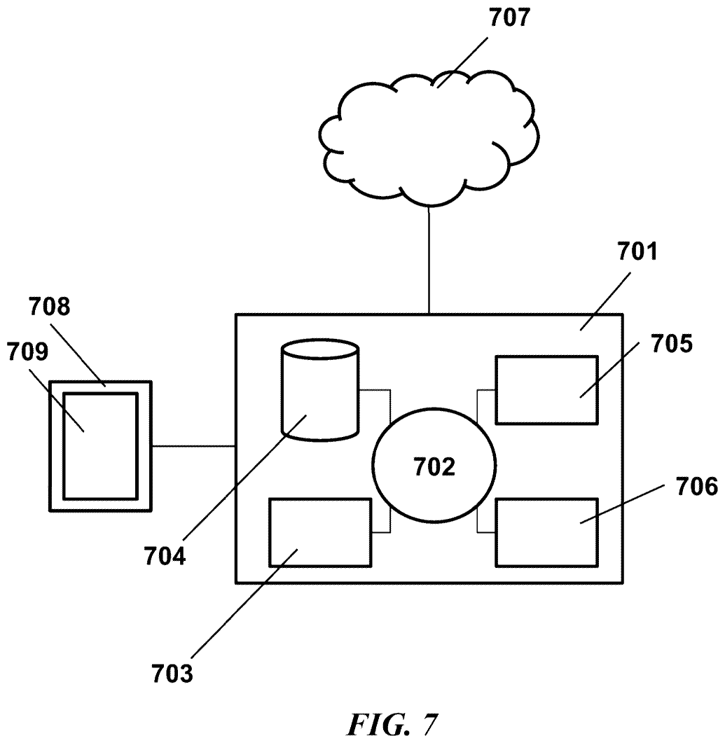

The present disclosure provides computer systems (e.g., controllers, computing devices and/or computers) that are programmed to implement methods of the disclosure. FIG. 7 shows a computer system 701 that is programmed or otherwise configured to control the systems disclosed herein. The computer system 701 can regulate various aspects of the systems disclosed in the present disclosure. The computer system 701 can be an electronic device of a user or a computer system that is remotely located with respect to the electronic device. The electronic device can be a mobile electronic device.

The computer system 701 includes a central processing unit (CPU, also “processor” and “computer processor” herein) 702, which can be a single core or multi core processor, or a plurality of processors for parallel processing. The computer system 701 also includes memory or memory location 703 (e.g., random-access memory, read-only memory, flash memory), electronic storage unit 704 (e.g., hard disk), communication interface 705 (e.g., network adapter) for communicating with one or more other systems, and peripheral devices 706, such as cache, other memory, data storage and/or electronic display adapters. The memory 703, storage unit 704, interface 705 and peripheral devices 706 are in communication with the CPU 702 through a communication bus (solid lines), such as a motherboard. The storage unit 704 can be a data storage unit (or data repository) for storing data. The computer system 701 can be operatively coupled to a computer network (“network”) 707 with the aid of the communication interface 705. The network 707 can be the Internet, an internet and/or extranet, or an intranet and/or extranet that is in communication with the Internet. The network 707 in some cases is a telecommunication and/or data network. The network 707 can include one or more computer servers, which can enable distributed computing, such as cloud computing. The network 707, in some cases with the aid of the computer system 701, can implement a peer-to-peer network, which may enable devices coupled to the computer system 701 to behave as a client or a server.

The CPU 702 can execute a sequence of machine-readable instructions, which can be embodied in a program or software. The instructions may be stored in a memory location, such as the memory 703. The instructions can be directed to the CPU 702, which can subsequently program or otherwise configure the CPU 702 to implement methods of the present disclosure. Examples of operations performed by the CPU 702 can include fetch, decode, execute, and writeback.

The CPU 702 can be part of a circuit, such as an integrated circuit. One or more other components of the system 701 can be included in the circuit. In some cases, the circuit is an application specific integrated circuit (ASIC).

The storage unit 704 can store files, such as drivers, libraries and saved programs. The storage unit 704 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 707. For instance, the computer system 701 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 701 via the network 707.

Methods as described herein can be implemented by way of machine (e.g., computer processor) executable code stored on an electronic storage location of the computer system 701, such as, for example, on the memory 703 or electronic storage unit 704. The machine executable or machine-readable code can be provided in the form of software. During use, the code can be executed by the processor 702. In some cases, the code can be retrieved from the storage unit 704 and stored on the memory 703 for ready access by the processor 702. In some situations, the electronic storage unit 704 can be precluded, and machine-executable instructions are stored on memory 703.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display 708 that comprises a user interface (UI) 709 for providing. Examples of UF s include, without limitation, a graphical user interface (GUI) and web-based user interface.

Methods and systems of the present disclosure can be implemented by way of one or more algorithms. An algorithm can be implemented by way of software upon execution by the central processing unit 702.

### Catalyst Fabrication Methods

In another aspect, the present disclosure provides catalysts and methods for fabricating one or more catalysts for processing ammonia to generate hydrogen. The method may comprise subjecting a catalyst support to one or more physical or chemical processes to modify one or more pores of the catalyst support. In some cases, the one or more physical or chemical processes for modifying the one or more pores of the catalyst support may comprise a thermal treatment (i.e., controlled heating) of the catalyst support. In some cases, modifying the one or more pores may comprise adjusting a size of the one or more pores, a pore density, and/or a pore volume of the catalyst support. In some cases, the method may further comprise thermally or chemically treating a surface of the catalyst support material to modify the one or more pores and/or one or more surface morphologies. In some cases, the thermal treatment of the support material, or chemically treated support materials, may be performed in an inert atmosphere (e.g., comprising N₂, or Ar), in a non-reducing atmosphere (e.g. comprising air, N₂, or O₂), in a non-oxidizing atmosphere (e.g., comprising N₂, Ar, CO, CO₂), or in a reactive, nitrogen-rich atmosphere (e.g., comprising NH₃, H₂—N₂, or forming gas). In some embodiments, the catalyst support comprises a bead, a pellet, a powder, a thin film, a monolith, a foam, reactor wall, heating element, wires, mesh, a corrugated or engineered sheet, or a porous solid material form factor. In some cases, the catalyst is powderless, for example, majority of the catalyst (e.g., 90% or more) may be greater than 0.1 mm in a characteristic dimension or aspect (e.g. diameter or length). In some embodiments, the catalyst is powderless, for example, a majority of the catalyst (e.g., 90% or more) may be greater than 1 mm in a characteristic dimension or aspect.

In some embodiments, the method may further comprise depositing a composite support material on the catalyst support, wherein the composite support material comprises a morphology, and (c) depositing one or more active metals on at least one of the composite support material and the catalyst support, wherein the one or more active metals comprise one or more nanoparticles configured to conform to the morphology of the composite support material, thereby modifying one or more active sites on the nanoparticles for ammonia processing. In some cases, the composite support material may be deposited using chemical vapor deposition. In some embodiments, the composite support material may be deposited using a wet impregnation method. In some cases, the one or more active metals may be deposited using chemical vapor deposition. In some embodiments, the one or more active metals may be deposited using a wet impregnation method. The active metals may comprise one or more nanoparticles with one or more active sites to which one or more ammonia molecules are attachable. The one or more ammonia molecules may be configured to bind or attach to the one or more active sites of the one or more active metal nanoparticles. The positions, orientations, and/or density of the one or more active sites may be determined based at least in part on a morphology and/or surface chemistry or property of the composite support material. In some embodiments, the morphology may comprise a grain structure, a grain size, or a grain shape.

In some cases, the catalyst support may comprise, for example, at least one of Al₂O₃, alumina, MgO, magnesia, CeO₂, ceria, SiO₂, silica, SiC, carborundum, Y₂O₃, yttria, TiO₂, titania, ZrO₂, or zirconia. In some cases, the catalyst support may comprise, for example, at least one of AlₓO_{y}, MgₓO_{y} CeₓO_{y}, SiₓO_{y}, YₓO_{y}, TiₓO_{y}, or ZrₓO_{y}. In some cases, the one or more active metals comprise, for example, at least one of ruthenium (Ru), nickel (Ni), rhodium (Rh), iridium (Ir), cobalt (Co), molybdenum (Mo), iron (Fe), platinum (Pt), chromium (Cr), palladium (Pd), manganese (Mn), tungsten (W), vanadium (V), zinc (Zn), or copper (Cu). In some cases, the composite support may comprise a carbon-based material, a boron-based material, or a metal oxide. The carbon-based material may comprise, for example, activated carbon (AC), one or more carbon nanotubes (CNT), one or more carbon nanofibers (CNF), graphene oxide (GO), graphite, or reduced graphene oxide (rGO). The boron-based material may comprise, for example, hexagonal boron nitride (hBN), boron nitride nanotubes (BNNT), hexagonal boron carbon nitride (hBCN), boron carbon nitride nanotubes (BCNNT), boron nitride nanosheets (BNNS), or boron carbon nitride nanosheets (BCNNS). The metal oxide may comprise, for example, TiO₂, titania, MgO, magnesia, magnesium aluminate (MgAl₂O₄), spinel, La₂O₃, lanthana, CeO₂, ceria, Y₂O₃, yttria, one or more CeO₂ nanotubes, nanorods or nanocubes, mesoporous silica (e.g., KIT-6), ZrO₂, zirconia, chromium oxide (Cr₂O₃), or chromia. The metal oxide may comprise, for example, zinc aluminate (ZnAl₂O₄), gahnite, ferrous aluminate (FeAl₂O₄), hercynite, manganese aluminate (MnAl₂O₄), galaxite, magnesium ferrous aluminate ((MgFe)Al₂O₄), or pleonaste. The metal oxide may comprise, for example, lime, quicklime, calcium oxide (CaO), calcium hydroxide (Ca(OH)₂), slaked lime, calcium carbonate (CaCO₃), calcite, barium oxide (BaO), baria, barium carbonate (BaCO₃), strontium oxide (SrO), strontia, ferrous oxide (FeO), zinc oxide (ZnO), or manganese oxide (MnO). The metal oxide may comprise, for example, TiₓO_{y}, MgₓO_{y} LaₓO_{y}, CeₓO_{y}, YₓO_{y}, CeₓO_{y}, ZrₓO_{y}, CrₓO_{y}, or CaₓO_{y} In some cases, the composite support may comprise YSZ, Hydrotalcite (Mg₂Al-LDO), MOF (MIL-101, ZIFs), Alkaline amide (NaNH₂, Ca(NH₂)₂, Mg(NH₂)₂), Inorganic electride (C12A7:e-), Halloysite nanotubes (HNT), ABO₃ Perovskite, AB₂O₄ Spinel, or MCM-41.

In some embodiments, the method may further comprise thermally activating the one or more active metals. Thermally activating the one or more active metals may induce a growth of one or more nanoparticles of the active metals. In some cases, the one or more nanoparticles may be configured to grow while conforming to the morphology of the composite support material. In some cases, the method may further comprise promoting the catalyst, the active metal nanoparticles, and/or the composite support material of the catalyst with one or more promoters. The one or more promoters may comprise, for example, sodium (Na), potassium (K), rubidium (Rb), cesium (Cs), magnesium (Mg), calcium (Ca), strontium (Sr), or barium (Ba).

In some aspects, the present disclosure provides a method of producing a catalyst. In some cases, the method comprises heating the support to a target temperature. In some cases, the method comprises depositing one or more promoter precursors on the support to produce the catalyst. In some cases, the catalyst is configured to decompose ammonia to generate hydrogen. In some cases, the catalyst is configured to decompose ammonia to generate hydrogen and nitrogen.

In some cases, the one or more active metal precursors comprise a Ru precursor, a Ni precursor, a Rh precursor, a Ir precursor, a Co precursor, a Fe precursor, a Pt precursor, a Cr precursor, a Mo precursor, a Pd precursor, or a Cu precursor. In some cases, the ruthenium precursor comprises ruthenium iodide, ruthenium acetylacetonate, ruthenium chloride hydrate, ruthenium oxide hydrate, ruthenium chloride, bis(cyclopentadienyl)ruthenium, ruthenium nitrosyl nitrate, ruthenium iodide hydrate, triruthenium dodecacarbonyl, or any combination thereof.

In some cases, the catalyst comprises about 0.2 wt % to about 20 wt % of ruthenium. In some cases, the catalyst comprises about 0.5 wt % to about 5 wt % of ruthenium. In some cases, the catalyst comprises at least about 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 wt % of ruthenium. In some cases, the catalyst comprises not more than about 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 wt % of ruthenium.

In some cases, the processing further comprises processing (iii) a promoter or a promoter precursor to produce or yield a target molar ratio of the dopant and support surface modifier in the support. In some cases, the promoter precursor comprises an alkali metal precursor. In some cases, an alkali metal of the alkali metal precursor comprises Li, Na, K, Rb, or Cs. In some cases, the catalyst is substantially free of alkali metals. In some cases, the catalyst is substantially free of promoters. In some instances, the catalyst is substantially free of rare earth metals. In some instances, the catalyst is substantially free of support surface modifiers.

In some cases, the promoter precursor comprises potassium or cesium as a soluble salt or complex, such as the metal: methylate, tetrafluoroborate, hydrogen fluoride, thiocyanate, disulfite, bisulfate, sulfide, methoxide, trifluoroacetate, dioxide, persulfate, formate, bicarbonate, sorbate, hydroxide, borohydride, dichloroacetate, iodate, chlorate, fluoride, chloride, nitrate, perchlorate, cyanate, or hexachloroiridate. In some cases, the promoter precursor is processed in an aqueous solution. In some cases, the promoter precursor is processed in an organic solution.

In some cases, the method comprises drying the support in a vacuum. In some cases, the method comprises heating the support to a first target temperature. In some cases, the method comprises reducing the one or more promoter precursors, the support surface modifier, the support, and/or the mixed oxide on the support under hydrogen at a second target temperature. In some cases, the method comprises drying the impregnated support in a vacuum prior to depositing the one or more promoters or dopant precursors. In some cases, drying the impregnated support comprises vacuum drying. In some cases, the vacuum may comprise a pressure that is less than 1 bar. In some cases, the vacuum may comprise a pressure that is less than about 1, 0.1, 0.01, 0.001, 0.0001, or 0.00001 bar. In some cases, the heating comprises using an inert gas. In some cases, the heating comprises using air. In some cases, the inert gas may comprise He, Ne, Ar, Kr, Xe, or N₂.

In some cases, a promoter may be configured to modify the basicity of the composite oxide support. In some cases, a promoter may be configured to increase the electron density of active metal to facilitate recombinative nitrogen desorption and/or N—H bond cleavage during an ammonia decomposition reaction.

In some cases, the catalyst may comprise nanorod supports. In some cases, the nanorods comprise a rod of material with a thickness or diameter of only a few nm. In some cases, the nanorod supports may be produced using hydrothermal synthesis. In some cases, processing conditions of the hydrothermal synthesis may be tuned to control the morphology of the support. For example, the morphology of the support may comprise a nanorod diameter, a nanorod length, polydispersity, aggregation, or any combination thereof. In some cases, the support may be produced using hydrothermal synthesis to coprecipitate an oxide with a promoter. In some cases, the support surface modifier and the promoter may be coprecipitated. In some cases, co-impregnation of a promoter and an oxide (e.g., KOH and Ce(NO₃)₃) may be performed at high pH reaction conditions.

In some cases, X-Ray Photoelectron Spectroscopy (XPS) may be used to determine electron density by measuring the electron binding energy of electron states. In some cases, XPS may be used to analyze the electronic state by measuring the electron binding energy in a surface region. It is noted that a higher binding energy may indicate an increased difficulty in removing an electron. In some cases, higher binding energy may indicate a more electropositive environment.

In some aspects, the present disclosure provides a method of producing a catalyst. In some cases, the method comprises providing a support comprising alumina. In some cases, the method comprises depositing a precursor comprising ruthenium and a precursor comprising phosphorous on the support. In some cases, the method comprises processing the support by annealing the support at a first target temperature under N₂. In some cases, the method comprises processing the support by reducing the support at a second target temperature under H₂ to yield the catalyst.

### Selection of Catalyst Precursors

In some cases, the ammonia decomposition reaction may be driven using a catalyst. The catalyst may comprise at least one active metal (e.g., Co, Mo, Fe, Ni, Zn, Cu, Ru) nanoparticle catalyst. The active metal nanoparticle catalyst may comprise one or more active metal nanoparticles. The active metal nanoparticle catalyst may be utilized to facilitate an ammonia decomposition reaction as described elsewhere herein, and may be fabricated by loading a given precursor onto a carrier (e.g., a support comprising alumina, zirconia, silica, silicon carbide, or carbon), or a modified carrier (e.g., a composite support, modified support or doped support comprising alumina, zirconia, silica, silicon carbide, or carbon), and performing a reduction at a high temperature.

In some cases, the support comprises an amorphous, monoclinic, tetragonal, cubic, hexagonal, isometric, spinel, or perovskite phase. In some cases, the modified support comprises an amorphous, monoclinic, tetragonal, cubic, hexagonal, isometric, spinel, or perovskite phase. In some embodiments, a metal salt or a metal salt hydrate, such as MNO₃, may be initially deposited on a surface of the alumina carrier, followed by high-temperature calcination to generate an M-Al oxide support. As used herein, M may refer to any alkaline earth or spinel-forming metal. In some cases, the M-Al oxide may form an alumina supported perovskite phase, MAlO₃/Al₂O₃. In some cases, the M-Al oxide may form an alumina supported spinel phase, MAlO₄/Al₂O₃. In some cases, two or more types of metal salts or metal salt hydrates may be added to generate a mixed M1-M2-Al oxide support. Onto this support, an active metal (e.g. ruthenium) precursor may be deposited, and the support and/or the active metal precursor may be reduced at an elevated temperature (e.g., an elevated temperature ranging from about 300° C. to about 1300° C.) to generate an improved nanoparticle catalyst. In some cases, a promoter may be added to the catalyst in the form of electron donors, (e.g. Cs or K), which can further improve ammonia conversion efficiency.

In some cases, the ruthenium nanoparticle catalysts of the present disclosure may be synthesized using various ruthenium precursors comprising, for example, Ru(NO)(NO₃)₃, RuCl₃ and Ru₃(CO)₁₂, Ru(NO₃)₃, Ru(acac)₃ (ruthenium acetylacetonate), Ru(NH₃)₆Cl₃ (ruthenium hexaamine chloride), (CHD)Ru(CO)₃ (cyclohexadiene ruthenium tricarbonyl), (BD)Ru(CO)₃ (Butadiene ruthenium tricarbonyl), or (DMBD)Ru(CO)₃ (dimethyl butadiene ruthenium tricarbonyl).

### Support Precursors

In some cases, the support comprises an amorphous, monoclinic, tetragonal, hexagonal, or perovskite phase. In some cases, the modified support comprises an amorphous, monoclinic, tetragonal, hexagonal, or perovskite phase. In some embodiments, a metal salt or a metal salt hydrate, such as MNO₃, may be initially deposited on a surface of the carrier, followed by high-temperature calcination to generate mixed M-X-oxide support (where X may comprise, for example, Al, Zr, Si, or C). As used herein, M may refer to any type of metal. In some cases, the mixed M-X-oxide may comprise an alumina supported perovskite phase, MAlO₃/Al₂O₃. In some instances, the M-Al oxide may not form a perovskite phase. In some cases, the mixed M-X-oxide comprises an amorphous structure, a monoclinic structure, or a tetragonal network structure of (Zr:X)O₂. In some cases, two or more types of metal salts or metal salt hydrates may be added to generate a mixed M1-M2-Al oxide support. Onto this support, an active metal (e.g., Ru, Co, Mo, Fe, Ni, Zn, Cu) precursor may be deposited, and the support and/or the active metal precursor may be reduced (e.g., in an atmosphere comprising H₂) at an elevated temperature (e.g., an elevated temperature ranging from about 300° C. to about 1300° C., or from about 500° C. to about 1300° C.) to generate an improved nanoparticle catalyst. In some cases, a promoter may be added to the catalyst in the form of electron donors, (e.g., Cs or K), which can further improve ammonia conversion efficiency.

### Catalyst Support Form Factor

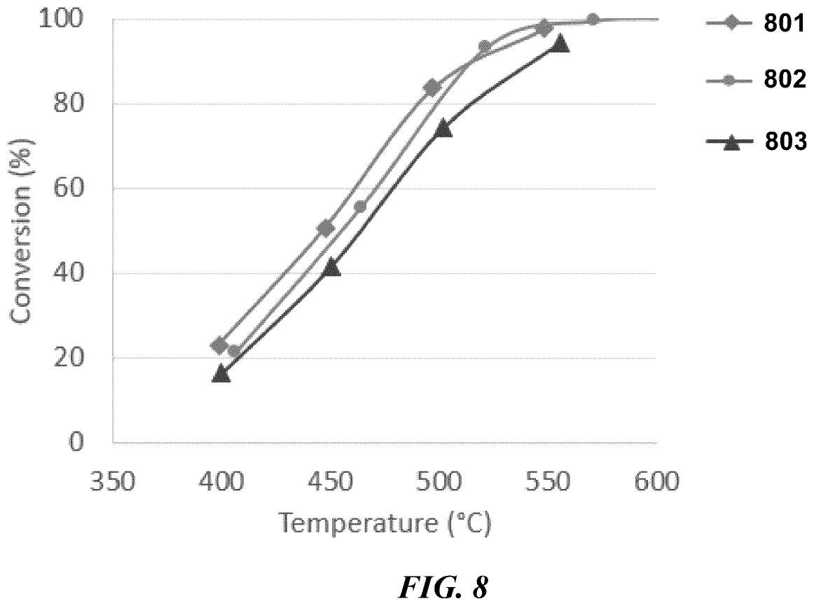

In some cases, the catalysts of the present disclosure may be synthesized using various alumina, zirconia, silicon or carbon carriers. The carriers may be in the form of a bead or a cylindrical pellet or a combination of both. In some cases, the carrier may comprise any type of a porous solid material. In other cases, the carrier may comprise a bead, a pellet, a powder, a monolith, a foam, or any combination thereof. In some cases, a smaller particle size may lead to a more active catalyst. In some cases, a smaller particle size may lead to increased pressure drop across the reformer. In some instances, the bead or the pellet may have a diameter of at least about 0.1, 0.5, 1, 1.5, 2, 2.5, 3, 3.5, 4, 4.5, 5, 5.5, 6, 6.5, 7, 7.5, 8, 8.5, 9, or 9.5 millimeters (mm). In some instances, the bead or the pellet may have a diameter of at most about 0.5, 1, 1.5, 2.0, 2.5, 3, 3.5, 4, 4.5, 5 5.5, 6, 6.5, 7, 7.5, 8, 8.5, 9, 9.5 or 10 mm. In some cases, the bead or the pellet may have a surface area per unit mass ranging from about 50 m²/g to about 500 m²/g. In some instances, the bead or the pellet may have a surface area per unit mass of at least about 50, 100, 150, 200, 250, 300, 350, 400, 450, 500, 550, 600, 650, 700, 750, 800, 850, 900, 950, 1000, 1050, 1100, or 1150 m²/g. In some instances, the bead or the pellet may have a surface area per unit mass of at most about 100, 150, 200, 250, 300, 350, 400, 450, 500, 550, 600, 650, 700, 750, 800, 850, 900, 950, 1000, 1050, 1100, 1150, or 1200 m²/g. Described herein is an example of the effect of support form factor on the hydrogen generation performance of a Ru-alumina catalyst. Across a temperature range from about 400° C. to about 500° C., the catalyst based on 1.0 mm beads exhibited superior performance. Above a temperature of about 500° C., the difference between the catalyst using 1.0 mm beads and the catalyst using 1.5 mm beads seems to reduce in significance. The catalyst based on 3.2 mm pellets exhibits lower performance than the other two catalysts, across a temperature range from about 400° C. to about 575° C. With reference to FIG. 8, Ru-alumina catalysts may be prepared according to the same methods and materials (described herein), and with the same composition. The catalysts may be prepared using RuCl₃ as the active metal precursor and on support material comprising gamma-alumina (γ-alumina). The catalysts may comprise a form factor of: 1.0 mm beads 801, 1.5 mm beads 802, or 3.2 mm pellets 803.

### Mixed Metal Oxide Composite Support

In some cases, an alumina support may be initially modified by incorporation of a Group 2 alkaline earth metal and/or a spinel-forming metal (M) via high-temperature treatment to generate a M-Al mixed metal alloy, mixed metal oxide, or mixed metal nitride layer adjacent to the support material to form a M-Al mixed metal composite support that can serve as an improved catalyst support. In some cases, the alumina may comprise at least one of alpha-alumina (α-alumina), gamma-alumina (γ-alumina), or theta-alumina (θ-alumina). In some cases, the composite support may comprise an alkaline earth metal and/or a spinel-forming metal oxide (MO) layer, adjacent to the alumina. In some cases, the composite support may comprise an alkaline earth metal or a spinel-forming metal aluminate (MAl₂O₄) spinel structure or layer, adjacent to the alumina. In some cases, the composite support may comprise a layer of alkaline earth metal and/or a spinel-forming metal oxide (MO) adjacent to a MAl₂O₄ spinel structure or layer, adjacent to the alumina. In some cases, the composite support may comprise particles of MO adjacent to a MAl₂O₄ spinel structure or layer, adjacent to the alumina. In some cases, the particles of MO comprise nanoparticles of MO. In some cases, the composite support may comprise discrete particles, areas, or zones of MO adjacent to a MAl₂O₄ spinel structure or layer, adjacent to the alumina. In some cases, the discrete areas or zones of MO adjacent to a MAl₂O₄ spinel structure or layer may be fabricated by overloading of an alumina support by MO or a precursor thereof. In some cases, the discrete areas or zones of MO adjacent to a MAl₂O₄ spinel structure or layer may be fabricated by leaching or etching of a layer of MAl₂O₄ using an aqueous acid or alkaline solution, to remove Al. In some cases, the discrete areas or zones of MO adjacent to a MAl₂O₄ spinel structure or layer may be fabricated by leaching or etching of a layer of MAl₂O₄ using an aqueous acid or alkaline solution and a resist layer, template or framework, to selectively remove Al. In some cases, the discrete areas or zones of MO adjacent to a MAl₂O₄ spinel structure or layer may be fabricated by the formation of a layer of MO using a designed template or framework, adjacent to a layer of MAl₂O₄. In some embodiments, the alkaline earth metal may be Mg, Ca, Sr, or Ba. In some embodiments, the spinel-forming metal may be at least one of Mg, Ca, Sr, Ba, Fe, Mn, or Zn.

In some embodiments, the concentration of alkaline earth metal and/or spinel-forming metal in the composite support may comprise at least about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, or 89 mol %. In some embodiments, the concentration of alkaline earth metal and/or spinel-forming metal in the composite support may comprise not more than about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %.

In some embodiments, the concentration of alkaline earth metal and/or spinel-forming metal in the composite support may comprise at least about 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, or 89 wt %. In some embodiments, the concentration of alkaline earth metal and/or spinel-forming metal in the composite support may comprise not more than about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %.

### Quantity of Composite Support Metal Species Relative to Each Other

In some embodiments, the composite support may comprise a molar ratio of the alkaline earth metal and/or spinel-forming metal, to aluminum of at least about 9.9:1, 9.8:1, 9.7:1. 9.6:1, 9.5:1, 9.4:1, 9.3:1, 9.2:1, 9.1:1, 9:1, 8.9:1, 8.8:1, 8.7:1, 8.6:1, 8.5:1, 8.4:1, 8.3:1, 8.2:1, 8.1:1, 8:1, 7.9:1, 7.8:1, 7.7:1, 7.6:1, 7.5:1, 7.4:1, 7.3:1, 7.2:1, 7.1:1, 7:1, 6.9:1, 6.8:1, 6.7:1, 6.6:1, 6.5:1, 6.4:1, 6.3:1, 6.2:1, 6.1:1, 6:1, 5.9:1, 5.8:1, 5.7:1, 5.6:1, 5.5:1, 5.4:1, 5.3:1, 5.2:1, 5.1:1, 5:1, 4.9:1, 4.8:1, 4.7:1, 4.6:1, 4.5:1, 4.4:1, 4.3:1, 4.2:1, 4.1:1, 4:1, 3.9:1, 3.8:1, 3.7:1, 3.6:1, 3.5:1, 3.4:1, 3.3:1, 3.2:1, 3.1:1, 3:1, 2.9:1, 2.8:1, 2.7:1, 2.6:1, 2.5:1, 2.4:1, 2.3:1, 2.2:1, 2.1:1, 2:1, 1.9:1, 1.8:1, 1.7:1, 1.6:1, 1.5:1, 1.4:1, 1.3:1, 1.2:1, 1.1:1, 1:1, 1:1.1, 1:1.2, 1:1.3, 1:1.4, 1:1.5, 1:1.6, 1:1.7, 1:1.8, 1:1.9, 1:2, 1:2.5, 1:3, 1:3.5, 1:4, 1:4.5, 1:5, 1:5.5, 1:6, 1:6.5, 1:7, 1:7.5, 1:8, 1:8.5, or 1:9.

In some embodiments, the composite support may comprise a molar ratio of the alkaline earth metal and/or spinel-forming metal, to aluminum of not more than about 10:1, 9.9:1, 9.8:1, 9.7:1. 9.6:1, 9.5:1, 9.4:1, 9.3:1, 9.2:1, 9.1:1, 9:1, 8.9:1, 8.8:1, 8.7:1, 8.6:1, 8.5:1, 8.4:1, 8.3:1, 8.2:1, 8.1:1, 8:1, 7.9:1, 7.8:1, 7.7:1, 7.6:1, 7.5:1, 7.4:1, 7.3:1, 7.2:1, 7.1:1, 7:1, 6.9:1, 6.8:1, 6.7:1, 6.6:1, 6.5:1, 6.4:1, 6.3:1, 6.2:1, 6.1:1, 6:1, 5.9:1, 5.8:1, 5.7:1, 5.6:1, 5.5:1, 5.4:1, 5.3:1, 5.2:1, 5.1:1, 5:1, 4.9:1, 4.8:1, 4.7:1, 4.6:1, 4.5:1, 4.4:1, 4.3:1, 4.2:1, 4.1:1, 4:1, 3.9:1, 3.8:1, 3.7:1, 3.6:1, 3.5:1, 3.4:1, 3.3:1, 3.2:1, 3.1:1, 3:1, 2.9:1, 2.8:1, 2.7:1, 2.6:1, 2.5:1, 2.4:1, 2.3:1, 2.2:1, 2.1:1, 2:1, 1.9:1, 1.8:1, 1.7:1, 1.6:1, 1.5:1, 1.4:1, 1.3:1, 1.2:1, 1.1:1, 1:1, 1:1.1, 1:1.2, 1:1.3, 1:1.4, 1:1.5, 1:1.6, 1:1.7, 1:1.8, 1:1.9, 1:2, 1:2.5, 1:3, 1:3.5, 1:4, 1:4.5, 1:5, 1:5.5, 1:6, 1:6.5, 1:7, 1:7.5, 1:8, or 1:8.5.

In some embodiments, the composite support may comprise a mass ratio of the alkaline earth metal and/or spinel-forming metal, to aluminum of at least about 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:341, 65:35, 64:36, 63:37, 62:38, 61:39, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, or 1:99.

In some embodiments, the composite support may comprise a mass ratio of the alkaline earth metal and/or spinel-forming metal, to aluminum of not more than about 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:341, 65:35, 64:36, 63:37, 62:38, 61:39, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, or 2:98.

In some embodiments, the composite support may comprise a molar ratio of alkaline earth metal and/or spinel-forming metal in the free oxide (i.e., MO) to alkaline earth metal and/or spinel-forming metal, in the metal aluminate (i.e., MAl₂O₄) of at least about 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1:1, 1:1.5, 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:10, 1:20, 1:30, 1:40, 1:50, 1:60, 1:70, 1:80, 1:90, or 1:100. In some embodiments, the composite support may comprise a molar ratio of alkaline earth metal and/or spinel-forming metal in the free metal oxide (i.e., MO) to alkaline earth metal and/or spinel-forming metal in the metal aluminate (i.e., MAl₂O₄) of not more than about 10:1, 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1:1, 1:1.5, 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:10, 1:20, 1:30, 1:40, 1:50, 1:60, 1:70, 1:80, or 1:90. In some embodiments, the alkaline earth metal and/or spinel-forming metal aluminate (i.e., MAl₂O₄) may comprise essentially all of the alkaline earth metal and/or spinel-forming metal, and any free alkaline earth metal and/or spinel-forming metal oxide (i.e., MO) may be in such low concentration as to be undetectable. In some embodiments, the composite support may comprise a mass ratio of alkaline earth metal and/or spinel-forming metal in the free metal oxide (i.e., MO) to alkaline earth metal and/or spinel-forming metal in the metal aluminate (i.e., MAl₂O₄) of at least about 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1:1, 1:1.5, 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:10, 1:20, 1:30, 1:40, 1:50, 1:60, 1:70, 1:80, 1:90, or 1:100. In some embodiments, the composite support may comprise a mass ratio of alkaline earth metal and/or spinel-forming metal in the free metal oxide (i.e., MO) to alkaline earth metal and/or spinel-forming metal in the metal aluminate (i.e., MAl₂O₄) of not more than about 10:1, 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1:1, 1:1.5, 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:10, 1:20, 1:30, 1:40, 1:50, 1:60, 1:70, 1:80, or 1:90.

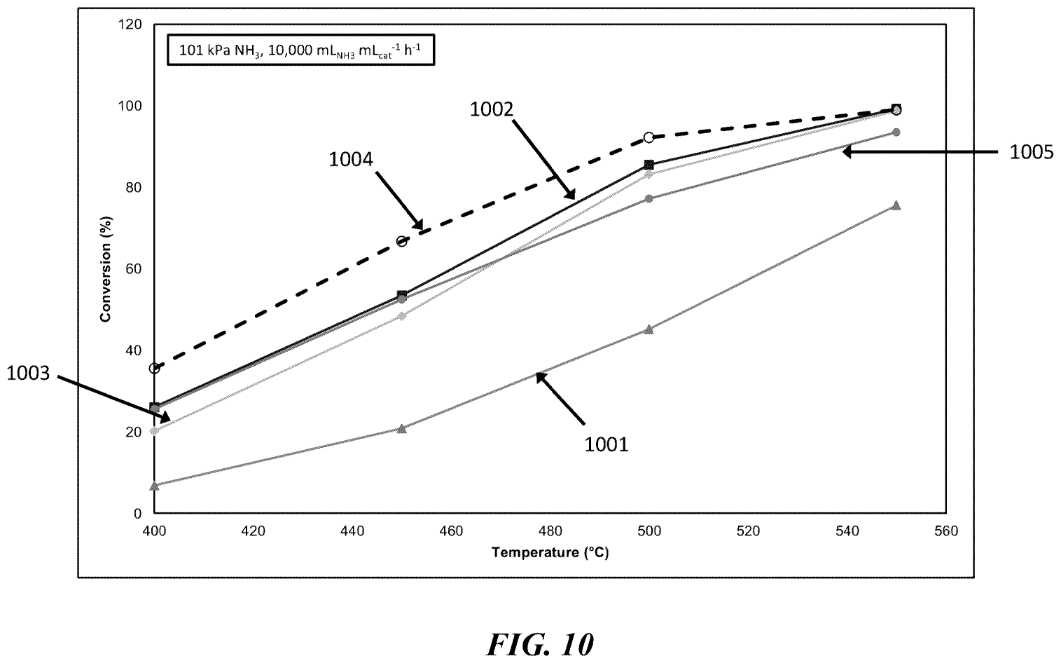

FIG. 10 shows the effect of various concentrations of alkaline earth and/or spinel-forming metal on ammonia conversion efficiency, for Ru catalysts prepared with mixed metal (M-Al) oxide composite supports based on gamma-alumina support material. The results again indicate that there may be a range of concentrations for the alkaline earth and/or spinel-forming metal that is most effective for improvement of ammonia conversion efficiency. Interestingly, the inclusion of a small amount of the metal (M) resulted in a significant increase in ammonia conversion efficiency from about 400 to about 550° C. As the concentration of M is increased, there is no improvement in conversion efficiency until a threshold value is reached. Above this threshold value, conversion efficiency reduced to a similar level to those for lower concentrations of M. Catalysts with molar concentrations of M from about 5 to about 30% were the most effective below 550° C.

With respect to FIG. 10, catalysts may be prepared with alkaline earth and/or spinel-forming metal-Al mixed metal oxide composite supports, according to the materials and methods described elsewhere herein and using the same form factor. In these cases, the alkaline earth and/or spinel-forming metal (Ba) may be represented by M, as described herein. For comparison a catalyst was prepared using the same support material (gamma-alumina) and form factor, but without M (line 1001). The catalysts contained the same concentration of active metal, used the same form factor and were all subjected to the same high temperature calcination and reduction treatments. The M-Al mixed metal oxide composite supports may comprise a range of molar concentrations for M between 5 and 30%: low (line 1302), medium (line 1003), medium high (line 1004), and high (line 1005).

### Mechanical Strength of Support, Modified Support and Catalyst

To perform efficiently and for an extended period, catalysts may be porous, exhibit excellent adsorption-desorption characteristics, and have high mechanical strength. Mechanical failure and physical breakdown of structured catalysts may result in the formation of small fragments and fine particles, which may fill pores and gaps between beads and pellets and create blockages in fluid flow. This process may also increase the pressure drop across the reformer to an unacceptable level, and may cause extreme variations in heat transfer characteristics that severely compromise the performance of the catalyst and reformer. Therefore, several standard industry tests are available to evaluate the mechanical strength of solid catalyst material, to assist in the development of catalysts and achieving the desired reaction process. Each test is designed to enable comparisons between catalysts and supports with significantly different geometric shapes (e.g., pellets, granules, tablets, spheres, rings and extrudates), and very high hardness levels (often fracturing or cracking with relatively little deformation).

ASTM D4179 (Single Pellet Crush Strength of Formed Catalysts and Catalyst Carriers) is intended to evaluate the compressive ‘side crush strength’ (SCS) of single, regular form pellets, such as spheres, short cylinders, or tablets. Radial and axial crush strength can be measured, although it is understood that axial crush strength is higher than radial crush strength and less representative of catalyst behavior in a packed reformer. A force is applied (from 0 to 220 N) to the test pellet at a uniform rate, until it crushes or collapses. The maximum crush strength, occurring at the point of initial collapse, is recorded in N or pound-force.

ASTM D6175 (Radial Crush Strength of Extruded Catalyst and Catalyst Carrier Particles) covers measuring the radial, compressive SCS of single, extruded catalysts, of 1.6-3.2 mm diameter, a length to diameter ratio of 1:1, and expected crush strength of 0-65 N/mm. Similar to ASTM D4179, a force is applied at a uniform rate to the pellet until it crushes or collapses and the force per millimeter of deformation (N/mm) is recorded.

ASTM D7084 (Determination of Bulk Crush Strength of Catalysts and Catalyst Carriers) is preferred for industrial applications with catalytical material fabricated from irregular particles. This method may be used with catalyst particles of 0.8-4.8 mm diameter such as granules. Catalyst particles are packed into a cylindrical sample holder and then crushed with a piston. Increasing pressure is applied at a uniform rate to the bed of particles, the maximum pressure is held for 30 seconds, and then the pressure is slowly released. The pressure required to force 1% of fines through a sieve with a mesh size half the size of the particles is recorded. Typical ranges for this pressure are about 0.1 MPa to about 0.35 MPa (14.5-50.8 psi) for granules and 1-3.5 MPa (145-508) psi) for larger formed particles.

In some embodiments, the present disclosure describes modified supports comprising a support and a layer deposited adjacent to the layer, wherein the modified supports exhibit a peak stress in the ASTM D7084 crush test of at least about 2000, 2200, 2400, 2600, 2800, 3000, 3200, 3400, 3600, 3800, 4000, 4200, 4400, 4600, 4800, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, 10000, 10100, 10200, 10300, 10400, 10500, 10600, 10700, 10800, or 10900 psi.

In some embodiments, the present disclosure describes modified supports comprising a support and a layer deposited adjacent to the support, wherein the modified supports exhibit a peak stress in the ASTM D7084 crush test of not more than about 2200, 2400, 2600, 2800, 3000, 3200, 3400, 3600, 3800, 4000, 4200, 4400, 4600, 4800, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, 9900, 10000, 10100, 10200, 10300, 10400, 10500, 10600, 10700, 10800, 10900, or 11000 psi.

In some embodiments, the present disclosure describes catalysts comprising a support, a layer deposited adjacent to the support, and dopants deposited adjacent to the layer, wherein the catalysts exhibit a peak stress in the ASTM D7084 crush test of at least about 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, or 7900, or 8000 psi.

In some embodiments, the present disclosure describes catalysts comprising a support, a layer deposited adjacent to the support, and dopants deposited adjacent to the layer, wherein the catalysts exhibit a peak stress in the ASTM D7084 crush test of not more than about 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, or 7900, or 8000 psi.

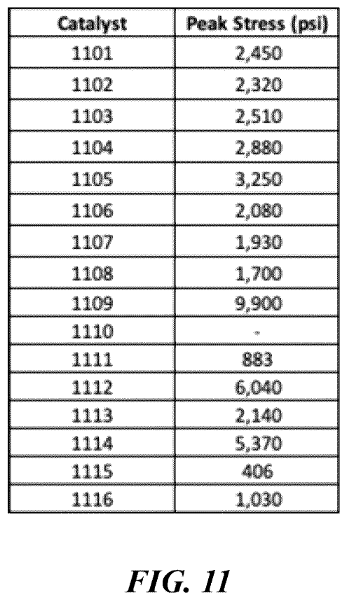

FIG. 11 shows the mechanical strength of various catalysts and support materials, reported as the peak stress achieved in the ASTM D7084 crush test. Surprisingly, the incorporation of an alkaline earth metal and/or a spinel-forming metal (e.g., MgO), onto alumina to form a mixed metal-Al oxide composite support may result in a significant (about 400%) increase in mechanical strength of the alumina support material. Deposition and reduction of an active metal (e.g., Ru) on the surface of the composite supports unexpectedly reduces the mechanical strength by a significant amount. However, even more surprisingly, much of the original support strength may be retained if it is subjected to a high temperature calcination step before deposition and reduction of the active metal.

With respect to FIG. 11, various supports, doped supports and catalysts may be subjected to mechanical strength testing, by the ASTM D7084 crush test procedure. Commercially available alumina supports were obtained and tested without further treatment, including alpha-alumina (α-alumina) 1101, theta-alumina (θ-alumina) 1102, and gamma-alumina (γ-alumina) 1103. Doped alumina supports included theta-alumina doped with a rare earth metal 1104, and gamma-alumina doped with a rare earth metal 1105. Competitive catalysts included Ru on theta-alumina doped with a rare earth metal 1106, Ru on gamma-alumina doped with a rare earth metal 1107, and Ru on theta-alumina doped with rare earth metals and an alkali metal promoter 1108.

Various catalysts were prepared by the fabrication of M-Al oxide composite supports based on gamma-alumina and subsequent deposition and reduction of a Ru precursor, according to materials, methods and embodiments described herein. In these cases, the alkaline earth metal and/or spinel-forming metal used (Mg) may be represented by M, as described herein. A M:A1 oxide composite support was prepared with a M:A1 molar ratio of 1:1, and high temperature calcination 1109. A sample of this calcined M-Al oxide composite support then underwent deposition and reduction of the active metal 1110.

A range of M-Al oxide composite supports based on gamma-alumina were prepared with 3 different mass ratios of the metals, each of which was divided into 2 samples. A sample of each M-Al oxide composite support was then subjected to deposition and reduction of the same quantity of active metal as for 1110, and under identical conditions of temperature, atmosphere and duration. The other sample from each M-Al oxide composite support was calcined under the same conditions of temperature, atmosphere and duration as for 1109, before undergoing the same active metal deposition and reduction steps as the other samples. This resulted in a total of 6 samples with active metal on M-Al composite oxide supports: M to Al mass ratio 26:74, no calcination 1111, M to Al mass ratio 26:74, calcined 1112; M to Al mass ratio 30:70, no calcination 1113, M to Al mass ratio 30:70, calcined 1114; M to Al mass ratio 70:30, no calcination 1115, M to Al mass ratio 70:30, calcined 1116.

### Application of Dopants

There are many well-established techniques for the application of metal oxides and their precursors onto the surface of a support, to form a composite, modified or doped support. Such techniques include: wet impregnation, template ion exchange, precipitation, sol-gel, citric acid process, deposition-precipitation, hydrothermal synthesis, chemical vapor deposition (CVD), physical vapor deposition (PVD), single atom catalysts, thermal shock-high entropy alloy, galvanic exchange, ferromagnetic inductive heating and nanoparticle transfer.

Examples of such dopant materials are the rare earth metals, their oxides and precursors. Following deposition of the rare earth metal oxide or a precursor onto the surface of the of a metal oxide support, appropriate heat treatment conditions may be selected to forming a mixed metal oxide layer on the surface of the doped support. The mixed metal oxide layer may provide an improved surface for deposition of the active metal oxide or precursor and during further heat treatment, achieve improved dispersion and nanoparticle characteristics for the active metal.

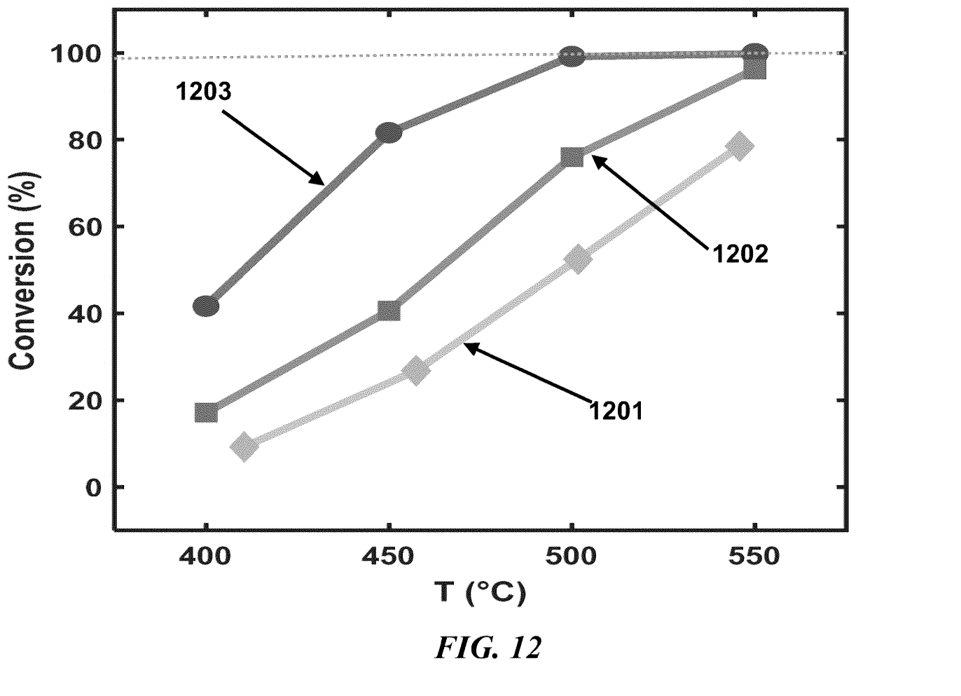

With reference to FIG. 12, Ru-alumina catalysts were prepared using the same methods, materials and support form factors described herein. All contained the same wt % of Ru with respect to the weight of the catalyst, but one of the catalysts was doped with a low concentration (less than 10 mol %) of a rare earth metal. The test results showed that using a theta-alumina support 1202 may give a catalyst with higher ammonia conversion efficiency than using a gamma-alumina support 1201, but doping the theta-alumina support with a rare earth metal 1203 increases ammonia conversion efficiency still further.

### Wet Impregnation Procedure

Wet (or wetness) impregnation may be a convenient technique, especially for laboratory preparations, and the procedure is described here as an example. Other techniques may also be used to prepare the catalysts of the instant disclosure and should be considered as included by this disclosure.

Dopants may be applied to the support surface using separate solutions, with a drying step(s) between each application (sequential deposition or impregnation), or as a mixed solution of dopant metal precursor(s) (co-impregnation or co-deposition). Mixed dopant and precursor solutions may be understood to produce improved support characteristics for many finished catalysts. When applying solutions of mixed dopant precursors, it may be beneficial to ensure compatibility between them to avoid unintentional precipitation. Alternatively, precipitation may be induced within the pore structure via sequential deposition of a dopant precursor followed by a precipitant. The promoter/precipitant precursor may also be included at this stage (e.g., KOH, CsNO₃, or CsOH). This may lead to potential morphological control over the final surface overlayer and/or better inclusion of the precipitant (often also a promoter, e.g., K, or Cs) into the support pore structure.

To dope the support material, an aqueous solution of the chosen metal precursor(s) (e.g., cobalt nitrate, ammonium molybdate, cobalt molybdate, magnesium chloride, magnesium nitrate hexahydrate Mg(NO₃)₂·6H₂O, cerium acetate, cerium nitrate hexahydrate Ce(NO₃)₄·6H₂O) may be prepared, using water (e.g., deionized, distilled, or tap water). The mass of each dopant precursor(s) may be chosen to provide the desired metal loading on the support surface, and the volume of solvent water may be chosen to be about equal in mass to the support material, prior to deposition.

The steps involved in this procedure may include: (i) weigh the support material to determine its mass; (ii) knowing the chemical composition of the support, calculate the number of moles of support molecules (e.g. Al₂O₃, SiO₂, or ZrO₂) or key element (e.g. Al, Si, Zr, or C); (iii) calculate the number of moles of dopant metal required to achieve the desired loading (mol %) or molar ratio on the support; (iv) prepare a solution of the dopant precursor(s) in the appropriate mass of water (about equal to the mass of the support material for incipient wetness). The number of moles of precursor (or metal ion) in the required volume of water (calculated from the required mass) establishes the molarity of the solution with respect to the precursor (or metal ion). If excess precursor solution is required, then the mass of water and precursor are increased in proportion to the desired quantity. In some cases, the volume of the impregnation solution may be at least about 5%, about 10%, about 15%, or about 20% greater than the pore volume of the support. In some cases, the volume of the impregnation solution may be not more than about 5%, about 10%, about 15%, or about 20% greater than the pore volume of the support.

Typically, the metal loading on the support may be expressed as a molar ratio of the dopant metal(s) (e.g., Co, Mo, Mg, La, or Ce) to the support material or the primary metal in the support (e.g., Al₂O₃, C, SiC, SiO₂, ZrO₂, Al, Si, or Zr), and may range from about 0.1:1 to about 15:1, or from about 0.25:1 to about 15:1. The desired loading of each dopant metal(s) on the support may require a dopant solution concentration of between about 0.1 Molar (M) and about 10M with respect to each dopant metal, or between about 0.1M and about 10M. The pH of the precursor solution may also be adjusted (with a suitable strong acid or base) to improve the effectiveness of the doping process, or the precursor may be dissolved in a suitable, prepared solution of an acid or base (e.g., 0.01M to 20M nitric acid, hydrochloric acid, acetic acid, sodium hydroxide, potassium hydroxide). The pH of the dopant solution may be at least about pH 0, 1, 2, 3, 4, 5, 6, 7, 8, 9, 10, 11, 12, 13, or 14. The pH of the dopant solution may be not more than about pH 1, 2, 3, 4, 5, 6, 7, 8, 9, 10, 11, 12, 13, 14, or 15.

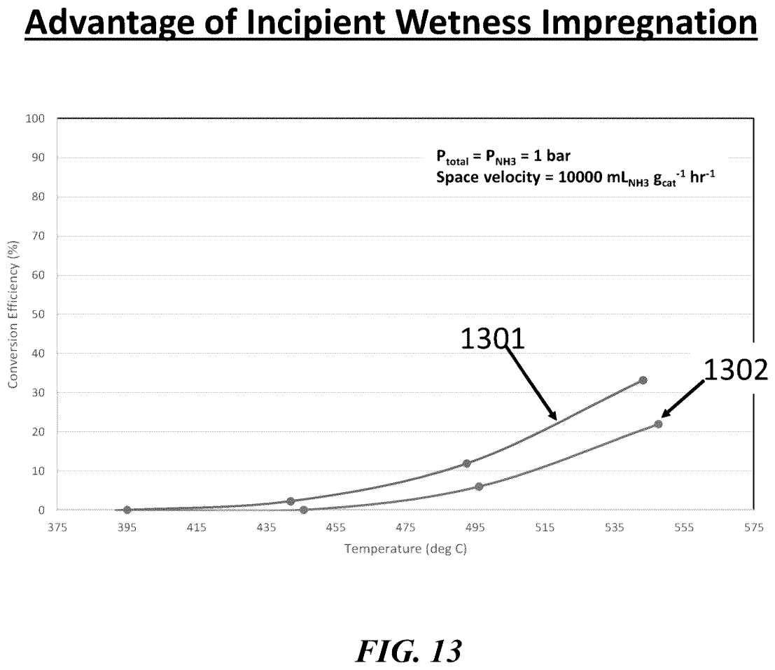

The support material is immersed in the precursor solution for a duration of up to about 48 hours at ambient temperature (e.g., about 20 to about 30° C.). The volume of the solution is selected to be at least equal to the total pore volume of the support material (when these values are about equal, it is termed “incipient wetness”). A greater volume of solution may be unnecessary and may reduce the efficiency of the doping process (as shown in FIG. 13), but may be typically chosen when doping structured or monolithic catalyst supports. In some embodiments, the volume of solution may be equal to the pore volume of the support. In some embodiments, the volume of solution may be at least about 5%, about 10%, about 15%, or about 20% less than the pore volume of the support. In some embodiments, the volume of solution may be no more than about 5%, about 10%, about 15%, or about 20% less than the pore volume of the support. In some instances, the impregnation solution may be applied to the support as separate aliquots or doses to meet the total amount. In some embodiments, the doped support is dried between the application of each dose of impregnation solution. In some cases, the impregnation solution is applied to the support material in one continuous dose.

With respect to FIG. 13, two catalysts were prepared with the same composition and the same SiC support material, but slightly different impregnation methods for the dopant metals. The catalyst prepared using incipient wetness impregnation (line 1301) exhibited higher performance than the catalyst prepared with excess solution (line 1302).

At conclusion of the immersion time, the doped (wet) support material may be transferred to suitable equipment to remove or evaporate the bulk solvent. A rotary evaporator (or rotovap) is a convenient and efficient apparatus to facilitate the removal of solvent at moderate temperatures (e.g from about 20° C. to about 80° C.) below atmospheric pressure or in vacuo. The doped (wet) support may also be dried in a laboratory oven under vacuum or above atmospheric pressure, in which case higher temperatures (e.g. from about 80° C. to about 150° C.) and/or longer drying times may be required. Drying the doped support in a laboratory oven may also be performed as a supplemental step, before or after drying in other equipment (such as a rotary evaporator). Each drying step may be performed for up to 168 hours, depending on the conditions used.

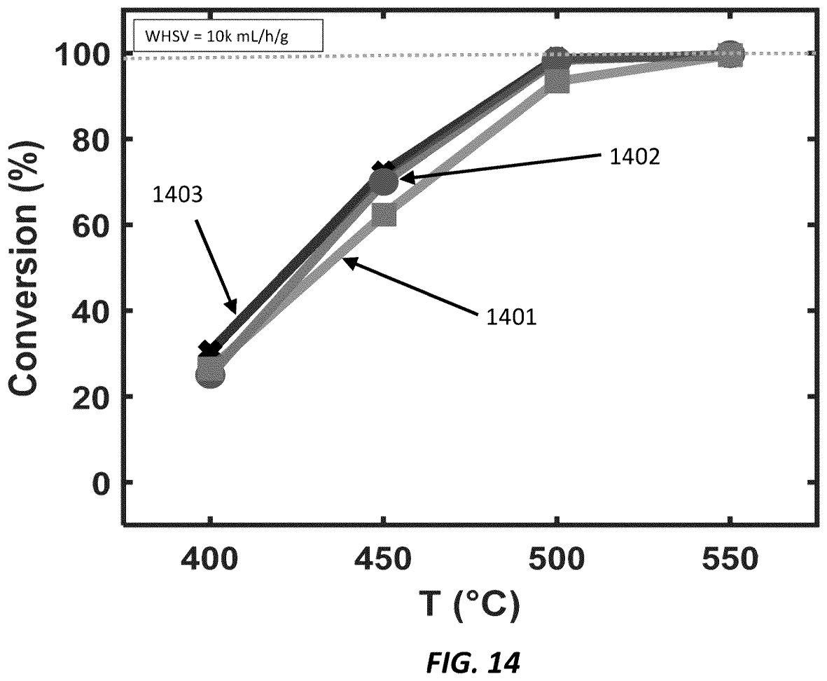

In some instances, it may be advantageous to use a volume of impregnation solution that is greater than the pore volume of the support. Ru-alumina catalysts were prepared according to methods and materials described herein, and with the same support and form factor. The catalysts contained the same wt % of Ru and the same concentration (greater than 10 mol %) of a rare earth metal. One catalyst (1401) was prepared with a reduced volume of impregnation solution, equal to the volume of the support material (incipient wetness impregnation). The other two catalysts (1402 and 1403) were prepared with a volume of solution approximately 10% greater than the pore volume of the support material, and with different Ru precursors. With reference to FIG. 14, the catalyst prepared using the incipient wetness technique 1401 exhibited lower ammonia conversion efficiency than the two catalysts prepared with excess impregnation solution 1402 and 1403.

### Doping Conditions (Wet Impregnation)

In some embodiments, the dopant metal precursor(s) (e.g., La(NO₃)₃, CeCl₃, Ce(HCO₃)₃, Ce(CH₃COO)₃, MgCl₂, ZnSO₄, Fe(NO₃)₂, or MnCl₂, and their hydrates) may be applied to the support surface as one solution comprising a water-soluble metal salt wherein the anions may comprise at least one member of the group: NO₃⁻, Cl⁻, CO₃²⁻, HCO₃⁻, SO₄²⁻, or CH₃COO⁻. In some embodiments, the dopant metal precursor(s) may be applied to the support surface as one solution comprising a water-soluble metal ligand complex with ammonia (e.g., ammonium molybdate, (NH₄)₆Mo₇O₂₄). In some embodiments, the dopant metal precursor(s) are applied to the support surface as separate solutions (with a drying step between each application).

In some embodiments, the concentration of the dopant metal precursor solution may comprise at least about 0.01, 0.05, 0.1, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.5, 4, 4.5, 5, 5.5, 6, 6.5, 7, 7.5, 8, 8.5, 9, or 9.5 M, with respect to each dopant metal. In some embodiments, the concentration of the dopant metal precursor solution may comprise at most about 0.05, 0.1, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.5, 4, 4.5, 5, 5.5, 6, 6.5, 7, 7.5, 8, 8.5, 9, 9.5, or not more than 10M, with respect to each dopant metal.

The support material may be immersed in the precursor solution for at least about 1, 2, 3, 4, 5, 6, 7, 8, 9, 10, 11, 12, 13, 14, 15, 16, 17, 18, 19, 20, 21, 22, or 23 hours. The support material may be immersed in the precursor solution for no more than about 2, 3, 4, 5, 6, 7, 8, 9, 10, 11, 12, 13, 14, 15, 16, 17, 18, 19, 20, 21, 22, 23, or 24 hours.

### Drying Conditions for the Support or Doped Support

In some instances, the support or doped support may be maintained at a temperature of at least about 10, 15, 20, 25, 30, 35, 40, 45, 50, 55, 60, 65, 70, 75, 80, 85, 90, 95, 100, 105, 110, 115, 120, 125, 130, 135, 140, or 145° C., at a pressure of about 0.0001 to about 5 bar absolute, for a duration of about 0.1 to about 168 hours. In some instances, the support or doped support may be maintained at a temperature of not more than about 15, 20, 25, 30, 35, 40, 45, 50, 55, 60, 65, 70, 75, 80, 85, 90, 95, 100, 105, 110, 115, 120, 125, 130, 135, 140, 145, or 150° C., at a pressure of about 0.0001 to about 5 bar absolute, for a duration of about 0.1 to about 168 hours.

In some cases, the support or doped support may be maintained at a pressure of at least about 0.0001, 0.001, 0.01, 0.05, 0.1, 0.2, 0.3, 0.4, 0.5, 0.6, 0.7, 0.8, 0.9, 1, 2, 3, or 4 bar absolute pressure, at a temperature of about 10° C. to about 150° C., for a duration of about 0.1 hours to about 168 hours. In some cases, the support or doped support may be maintained at a pressure of not more than about 0.001, 0.01, 0.05, 0.1, 0.2, 0.3, 0.4, 0.5, 0.6, 0.7, 0.8, 0.9, 1, 2, 3, or 4, or 5 bar absolute pressure, at a temperature of about 10° C. to about 150° C., for a duration of about 0.1 hours to about 168 hours.

In some instances, the support or doped support may be maintained at a temperature of about 10° C. to about 150° C., and a pressure of about 0.0001 bar absolute to about 5 bar absolute, fora duration of at least about 0.1, 0.5, 1, 2, 3, 4, 5, 6, 7, 8, 9, 10, 11, 12, 18, 24, 30, 36, 42, 48, 60, 72, 84, 96, 108, 120, 132, 144, or 156 hours. In some instances, the support or doped support may be maintained at a temperature of about 10° C. to about 150° C., and a pressure of about 0.0001 bar absolute to about 5 bar absolute, for a duration of not more than about 0.5, 1, 2, 3, 4, 5, 6, 7, 8, 9, 10, 11, 12, 18, 24, 30, 36, 42, 48, 60, 72, 84, 96, 108, 120, 132, 144, 156 or 168 hours.

In some embodiments, if separate dopant solutions are to be used, or if the promoter precursor solution was not added during the wet impregnation process, then the immersion step and the drying step may need to be repeated for each dopant and/or promoter precursor solution. In some cases, the support or doped support may be subjected to heat treatment (e.g., calcination or annealing) between immersion in separate dopant and/or promoter precursor solution. Once the support material has been impregnated with all of the desired dopant metals, then the support or doped support may be subjected to further heat treatment, including (but not limited to) calcination, annealing, nitriding and reduction. The heat treatment step(s) may be performed before the active metal precursor is applied to the surface of the support or doped support. The heat treatment step(s) may also be performed before the promoter precursor is applied to the surface of the support or doped support, in which case the drying step(s) and the heat treatment step(s) may need to be repeated before the active metal precursor is applied to the surface of the support or doped support.

### Support Monoliths and Substrates

Monolith supports may be preferred for mobile and transport applications, as they may offer some advantages compared to pellets, beads and powders (e.g., lower back pressure, higher mechanical strength, increased resistance to fragmentation and attrition losses). Monolith supports may be formed from many materials, including metals, metal alloys, and ceramics. They may be fabricated using many techniques, including stamping, extrusion, folding, corrugating, foaming, extrusion, casting, 3-D printing, and additive manufacturing.

Metallic monolith supports or substrates may comprise of several thin metal sheets or foils, which may be corrugated or remain flat. To provide channels through which reacting gases can pass, these metallic sheets may be perforated and/or formed into more complex shapes (e.g., spirals, concentric tubes, or “honeycomb” structures), which can be inserted into a metal container. Metallic supports may be designed to increase their geometric surface area and reduce back pressure. To strengthen the monolith structure, the metallic plates can be brazed/welded together to improve mechanical durability and increase their resistance to rapid changes in temperature or uneven heating (i.e., thermal shock).

Ceramic substrates may be a lower cost alternative to metallic monoliths, but may also possess lower mechanical strength and resistance to attrition and thermal shock. Ceramic monoliths may be formed (e.g., by extrusion) into honeycomb structures with cells of regular shapes (e.g., circular, oval, ellipsoidal, triangular, square, oblong, rectangular, trapezoidal, or hexagonal). The size and density of the cells may be designed to improve performance for a specific function and to accommodate the choice of catalytic materials. The density of cells through the monolith may range from about 10 to more than about 1000 cells per square inch (cpsi), although a range from about 200 to about 600 cpsi is often used in automotive applications. Depending on the choice of material and method of manufacture, ceramic monoliths may be highly porous, or have low porosity, and they may be electrically conducting or insulating. In some cases, a non-metallic cellular monolith may comprise a rigid foam made of cordierite, or silicon carbide. Compared to the honeycomb monoliths, these products have even lower geometric surface areas and/or create higher back pressure. These rigid foam substrates may be used for specialist applications.

Compared to smaller form factors (e.g., beads, or pellets), ceramic monoliths may have a smaller number of relatively large pores and a lower specific surface area. Metallic monoliths may be designed to achieve a higher specific surface area, but they have very low porosity. To remedy these deficiencies, a monolith substrate may be further processed by thermal and/or chemical treatment, or by the application of a washcoat.

### Surface Treatment of Monolith Substrates

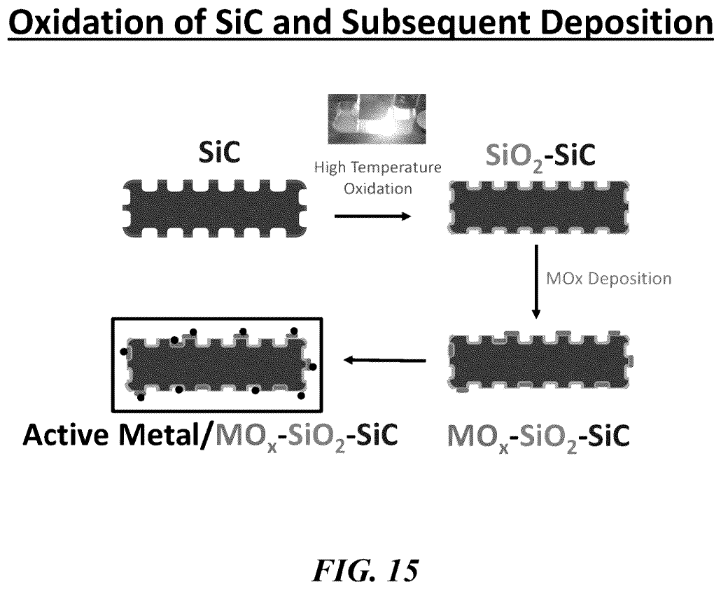

Monolith substrates may be chemically and/or thermally treated to improve or modify their surface characteristics as catalyst supports, or to improve adhesion of a washcoat. Monolith substrates may be subjected to high temperature calcination or nitriding to form oxides or nitrides on the surface, using techniques described herein. FIG. 15 shows a schematic for this treatment, using the oxidation of SiC as an example.

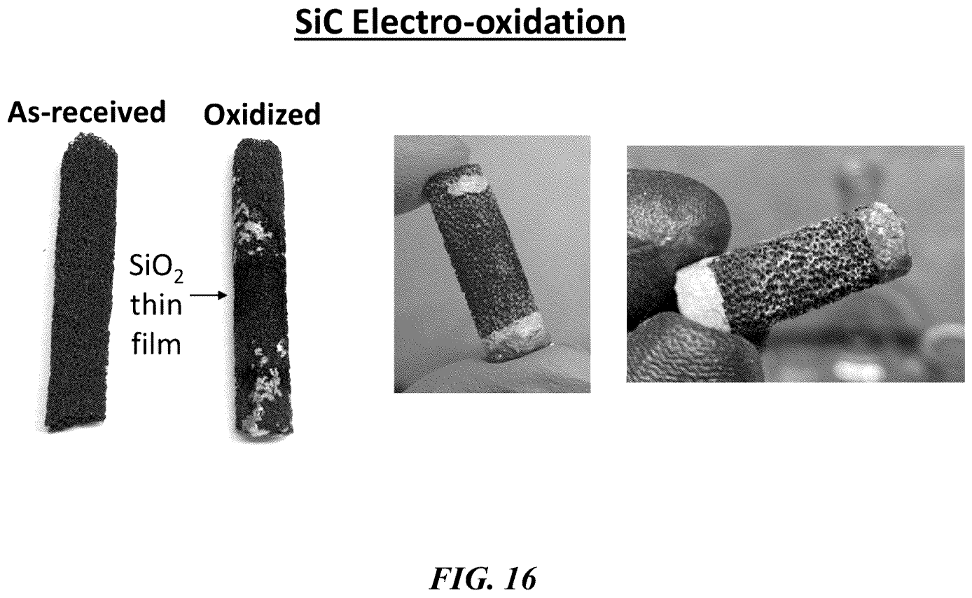

Often, these high temperature treatments may need to be performed in the range of from about 900 to about 1300, or 1000 to 1200° C. The high temperature treatment may be performed by heating in a furnace, by applying a flame directly to the surface (e.g., acetylene torch), or by using resistive (Joule) heating with electrically conducting monoliths. In some cases, a monolith with a resistance of about 5 to about 100 ohms (Ω) may be heated to at least 900° C. using a 24 to 36 volt (V) laboratory power source. The electrical power may need to be applied as short pulses (e.g., from a few milliseconds to less than 1 second) to avoid overheating the monolith substrate. Using this type of resistive heating, a film of oxide or nitride material may be observed to form over the surface of the monolith in about 5 to 30 minutes, as illustrated in FIG. 16.

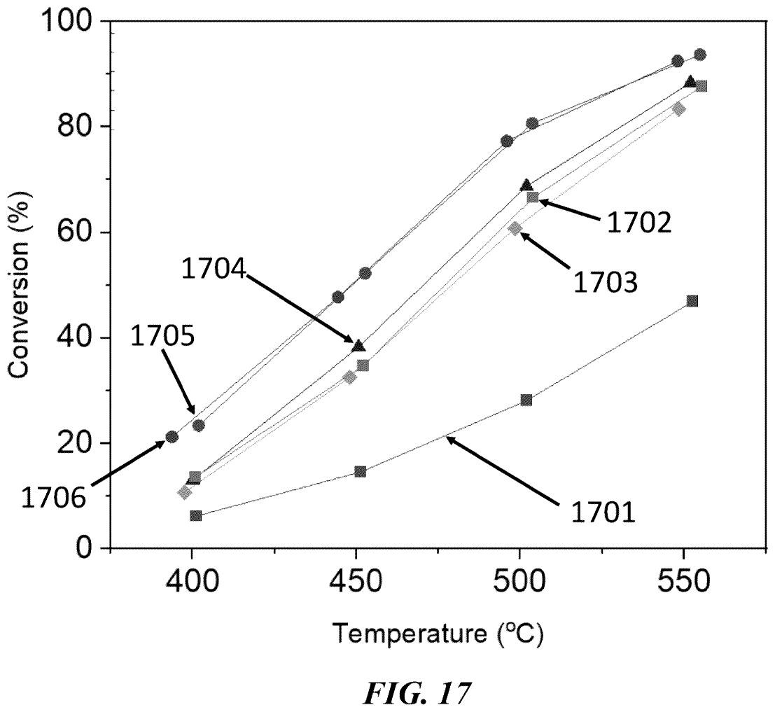

With reference to FIG. 17, oxidation of the surface of a relatively non-porous ceramic support may improve the activity of a catalyst fabricated on the support. However, this may still not be as effective as depositing support surface modifiers directly onto the surface of the unmodified support. Several Ru-catalysts were prepared with the same loading of active metal and the same reduction treatment. One catalyst was formed by impregnation of the active metal directly onto the surface of a SiC support, line 1701. Another catalyst was formed by impregnation of the active metal onto a silica (SiO₂) support, line 1702. Two catalysts were prepared by depositing the active metal onto an oxidized surface of the SiC support material after calcination at 1050° C. (line 1703) or 1200° C. (line 1704). Two more catalysts were prepared by depositing a rare earth metal directly onto the surface of a SiC support, followed by calcining at 900° C. (line 1705) or annealing at 900° C. (line 1706) and their activities were similar.

### Washcoating

Catalyst activity and performance may be increased by using highly porous support materials, or carriers, with high specific surface areas. Monolith supports rarely have both of these features, so their characteristics are improved by depositing a layer of material (a “washcoat”) onto the inner surfaces of the monolith. The washcoat may comprise of one or more metal oxides, or inorganic oxides, that form a high surface area coating (e.g., greater than 100 m²/g). The washcoat layer may comprise at least one of: alumina, Al₂O₃, aluminum oxide, silica, SiO₂, silicon dioxide, titania, TiO₂, titania dioxide, ceria, CeO₂, cerium dioxide, zirconia, ZrO₂, zirconium dioxide, VO₂ (vanadium dioxide), vanadia, V₂O₅, vanadium pentoxide, lanthana, La₂O₃, lanthanum oxide, nickel oxide, NiO, Ni₂O₃, zinc oxide, ZnO, or zeolites. The washcoat layer may comprise at least one of: iron oxide, wustite, ferrous oxide, FeO, ferric oxide, Fe₂O₃, hematite, maghemite, Fe₃O₄, magnetite, magnesia, MgO, magnesium oxide, manganosite, MnO, manganese oxide, bixbyite, Mn₂O₃, hausmannite, Mn₃O₄, pyrolusite, MnO₂, manganese dioxide, birnessite, buserite, or psilomelane. In some embodiments, other catalyst materials (e.g., support surface modifiers, promoters, active metals) may be deposited on the surface and inside the pores of the washcoat layer. In some instances, the thickness of the washcoat layer may comprise from about 5 to about 500, 5 to 250, 5 to 100, 5 to 50, 5 to 25, 10 to 250, 10 to 100, 10 to 50, 20 to 250, 20 to 100, 20 to 50, 50 to 250, 50 to 100 (microns) μm, but it may be difficult to maintain a constant layer thickness throughout the monolith. In some cases, another layer may be deposited before (i.e., underneath) the washcoat, to coat sharp corners or edges and prevent excessive washcoat deposition. The specific surface area of the washcoat (or the finished catalyst) is typically determined by nitrogen adsorption measurements with mathematical modeling, known as the BET (Brunauer, Emmet, and Teller) method.

### Application of the Washcoat

Several techniques may be used to apply the washcoat to the monolith substrate, such as wet impregnation, sol-gel, colloidal coating, slurry coating, dip-coating, deposition-precipitation, and solution-combustion. A combination of slurry coating and wet impregnation procedures may be a simple and convenient method to prepare a catalyst from support monoliths or structured supports.

A washcoat slurry may be prepared, comprising a binder and a metal oxide or inorganic oxide, in powder form, and a suitable solvent. The metal oxide or inorganic oxide may provide the washcoat layer and the binder may be used to improve dispersion and adhesion of the washcoat material in, on or adjacent to the surface of the substrate, throughout the monolith. In some instances, the binder may comprise at least one of: an alumina-derived sol-gel (e.g., boehmite (γ-A100H), or bayerite (α-Al(OH)₃), or gibbsite (γ-Al(OH)₃)), or a hydrocarbon-based binder (e.g., polyvinyl alcohol (PVA), polyethylene glycol (PEG), polyurethane (PUR), or polyethylene imine (PEI)). In some instances, the metal oxide powder may comprise at least one of alpha-alumina (α-Al₂O₃), delta-alumina (δ-Al₂O₃), gamma-alumina (γ-Al₂O₃), eta-alumina (η-Al₂O₃), or theta-alumina (θ-Al₂O₃).

In some cases, improved washcoat characteristics may be obtained with smaller dry particles (e.g., mean diameter less than about 50, 25, 10, 5, or 3 microns (μm)), which may be obtained commercially, or generated through grinding techniques (such as ball milling). In some cases, improved washcoat characteristics may be obtained with smaller dispersed particle sizes (e.g., mean diameter less than about 500, 400, 300, 200, 100, or 50 nanometers (nm)), which may be obtained commercially, or generated through dispersion techniques (such as ultrasound).

In some instances, the solvent may comprise water (deionized, distilled, or tap). In some cases, the solvent may comprise an organic solvent. In some cases, the dispersion of the metal oxide powder may be improved by adjusting the pH of the slurry, using 0.01 to 20M nitric acid (HNO₃). In some instances, the slurry may comprise a pH of the slurry of at least about 0.1, 0.5, 1, 1.5, 2, 2.5, 3, 3.5 4, 4.5, 5 or 5.5. In some instances, the slurry may comprise a pH of not more than about 0.5, 1, 1.5, 2, 2.5, 3, 3.5, 4, 4.5, 5, 5.5, or 6. In some instances, the slurry may comprise a pH of from about 0.1 to about 6, 0.1 to 5, 0.1 to 4, 0.1 to 3, 0.1 to 2, 0.1 to 1, 0.5 to 6, 0.5 to 5, 0.5 to 4, 0.5 to 3, 0.5 to 2, 1 to 6, 1 to 5, 1 to 4, 1 to 3, 1 to 2, 2 to 6, 2 to 5, 2 to 4, 2 to 3, 3 to 6, 3 to 5, 3 to 4, 4 to 6, 4 to 5, or 5 to 6.

The viscosity of the slurry is determined by the size of the metal oxide particles and the concentration, and the viscosity may have a strong effect on the ability of the binder and metal oxide to disperse evenly throughout the support monolith. If the viscosity is too low, the concentration of the metal oxide particles may also be very low, resulting in a thin, potentially non-continuous washcoat layer. In this case, repeat applications may be necessary. If the viscosity of the slurry is too high, the binder and the metal oxide particles may not penetrate significantly into the monolith support and a washcoat layer will be formed only on the outermost surfaces of the monolith. In some instances, the concentration of the solid material in the slurry may comprise at least about 10, 15, 20, 30, 35, 40, 45, 50, 55, 60, or 65 wt %. In some instances, the concentration of the solid material in the slurry may comprise not more than about 15, 20, 25, 30, 35, 40, 45, 50, 55, 60, 65, or 70 wt %. In some instances, the concentration of the solid material in the slurry may comprise of from about 10 to about 70, 10 to 60, 10 to 50, 10 to 40, 10 to 30, 10 to 20, 20 to 70, 20 to 60, 20 to 50, 20 to 40, 20 to 30, 30 to 70, 30 to 60, 30 to 50, 30 to 40, 40 to 70, 40 to 60, 40 to 50, 50 to 70, 50 to 60, or 60 to 70 wt %.

Once the washcoat slurry has been prepared, the support monolith is submerged into the slurry. In some instances, the support monolith may be submerged into the washcoat slurry at a rate of at least about 0.1, 0.5, 1, 2, 3, 4, 5, 6, 7, 8, or 9 millimeters per second (mm/s). In some instances, the support monolith may be submerged into the washcoat slurry at a rate of no more than about 0.5, 1, 2, 3, 4, 5, 6, 7, 8, 9, or 10 mm/s. In some instances, the support monolith may be submerged into the washcoat slurry at a rate of from about 0.1 to about 10, 0.1 to 5, 0.5 to 10, 0.5 to 5, 1 to 10, 1 to 8, 1 to 5, 2 to 10, 2 to 7, 2 to 5, 3 to 10, 3 to 8, 3 to 6, 4 to 10, 4 to 8, 5 to 10, 5 to 7, 6 to 10, 6 to 8, 7 to 10, or 8 to 10 mm/s.

In some cases, the temperature of the slurry may comprise at least about 0, 5, 10, 15, 20, 25, 30, 35, 40, 45, 50, 60, 70, 80, or 90° C. In some cases, the temperature of the slurry may comprise not more than about 5, 10, 15, 20, 25, 30, 35, 40, 45, 50, 60, 70, 80, 90, or 100° C. In some cases, the temperature of the slurry may comprise of from about 0 to 100, 0 to 80, 0 to 60, 0 to 50, 0 to 40, 0 to 30, 0 to 20, 10 to 100, 10 to 80, 10 to 60, 10 to 50, 10 to 40, 10 to 30, 10 to 20, 15 to 100, 15 to 80, 15 to 60, 15 to 50, 15 to 40, 15 to 30, 15 to 25, 20 to 100, 20 to 80, 20 to 60, 20 to 50, 20 to 40, 20 to 30, 10 to 20, 25 to 100, 25 to 80, 25 to 60, 25 to 50, 25 to 40, 25 to 35, 30 to 100, 30 to 80, 30 to 60, 30 to 50, 30 to 40, 40 to 100, 40 to 80, 40 to 60, 40 to 50, 50 to 100, 50 to 90, 50 to 80, or 50 to 70° C.

The support monolith may be submerged in the washcoat slurry for a predetermined length of time, which begins immediately after the monolith is completely submerged. In some instances, the support monolith may be submerged in the washcoat slurry for a duration comprising at least about 0.1, 0.5, 1, 5, 10, 20, 30, 60, 120, 180, 240, 300, 360, 420, 480, 540, 600, 900, 1200, or 1800 seconds. In some instances, the support monolith may be submerged in the washcoat slurry for a duration comprising not more than about 0.5, 1, 5, 10, 20, 30, 60, 120, 180, 240, 300, 360, 420, 480, 540, 600, 900, 1200, 1800, or 3600 seconds. In some instances, the support monolith may be submerged in the washcoat slurry for a duration comprising of from about 0.1 to about 600, 0.5 to 600, 1 to 600, 5 to 600, 10 to 600, 30 to 600, 60 to 1200, 60 to 900, 60 to 600, 300 to 1200, 300 to 1800, 300 to 600, 600 to 3600, 600 to 1800, 600 to 1200, 600 to 900, 900 to 3600, 900 to 1800, 900 to 1200, 1200 to 3600, 1200 to 1800, or 1800 to 3600 seconds.

In some cases, the support monolith and the slurry may be subjected to a pressure of greater than 1 bar absolute, to force material into the substrate. In some cases, the support and the slurry may be subjected to a vacuum, or a pressure of less than 1 bar absolute, to draw material into the substrate. In some cases, the support monolith and the slurry may be subjected to rotational motion to force material into the substrate through centripetal force.

Once the desired submersion time has been completed, the support monolith (now comprising a washcoat layer) may be removed from the slurry container and subjected to a drying process, as described herein. In some instances, the support monolith and washcoat layer may be subjected to a direct flow of air (e.g., blown from a compressed air line), to assist with the drying process. In some instances, the support monolith and washcoat layer may be subjected to direct or indirect heating from a flame or combustion product gases on, or adjacent, to the support monolith. After the support monolith and washcoat layer have been dried, the coated monolith may be weighed and this may be compared to the weight of the original monolith. Knowing the composition and porosity of the support monolith, the concentration and thickness of the washcoat layer may be calculated.

If the amount of washcoat has not reached the desired level, then the support monolith and existing washcoat layer may be subjected to submersion in additional washcoat slurry. The submersion and drying procedures may be repeated as many times as necessary to obtain the desired amount of washcoat layer. Experience indicates that one repeat submersion may provide the most significant benefit, and that more than two submersions may increase the depth of the washcoat layer in some areas at the expense of overfilling or blocking other areas of the substrate. The length of time for each submersion procedure may be estimated from the duration of previous submersion steps and the additional weight of washcoat deposited in the substrate. When the desired amount of washcoat has been deposited in the support monolith, then it may be subjected to heat treatment (e.g., calcination) to complete the binding process of the washcoat layer to the substrate and obtain the desired characteristics of the washcoat layer. The various types of heat treatment and their conditions are described herein. The support monolith and the washcoat layer may be subjected to a doping process, to deposit additional materials in and around the monolith structure and in, on, or adjacent to the washcoat layer. Such doping procedures are described herein, and wet impregnation (or incipient wetness) is a convenient technique for doping support monoliths.

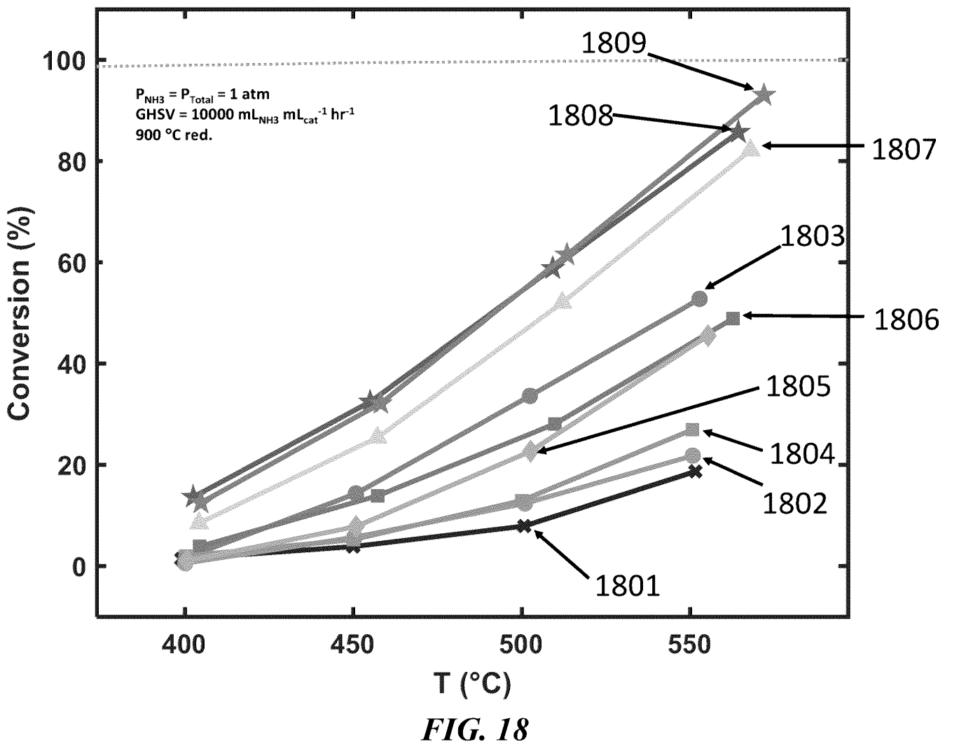

With reference to FIG. 18, application of a satisfactory washcoat layer incorporating a suitable binder may enable significant improvement of catalyst activity, based on a relatively non-porous support material. Nine Ru-catalysts were prepared from a SiC monolith and using the same reduction conditions. Seven of these used the same, low loading of active metal and two (lines 1802 and 1803) used 4 times the amount of active metal, but with different precursors. Three catalysts were prepared by impregnation of the active metal directly onto the untreated surface of the monolith substrate: lines 1801, 1802 and 1803. Electrooxidation of the substrate surface at 1050° C. (line 1804) did not significantly increase catalyst activity, but electrooxidation at 1200° C. (line 1805) or priming the untreated surface of the substrate with a pH of about 2 to about 5, aqueous solution of boehmite (line 1806) both gave a small increase. The application of a washcoat gave the most significant increase in conversion efficiency (line 1807), which was further improved by the use of a PVA binder mixed into the washcoat (lines 1808 and 1809).

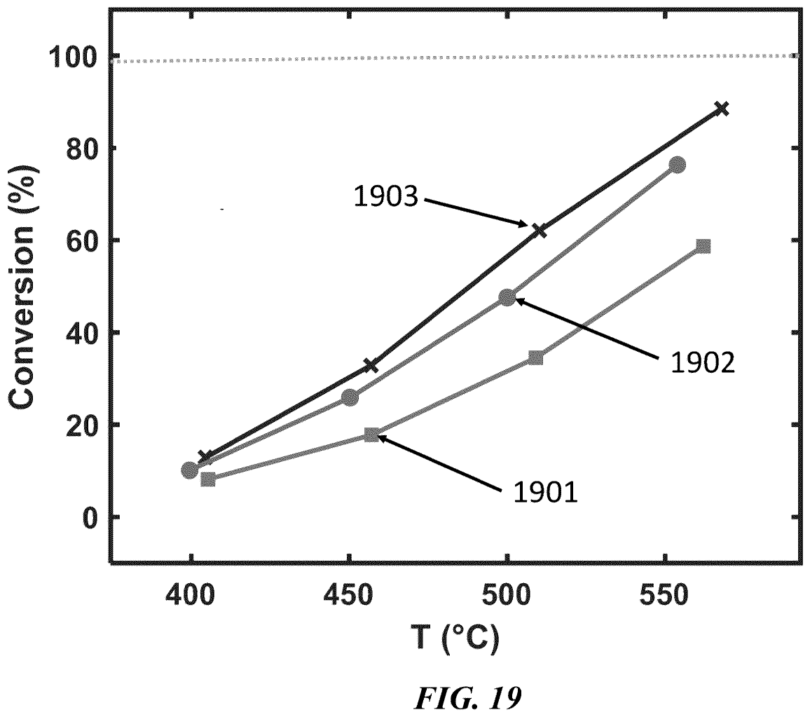

With reference to FIG. 19, a more active catalyst is obtained with a washcoat layer comprising gamma-alumina (γ-alumina) than a washcoat layer comprising alpha-alumina (α-alumina). Additionally, the order of deposition (washcoat and active metal) is very significant for determining catalyst activity. Three Ru-catalysts were prepared using the same SiC monolith substrate, the similar washcoat compositions and the same calcination (700° C. for 3 hours) and reduction treatments. One catalyst was prepared by impregnation of the monolith substrate with active metal before submerging in a gamma-alumina washcoat slurry (line 1901). The other two catalysts were prepared by impregnation of the monolith with active metal after submerging the substrate in washcoat solutions of alpha-alumina (line 1902) or gamma-alumina (line 1903).

### Calcination of the Support or Doped Support

The chemical composition and morphology of the surface of the support or doped support can be modified, or thermally activated, to further improve the characteristics and properties of the catalyst. Such modifications may be used to improve or moderate the dispersion of active metal species, and/or the surface morphology, selectivity, activity, or temperature sensitivity of the catalyst. One such modification is calcination, which is performed at elevated temperatures, with the objective of converting up to 100% of the precursor species on the surface to the metal oxides. The elevated temperatures may also be selected to promote solid state reaction(s) between the catalyst support material and/or the metal dopants and/or promoters to form solid solutions or alloys which further improve the desired characteristics and performance of the final catalyst. An oxidizing or inert (i.e. non-reducing) atmosphere, e.g., comprising air, O₂, N₂, CO₂, Ar, He, Xe (or mixtures thereof), may be used. The relative temperature ranges for calcination may be described as at low (e.g., from about 300 to about 600° C.), medium (e.g., from about 700 to about 1000° C.), or high (e.g., about 1100° C. or higher). Once the high temperature heat treatment has reached the end of the desired time duration, the calcined material remains in the oven and in the same atmosphere, and it is allowed to cool to ambient temperature over a period of several hours. If a flowing or circulating atmosphere is used (e.g., a furnace or oven equipped with a fan or convection capability), then the time for effective heat treatment may be reduced significantly (e.g. between 2 to 6 hours at temperatures from 500° C. to 1000° C.).

In some embodiments, the support or doped support may be maintained at a temperature of at least about 200, 250, 300, 350, 400, 450, 500, 550, 600, 650, 700, 750, 800, 850, 900, 950, 1000, 1050, 1100, 1150, 1200, 1250, 1300, 1350, 1400, or 1450° C., fora duration of about 0.1 to about 168 hours, in an oxidizing (e.g., an environment comprising at least oxygen) or an inert atmosphere. In some embodiments, the support or doped support may be maintained at a temperature of not more than about 200, 250, 350, 400, 450, 500, 550, 600, 650, 700, 750, 800, 850, 900, 950, 1000, 1050, 1100, 1150, 1200, 1250, 1300, 1350, 1400, 1450, or 1500° C., for a duration of about 0.1 to about 168 hours, in an oxidizing or inert atmosphere.

In some embodiments, the support or doped support may be maintained at a temperature of about 200° C. to about 1500° C., for a duration of at least about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, or 156 hours, in an oxidizing or inert atmosphere. In some embodiments, the support or doped support may be maintained at a temperature of about 200° C. to about 1500° C., for a duration of not more than about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, 156, or 168 hours, in an oxidizing or inert atmosphere.

In some cases, the calcination temperature may range from about 300 to about 800, 300 to 750, 300 to 700, 300 to 650, 300 to 600, 350 to 800, 350 to 750, 350 to 700, 350 to 650, 350 to 600, 400 to 800, 400 to 750, 400 to 700, 400 to 650, 400 to 600, 450 to 800, 450 to 750, 450 to 700, 450 to 650, 450 to 600, 500 to 800, 500 to 750, 500 to 700, 550 to 800, 550 to 750, 550 to 700, 600 to 800, 600 to 750, 600 to 700, 650 to 800, 650 to 750, or 700 to 800° C. In some embodiments, the calcination temperature may range from about 500 to about 650, 500 to 600, 550 to 650, or 550 to 600° C.

### Annealing of the Support or Doped Support

The chemical composition of the surface of the support or doped support can be modified, or thermally activated, to further improve the characteristics and properties of the catalyst. Such modifications may be used to improve or moderate the dispersion of active metal species, and/or the surface morphology, selectivity, activity, or temperature sensitivity of the catalyst. One such modification is annealing, which is performed at elevated temperatures, with the objective of modifying the crystal structure, and/or size and/or composition of the surface layers. In some cases, annealing may be performed to agglomerate smaller particles to combine into larger particles and expose a larger area of the surface of the support or doped support. In some instances, annealing may be performed to partially reduce the support, or doped support. In some instances, annealing may be performed to generate oxygen vacancies in the support, or doped support. The elevated temperatures may also be selected to promote solid state reaction(s) between the catalyst support material and/or the metal dopants and/or promoters to form solid solutions or alloys which further improve the desired characteristics and performance of the final catalyst. An inert or reducing (i.e. non-oxidizing) atmosphere, e.g., comprising any of N₂, CO₂, CO, H₂, Ar, He, Xe (or mixtures thereof), may be used. Once the high temperature heat treatment has reached the end of the desired time duration, the annealed material remains in the oven and in the same atmosphere, and it is allowed to cool to ambient temperature over a period of several hours. If a flowing or circulating atmosphere is used (e.g., a furnace or oven equipped with a fan or convection capability), then the time for effective heat treatment may be reduced significantly (e.g. between 2 to 6 hours at temperatures from 500° C. to 1000° C.).

In some embodiments, the support or doped support may be maintained at a temperature of at least about 200, 250, 300, 350, 400, 450, 500, 550, 600, 650, 700, 750, 800, 850, 900, 950, 1000, 1050, 1100, 1150, 1200, 1250, 1300, 1350, 1400, or 1450° C., fora duration of about 0.1 to about 168 hours, in an inert, anoxic, or reducing atmosphere. In some embodiments, the support or doped support may be maintained at a temperature of not more than about 250, 300, 350, 400, 450, 500, 550, 600, 650, 700, 750, 800, 850, 900, 950, 1000, 1050, 1100, 1150, 1200, 1250, 1300, 1350, 1400, 1450, or 1500° C., fora duration of about 0.1 to about 168 hours, in an inert, anoxic, or reducing atmosphere.

In some cases, the annealing temperature may range from about 300 to about 800, 300 to 750, 300 to 700, 300 to 650, 300 to 600, 350 to 800, 350 to 750, 350 to 700, 350 to 650, 350 to 600, 400 to 800, 400 to 750, 400 to 700, 400 to 650, 400 to 600, 450 to 800, 450 to 750, 450 to 700, 450 to 650, 450 to 600, 500 to 800, 500 to 750, 500 to 700, 550 to 800, 550 to 750, 550 to 700, 600 to 800, 600 to 750, 600 to 700, 650 to 800, 650 to 750, or 700 to 800° C. In some embodiments, the annealing temperature may range from about 500 to about 650, 500 to 600, 550 to 650, or 550 to 600° C.

In some embodiments, the support or doped support may be maintained at a temperature of about 200° C. to about 1500° C., for a duration of at least about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, or 100, 105, 110, 115, 120, 132, 144, or 156 hours, in an inert or reducing atmosphere. In some embodiments, the support or doped support may be maintained at a temperature of about 200° C. to about 1500° C., for a duration of not more than about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, 156, or 168 hours, in an inert, anoxic, or reducing atmosphere.

### Nitriding of the Support or Doped Support

The chemical composition of the surface of the support or doped support can be modified, or thermally activated, to further improve the characteristics of the catalyst. Such modifications may be used to improve or moderate the dispersion of active metal species, and/or the surface morphology, selectivity, activity, or temperature sensitivity of the catalyst. One such modification is nitriding, which is performed at elevated temperatures, with the objective of converting up to 100% of the metal oxides or precursor species on the surface to the metal nitrides. The elevated temperatures may also be selected to promote solid state reaction(s) between the catalyst support material and/or the metal dopants and/or promoters to form solid solutions or alloys which further improve the desired characteristics and performance of the final catalyst. A reactive, nitrogen-rich or nitrogen-containing atmosphere comprising e.g., NH₃, H₂—N₂, forming gas, or endothermic gas (or mixtures thereof), may be used. Once the high temperature heat treatment has reached the end of the desired time duration, the nitrided material remains in the oven and in the same atmosphere, and it is allowed to cool to ambient temperature over a period of several hours.

In some embodiments, the support or doped support may be maintained at a temperature of at least about 200, 250, 300, 350, 400, 450, 500, 550, 600, 650, 700, 750, 800, 850, 900, 950, 1000, 1050, 1100, 1150, 1200, 1250, 1300, 1350, 1400, or 1450° C., fora duration of about 0.1 to about 168 hours, in a reactive, nitrogen-rich or nitrogen-containing atmosphere. In some embodiments, the support or doped support may be maintained at a temperature of not more than about 250, 300, 350, 400, 450, 500, 550, 600, 650, 700, 750, 800, 850, 900, 950, 1000, 1050, 1100, 1150, 1200, 1250, 1300, 1350, 1400, 1450, or 1500° C., fora duration of about 0.1 to about 168 hours, in a reactive, nitrogen-rich or nitrogen-containing atmosphere.

In some embodiments, the support or doped support may be maintained at a temperature of about 200° C. to about 1500° C., for a duration of at least about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, or 156 hours, in a reactive, nitrogen-rich or nitrogen-containing atmosphere. In some embodiments, the support or doped support may be maintained at a temperature of about 200° C. to about 1500° C., for a duration of not more than about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, 156, or 168 hours, in a reactive, nitrogen-rich or nitrogen-containing atmosphere.

In some cases, the nitriding temperature may range from about 300 to about 800, 300 to 750, 300 to 700, 300 to 650, 300 to 600, 350 to 800, 350 to 750, 350 to 700, 350 to 650, 350 to 600, 400 to 800, 400 to 750, 400 to 700, 400 to 650, 400 to 600, 450 to 800, 450 to 750, 450 to 700, 450 to 650, 450 to 600, 500 to 800, 500 to 750, 500 to 700, 550 to 800, 550 to 750, 550 to 700, 600 to 800, 600 to 750, 600 to 700, 650 to 800, 650 to 750, or 700 to 800° C. In some embodiments, the catalyst temperature may range from about 500 to about 650, 500 to 600, 550 to 650, or 550 to 600° C.

### Reduction of the Support or Doped Support

As discussed above, once the active metal (e.g., Co, Ni, Fe, Ni, Ru) precursor is deposited on the support or doped support, reduction of the precursor may lead to an improved active metal nanoparticle catalyst that can be used to facilitate ammonia decomposition. The conditions of such reduction may strongly influence the physical or chemical properties or characteristics of the active metal on the surface of the support, and thus the activity and/or ammonia conversion efficiency of the catalyst. In some embodiments, the conditions of reduction may strongly influence properties of the active metal nanoparticles on the surface, including, for example, size, dispersion and dominant crystal facets. In some cases, the reduction of the precursor(s) may be performed in an atmosphere comprising hydrogen. The relative temperature ranges for reduction may be described as at low (e.g., from about 300 to about 600° C.), medium (e.g., from about 700 to about 1000° C.), or high (e.g., about 1100° C. or higher). Once the high temperature heat treatment has reached the end of the desired time duration, the reduced material remains in the oven and in the same atmosphere, and it is allowed to cool to ambient temperature over a period of several hours. If a flowing or circulating atmosphere is used, then the time for effective reduction may be reduced significantly (e.g., between 2 to 6 hours at temperatures of about 600° C. or higher).

In some embodiments, the support or doped support may be maintained at a temperature of at least about 200, 250, 300, 350, 400, 450, 500, 550, 600, 650, 700, 750, 800, 850, 900, 950, 1000, 1050, 1100, 1150, 1200, or 1250° C., fora duration of about 0.1 hours to about 168 hours, in an atmosphere comprising hydrogen. In some embodiments, the support or doped support may be maintained at a temperature of not more than about 250, 300, 350, 400, 450, 500, 550, 600, 650, 700, 750, 800, 850, 900, 950, 1000, 1050, 1100, 1150, 1200, 1250, or 1300° C., for a duration of 0.1 hour to about 168 hours, in an atmosphere comprising hydrogen.

In some embodiments, the support or doped support may be maintained at a temperature of about 300° C. to about 1300° C., for a duration of at least about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, or 156 hours, in an atmosphere comprising hydrogen. In some embodiments, the support or doped support may be maintained at a temperature of about 300° C. to about 1300° C., for a duration of not more than about 0.1, 0.5, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 132, 144, 156, or 168 hours, in an atmosphere comprising hydrogen.

In some cases, the catalyst reduction temperature may range from about 300 to about 800, 300 to 750, 300 to 700, 300 to 650, 300 to 600, 350 to 800, 350 to 750, 350 to 700, 350 to 650, 350 to 600, 400 to 800, 400 to 750, 400 to 700, 400 to 650, 400 to 600, 450 to 800, 450 to 750, 450 to 700, 450 to 650, 450 to 600, 500 to 800, 500 to 750, 500 to 700, 550 to 800, 550 to 750, 550 to 700, 600 to 800, 600 to 750, 600 to 700, 650 to 800, 650 to 750, or 700 to 800° C. In some embodiments, the catalyst reduction temperature may range from about 500 to about 650, 500 to 600, 550 to 650, or 550 to 600° C.

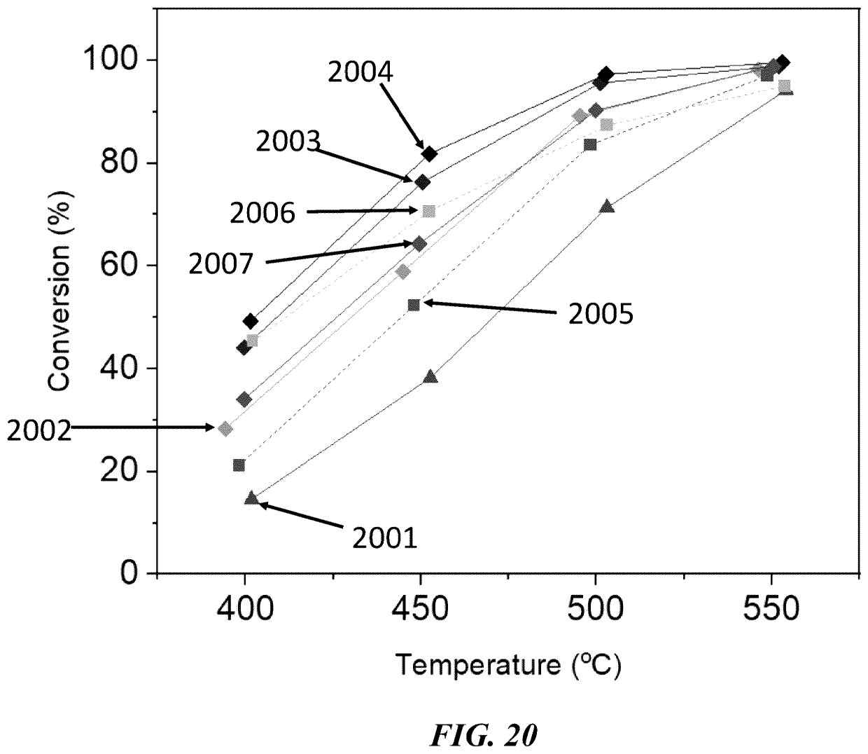

With reference to FIG. 20, reduction at high temperatures may not provide improved performance for a SiC monolith washcoated with an alumina slurry. Similarly, there may not be an advantage in using a high active metal loading. Four Ru-catalysts were prepared using the same SiC monolith, washcoating with alumina slurry and calcination treatment, as described herein. The active metal loading loadings were 2 wt % (lines 2001 and 2002), 4 wt % (line 2003) and 8 wt % (line 2004). The reduction step was conducted at 900° C. (line 2001) and 700° C. (lines 2002, 2003 and 2004). For comparison, three competitive Ru-catalysts on alumina beads on were also tested (lines 2005, 2006 and 2007). The monolith catalysts with the lowest active metal loading gave inferior conversion efficiency to the higher loadings, but the difference between the highest loadings was much smaller. The monolith catalyst reduced at the highest temperature gave the worst performance.

### Incorporation of Dopant Metals

In some cases, the support may further comprise additional dopants to improve the characteristics and performance of the catalyst. Such dopants may comprise at least one of: an alkali metal, an alkaline earth metal, a lanthanum, lanthanide or lanthanoid series metal, a transition metal, a post-transition metal or a metalloid, selected from Group 1 to Group 16 and Row 2 to Row 6 of the periodic table. In some cases, the support may comprise the oxide(s) of at least one of: an alkali metal, an alkaline earth metal, a lanthanum, lanthanide or lanthanoid series metal, a transition metal, a post-transition metal or a metalloid, selected from Group 1 to Group 16 and Row 2 to Row 6 of the periodic table. In some cases, the support may comprise the nitride(s) of at least one of: an alkali metal, an alkaline earth metal, a lanthanum, lanthanide or lanthanoid series metal, a transition metal, a post-transition metal or a metalloid, selected from Group 1 to Group 16 and Row 2 to Row 6 of the periodic table. In some cases, the support may comprise the elemental (reduced) form of at least one of: an alkali metal, an alkaline earth metal, a lanthanum, lanthanide or lanthanoid series metal, a transition metal, a post-transition metal or a metalloid, selected from Group 1 to Group 16 and Row 2 to Row 6 of the periodic table.

### Support Surface Modifiers

In some embodiments, the support or catalyst may comprise at least one support surface modifier. In some instances, the support surface modifier may comprise at least one rare earth metal. In some embodiments, the support surface modifier may comprise at least one of the F-block, lanthanum, lathanide, or lathanoid series elements (La, Ce, Pr, Nd, Pm, Sm, Eu, Gd, Tb, Dy, Ho, Er, Tm, Yb, and Lu). In some embodiments, the support surface modifier may comprise at least one of lanthanum (La) and cerium (Ce). In some cases, the support surface modifier may comprise at least one alkaline earth metal. In some cases, the support surface modifier may comprise at least one of Mg, Ca, Sr, or Ba. In some cases, the support surface modifier may comprise at least one of Fe, Mn, Ni, or Zn. In some cases, the support surface modifier may comprise B and N.

In some instances, the at least one support surface modifier may be incorporated into the surface layer of the support, to form a solid solution. In some instances, the at least one support surface modifier may be incorporated into the surface layer of the support, to form a metal or metal oxide alloy. In some instances, the at least one support surface modifier may be incorporated into the surface layer of the support, to modify the crystal structure. In some embodiments, the at least one support surface modifier may combine with the support material to form one or more perovskite, spinel, triclinic, monoclinic, orthorhombic, tetragonal, trigonal, hexagonal, or cubic structure, or phase. In some embodiments, the at least one support surface modifier may combine with the support material to form an amorphous phase.

In some cases, the support or catalyst may comprise at least one support surface modifier at a mass concentration from about 0.1 to about 50, 0.1 to 40, 0.1 to 30, 0.1 to 25, 0.5 to 50, 0.5 to 40, 0.5 to 30, 0.5 to 25, 0.5 to 20, 1 to 50, 1 to 40, 1 to 30, 1 to 25, 1 to 20, 1 to 15, 1 to 10, 1 to 5, 2 to 50, 2 to 40, 2 to 30, 2 to 25, 2 to 20, 2 to 15, 2 to 10, 2 to 5, 3 to 50, 3 to 40, 3 to 30, 3 to 25, 3 to 20, 3 to 15, 3 to 10, 3 to 5, 4 to 50, 4 to 40, 4 to 30, 4 to 25, 4 to 20, 4 to 15, 4 to 10, 4 to 5, 5 to 50, 5 to 40, 5 to 30, 5 to 25, 5 to 20, 5 to 15, 5 to 10, 5 to 9, 5 to 8, 5 to 7, 5 to 6, 10 to 50, 10 to 40, 10 to 30, 10 to 25, 10 to 20, 10 to 15, 10 to 14, 10 to 13, 10 to 12, 10 to 11, 15 to 50, 15 to 40, 15 to 30, 15 to 25, 15 to 20, 15 to 19, 15 to 18, 15 to 17, 15 to 16, 20 to 50, 20 to 40, 20 to 30, 20 to 25, 25 to 50, 25 to 40, 25 to 30, 30 to 50, 30 to 40, 30 to 35, 40 to 50, 40 to 45, or 45 to 50 wt %.

In some cases, the support or catalyst may comprise at least one support surface modifier at a molar concentration from about 0.1 to about 50, 0.1 to 40, 0.1 to 30, 0.1 to 25, 0.5 to 50, 0.5 to 40, 0.5 to 30, 0.5 to 25, 0.5 to 20, 1 to 50, 1 to 40, 1 to 30, 1 to 25, 1 to 20, 1 to 15, 1 to 10, 1 to 5, 2 to 50, 2 to 40, 2 to 30, 2 to 25, 2 to 20, 2 to 15, 2 to 10, 2 to 5, 3 to 50, 3 to 40, 3 to 30, 3 to 25, 3 to 20, 3 to 15, 3 to 10, 3 to 5, 4 to 50, 4 to 40, 4 to 30, 4 to 25, 4 to 20, 4 to 15, 4 to 10, 4 to 5, 5 to 50, 5 to 40, 5 to 30, 5 to 25, 5 to 20, 5 to 15, 5 to 10, 5 to 9, 5 to 8, 5 to 7, 5 to 6, 10 to 50, 10 to 40, 10 to 30, 10 to 25, 10 to 20, 10 to 15, 10 to 14, 10 to 13, 10 to 12, 10 to 11, 15 to 50, 15 to 40, 15 to 30, 15 to 25, 15 to 20, 15 to 19, 15 to 18, 15 to 17, 15 to 16, 20 to 50, 20 to 40, 20 to 30, 20 to 25, 25 to 50, 25 to 40, 25 to 30, 30 to 50, 30 to 40, 30 to 35, 40 to 50, 40 to 45, or 45 to 50 mol %.

### Relative Quantities of Two Support Surface Modifiers

In some embodiments, the support or catalyst may comprise two or more support surface modifiers. In some embodiments, the support or catalyst may comprise a first support surface modifier and a second support surface modifier in a mass ratio of at least about 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. In some embodiments, the support or catalyst may comprise a first support surface modifier and a second support surface modifier in a mass ratio of no more than about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5 or 99:1.

In some embodiments, the support or catalyst may comprise a first support surface modifier and a second support surface modifier in a molar ratio of at least about 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. In some embodiments, the support or catalyst may comprise a first support surface modifier and a second support surface modifier in a molar ratio of no more than about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 99:1.

### Catalyst Promoters

In some embodiments, the support or catalyst may comprise at least one promoter, selected from: Li, Na, K, Cs or Rb. In some instances, the support or catalyst may comprise at least one promoter, selected from: Be, Mg, Ca, Sr or Ba. In some cases, the support or catalyst may comprise at least one promoter, elected from: Fe, Co, Cr, Cu, Mn, Mn, Ni, or Zn. In some cases, the support or catalyst may be essentially free of a promoter, an alkali metal or an alkaline earth metal.

In some cases, the support or catalyst may comprise at least one promoter at a mass concentration from about 0.1 to about 50, 0.1 to 40, 0.1 to 30, 0.1 to 25, 0.5 to 50, 0.5 to 40, 0.5 to 30, 0.5 to 25, 0.5 to 20, 1 to 50, 1 to 40, 1 to 30, 1 to 25, 1 to 20, 1 to 15, 1 to 10, 1 to 5, 1 to 4, 1 to 3, 2 to 50, 2 to 40, 2 to 30, 2 to 25, 2 to 20, 2 to 15, 2 to 10, 2 to 5, 2 to 4, 3 to 50, 3 to 40, 3 to 30, 3 to 25, 3 to 20, 3 to 15, 3 to 10, 3 to 5, 4 to 50, 4 to 40, 4 to 30, 4 to 25, 4 to 20, 4 to 15, 4 to 10, 4 to 9, 4 to 8, 4 to 7, 4 to 6, 4 to 5, 5 to 50, 5 to 40, 5 to 30, 5 to 25, 5 to 20, 5 to 15, 5 to 10, 5 to 9, 5 to 8, 5 to 7, 5 to 6, 10 to 50, 10 to 40, 10 to 30, 10 to 25, 10 to 20, 10 to 15, 10 to 14, 10 to 13, 10 to 12, 10 to 11, 15 to 50, 15 to 40, 15 to 30, 15 to 25, 15 to 20, 15 to 19, 15 to 18, 15 to 17, 15 to 16, 20 to 50, 20 to 40, 20 to 30, 20 to 25, 25 to 50, 25 to 40, 25 to 30, 30 to 50, 30 to 40, 30 to 35, 40 to 50, 40 to 45, or 45 to 50 wt %.

In some cases, the support or catalyst may comprise at least one promoter at a molar concentration from about 0.1 to about 50, 0.1 to 40, 0.1 to 30, 0.1 to 25, 0.5 to 50, 0.5 to 40, 0.5 to 30, 0.5 to 25, 0.5 to 20, 1 to 50, 1 to 40, 1 to 30, 1 to 25, 1 to 20, 1 to 15, 1 to 10, 1 to 5, 1 to 4, 1 to 3, 2 to 50, 2 to 40, 2 to 30, 2 to 25, 2 to 20, 2 to 15, 2 to 10, 2 to 5, 2 to 4, 3 to 50, 3 to 40, 3 to 30, 3 to 25, 3 to 20, 3 to 15, 3 to 10, 3 to 5, 4 to 50, 4 to 40, 4 to 30, 4 to 25, 4 to 20, 4 to 15, 4 to 10, 4 to 9, 4 to 8, 4 to 7, 4 to 6, 4 to 5, 5 to 50, 5 to 40, 5 to 30, 5 to 25, 5 to 20, 5 to 15, 5 to 10, 5 to 9, 5 to 8, 5 to 7, 5 to 6, 10 to 50, 10 to 40, 10 to 30, 10 to 25, 10 to 20, 10 to 15, 10 to 14, 10 to 13, 10 to 12, 10 to 11, 15 to 50, 15 to 40, 15 to 30, 15 to 25, 15 to 20, 15 to 19, 15 to 18, 15 to 17, 15 to 16, 20 to 50, 20 to 40, 20 to 30, 20 to 25, 25 to 50, 25 to 40, 25 to 30, 30 to 50, 30 to 40, 30 to 35, 40 to 50, 40 to 45, or 45 to 50 mol %.

### Catalyst Active Metals

In some embodiments, the support or catalyst may comprise at least one active metal. In some instances, the active metal may comprise at least one platinum group metal, or noble metal. In some cases, the active metal may comprise at least one of a Row 4 (“early” or “light”) transition metal (Sc, Ti, V, Cr, Mn, Fe, Co, Ni, Cu, or Zn). In some embodiments, the active metal may comprise at least one of a Row 5 (“middle” or “medium”) transition metal (Y, Zr, Nb, Mo, Tc, Ru, Rh, Pd, Ag, or Cd). In some instances, the active metal may comprise at least one of a Row 6 (“late” or “heavy”) transition metal (Hf, Ta, W, Re, Os, Ir, Pt, Au, or Hg). In some cases, the active metal may comprise at least one of an alkali metal and/or an alkaline earth metal. In some cases, the active metal may comprise at least one of: B, C, Al, Si, P, Ga, Ge, Se, In, Sn, Sb, Te, Tl, Pb or Bi). In some cases, the at least one active metal may comprise particles or nanoparticles of at least one of an alkali metal, an alkaline earth metal, or a metalloid.

In some instances, at least one active metal precursor may be applied to the support, separately or together, using CVD, PVD, wet impregnation, or other suitable methods. In some embodiments, the at least one active metal may comprise impregnation to the support or as precursors, using separate or mixed solutions. In some cases, the active metal precursor may comprise at least one active metal as soluble salt or complex, e.g.: the metal iodide, acetylacetonate, chloride hydrate, oxide hydrate, chloride, bis(cyclopentadienyl), nitrosyl nitrate, iodide hydrate, carbonyl. In some embodiments, the active metal precursor may comprise at least one of: Ru(NO)(NO₃)₃, Ru(NO₃)₃, RuCl₃, Ru₃(CO)₁₂, ruthenium(III) chloride hexa-ammoniate Ru(NH₃)₆Cl₃, cyclohexadiene ruthenium tricarbonyl ((CHD)Ru(CO)₃), butadiene ruthenium tricarbonyl ((BD)Ru(CO)₃), and dimethylbutadiene ruthenium tricarbonyl ((DMBD)Ru(CO)₃).

In some embodiments, the at least one active metal may comprise a solid-state fusion process during a heat treatment step described previously herein. In some embodiments, this solid-state fusion process may comprise the formation of active metal particles or nanoparticles, comprising some or all of the active metal deposited onto the support. In some embodiments, the active metal particles or nanoparticles may comprise alloys or mixtures of more than one active metal. In some cases, the support or catalyst comprises at least two active metals.

In some embodiments, the support or catalyst may comprise at least one active metal at a mass concentration of at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 2.6, 2.7, 2.8, 2.9, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, or 49.5 wt %. In some embodiments, the support or catalyst may comprise at least one active metal at a mass concentration of not more than about 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1 2.2, 2.3, 2.4, 2.5, 2.6, 2.7, 2.8, 2.9, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, or 50 wt %. In some cases, the support or catalyst may comprise at least one active metal at a mass concentration from about 0.1 to about 50, 0.1 to 40, 0.1 to 30, 0.1 to 25, 0.5 to 50, 0.5 to 40, 0.5 to 30, 0.5 to 25, 0.5 to 20, 1 to 50, 1 to 40, 1 to 30, 1 to 25, 1 to 20, 1 to 15, 1 to 10, 1 to 5, 1 to 4, 1 to 3, 2 to 50, 2 to 40, 2 to 30, 2 to 25, 2 to 20, 2 to 15, 2 to 10, 2 to 8, 2 to 6, 2 to 5, 2 to 4, 3 to 50, 3 to 40, 3 to 30, 3 to 25, 3 to 20, 3 to 15, 3 to 10, 3 to 5, 4 to 50, 4 to 40, 4 to 30, 4 to 25, 4 to 20, 4 to 15, 4 to 10, 4 to 9, 4 to 8, 4 to 7, 4 to 6, 4 to 5, 5 to 50, 5 to 40, 5 to 30, 5 to 25, 5 to 20, 5 to 15, 5 to 10, 5 to 9, 5 to 8, 5 to 7, 5 to 6, 6 to 10, 6 to 8, 7 to 9, 8 to 10, 10 to 50, 10 to 40, 10 to 30, 10 to 25, 10 to 20, 10 to 15, 10 to 14, 10 to 13, 10 to 12, 10 to 11, 15 to 50, 15 to 40, 15 to 30, 15 to 25, 15 to 20, 15 to 19, 15 to 18, 15 to 17, 15 to 16, 20 to 50, 20 to 40, 20 to 30, 20 to 25, 25 to 50, 25 to 40, 25 to 30, 30 to 50, 30 to 40, 30 to 35, 40 to 50, 40 to 45, or 45 to 50 wt %.

In some embodiments, the support or catalyst may comprise at least one active metal at a molar concentration of at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1 2.2, 2.3, 2.4, 2.5, 2.6, 2.7, 2.8, 2.9, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, or 49.5 mol %. In some embodiments, the support or catalyst may comprise at least one active metal at a molar concentration of not more than about 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1 2.2, 2.3, 2.4, 2.5, 2.6, 2.7, 2.8, 2.9, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, or 50 mol %. In some cases, the support or catalyst may comprise at least one active metal at a molar concentration from about 0.1 to about 50, 0.1 to 40, 0.1 to 30, 0.1 to 25, 0.5 to 50, 0.5 to 40, 0.5 to 30, 0.5 to 25, 0.5 to 20, 1 to 50, 1 to 40, 1 to 30, 1 to 25, 1 to 20, 1 to 15, 1 to 10, 1 to 5, 1 to 4, 1 to 3, 2 to 50, 2 to 40, 2 to 30, 2 to 25, 2 to 20, 2 to 15, 2 to 10, 2 to 8, 2 to 6, 2 to 5, 2 to 4, 3 to 50, 3 to 40, 3 to 30, 3 to 25, 3 to 20, 3 to 15, 3 to 10, 3 to 5, 4 to 50, 4 to 40, 4 to 30, 4 to 25, 4 to 20, 4 to 15, 4 to 10, 4 to 9, 4 to 8, 4 to 7, 4 to 6, 4 to 5, 5 to 50, 5 to 40, 5 to 30, 5 to 25, 5 to 20, 5 to 15, 5 to 10, 5 to 9, 5 to 8, 5 to 7, 5 to 6, 6 to 10, 6 to 8, 7 to 9, 8 to 10, 10 to 50, 10 to 40, 10 to 30, 10 to 25, 10 to 20, 10 to 15, 10 to 14, 10 to 13, 10 to 12, 10 to 11, 15 to 50, 15 to 40, 15 to 30, 15 to 25, 15 to 20, 15 to 19, 15 to 18, 15 to 17, 15 to 16, 20 to 50, 20 to 40, 20 to 30, 20 to 25, 25 to 50, 25 to 40, 25 to 30, 30 to 50, 30 to 40, 30 to 35, 40 to 50, 40 to 45, or 45 to 50 mol %.

### Quantity of Active Metal Relative to Support or Washcoat Metal

In some embodiments, the support or catalyst may comprise a molar ratio of the support or washcoat metal (e.g., Al, Zr, Si, C) to active metal of at least about 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. In some embodiments, the support or catalyst may comprise a molar ratio of the support or washcoat metal to active metal of not more than about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 99:1. In some embodiments, the support or catalyst may comprise a mass ratio of the support or washcoat metal to active metal of at least about 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, or 95:5. In some embodiments, the support or catalyst may comprise a mass ratio of the support or washcoat metal to active metal of not more than about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 99:1.

In some embodiments, the mixed metal-Al oxide composite support may comprise a molar ratio of alkaline earth metal and/or spinel-forming metal to active metal of at least about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10 or 95:5. In some embodiments, the mixed metal-Al oxide composite support may comprise a molar ratio of alkaline earth metal and/or spinel-forming metal to active metal of not more than about 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 99:1. In some embodiments, the mixed metal-Al oxide composite support may comprise a mass ratio of alkaline earth metal and/or spinel-forming metal to active metal of at least about 5:95, 10:90, 15:85, 20:80, 25:75, 30:70, 35:65, 40:60, 45:55, 50:50, 55:45, 60:40, 65:35, 70:30, 75:25, 80:20, 85:15, 90:10 or 95:5. In some embodiments, the mixed metal-Al oxide composite support may comprise a mass ratio of alkaline earth metal and/or spinel-forming metal to active metal of not more than about 15:85, 20:80, 25:75, 30:70, 35:65, 40:60, 45:55, 50:50, 55:45, 60:40, 65:35, 70:30, 75:25, 80:20, 85:15, 90:10, 95:5, or 99:1.

### Joule Heated Catalyst

A catalyst heated to operating temperature by Joule or resistive heating may exhibit similar or better conversion efficiency to the same catalyst heated by an external source (e.g., furnace, or combustion gases). A Joule heated catalyst may reach operating temperature in a much shorter time period than is typical for a catalyst heated externally. A Joule heated catalyst may possess excellent durability characteristics through repeated heating and cooling cycles.

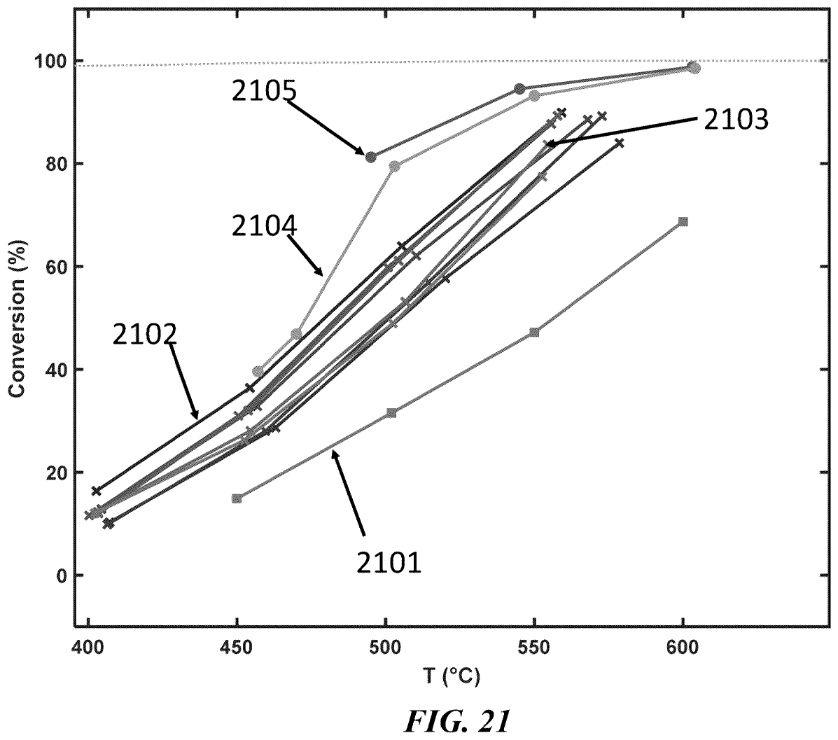

With reference to FIG. 21, catalysts based on a conductive support can exhibit higher conversion activity across a range of temperatures when directly heated by passing an electric current through them, comparted to the same catalysts heated in a furnace. Various catalysts were prepared from the same SiC monolith substrate, various alumina washcoat compositions and the same loading of active metal. One catalyst (line 2101) was impregnated with active metal prior to the application of the washcoat, the rest were washcoated, dried and calcined, before impregnation with active metal and reduced, as described herein. Two identical catalysts (lines 2102 and 2104) were dried by first by wrapping the long dimension in a plastic film and blowing air into and through the short dimension (or base), before using drying procedures described herein. Two other catalysts (lines 2103 and 2105) were dried by shaking, before using drying procedures described herein. Two catalysts (lines 2102 and 2103) were evaluated for ammonia conversion efficiency by heating in a furnace, and three catalysts (lines 2101, 2104 and 2105) were evaluated using Joule heating to achieve operating temperature. The Joule heated catalysts outperformed the same catalysts heated by a furnace, but the catalyst impregnated with active metal prior to application of the washcoat had poor conversion efficiency.

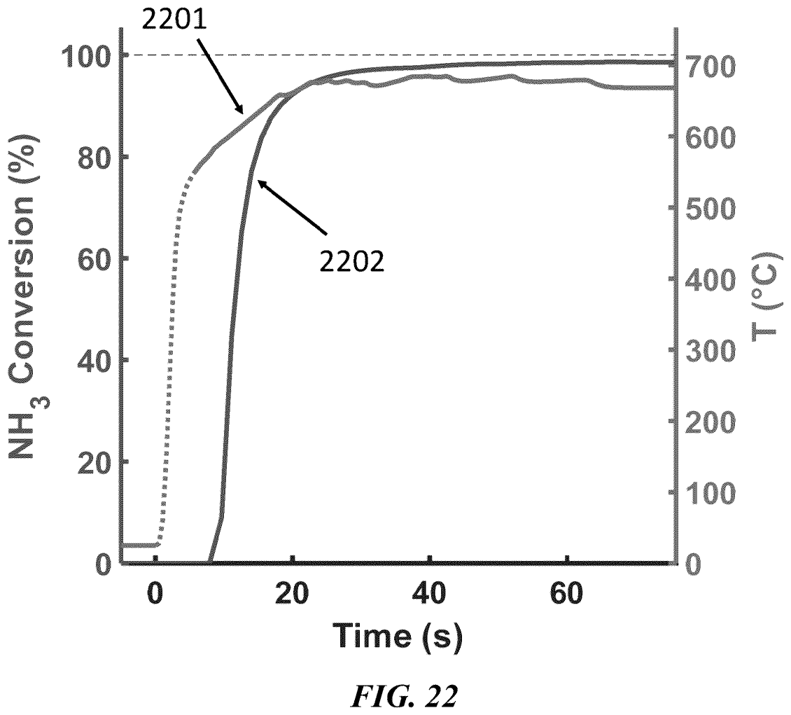

With reference to FIG. 22, starting from ambient temperature (about 20-25° C.), a Joule heated catalyst can reach an operating temperature of about 675° C. and an ammonia conversion efficiency of about 95%, in about 20 seconds. The same catalyst can reach an operating temperature of about 500° C. and a conversion efficiency of about 70% in about 15 seconds. This is much faster than catalysts heated by external sources. The catalyst temperature (line 2201) and ammonia conversion efficiency (line 2202) are shown, against the time since current started to flow through the catalyst (x-axis).

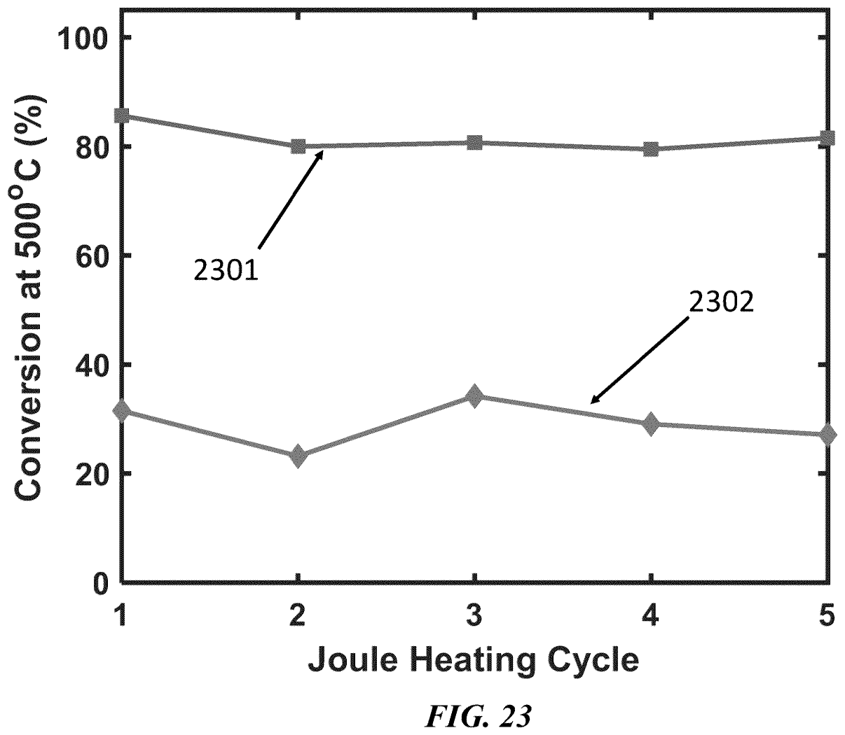

With reference to FIG. 23, repeated heating and cooling cycles between 500° C. and room temperature (about 20 to 25° C.) show no significant detrimental effect on conversion efficiency for Joule heated catalysts. Two catalysts with the same SiC monolith and overall composition were prepared using techniques described herein. The catalyst prepared by impregnation with active metal prior to application of the washcoat (line 2302) gave inferior performance to a catalyst with the same formulation, but where the active metal was deposited after washcoating and calcination (line 2301).

### Effect of Reduction Temperature

As discussed above, once the ruthenium precursor is deposited on the alumina carrier or support, reduction of the precursor may lead to an improved ruthenium nanoparticle catalyst that can be used to facilitate ammonia decomposition. The conditions of such reduction may strongly influence the physical or chemical properties or characteristics of the ruthenium on the surface of the support, and thus the activity and/or ammonia conversion efficiency of the catalyst. Surprisingly, the conditions of reduction may strongly influence properties of the ruthenium nanoparticles on the surface, including, for example, size, dispersion and dominant crystal facets.

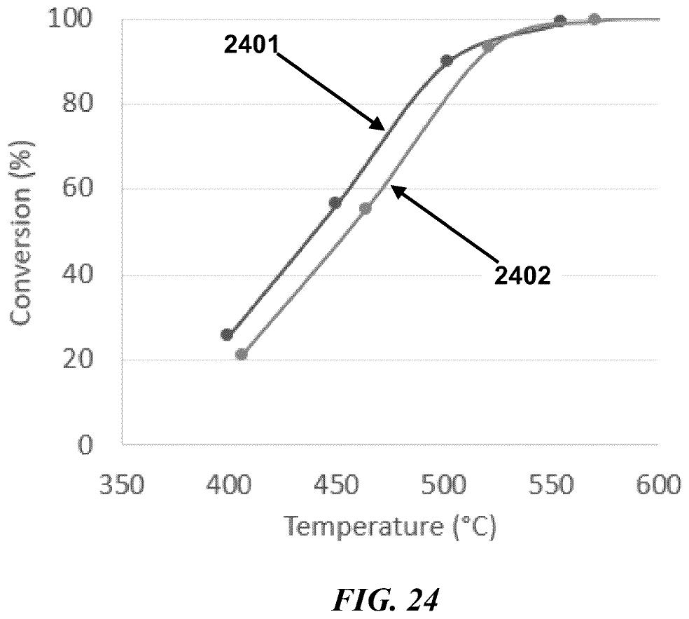

Described herein is an example that reduction at a higher temperature may surprisingly result in improved ammonia conversion performance across a wide temperature range (from about 400° C. to about 550° C.), even for a more effective, doped catalyst. With reference to FIG. 24, a Ru/La-gamma-alumina catalyst may be prepared according to the methods and materials described herein, and reduced for a set period of time in a H₂ atmosphere, at a temperature of about 900° C. 2401, or about 500° C. 2402.

In some instances, the catalyst reduction temperature may range from about 500 to about 1300, from about 550 to about 1250, from about 600 to about 1200, from about 650 to about 1150, from about 700 to about 1100, from about 750 to about 1050, from about 800 to about 1000, or from about 850 to about 950° C. In some cases, the catalyst reduction period may range from about 0.5 hour to about 200 hours, from about 1 hour to about 190 hours, from about 5 hours to about 180 hours, or from about 10 hours to about 170 hours, from about 15 hours to about 160 hours, from about 20 hours to about 150 hours, from about 25 hours to about 140 hours, or from about 30 hours to about 130 hours, from about 35 hours to about 120 hours, from about 40 hours to about 110 hours, from about 45 hours to about 100 hours, or from about 50 hours to about 95 hours, from about 55 hours to about 90 hours, from about 60 hours to about 85 hours, from about 65 hours to about 80 hours, or from about 70 hours to about 75 hours.

### Alumina Support Phase

While gamma-alumina (γ-Al₂O₃) is an alumina phase that is commonly used as a catalyst support, other phases of alumina exist, including alpha- (α-), theta- (θ-), delta- (δ-) and eta- (η-). Alpha alumina (α-Al₂O₃) can be provided in a highly sintered form of the support with a very low surface area, which can lead to poor catalyst dispersion. In contrast, theta alumina (θ-Al₂O₃) can be a phase that is generated during the transition from gamma to alpha at very high temperatures and can retain a relatively high surface area, which can make theta alumina one example of a higher performing support material.

Described herein is an example that the unexpected effect of using theta-alumina (θ-alumina) as the support material compared to using gamma-alumina (γ-alumina). Across a temperature range from about 400° C. to about 550° C., the catalyst using 1.6 mm beads of theta-alumina exhibited equivalent performance to the catalyst using 1.0 mm beads of gamma-alumina. Across a temperature range from about 400° C. to about 525° C., the catalyst using 1.6 mm beads of gamma-alumina gave inferior performance to the other two catalysts. It is surprising to observe improved performance using theta-alumina compared to higher porosity gamma-alumina, but these results indicate that larger form factors can be used with theta-alumina, reducing the pressure drop across the catalyst bed while maintaining conversion performance.

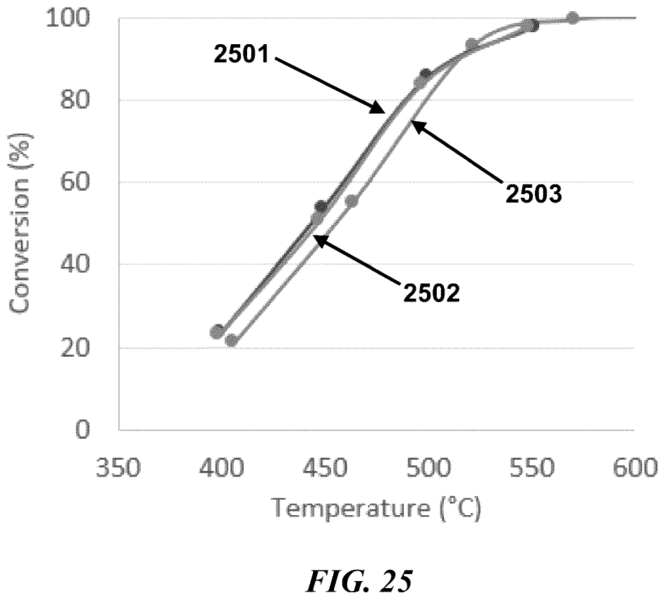

With reference to FIG. 25, Ru-alumina catalysts may be prepared according to the same methods and materials (described herein) and with the same composition. The catalysts may use 1.6 mm beads comprised of theta-alumina 2501, 1.0 mm beads comprised of gamma-alumina 2502, or 1.6 mm beads comprised of gamma-alumina 2503.

In some cases, in a full-scale reformer, pressure drops may be significant and may be a function of the size of the support used, and as the particles get smaller, the pressure drop may increase. In some cases, switching the phase of the support from gamma-alumina to theta-alumina may allow the catalyst to perform comparably to smaller catalysts, while still minimizing pressure drop with a larger catalyst size. In some embodiments, the support comprises at least one of theta-alumina (θ-Al₂O₃) or gamma-alumina (γ-Al₂O₃). In some embodiments, the support comprises theta-alumina (θ-Al₂O₃). In some embodiments, the support comprises gamma-alumina (γ-Al₂O₃).

### Effect of Ru Precursor

Described herein is an example of the unexpected effect of the choice of Ru precursor. In some cases, the ruthenium nanoparticle catalysts of the present disclosure may be synthesized using various ruthenium precursors comprising, for example, Ru(NO)(NO₃)₃, RuCl₃ and Ru₃(CO)₁₂.

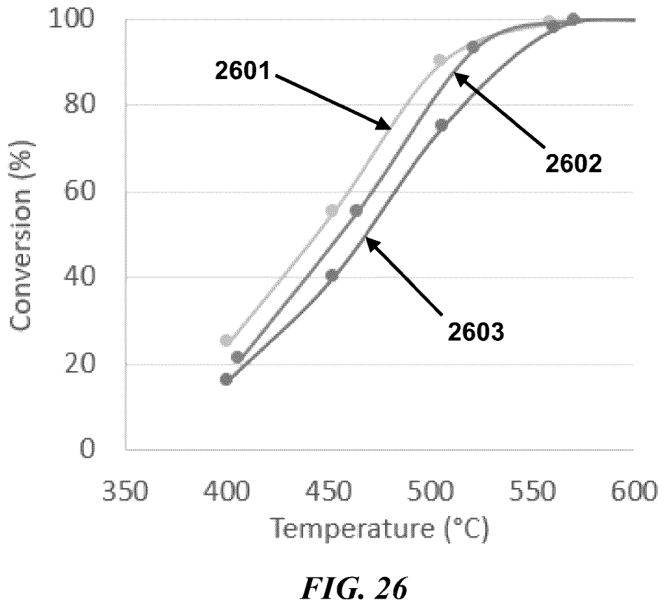

The use of Ru(NO)(NO₃)₃ resulted in improved catalyst performance across a wide temperature range (from about 400° C. to about 525° C.). The use of RuCl₃ gave lower performance and Ru₃(CO)₁₂ provided the lowest performance in a temperature range from about 400° C. to about 600° C. With respect to FIG. 26, Ru-alumina catalysts with 2 wt % Ru content and having the same final composition may be prepared by the same method and materials, described herein. The catalysts may be prepared using a Ru precursor comprising: Ru(NO)(NO₃)₃ 2601, RuCl₃ 2602, or Ru₄(CO)₁₂ 2603.

### Mixed La—Al, Ce—Al, and La—Ce—Al Oxide Supports

In some cases, the alumina support may be initially modified by incorporation of lanthanum via high-temperature calcination to generate a La—Al oxide support that can serve as an improved catalyst support.

The catalysts described in this disclosure were prepared by the wet impregnation method, as described herein. Other synthesis techniques (e.g. sol-gel, precipitation, CVD) may also be used to prepare these catalysts. In some embodiments, the catalyst may be prepared by doping a support material with at least one precursor comprising La. In some embodiments, the catalyst may be prepared by doping a support material with at least one precursor comprising Ce. In some instances, the catalyst may be prepared by doping a support material with at least one precursor comprising Cs. In some instances, the catalyst may be prepared by doping a support material with at least one precursor comprising La and Ce. In some embodiments, the catalyst may be prepared by doping a support material with at least one precursor comprising La, Ce and Cs.

In some instances, this may be achieved by using suitable precursors, for example, La(NO₃)₃, Ce(NO₃)₃, CsNO₃, and their hydrates. In some instances, the La and Ce precursors may be applied as one solution (using deionized water, or other suitable solvent), or separately. In some embodiments, the Cs precursor may be applied as a separate solution. In some instances, each precursor may be applied as a separate solution, with a drying step between each application, (as described herein). In some embodiments, the Ce precursor may be applied to the support material before the La precursor. In some embodiments, the La precursor may be applied to the support material before the Ce precursor.

The concentration of the precursor solutions is determined by the desired metal loading on the catalyst. In some embodiments, it may be convenient to use the desired loading of La on the catalyst as the basis for the concentrations of the precursor solution(s). In some embodiments, it may be convenient to use the desired loading of Ce as the basis for the concentrations of precursor solution(s). The relationships between catalyst loading, the required concentrations of the precursor solutions and their preparation are described herein.

### Incorporation of La

Described herein is an example of the surprising improvement in ammonia conversion efficiency that may be achieved with the use of theta-alumina support material doped with lanthanum (La), the use of a more effective molar ratio of active metal and promoter, and the selection of appropriate reduction conditions.

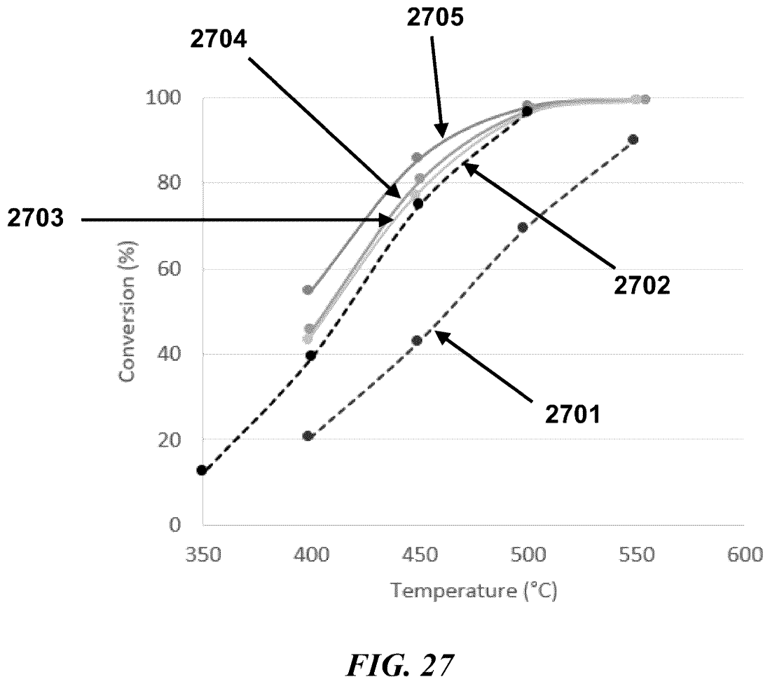

With respect to FIG. 27, Ru-alumina catalysts may be prepared with the same concentration of Ru and a constant dopant level of La, according to the same methods and materials described herein, and using the same form factor for the support materials. Gamma-alumina (γ-alumina) may be used for the support material (2701 and 2702) or theta-alumina (θ-alumina) may be used (2703, 2704, and 2705). The catalyst may not comprise a promoter 2701, 2703 and 2704, or it may comprise a promoter (Cs) 2702 and 2705. The catalyst may not be subjected to a heat treatment step 2701 and 2702, The catalyst may be subjected to a high temperature reduction step in a H₂ atmosphere, for a duration of about 2 hours 2703 and 2705, or for about 12 hours 2704.

In some embodiments, the concentration of La in the catalyst may comprise at least about 1, 2, 3, 4, 5, 6, 7, 8, 9, 10, 11, 12, 13, 14, 15, 16, 17, 18, 19, 20, 21, 22, 23, or 24 mol %. In some embodiments, the concentration of La in the catalyst may comprise from about 1 to about 15, about 1 to about 10, about 1 to about 5, about 2 to about 8, about 2 to about 6, about 2 to about 4, about 4 to about 10, about 4 to about 8, about 4 to about 6, about 5 to about 20, about 5 to about 15, about 5 to about 10, about 6 to about 10, about 6 to about 8, about 8 to about 10, about 10 to about 20, about 10 to about 18, about 10 to about 16, about 10 to about 14, about 10 to about 12, about 15 to about 20, about 12 to about 18, about 12 to about 16, about 12 to about 14, about 14 to about 20, about 14 to about 18, about 14 to about 16, about 16 to about 18, or about 18 to about 20 mol %. In some embodiments, the concentration of La in the catalyst may comprise at least about 1, 2, 3, 4, or 5 mol %. In some embodiments, the concentration of La in the catalyst may comprise not more than about 10, 9, 8, 7, 6, or 5 mol %. In some embodiments the concentration of La in the catalyst may comprise from about 2 to about 8, about 2 to about 7, about 2 to about 6, about 3 to about 7, about 3 to about 6, about 4 to about 8, about 4 to about 7, or about 4 to about 6 mol %.

Incorporation of La with Ce

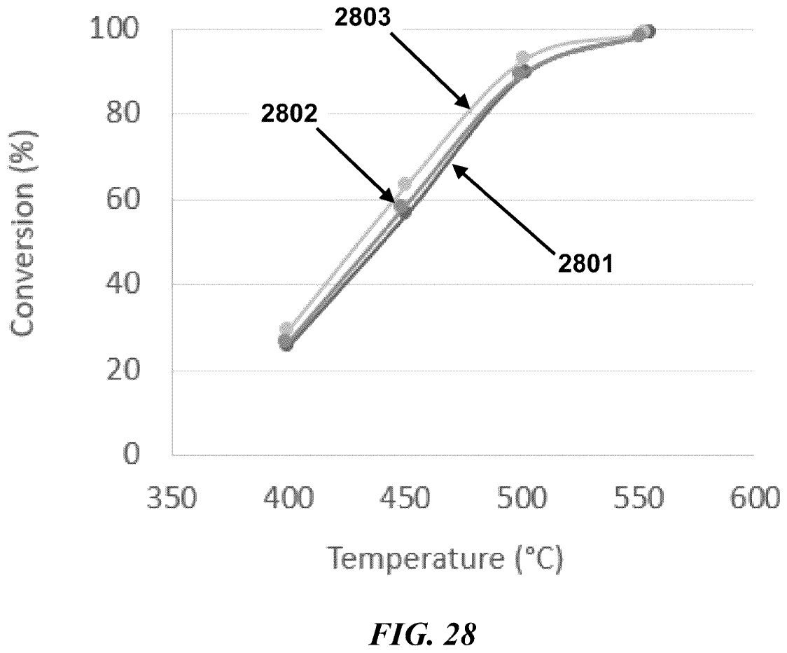

Described herein is an example of the unexpected synergy between La and Ce to give improved catalyst performance beyond that demonstrated by each dopant alone, while maintaining a constant total dopant metal concentration of 15 mol %. With respect to FIG. 28, Ru-alumina catalysts may be prepared according to the methods and materials described herein, and based on the same form factor for the support. The catalyst may be doped with La 2801, the catalyst may be doped with Ce 2802, or the catalyst may be doped with a of La and Ce combined 2803.

In some instances, it may be convenient to determine the required concentration of Ce in the catalyst by the concentration of La and the desired molar ratio of La and Ce. In some instances, it may be convenient to determine the required concentration of La in the catalyst by the concentration of Ce and the desired molar ratio of Ce and La.

In some embodiments, the concentration of Ce in the catalyst may comprise at least about 1, 2, 3, 4, 5, 6, 7, 8, 9, 10, 11, 12, 13, 14, 15, 16, 17, 18, 19, 20, 21, 22, 23, or 24 mol %. In some embodiments, the concentration of Ce in the catalyst may comprise no more than about 2, 3, 4, 5, 6, 7, 8, 9, 10, 11, 12, 13, 14, 15, 16, 17, 18, 19, 20, 21, 22, 23, 24 or 25 mol %. In some embodiments, the concentration of Ce in the catalyst may comprise at least about 1, 2, 3, 4, or 5 mol %. In some embodiments, the concentration of Ce in the catalyst may comprise not more than about 10, 9, 8, 7, 6, or 5 mol %. In some embodiments, the concentration of Ce in the catalyst may comprise from about 1 to about 25, about 1 to about 15, about 1 to about 5, about 2 to about 8, about 2 to about 6, about 2 to about 4, about 4 to about 10, about 4 to about 8, about 4 to about 6, about 5 to about 20, about 5 to about 15, about 5 to about 10, about 6 to about 10, about 6 to about 8, about 8 to about 10, about 10 to about 20, about 10 to about 18, about 10 to about 16, about 10 to about 14, about 10 to about 12, about 15 to about 20, about 12 to about 18, about 12 to about 16, about 12 to about 14, about 14 to about 20, about 14 to about 18, about 14 to about 16, about 16 to about 18, or about 18 to about 20 mol %.

In some embodiments, the combined concentration of La and Ce in the catalyst may comprise at least about 1, 2, 3, 4, 5, 6, 7, 8, 9, 10, 11, 12, 13, 14, 15, 16, 17, 18, 19, 20, 21, 22, 23, or 24 mol %. In some embodiments, the combined concentration of La and Ce in the catalyst may comprise no more than about 2, 3, 4, 5, 6, 7, 8, 9, 10, 11, 12, 13, 14, 15, 16, 17, 18, 19, 20, 21, 22, 23, 24 or 25 mol %. In some embodiments, the combined concentration of La and Ce in the catalyst may comprise from about 1 to about 15, about 1 to about 10, about 1 to about 5, about 2 to about 8, about 2 to about 6, about 2 to about 4, about 4 to about 10, about 4 to about 8, about 4 to about 6, about 5 to about 20, about 5 to about 15, about 5 to about 10, about 6 to about 10, about 6 to about 8, about 8 to about 10, about 10 to about 20, about 10 to about 18, about 10 to about 16, about 10 to about 14, about 10 to about 12, about 15 to about 20, about 12 to about 18, about 12 to about 16, about 12 to about 14, about 14 to about 20, about 14 to about 18, about 14 to about 16, about 16 to about 18, or about 18 to about 20 mol %.

### High Temperature Treatment to Form Modified Surface Layer

In some cases, the conditions of the high temperature treatment may be selected to improve the solid-state reaction between the alumina (Al₂O₃) support and cerium oxide (CeO₂) and lanthanum oxide (La₂O₃) dopants (or precursors) on the support surface. In some instances, this reaction results in the formation of a surface layer comprised of a perovskite phase, comprising of Al, O, and La. In some instances, this reaction results in the formation of a surface layer comprised of a perovskite phase, comprising of Al, O, and Ce. In some embodiments, this reaction results in the formation of a surface layer comprised of a perovskite phase, comprising of Al, O, La, and Ce. In some cases, the surface layer comprises theta-alumina (θ-alumina). In some cases, the surface layer comprises gamma-alumina (γ-alumina).

In some embodiments, doping of a La—Al oxide support with an electron-donating metal such as cerium may comprise La—Ce—Al oxide supports of the general formula La₍₁₋ₓ₎CeₓAlO₃/Al₂O₃. In some instances, the La₍₁₋ₓ₎CeₓAlO₃/Al₂O₃ composition may comprise, for example, a mixed La—Ce oxide structure. In some embodiments, the surface layer comprises a perovskite phase of the general formula La₍₁₋ₓ₎CeₓAlO₃. The value of x in this formula may be at least about 0.1, 0.2, 0.3, 0.4, 0.5, 0.6, 0.7, 0.8, or 0.9. The value of x in this formula may be no more than about 0.2, 0.3, 0.4, 0.5, 0.6, 0.7, 0.8, 0.9, or 0.95. The value of x may be from about 0.05 to about 0.9, from about 0.1 to about 0.7, from about 0.15 to about 0.5, from about 0.2 to about 0.4, or from about 0.25 to about 0.35.

### Incorporation of Cs and Ru

In some cases, it may be convenient to determine the required concentration of Cs in the catalyst by the desired molar ratio of Cs and Ru, and the desired concentration of Ru in the catalyst. In some cases, it may be convenient to determine the required concentration of Ru in the catalyst by the desired molar ratio of Ru and Cs, and the desired concentration of Cs in the catalyst.

In some instances, the doped and calcined support is further doped with Cs. In some embodiments, the concentration of Cs in the catalyst may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, or 59 wt %. In some embodiments, the concentration of Cs in the catalyst may comprise not more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. In some embodiments, the concentration of Cs in the catalyst may comprise from about 1 to about 15, about 1 to about 10, about 1 to about 5, about 2 to about 8, about 2 to about 6, about 2 to about 4, about 4 to about 10, about 4 to about 8, about 4 to about 6, about 5 to about 20, about 5 to about 15, about 5 to about 10, about 6 to about 10, about 6 to about 8, about 8 to about 10, about 10 to about 20, about 10 to about 18, about 10 to about 16, about 10 to about 14, about 10 to about 12, about 15 to about 20, about 12 to about 18, about 12 to about 16, about 12 to about 14, about 14 to about 20, about 14 to about 18, about 14 to about 16, about 16 to about 18, or about 18 to about 20 wt %.

In some embodiments, the doped and calcined support is further doped with Ru. In some embodiments, the concentration of Ru in the catalyst may comprise at least about 0.1, 0.25, 0.5, 0.75, 1, 1.25, 1.5, 2, 2.5, 3, 3.5, 4, 4.5, 5, 6, 7, 8, 9, 10, 11, 12, 13, or 14 wt %. In some embodiments, the concentration of Ru in the catalyst may comprise no more than about 0.25, 0.5, 0.75, 1, 1.25, 1.5, 2, 2.5, 3, 3.5, 4, 4.5, 5, 6, 7, 8, 9, 10, 11, 12, 13, 14, or 15 wt %. In some embodiments, the concentration of Ru in the catalyst may comprise from about 1 to about 15, about 1 to about 10, about 1 to about 5, about 1 to about 3, about 2 to about 8, about 2 to about 6, about 2 to about 4, about 3 to about 5, about 4 to about 10, about 4 to about 8, about 4 to about 6, about 5 to about 10, about 5 to about 7, about 6 to about 10, about 6 to about 8, about 7 to about 9, or about 8 to about 10 mol %. In some embodiments, the concentration of Ru in the catalyst may comprise from about 0.25 to about 5, about 0.25 to about 4, about 0.25 to about 3, about 0.5 to about 5, about 0.5 to about 4, about 0.5 to about 3, about 1 to about 5, about 1 to about 4, about 1 to about 3, about 1 to about 2.5, about 1.25 to about 5, about 1.25 to about 4, about 1.25 to about 3, about 1.25 to about 2.5, about 1.5 to about 5, about 1.5 to about 4, about 1.5 to about 3, or about 1.5 to about 2.5 wt %.

In some embodiments, the molar ratio of Cs and Ru may comprise at least about 1:2, 1:1, 1.5:1, 2:1, 2.5:1, 3:1, 3.5:1, 4:1, 4.5:1, 5:1, 5.5:1, 6:1, 7:1, 8:1, or 9:1. In some embodiments, the molar ratio of Cs and Ru may comprise no more than about 1:1, 1.5:1, 2:1, 2.5:1, 3:1, 3.5:1, 4:1, 4.5:1, 5:1, 5.5:1, 6:1, 7:1, 8:1, 9:1, or 10:1. In some instances, the molar ratio of Cs and Ru may comprise from about 1:2 to about 5.5:1, from about 1:1 to about 5:1, from about 1.5:1 to about 4.5:1, from about 2:1 to about 4:1, or from about 2.5:1 to about 3.5:1.

### Mixed La—Ce—Al Oxide Support and Cs Promotion for Theta Alumina

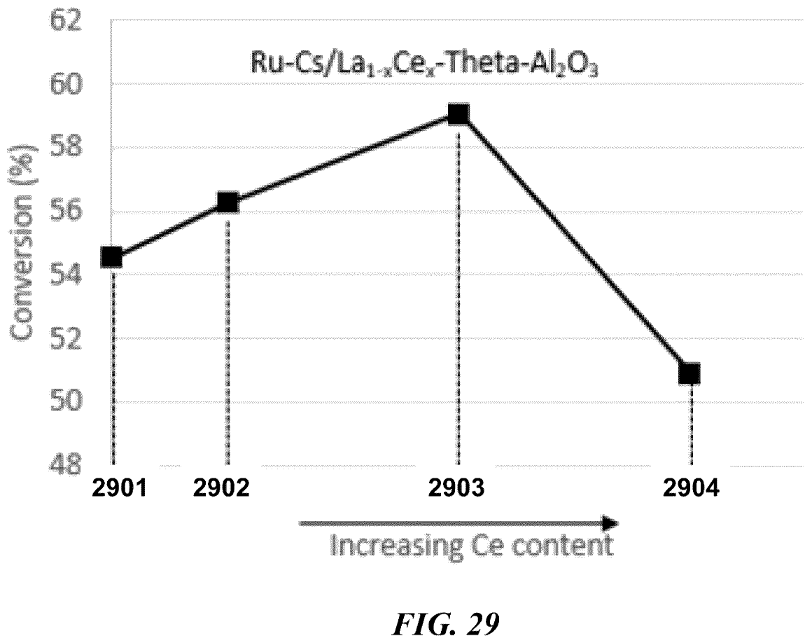

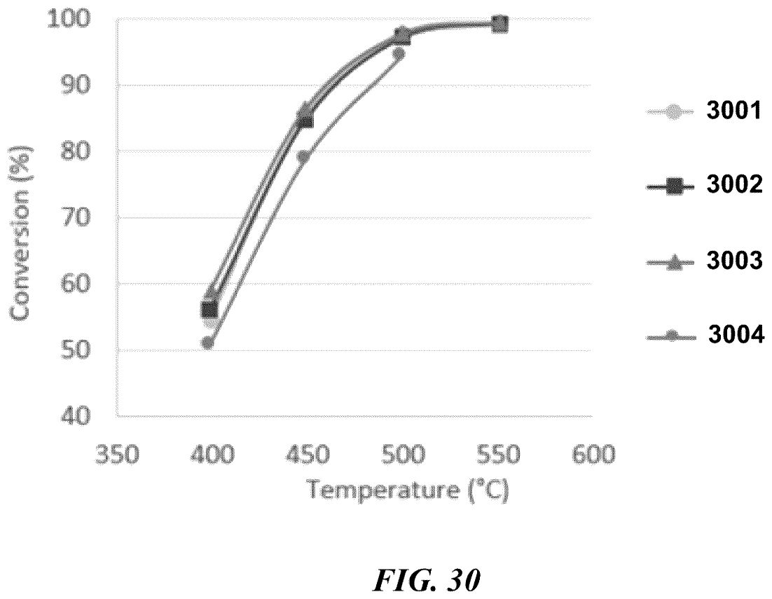

Referring to FIG. 29 and FIG. 30, in some cases, the catalysts of the present disclosure may be further improved by adjusting the molar ratio of La and Ce.

Described herein is an example showing that the unexpected synergy between La and Ce (according to the formula, Ru—Cs/La₁₋ₓCeₓ-Theta-Al₂O₃) is most effective when the value of x is greater than 0 and less than 0.5. With respect to FIG. 27, Ru-alumina catalysts may be prepared according to the methods and materials described herein, based on theta-alumina (6-alumina) and the same form factor for the support. The catalysts may comprise the same concentration of active metal (Ru), the same molar ratio of Ru and promoter (Cs), and different ratios of La and Ce dopants at a constant combined dopant loading, according to the formula: Ru—Cs/La₁₋ₓCeₓ-Theta-Al₂O₃. The catalysts may comprise values for x of: x=0 (no Ce) 2901, x=0.1 2902, x=0.3 2903, or x=0.5 2904. The conversion efficiency of these catalysts was measured at a fixed temperature and fixed NH₃ flow rate.

Described herein is an example showing that unexpected synergy between La and Ce is observed across a wide temperature range (about 400° C. to about 550° C.), in the same ratios as used in Example 9. With respect to FIG. 30, Ru-alumina catalysts may be prepared with constant Ru concentration according to the methods and materials described herein, based on theta-alumina (θ-alumina) and the same form factor for the support. The catalysts may comprise Ru/La₍₁₋ₓ₎Ceₓ-Theta-Al₂O₃ with values for x of: x=0 (no Ce) 3001, x=0.1 3002, x=0.3 3003, or x=0.5 3004. The conversion efficiency of these catalysts may be measured across a temperature range and at constant NH₃ flow rate.

Such further improvements may yield a catalyst that exhibits enhanced performance characteristics compared to other catalysts fabricated using various baseline conditions. In some examples, the baseline conditions may correspond to an incorporation amount of Ru, a molar ratio of Cs promoter to Ru, a type of Ru precursor, a catalyst reduction temperature, a catalyst reduction period and alumina support phase. In any of the embodiments described herein, the alumina support phase may be theta-alumina, gamma-alumina, or a combination of both. In some embodiments, a mixed La—Ce—Al oxide structure may be introduced on or to a support comprising theta alumina by varying a molar ratio of La and Ce, as shown in FIG. 29 and FIG. 30. In some embodiments, the molar ratio of La and Ce may be at least about 100:0, 95:5, 90:10, 85:15, 80:20, 75:25, 70:30, 65:35, 60:40, 55:45, 50:50, 45:55, 40:60, 35:65, 30:70, 25:75, 20:80, 15:85, 10:90, 5:95, or 0:100. In some cases, there may be an upward trend in activity or ammonia conversion efficiency as a function of cerium content in the support.

Improvement of Catalyst Performance with Lower Rare Earth Metal Content

In some cases, by reducing the volume of impregnation solution to that required for incipient wetness impregnation, catalysts prepared with lower concentrations of rare earth metals and without a promoter may result in improved ammonia conversion efficiency.

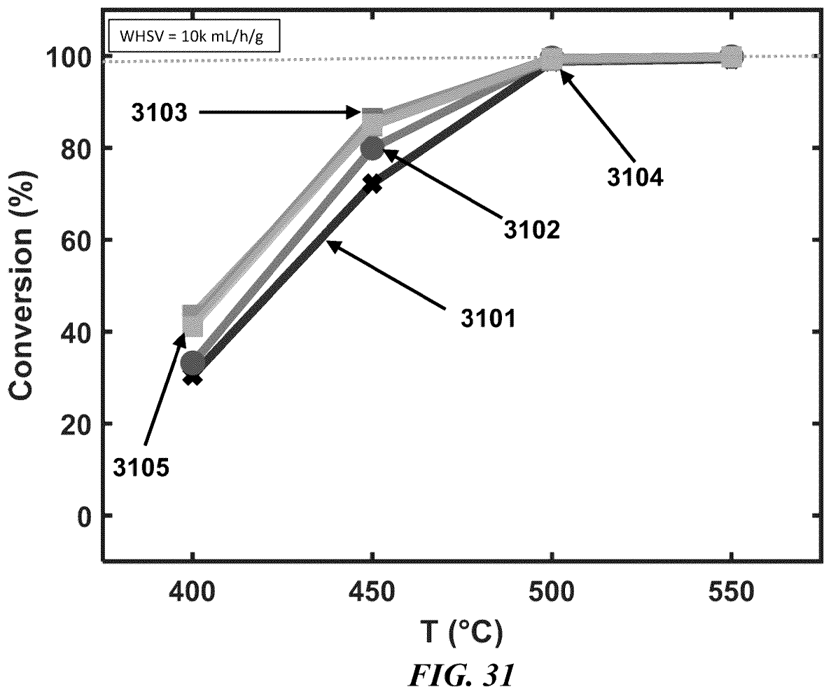

Ru-alumina catalysts were prepared according to methods and materials disclosed herein. The catalysts contained the same wt % of Ru on identical theta-alumina support materials with the same form factor. All the catalysts were prepared with heat treatment temperatures of about 600° C. for calcination and reduction steps. Catalysts prepared with lower rare earth metal content (for example, below 10 mol %) using the incipient wetness impregnation technique exhibited higher ammonia conversion efficiency than the same catalyst prepared with excess impregnation solution. Surprisingly, these catalysts also exhibited higher conversion efficiency than a similar catalyst containing about 15 mol % of lanthanum, prepared with excess impregnation solution. With reference to FIG. 31, Ru-alumina catalysts were prepared using the wet impregnation technique (excess impregnation solution), containing 15 mol % La (catalyst 3101), and less than 10 mol % La (catalyst 3102). Catalysts prepared using the incipient wetness technique (no excess impregnation solution) and containing less than 10 mol % La resulted in higher ammonia conversion efficiency. Almost identical performance was observed for catalysts 3103 and 3104 that were prepared with about 5-10% nitric acid in the Ru precursor solution, and a catalyst 3105 that was not prepared with nitric acid in the Ru precursor solution.

In some cases, Ru-alumina catalysts prepared using the incipient wetness impregnation technique and with relatively low rare earth metal content and without a promoter can exhibit equal performance to a high activity catalyst made with an improved combination of two rare earth metals and including an alkali metal promoter.

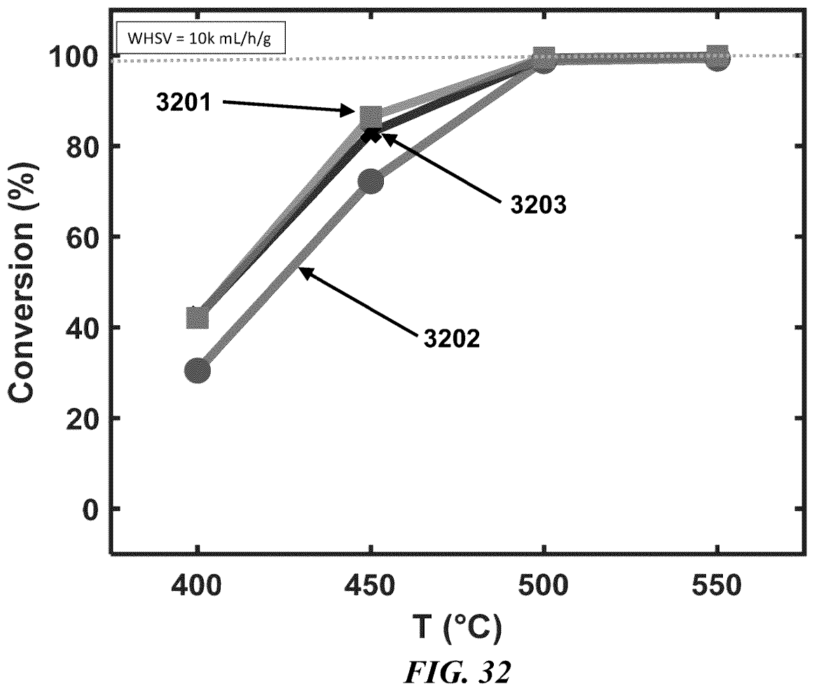

Ru-alumina catalysts were prepared according to methods and materials disclosed herein. The catalysts contained the same wt % of Ru on identical theta-alumina support materials with the same form factor. All the catalysts were prepared with heat treatment temperatures of about 600° C. for calcination and reduction steps. A catalyst prepared with lower rare earth metal content (below 10 mol %) using the incipient wetness impregnation technique exhibited higher ammonia conversion efficiency than the same catalyst prepared with excess impregnation solution. Surprisingly, the catalyst prepared using the incipient wetness technique exhibited equivalent conversion efficiency compared to a similar catalyst conforming to the improved composition of catalyst 2903 (FIG. 29) and prepared with excess impregnation solution. With reference to FIG. 32, Ru-alumina catalysts were prepared using the wet impregnation technique (excess impregnation solution), containing 15 mol % (total) of La and Ce (catalyst 3203), and less than 10 mol % La (catalyst 3202). A catalyst 3201 prepared using the incipient wetness technique (no excess impregnation solution) and containing less than 10 mol % La gave higher ammonia conversion efficiency compared to catalyst 3202 and equivalent performance to catalyst 3203.

### Effect of Heat Treatment on Conversion Efficiency

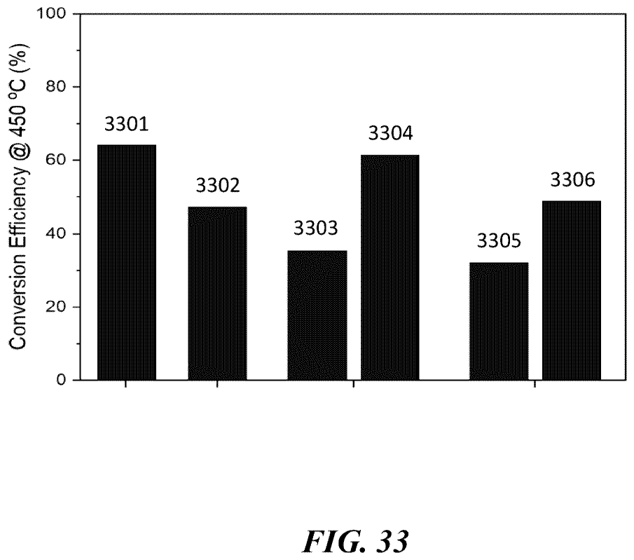

FIG. 33 shows the effect of high temperature calcination on the ammonia conversion efficiency at 450° C. and constant gas flow rate, of various catalysts based on mixed metal oxide composite supports with the same concentration of active metal (Ru). Catalysts subjected to high temperature calcination may exhibit an ammonia conversion efficiency up to 30% higher than the same catalysts not subjected to high temperature calcination.

With respect to FIG. 33, various catalysts were prepared by the fabrication of M-Al oxide composite supports based on gamma-alumina and subsequent deposition and reduction of active metal precursor, according to materials, methods and embodiments described herein. The catalysts contained the same wt % of active metal and used the same form factor. In these cases, the alkaline earth and/or spinel-forming metal used (Mg) may be represented by M, as described herein. M-A1 oxide composite supports were prepared with different mass ratios of M to Al: 37:63 (bar 3301), 26:74 (bar 3302), 30:70 (bars 3303 and 3304), 70:30 (bars 3305 and 3306). One catalyst used a support prepared in-house (bar 3301), while the other catalysts used a commercially available support material. Two catalysts were subjected to high temperature calcination (bars 3304 and 3306).

### Improvement of Catalyst Conversion Efficiency

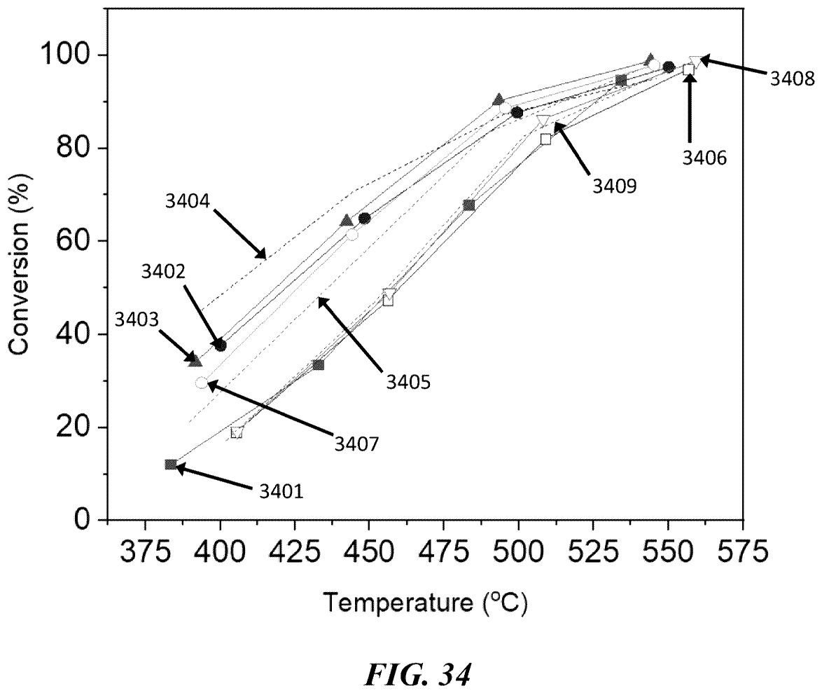

FIG. 34 shows the effect of metal ratio on ammonia conversion efficiency for Ru catalysts prepared with mixed metal (M-Al) oxide composite supports using gamma-alumina support material from 2 sources. The results indicate that there may be a range of concentrations for the alkaline earth and/or spinel-forming metal that is most effective for improvement of ammonia conversion efficiency. For one gamma-alumina support, conversion efficiency between about 400 and about 500° C. was significantly improved by increasing the M to Al mass ratio from 47:53 to 52:48, but increasing further significantly reduced conversion efficiency across the same temperature range. For the same support, the results also indicated that one active metal precursor produces a more active than a different precursor. For the second support, conversion efficiency between about 400 and about 500° C. was significantly improved by increasing M to Al mass ratio slightly from 50:50 and increasing further resulted in another slight improvement.

With respect to FIG. 34, catalysts may be prepared with alkaline earth metal-Al oxide composite supports, according to the materials and methods described elsewhere herein and using the same form factor. In these cases, the alkaline earth and/or spinel-forming metal used (Mg) may be represented by M, as described herein. The catalysts contained the same concentration of active metal, used the same form factor and were all subjected to the same high temperature calcination and reduction treatments. In some cases, the M-Al oxide composite support may comprise a commercial gamma-alumina support material (lines 3406, 3407, 3408 and 3409). In some cases, the M-Al oxide composite support may comprise an in-house gamma-alumina support material (lines 3401, 3402 and 3403). The M-Al oxide composite support may comprise a M to Al mass ratio of 50:50 (line 3401), 55.5:44.5 (line 3402), 60:40 (line 3403), 47:53 (line 3406), 52:48 (line 3407), 85.5:14.5 (line 3408), or 52:48 (line 3409). One of the catalysts (line 3409) was prepared using RuCl₃ as the active metal precursor, while the others used Ru(NO)(NO₃)₃. The performance of the catalysts comprising M-Al oxide composite supports may be compared with the performance of benchmark competitive, high performance, ammonia decomposition catalysts on the same form factor. The benchmark catalysts contained Ru as the active metal on a gamma-alumina and/or theta-alumina supports, doped with rare earth metal support surface modifiers, (lines 3404 and 3405). One of the benchmark catalysts was promoted with an alkali metal, (line 3405).

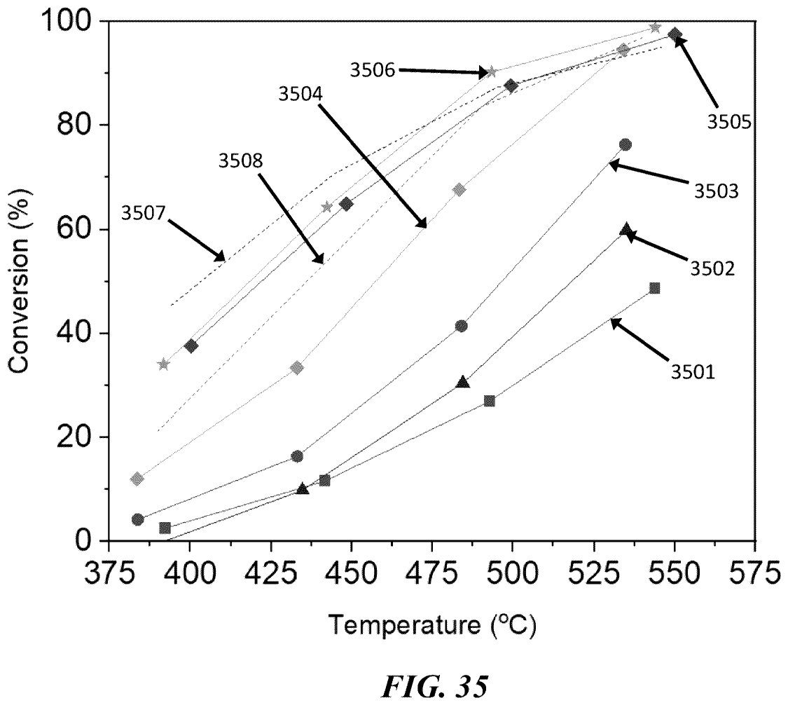

FIG. 35 shows the effect of the metal ratio on ammonia conversion efficiency for Ru catalysts prepared with alkaline earth and/or spinel-forming metal and aluminum (M-Al) mixed metal oxide composite supports based on gamma-alumina support material. The results indicate that there may be a range of concentrations for the alkaline earth and/or spinel-forming metal that is most effective for improvement of ammonia conversion efficiency. Interestingly, at lower molar ratios of M to Al, differences in catalyst conversion efficiency became more significant as temperature increased from about 425 to about 550° C. At higher molar ratios of M to Al, differences between conversion efficiency became smaller as temperature increased from about 400 to about 550° C. Catalysts with a M to Al molar ratio greater than 1:1 were the most effective below 525° C. and matched or outperformed two benchmark competitive catalysts above about 475° C.

With respect to FIG. 35, catalysts may be prepared with alkaline earth and/or spinel-forming metal-Al mixed metal oxide composite supports, according to the materials and methods described elsewhere herein and using the same form factor. In these cases, the alkaline earth and/or spinel-forming metal (Mg) may be represented by M, as described herein. The catalysts contained the same concentration of active metal, used the same form factor and were all subjected to the same high temperature calcination and reduction treatments. The M-Al mixed metal oxide composite supports may comprise a range of molar ratios for M and Al: 0.25:1 (line 3501), 0.75:1 (line 3502), 0.5:1 (line 3503), 1:1 (line 3504), 1.25:1 (line 3505), or 1.5:1 (line 3506). The performance of the catalysts comprising M-Al oxide composite supports may be compared with the performance of benchmark competitive, high performance, ammonia decomposition catalysts on the same form factor. The benchmark catalysts contained Ru as the active metal on a gamma-alumina and/or theta-alumina supports, doped with rare earth metals (lines 3507 and 3508). One of the benchmark catalysts was promoted with an alkali metal (line 3507).

### Advantages of Zr-Based Support

In some embodiments, the zirconia or ZrₓO_{y} may comprise a high thermal stability. In some cases, the thermal stability may impart stability properties to the catalyst. In some instances, the thermal stability may reduce a rate of mechanical defects forming or developing in the catalyst. In some cases, the thermal stability may reduce a rate of mechanical defect propagation in the catalyst (e.g., crack propagation). In some instances, the thermal stability may reduce a rate of undesirable phase transformations or other thermally-induced structural changes in the catalyst (e.g., diffusion and/or restructuring of surface structure of the catalyst, which can impact ammonia conversion efficiency of the catalyst). In some embodiments, the zirconia or ZrₓO_{y} may comprise a low thermal expansion coefficient. In some instances, the zirconia or ZrₓO_{y} may comprise a thermal expansion coefficient of at most about 1 e⁻⁶, 2 e⁻⁶, 3 e⁻⁶, 4 e⁻⁶, 5 e⁻⁶, 6 e⁻⁶, 7 e⁻⁶, 8 e⁻⁶, 9 e⁻⁶, 10 e⁻⁶, 11 e⁻⁶, 12 e⁻⁶, 13 e⁻⁶, 14 e⁻⁶, or 15 e⁻⁶/K. In some instances, the support may comprise a thermal expansion coefficient of at most about 1 e⁻⁶, 2 e⁻⁶, 3 e⁻⁶, 4 e⁻⁶, 5 e⁻⁶, 6 e⁻⁶, 7 e⁻⁶, 8 e⁻⁶, 9 e⁻⁶, 10 e⁻⁶, 11 e⁻⁶, 12 e⁻⁶, 13 e⁻⁶, 14 e⁻⁶, or 15 e⁻⁶/K. In some cases, the zirconia or ZrₓO_{y} may comprise a high melting point. In some cases, the support may comprise a melting point of at least about 2000, 2100, 2200, 2300, 2400, 2500, 2600, 2700, 2800, 2900, 3000, 3100, 3200, or 3300° C. In some cases, the support may comprise a melting point of at most about 2000, 2100, 2200, 2300, 2400, 2500, 2600, 2700, 2800, 2900, 3000, 3100, 3200, or 3300° C.

In some instances, the zirconia or ZrₓO_{y} may comprise a density of about 5.68 g/cm³. In some instances, zirconia or ZrₓO_{y} comprises 1.5 to about 3 times higher density than some other supports (e.g., Al₂O₃ can have a density of about 3.95 g/cm³, SiO₂ can have a density of about 2.65 g/cm³ and activated carbon can have a density of about 2 g/cm³). In some cases, high densities for catalysts may enable compact reformer designs, and increased ammonia conversion efficiencies. In a fixed volume such as a reformer, a denser catalyst may have an increased surface area and/or increased catalyst weight, which may increase the amount of catalyst available for ammonia conversion. In some cases, a reformer may comprise a catalyst at a density of about 0.7 g/mL to about 1.4 g/mL. In some cases, a reformer may comprise a catalyst at a density of about 0.85 g/mL to about 1.25 g/mL with respect to the packing volume inside the reformer. In some instances, a reformer may comprise a catalyst at a density of about 0.5 g/mL to about 1.5 g/mL with respect to the packing volume inside the reformer. In some instances, a reformer may comprise a catalyst at a density of less than about 0.7 g/mL with respect to the packing volume inside the reformer. In some instances, a reformer may comprise a catalyst at a density of at least about 0.5, 0.6, 0.7, 0.8, 0.9, 1.0, 1.1, 1.2, 1.3, 1.4, or 1.5 g/mL. In some instances, a reformer may comprise a catalyst at a density of at most about 0.7, 0.8, 0.9, 1, 1.1, 1.2, 1.3, 1.4, or 1.5 g/mL.

In some cases, zirconia or ZrₓO_{y} may comprise a chemical resistance. In some cases, the chemical resistance may be an anti-corrosive property. In some cases, the chemical resistance may be against an acid (e.g., strong acids: nitric acid, hydrochloric acid, or sulfuric acid). In some instances, the chemical resistance may be against an organic solvent. In some instances, the chemical resistance may be against an alkaline environment. In some instances, the chemical resistance may impart stability properties to the catalyst. In some instances, the chemical resistance may reduce a rate of fouling of the catalyst when the catalyst is used for ammonia cracking. For example, ammonia provided to the catalyst may comprise trace amounts of contaminants. In some cases, the chemical resistance of the catalyst may slow down or prevent fouling by the contaminants. In some embodiments, the chemical resistance may reduce a rate of fouling of the catalyst when the catalyst is exposed to fouling contaminants. In some instances, the chemical resistance may reduce the corrosion of the catalyst during the reaction.

### Improvement of Ru Catalyst Efficiency

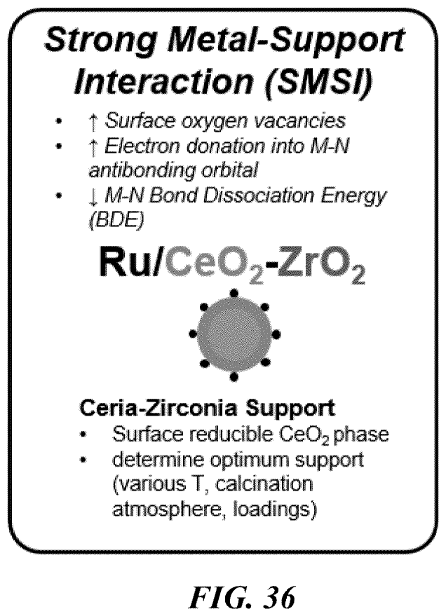

FIG. 36 provides examples of some strategies contemplated herein for improving the ammonia conversion efficiency of Ru, in accordance with some embodiments. In some instances, a catalyst may comprise a support (e.g., ruthenium may be provided on the support).

In some instances, the support may be configured to provide a strong metal-support interaction. In some embodiments, the strong metal-support interaction may alter or increase an ammonia conversion efficiency of the metal when the metal is provided on the support. In some cases, the support may be configured to change an electronic structure of a metal on the support. In some instances, changes in the electronic structure of the metal may increase ammonia conversion efficiency. In some cases, the support may shift a D-band center of the metal when the metal is provided on the support. In some instances, during an ammonia cracking reaction, a nitrogen atom may bind with a metal of the catalyst.

In some embodiments, the support may increase an electron occupancy of a metal-nitrogen antibonding orbital when the metal is provided on the support. In some instances, the support may be configured to provide the increased electron occupancy in the metal-nitrogen antibonding orbital during an ammonia conversion reaction. In some cases, this increased M-N antibonding orbital occupancy may facilitate nitrogen recombination and desorption.

### Oxygen Vacancies

In some embodiments, the support may comprise oxygen vacancies. In some instances, the support may comprise oxygen vacancies on the support surface. In some embodiments, the increased density of surface oxygen vacancies may reduce loss of active sites, e.g., during synthesis of the catalyst using the support and/or when the catalyst is in use. In some embodiments, the increased density of surface oxygen vacancies may increase an interaction between the metal and support, which may increase ammonia decomposition efficiency. In some embodiments, the oxygen vacancies may interact with a metal provided on the surface of the support. In some instances, the oxygen vacancies may contribute electrons to occupy a metal-nitrogen antibonding orbital. In some embodiments, the oxygen vacancies may comprise electropositive vacancies in the support. In some embodiments, the electropositive vacancies may contribute electron occupancy in the metal-nitrogen antibonding orbital. In some instances, the electropositive vacancies may increase the electron occupancy of the metal-nitrogen antibonding orbital when the nitrogen atom is bound to the metal. In some embodiments, the increased electron occupancy of the metal-nitrogen antibonding orbital may reduce a dissociation energy between the metal and the nitrogen atom. In some embodiments, the reduced dissociation energy between the metal and the nitrogen atom increases rates of nitrogen dissociation from the metal. In some embodiments, the reduced dissociation energy between the metal and the nitrogen atom increases the turnover frequency of the catalyst. In some instances, the reduced dissociation energy between the metal and the nitrogen atom increases the ammonia conversion efficiency of the catalyst. In some embodiments, the oxygen vacancies may reduce the activation energy of nitrogen desorption. In some case, the reduced activation energy of nitrogen desorption may increase the rates of ammonia decomposition reaction. In some case, the reduced activation energy of nitrogen desorption increases the turnover frequency of the catalyst. In some case, the reduced activation energy of nitrogen desorption increases the ammonia conversion efficiency. In some cases, the catalyst comprises oxygen vacancies at a concentration of about 0.1 mmol/g to about 10 mmol/g. In some cases, the catalyst comprises oxygen vacancies at a concentration of about 2 mmol/g to about 6 mmol/g.

The catalysts of the present disclosure may comprise oxygen vacancies at a concentration of at least about 0.01, 0.05, 0.1, 0.5, 1, 2, 3, 4, 5, 6, 7, 8, 9, 10, 20, 30, 40, 50, 60, 70, 80, or 90 or no more that 100 mmol/g. The catalysts of the present disclosure may comprise oxygen vacancies at a concentration of no more than about 0.05, 0.1, 0.5, 1, 2, 3, 4, 5, 6, 7, 8, 9, 10, 20, 30, 40, 50, 60, 70, 80, 90 or 100 mmol/g.

### Reducible Phase and Acid Sites

In some embodiments, the support may comprise a reducible phase on the surface of the support. In some instances, the support may comprise a reduced phase on the surface of the support. In some embodiments, the reducible phase may comprise a metal oxide (e.g., a reducible oxide). In some cases, the reducible phase may comprise ceria, iron oxide, titanium oxide, samarium oxide, molybdenum oxide, vanadia, chromia, or any combination thereof. In some cases, the reduced phase may partially comprise cerium, iron, vanadium, chromium, or any combination thereof. It is noted herein that the reduced phase may be partially reduced (for example, to a sub-stoichiometric CeₓO_{y} phase, where y<2).

Various processing conditions may be used (e.g., various temperatures, various calcinating conditions, various annealing conditions, and various loadings) to make the support. In some embodiments, a heat treatment under an anoxic atmosphere (e.g., annealing under inert gas such as N₂ or noble gas) may be used to reduce the reducible phase. In some embodiments, hydrogen gas may be used to reduce the reducible phase.

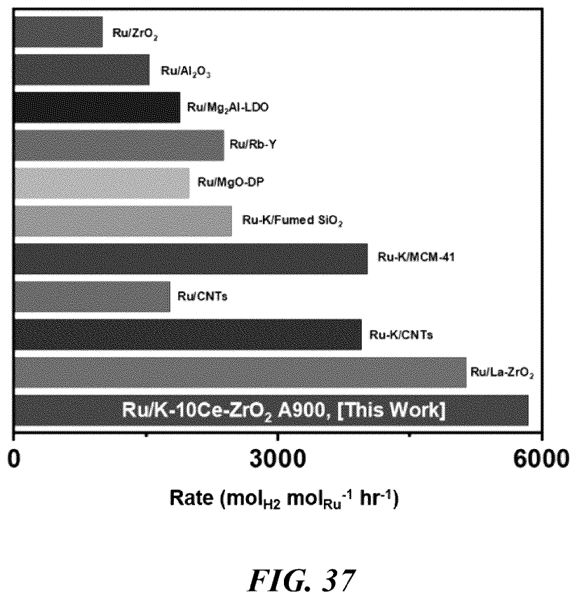

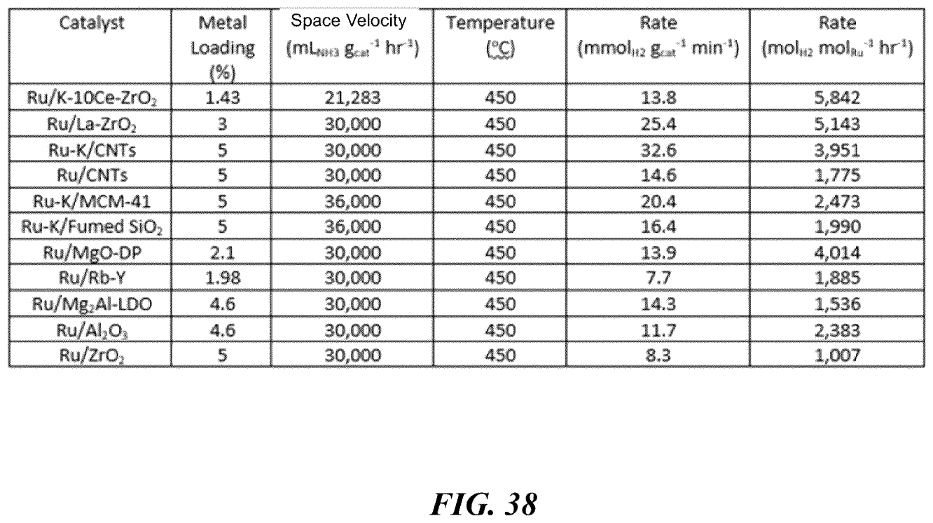

In some instances, reducing the reducible phase may lead to a reduction of strong acid sites on the surface of the support via formation of the tetragonal ZrO₂ phase. In some cases, the reduction of strong acid sites on the surface of the support may increase ammonia conversion efficiency. FIG. 37 is a bar chart showing a comparison of hydrogen production rates of various catalysts with the same Ru concentration, prepared according to the materials and methods described herein and in accordance with some embodiments. For example, under some measurement conditions, one of the ammonia decomposition catalyst embodiments disclosed herein (Ru/K-10Ce-ZrO₂ A900), exceeds the hydrogen production rates of other ammonia decomposition catalysts. FIG. 38 is a table showing the conditions at which the catalysts shown in FIG. 37 were tested, in accordance with some embodiments. It is noted that the hydrogen generation rate (about 1000 mol_{H2} mol_{Ru}⁻¹ hr⁻¹) of the basic Ru/ZrO₂ catalyst was the lowest of any of the catalysts tested. However, the same catalyst doped with La demonstrated significantly improved performance (hydrogen generation rate of about 5000 mol_{H2} mol_{Ru}⁻¹ hr⁻¹). Among the catalysts shown in FIGS. 37 and 38, the Ru/K-10Ce-ZrO₂ A900 catalyst showed the highest hydrogen production rate (almost 6000 mol_{H2} mol_{Ru}⁻¹ hr⁻¹), even though the Ru/K-10Ce-ZrO₂ A900 catalyst comprised 1-3 mm extrudates in this experiment. Meanwhile, some of the other catalysts were powders. In some cases, structured catalysts comprising foam, bead, and/or pellet form factors may be associated with lower activity or ammonia conversion efficiency than catalysts in powder-form, for example, when large form factors may incur mass transfer limitations and/or pore network change in the fabrication process. In some cases, a pore network change may entail a pore collapse that “traps” ruthenium nanoparticles in the interior of the bead and/or pellet, which may result in less active metal available for ammonia conversion (by reducing active metal surface area) and may result in a lower ammonia conversion efficiency per mass of deposited ruthenium metal (or per moles of deposited ruthenium metal). Even so, some catalysts of the present disclosure that comprise larger form factors (e.g., beads, pellets, etc.) may exhibit high ammonia catalytic activities that are comparable to, or capable of outperforming, some catalysts in powder-form.

### Use of Ce as a Dopant and Support Surface Modifier

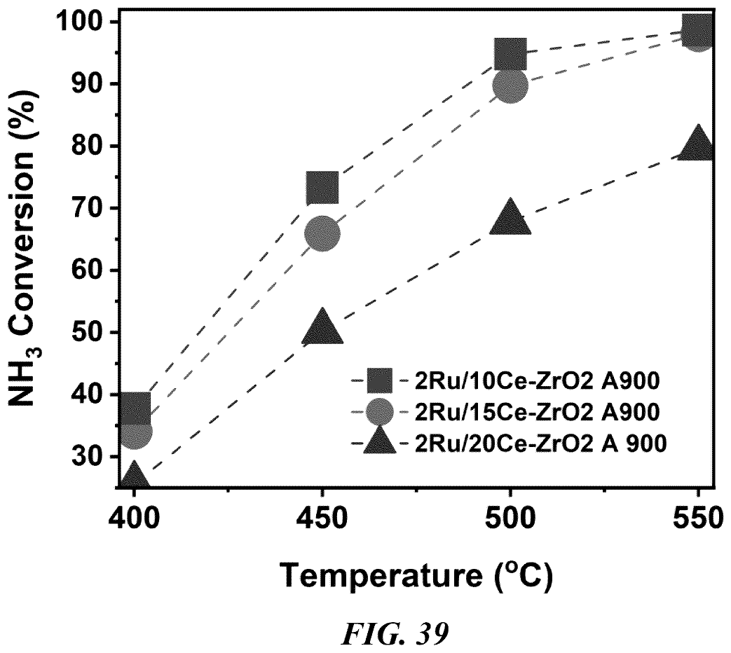

The ammonia conversion efficiency of catalysts, as shown in FIG. 39, increased in the following order: Ru/ZrO₂, Ru/20Ce—ZrO₂, Ru/15Ce—ZrO₂, then Ru/10Ce—ZrO₂. In some cases, this trend may correlate with incorporation of cerium into the ZrₓO_{y} framework to generate a solid solution, which may be determined using pXRD. In some cases, the ammonia conversion efficiency may correlate with the total intensity of the pXRD signals that indicate a tetragonal (Zrₓ:Ce_{y})O_{z} network in the support.

In some embodiments, the support comprises Al, Si, Zr, Ce, C, or O. In some embodiments, the support may comprise an oxide such as AlₓO_{y}, SiₓO_{y}, ZrₓO_{y} and a reducible oxide such as CeₓO_{y}, VₓO_{y}, or CrₓO_{y} (e.g., a reducible oxide that forms oxygen vacancies under an annealing or reducing heat treatment), wherein x and y are numbers greater than zero. In some embodiments, the support may comprise at least one of Al₂O₃, SiO₂, ZrO₂, CeO₂, V₂O₅, TiO₂, Sm₂O₃, MoO₃, or CrO₃ or carbon. In some cases, the support may comprise at least one of TiₓO_{y}, SmₓO_{y}, or MoₓO_{y}. In some instances, the support comprises ZrₓO_{y} having an amorphous, monoclinic, and/or tetragonal phase. In some embodiments, the support comprises zirconia (ZrO₂). In some instances, ZrₓO_{y} may comprise a high solubility with Ce or CeₓO_{y}. In some cases, ZrₓO_{y} and CeₓO_{y}, when mixed, may form an incorporated network structure. In some embodiments, ZrₓO_{y} and CeₓO_{y}, when mixed, may form a solid solution. In some cases, a solid solution may comprise a uniform distribution of the cerium dopant. In some instances, the cerium dopant may be highly dispersed. In some embodiments, the cerium dopant may form small nanoparticles. In some instances, the support may comprise an increased density of surface oxygen vacancies compared to a zirconia phase when doped with CeₓO_{y}. In some embodiments, the solid solution may comprise a high number of oxygen vacancies.

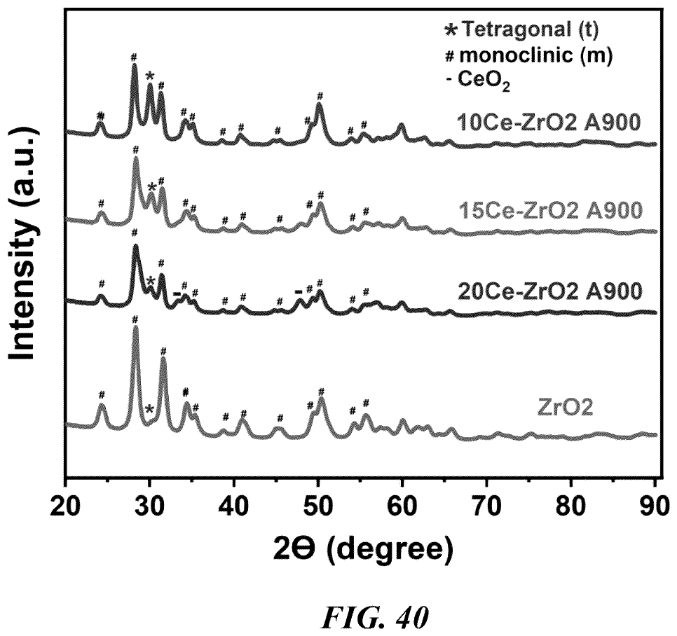

FIG. 40 shows powder XRD (pXRD) spectra of supports comprising varying amounts of CeₓO_{y} with ZrₓO_{y}, in accordance with some embodiments. A series of supports comprising differing amounts of CeₓO_{y} were synthesized, and pXRD was performed to characterize the supports. The pXRD spectra did not display a prominent peak that would indicate a large presence of CeₓO_{y}. The pXRD spectra may indicate that the cerium is distributed substantially uniformly in the supports. Alternatively, the pXRD spectra may indicate that any of the CeₓO_{y} phases that are present comprise dimensions that are below the detectable limit of the pXRD instrumentation (e.g., less than 2 nm in a characteristic dimension or aspect ratio), or that the density of particles over 2 nm may be low. In comparison, some other support materials (e.g., CeO₂—Al₂O₃) may display pXRD signals that indicate CeₓO_{y} phases. In the example of CeO₂—Al₂O₃, CeO₂ peaks may be observed even when the supports are calcinated at low temperatures (e.g., below 600° C.). The results shown in FIG. 40 may indicate that CeₓO_{y} and ZrₓO_{y} can form a solid solution (i.e., cerium incorporated into ZrₓO_{y}; denoted (Zrₓ:Ce_{y})O_{z}), which may allow stronger metal-support interactions (e.g., via the oxygen vacancies).

### Effect of Using Ce Dopant on a Zr-Based Support

In some instances, the support may comprise CeₓO_{y}. In some embodiments, the support may comprise CeO₂. In some cases, the support may be doped with CeₓO_{y}. In some instances, the support comprises a solid solution of ZrₓO_{y} and CeₓO_{y}. In some instances, the ZrₓO_{y} and the CeₓO_{y} may be substantially mixed. In some embodiments, the ZrₓO_{y} and the CeₓO_{y} may be substantially mixed to a degree such that the ZrₓO_{y} and the CeₓO_{y} form a continuous phase. In some cases, the continuous phase does not comprise one or more grain boundaries therein. In some instances, the support may comprise a homogeneous phase comprising zirconium and cerium in an oxide network. In some embodiments, the oxide network may comprise a tetragonal crystal structure. In some cases, the support may comprise a heterogenous phase comprising regions comprising ZrₓO_{y} and regions comprising CeₓO_{y}. In some instances, the heterogenous phase may comprise a ZrₓO_{y} matrix and CeₓO_{y} phases embedded therein.

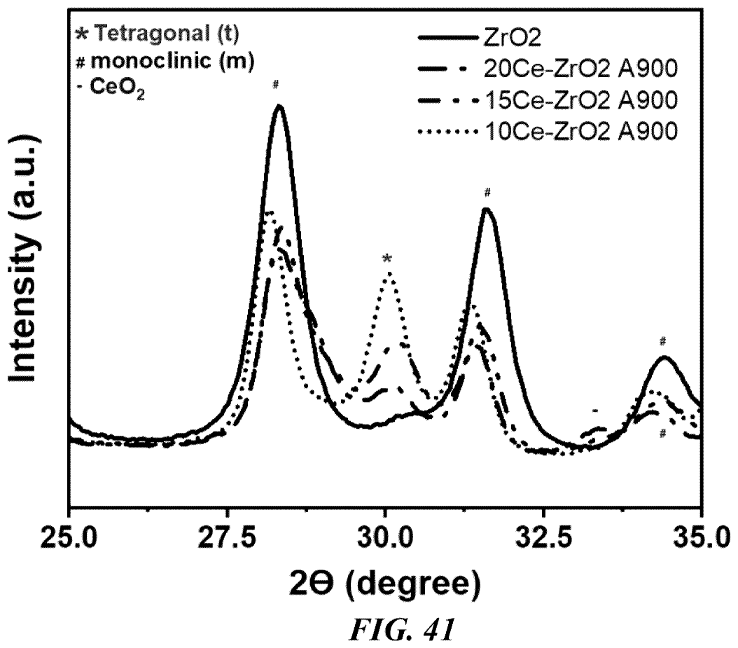

In some instances, a support may comprise a metal oxide phase. FIG. 41 shows pXRD spectra of supports comprising varying amounts of CeₓO_{y} with ZrₓO_{y}, in accordance with some embodiments. Doping of ZrₓO_{y} with cerium may incorporate the cerium into a lattice of the ZrₓO_{y} and a shift of a pXRD peak of the lattice framework towards a lower angle of diffraction. Upon doping ZrO₂ support with a low concentration of Ce, a peak shift towards lower angles of diffraction was observed, consistent with doping of the cerium atoms into the ZrₓO_{y} lattice. Increasing the doping of Ce to an intermediate concentration led to the peaks shifting to the right, which is closer to the results of the control group (undoped ZrₓO_{y}), and on increasing the doping of Ce to the highest concentration, new peaks for CeₓO_{y} were observed. The result at the highest concentration of Ce may indicate exsolution/agglomeration of the cerium from the lattice to generate discrete CeₓO_{y} nanoparticles on the support. It may also be possible that CeₓO_{y} ceria nanoparticles are produced on the surface of the material doped with an intermediate level of Ce, but that the nanoparticles are smaller than the size limit of detection of the powder-XRD instrumentation (approximately 2 nm). It was observed that when the concentration of Ce is decreased from the highest to the lowest level, the strength of the XRD signal that is associated with the tetragonal phase of ZrₓO_{y} (star) was increased. It was observed that in the absence of Ce, the XRD signal that indicates tetragonal phase of ZrₓO_{y} can be non-prominent or absent. Without being bound to a particular theory, the tetragonal phase of ZrₓO_{y} could be caused by (Zrₓ:Ce_{y})O_{z} (i.e., solid solution of ZrₓO_{y} and CeₓO_{y}) comprising a tetragonal network structure. The tetragonal phase may indicate that there is strong grafting of ceria on the ZrₓO_{y} surface. At the highest ceria loading, an XRD signal indicating excess CeₓO_{y} was detected. Similarly, the tetragonal network of the (Zrₓ:Ce_{y})O_{z} may induce a concentration of oxygen vacancies and/or high density of surface oxygen vacancies in the support. In some cases, the concentration of oxygen and/or high density of surface oxygen vacancies may increase a strength of the metal-support interaction.

In some cases, a significant portion of the CeₓO_{y} phases may comprise a characteristic dimension (length or diameter) of at least about 1, 2, 3, 4, 5, 6, 7, 8, 9, 10, 100, 1000, or 10000 nm. In some cases, a significant portion of the CeₓO_{y} phases may comprise a characteristic dimension (length or diameter) of at most about 1, 2, 3, 4, 5, 6, 7, 8, 9, 10, 100, 1000, or 10000 nm. In some cases, a significant portion of the CeₓO_{y} phases may comprise an aspect ratio of at least about 1:5, 1:4, 1:3, 1:2, 1:1, 2:1, 3:1, 4:1, 5:1, 10:1, 15:1, 20:1, 25:1, 30:1, 35:1, 40:1, or 45:1. In some cases, a significant portion of the CeₓO_{y} phases may comprise an aspect ratio of not more than about 1:4, 1:3, 1:2, 1:1, 2:1, 3:1, 4:1, 5:1, 10:1, 15:1, 20:1, 25:1, 30:1, 35:1, 40:1, 45:1 or 50:1. In some embodiments, the significant portion of the CeₓO_{y} phases may be at least about 5, 10, 20, 30, 40, 50, 60, 70, 80, 90, or 95 by wt %, vol %, or % by count. In some embodiments, the significant portion of the CeₓO_{y} phases may be not more than about 10, 20, 30, 40, 50, 60, 70, 80, 90, 95, or 99 by wt %, vol %, or % by count. In some embodiments, the heterogenous phase may comprise a CeₓO_{y} matrix and ZrₓO_{y} phases embedded therein. In some cases, the ZrₓO_{y} phases may comprise a characteristic dimension (length or diameter) of at least about 1, 2, 3, 4, 5, 6, 7, 8, 9, 10, 100, 1000, or 10000 nm. In some cases, the ZrₓO_{y} phases may comprise a characteristic dimension (length or diameter) of at most about 1, 2, 3, 4, 5, 6, 7, 8, 9, 10, 100, 1000, or 10000 nm. In some cases, a significant portion of the ZrₓO_{y} phases may comprise an aspect ratio of at least about 1:5, 1:4, 1:3, 1:2, 1:1, 2:1, 3:1, 4:1, 5:1, 10:1, 15:1, 20:1, 25:1, 30:1, 35:1, 40:1, or 45:1. In some cases, a significant portion of the ZrₓO_{y} phases may comprise an aspect ratio of not more than about 1:4, 1:3, 1:2, 1:1, 2:1, 3:1, 4:1, 5:1, 10:1, 15:1, 20:1, 25:1, 30:1, 35:1, 40:1, 45:1 or 50:1. In some embodiments, the significant portion of the ZrₓO_{y} phases may be at least about 5, 10, 20, 30, 40, 50, 60, 70, 80, 90, or 95 by wt %, vol %, or % by count. In some embodiments, the significant portion of the ZrₓO_{y} phases may be not more than about 10, 20, 30, 40, 50, 60, 70, 80, 90, 95, or 99 by wt %, vol %, or % by count. In some cases, the ZrₓO_{y} matrix may comprise a percolating network. In some instances, the CeₓO_{y} phase may comprises a non-percolating network.

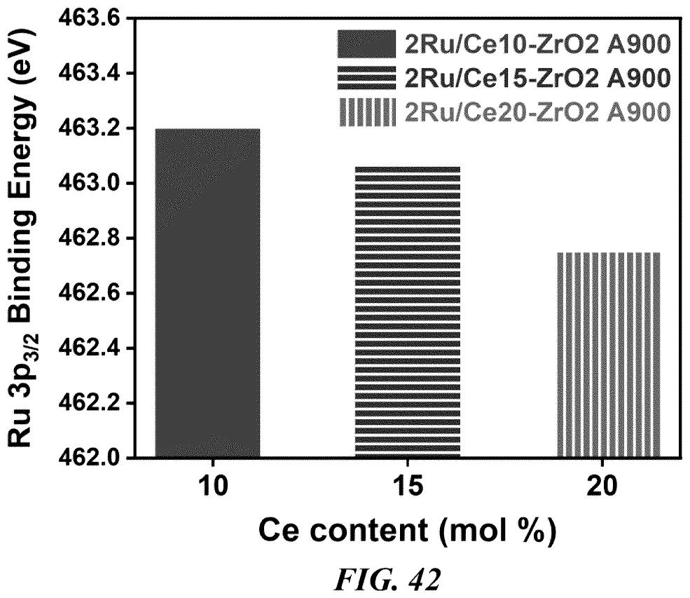

FIG. 42 shows electron binding energy for electrons in the 3P_{3/2} orbital of ruthenium provided on the supports measured using X-Ray Photoelectron Spectroscopy (XPS), in accordance with some embodiments. In some embodiments, the tetragonal (Zrₓ:Ce_{y})O_{z} network may provide a strong metal-support interaction. The Ru/10Ce—ZrO₂, which was measured to have the highest content of the tetragonal (Zrₓ:Ce_{y})O_{z} network among the catalysts shown in FIG. 42, had the highest binding energy, which may indicate that Ru strongly interacts with the 10Ce—ZrO₂ support. Without being bound to a particular theory, the solid solution comprising (Zrₓ:Ce_{y})O_{z} in the tetragonal phase may provide an electron poor environment on a surface of the support, to allow the Ru to interact strongly with the support. In some embodiments, the tetragonal phase of ZrₓO_{y} may have a lower hydroxyl group surface density than a monoclinic phase of ZrₓO_{y}. In some cases, a hydroxyl group may be a Brønsted acid site. In some cases, high density of the strong acid sites may reduce the ammonia conversion efficiency of the catalyst (and may reduce the rate of the ammonia decomposition reaction). In some instances, the transformation from monoclinic ZrₓO_{y} to tetragonal ZrₓO_{y} may promote ammonia conversion efficiency by reducing hydroxyl group surface density.

In some cases, the support comprising ceria (CeₓO_{y}) may reduce a binding energy of an electron in a 3P_{3/2} orbital of one or more active metal particles. In some instances, the support comprising the (CeₓO_{y}) may increase the metal-support interaction. In some cases, the CeₓO_{y} may be configured to reduce a metal-nitrogen binding energy during an ammonia cracking reaction. In some cases, the CeₓO_{y} may be configured to increase electron occupancy in a metal-nitrogen anti-bonding molecular orbital during an ammonia cracking reaction. In some instances, the CeₓO_{y} of a CeₓO_{y}-doped ZrₓO_{y} (or zirconia) support may be partially reduced for example, Ce(IV) may be converted to Ce(III) with a concurrent loss of oxygen to generate CeO₍₂₋ₓ₎. In the case of a (Zr:Ce)O₂ doped phase, the cerium cations may be reduced with a loss of oxygen to generate oxygen vacancies. It is noted that Ce metal may not be generated by the reduction and loss of oxygen.

In some instances, one or more XRD peaks of the catalyst doped with CeₓO_{y} may comprise a lower angle of diffraction compared to one or more corresponding XRD peaks of an undoped catalyst. In some instances, one or more XRD peaks of zirconia in Ru/Ce doped zirconia catalyst may comprise a lower angle of diffraction compared to one or more corresponding XRD peaks of an undoped catalyst. In some embodiments, the catalyst comprising the molar ratio of the Ce to the ZrO₂ of about 20:80 is configured to produce a detectable XRD peak of CeₓO_{y}. In some embodiments, the catalyst comprises Ce at an amount of at least about 1, 5, 10, 20, 30, 40, 50 mols of Ce per 100 mols of ZrO₂. In some instances, the catalyst comprises Ce at an amount of at least about 10, 20, 30, 40, 50, 60, 70, 80, or 90 mols of Ce per 100 mols of Ce and ZrO₂. In some instances, the catalyst comprises Ce at an amount of at most about 10, 20, 30, 40, 50, 60, 70, 80, or 90 mols of Ce per 100 mols of Ce and ZrO₂. In some cases, the catalyst comprises ZrO₂ at an amount of at least about 1, 5, 10, 20, 30, 40, 50 mols of ZrO₂ per 100 parts of Ce mols ZrO₂. In some cases, the catalyst comprises ZrO₂ at an amount of at least about 10, 20, 30, 40, 50, 60, 70, 80, or 90 mols of ZrO₂ per 100 parts of Ce mols ZrO₂. In some instances, the catalyst comprises ZrO₂ at an amount of at most about 1, 5, 10, 20, 30, 40, 50, 60, 70, 80, or 90 mols of ZrO₂ per 100 parts of Ce mols ZrO₂. In some embodiments, the layer deposited adjacent to the support comprises a molar ratio of Ce to Zr ranging from about 1:2 to about 1:25. In some embodiments, the layer deposited adjacent to the support comprises a molar ratio of Ce to Zr ranging from about 1:4 to about 1:20. In some embodiments, the layer deposited adjacent to the support comprises a molar ratio of Ce to Zr ranging from about 1:6 to about 1:16. In some embodiments, the layer deposited adjacent to the support comprises a molar ratio of Ce to Zr ranging from about 1:8 to about 1:12. In some embodiments, the layer deposited adjacent to the support comprises a molar ratio of Ce to Zr ranging from about 1:9 to about 1:11. In some embodiments, the layer deposited adjacent to the support comprises a molar ratio of Ce to Zr of about 1:10.

In some embodiments, the support comprises a layer provided on the support. In some cases, the layer comprises ZrₓO_{y}. In some instances, the layer comprises zirconia. In some embodiments, the layer comprises CeₓO_{y}. In some instances, the layer comprises ceria. In some embodiments, the layer comprises ZrₓO_{y} doped with cerium (Ce) and oxygen (O). In some instances, the layer comprises a solid solution of ZrₓO_{y} and CeₓO_{y}. In some embodiments, the ZrₓO_{y} may be doped with CeₓO_{y}. In some cases, the ZrₓO_{y} and the CeₓO_{y} may be partially mixed. In some cases, the layer may comprise a heterogenous phase comprising regions of the ZrₓO_{y} and regions of the CeₓO_{y}. In some instances, the layer may comprise a thickness of at least about 1, 10, 100, 1000, 10000 nm. In some instances, the layer may comprise a thickness of at most about 1, 10, 100, 1000, 10000 nm.

In some embodiments, a molar ratio of Ce to Zr in the layer ranges from about 1:5 to about 1:25. In some embodiments, the molar ratio of the Ce to the Zr ranges from about 1:8 to about 1:12. In some embodiments, a molar ratio of Ce to Zr in the layer is at least about 1:2, 1:3, 1:4, 1:5, 1:6, 1:7, 1:8, 1:9, 1:10, 1:11, 1:12, 1:13, 1:14, 1:15, 1:20, 1:25, 1:30, 1:35, 1:40, 1:45, 1:50, 1:60, 1:70, 1:80, 1:90, or 1:100. In some embodiments, a molar ratio of Ce to Zr in the layer is at most about 1:2, 1:3, 1:4, 1:5, 1:6, 1:7, 1:8, 1:9, 1:10, 1:11, 1:12, 1:13, 1:14, 1:15, 1:20, 1:25, 1:30, 1:35, 1:40, 1:45, 1:50, 1:60, 1:70, 1:80, 1:90, or 1:100.

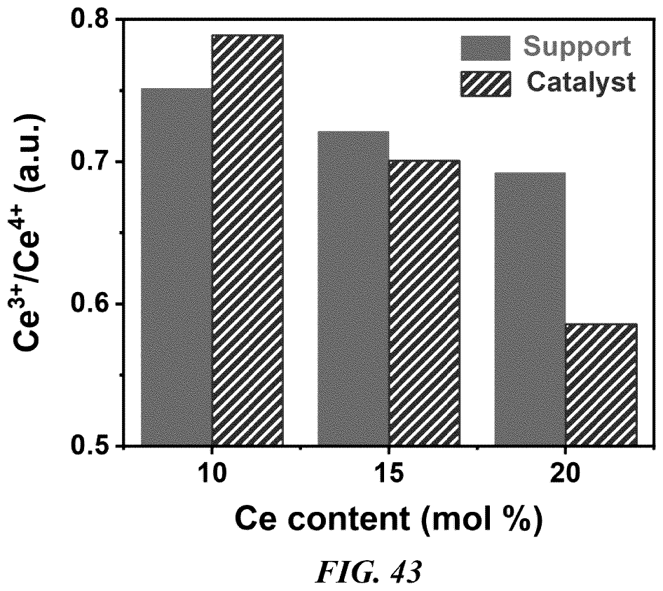

In some embodiments, synthesis of (Zrₓ:Ce_{y})O_{z} may be performed to create nanoparticles of CeO₂ on the surface. In some cases, the nanoparticles may comprise a size that is below a spatial resolution of analytic instruments (e.g., pXRD machines). In some instances, reducing cerium content increases the Ce³⁺/Ce⁴⁺ ratio. FIG. 43 shows Ce³⁺/Ce⁴⁺ ratio determined using XPS, in accordance with some embodiments. In some instances, high Ce³⁺/Ce⁴⁺ ratio may indicate a small particle size. In some instances, small nanoparticles of cerium may cause high Ce³⁺/Ce⁴⁺ ratios. In some instances, a high Ce³⁺/Ce⁴⁺ ratio may be associated with high dispersion of cerium with the small nanoparticle. In some instances, Ce³⁺/Ce⁴⁺ ratio and/or high dispersion of cerium may be correlated with ammonia conversion efficiency and the strength of the metal-support interaction, as derived from ruthenium binding energies (e.g., as measured with XPS). In some embodiments, the Ce³⁺/Ce⁴⁺ ratio, the strength of the metal-support interaction, and the ammonia conversion efficiency may increase in the order comprising: Ru/Ce20-ZrO₂, Ru/Ce15-ZrO₂, then Ru/Ce10-ZrO₂. In some embodiments, a high Ce³⁺/Ce⁴⁺ ratio and/or high dispersion of Ce caused by small nanoparticles of CeₓO_{y} can indicate a large number of surface oxygen vacancies. In some instances, dispersing Ce may reduce the loss of active sites via wetting of the ruthenium by the support and induce the strong-metal support interaction.

In some embodiments, the layer comprises an amorphous structure, a monoclinic structure, and/or a tetragonal network structure of (Zrₓ:Ce_{y})O_{z}. In some cases, the layer comprises a plurality of nanoparticles comprising CeO₂. In some embodiments, the layer comprises Ce³⁺ ions and Ce⁴⁺ ions, wherein a ratio of the Ce³⁺ ions to the Ce⁴⁺ ions range from about 0.3:1 to about 0.9:1. In some embodiments, the ratio ranges from about 0.7:1 to about 0.8:1. In some embodiments, the ratio is about 0.75:1. In some embodiments, the ratio of the Ce³⁺ ions to the Ce⁴⁺ ions is at least about 0.2:1, 0.3:1, 0.4:1, 0.5:1, 0.6:1, 0.7:1, 0.8:1, 0.9:1, or 1:1. In some embodiments, the ratio of the Ce³⁺ ions to the Ce⁴⁺ ions is at most about 0.2:1, 0.3:1, 0.4:1, 0.5:1, 0.6:1, 0.7:1, 0.8:1, 0.9:1, or 1:1.

### Effect of Heat Treatment

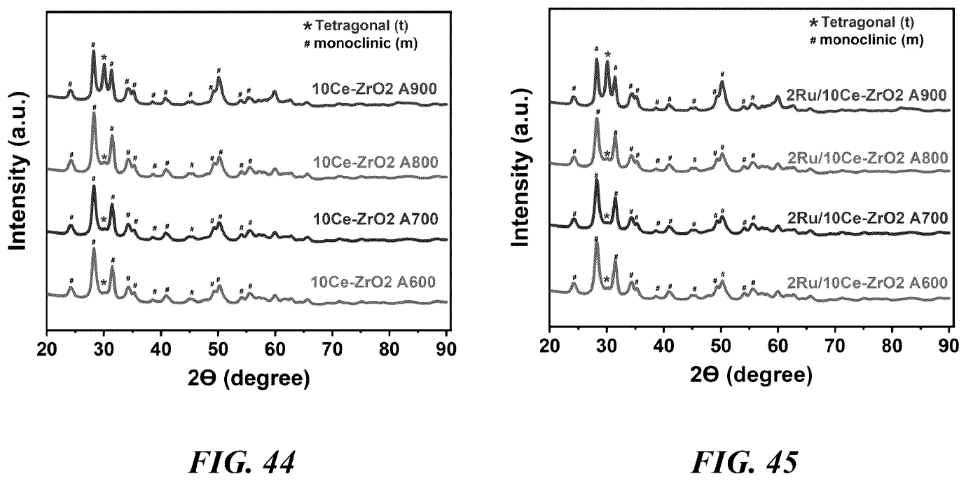

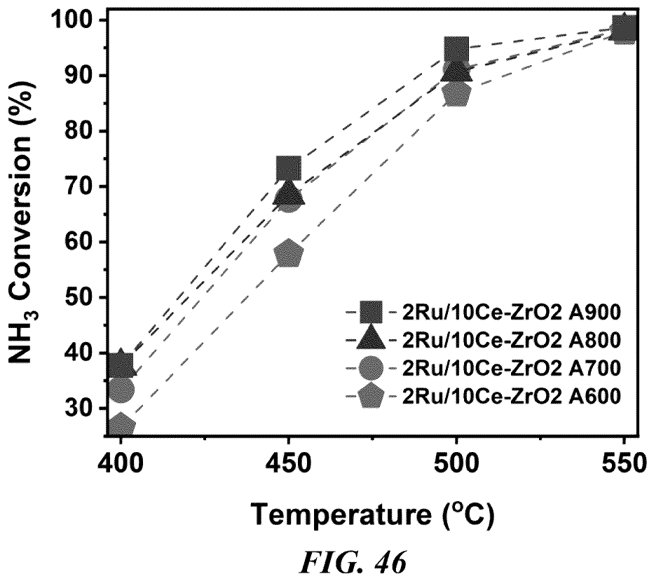

FIGS. 44 and 45 show powder X-ray diffraction (pXRD) spectra of supports and catalysts annealed under various temperatures, respectively, in accordance with some embodiments. Experiments were conducted to investigate the effects of heat treatment temperature on the support or catalyst structure. In some cases, increasing the heat treatment temperature increases the XRD signal (asterisk) for the tetragonal phase of ZrₓO_{y}. In some embodiments, increasing heat treatment temperatures increased the ammonia conversion efficiency of the catalyst, as shown in FIG. 46. In some instances, the correlated relationship between the tetragonal (Zrₓ:Ce_{y})O_{z} phase and ammonia conversion efficiency in the different test results indicated that the high tetragonal network of the (Zrₓ:Ce_{y})O_{z} mixture oxide leads to a reduction in strong acid sites and facilitates the kinetics of the ammonia decomposition reaction. In some embodiments, the ammonia conversion efficiency of samples increased in the following order: Ru/10Ce—ZrO₂ A600, Ru/10Ce—ZrO₂ A700, Ru/10Ce—ZrO₂ A800, then Ru/10Ce—ZrO₂ A900. In some cases, the catalytic performance correlated with the total intensity of the tetragonal (Zrₓ:Ce_{y})O_{z} network XRD signal of the support. Without being bound to a particular theory, the correlated relationship between the tetragonal (Zrₓ:Ce_{y})O_{z} phase and catalytic performance in the different test results may be due to the tetragonal network of the (Zrₓ:Ce_{y})O_{z} mixture oxide inducing strong metal-support interaction, thereby facilitating the kinetics of ammonia decomposition reaction.

### Incorporation of a Promoter

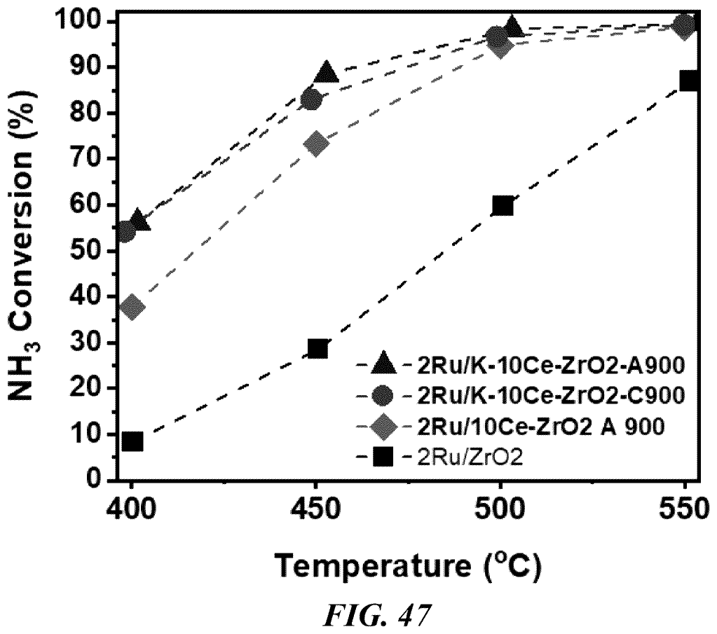

FIG. 47 shows ammonia conversion percentage versus temperature for various catalysts, in accordance with some embodiments. Experiments were conducted to compare various catalysts comprising CeₓO_{y}-doped ZrₓO_{y} supports, including a control catalyst comprising Ru/ZrO₂ (i.e., Ru supported on zirconia). Ammonia conversion efficiency was tested by applying ammonia to the catalyst with P_{NH3}=1 atm, with a space velocity=10000 mL_{NH3} g_{cat}⁻¹ hr⁻¹ (10 L_{NH3} g_{cat}⁻¹ hr⁻¹). In the range of temperatures investigated (from 400° C. to 550° C.), the catalysts comprising the CeₓO_{y}-doped ZrₓO_{y} supports provided increased ammonia conversion efficiency compared to the control catalyst (e.g., 2Ru/ZrO₂). In some instances, increasing the amount of Ru loaded in the catalyst can increase ammonia conversion efficiency. The ammonia conversion efficiency of samples increased in the following order: Ru/ZrO₂, Ru/10Ce—ZrO₂-C900, Ru/K-10Ce-ZrO₂-C900, then Ru/K-10Ce-ZrO₂-A900. In some instances, loading the catalyst with potassium (e.g., via coprecipitation of Ce(NO₃)₃ with KOH during support synthesis) to give a 1:1 molar ratio of promoter and active metal can improve ammonia conversion efficiency. For example, 2Ru—K/10Ce—ZrO₂-A900 and 2Ru/K-A900-10Ce-ZrO₂-A900 unexpectedly provide similar ammonia conversion efficiency as 8Ru/10Ce—ZrO₂-A900, enabling Ru content to be reduced by 75%, while maintaining a similar ammonia conversion efficiency. In some cases, a support comprising potassium increases ammonia conversion efficiency. In some instances, ammonia conversion efficiency may correlate with incorporation of cerium into the zirconia framework to generate a solid solution, as shown using pXRD.

In some cases, the ammonia conversion efficiency or the turnover frequency may be measured on a set of predetermined conditions. In some cases, the set of predetermined conditions may comprise temperature, ammonia pressure, ammonia flow rate, levels of one or more inert gases, or any combination thereof.

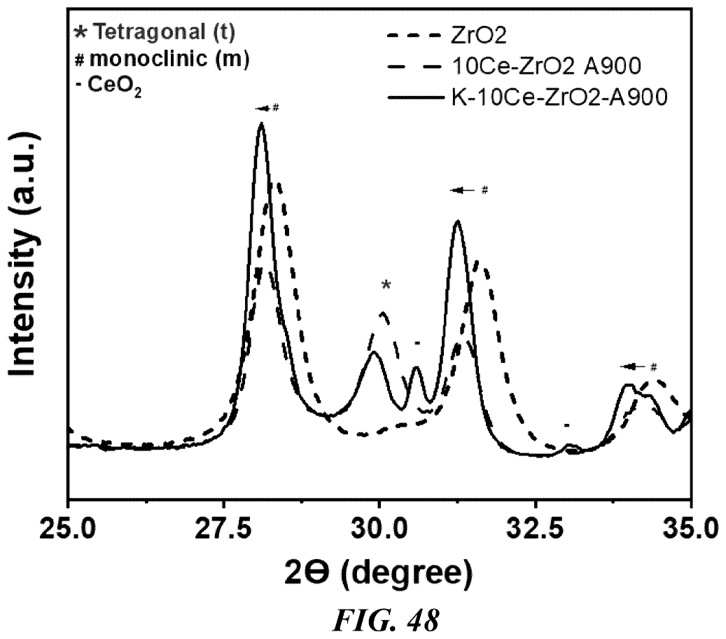

FIGS. 48 and 49 show powder X-ray diffraction (XRD) spectra, in accordance with some embodiments. In some instances, co-deposition of KOH with Ce(NO₃)₃ followed by heat treatment in a oxidizing atmosphere (e.g., air) results in an intermediate peak shift to the left, indicating incorporation of Ce into the zirconia matrix. In some instances, co-impregnation of KOH with Ce(NO₃)₃ followed by heat treatment in an inert atmosphere (e.g., N₂) results in an even further peak shift to the left, indicating more efficient incorporation of Ce into the zirconia matrix. In some instances, new peaks are observed corresponding to CeₓO_{y} in both K-doped samples. In some instances, the new peaks may be due to exsolution and/or agglomeration of the cerium from the lattice to generate discrete ceria nanoparticles on the support.

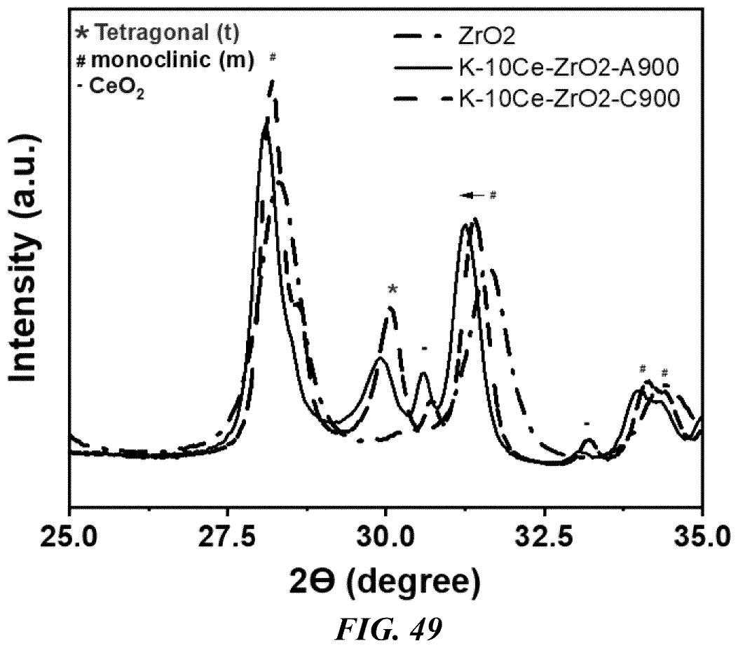

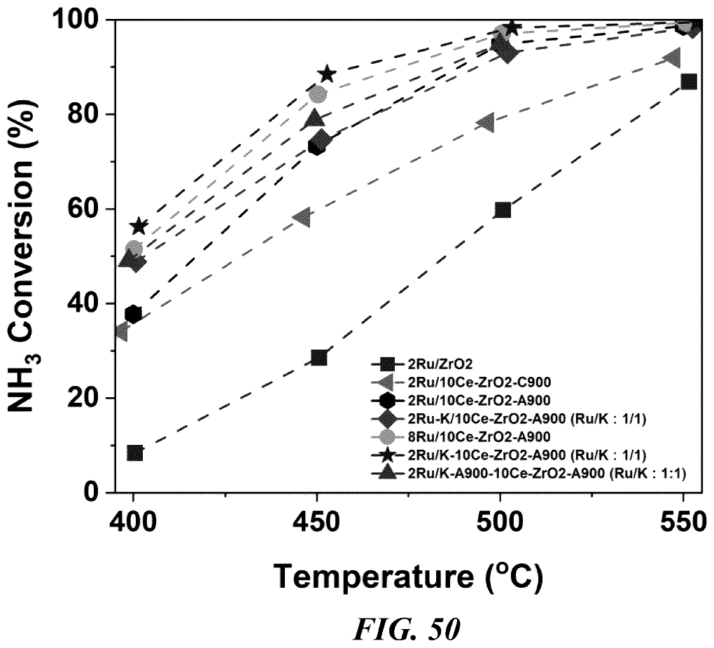

FIG. 50 shows ammonia conversion efficiency of various catalysts, in accordance with some embodiments. FIG. 51 shows electron binding energy for electrons in the 3p_{3/2} orbital of ruthenium provided on the supports measured using XPS, in accordance with some embodiments. In some instances, including an alkali promoter (e.g., potassium) can increase the basicity of a support. In some cases, increased basicity of the support may correlate with an increased electron density of the Ru sites surrounding basic sites (as determined from the lower Ru binding energy, measured via XPS). In some cases, the increased electron density of the Ru may improve the efficiency of a recombinative nitrogen desorption step by back-donation of electrons into the anti-bonding orbital of Ru—N. In some instances, the increased electron density of the Ru may weaken the N—H bond, which can promote N—H bond cleavage. In some embodiments, the catalyst comprises one or more promoters.

### Surface Effects

In some embodiments, the catalyst comprises a density of acid sites ranging from about 10 mol/g to about 1000 mol/g. In some instances, the density of acid sites is from about 50 mol/g to about 300 mol/g. In some embodiments, the density of acid sites is at least about 10, 20, 30, 40, 50, 60, 70, 80, 90, 100, 200, 300, 400, 500, 600, 700, 800, 900, or 1000 mol/g. In some embodiments, the density of acid sites is at most about 10, 20, 30, 40, 50, 60, 70, 80, 90, 100, 200, 300, 400, 500, 600, 700, 800, 900, or 1000 mol/g. In some instances, the one or more promoters modify a basicity of the support. In some embodiments, the one or more promoters comprise alkali metals and/or alkaline earth metals.

In some instances, the one or more active metals comprise Ru having a binding energy of 460 eV to 465 eV for an electron in a 3p_{3/2} orbital, Ni having a binding energy of 870 eV to 880 eV for an electron in a Ni 2p_{1/2} orbital, Rh having a binding energy of 305 eV to 315 eV for an electron in a Rh 3d_{3/2} orbital, Ir having a binding energy of 55 eV to 65 eV for an electron in a Ir 4f_{7/2} orbital, Co having a binding energy of 790 eV to 805 eV for an electron in a Co 2p_{1/2} orbital, Fe having a binding energy of 720 eV to 735 eV for an electron in a Fe 2p_{1/2} orbital, Pt having a binding energy of 67 eV to 75 eV for an electron in a Pt 4f_{7/2} orbital, Cr having a binding energy of 580 eV to 595 eV for an electron in a Cr 2p_{1/2} orbital, Mo having a binding energy of 225 eV to 240 eV for an electron in a Mo 3d_{3/2} orbital, Pd having a binding energy of 335 ev to 345 eV for an electron in a Pd 3d_{3/2} orbital, or Cu having a binding energy of 950 eV to 965 eV for an electron in a Cu 2p_{1/2} orbital.

### Selection of Components and Conditions

In some aspects, the present disclosure provides a method of producing a catalyst. In some embodiments, the method comprises using (i) CeₓO_{y} or a precursor(s) thereof and (ii) ZrₛOₜ or a precursor(s) thereof to produce a support comprising cerium (Ce), zirconium (Zr), and oxygen (O), wherein ‘x’, ‘y’, ‘s’, and ‘t’ are numbers greater than zero. In some embodiments, the method comprises heating the support to a target temperature. In some embodiments, the method comprises depositing one or more promoter precursors on the support to produce the catalyst. In some embodiments, the catalyst is configured to decompose ammonia to generate hydrogen. In some instances, the catalyst is configured to decompose ammonia to generate hydrogen and nitrogen.

In some embodiments, the processing is performed with an oxide comprising the CeₓO_{y} and the ZrₛOₜ. In some instances, the heating is performed in the presence of an inert gas phase. In some embodiments, the processing comprises doping the ZrₛOₜ with the CeₓO_{y} precursor to produce the support comprising CeₓO_{y} and ZrₛOₜ. In some instances, the processing comprises reacting the CeₓO_{y} precursor and the ZrₛOₜ precursor to produce the support comprising CeₓO_{y} and ZrₛOₜ.

In some cases, the CeₓO_{y} precursor comprises Ce(NO₃)₃, cerium nitrate hexahydrate, cerium nitrate x-hydrate, cerium chloride, cerium oxide, cerium oxide nanofiber, cerium fluoride, cerium chloride, cerium chloride heptahydrate, cerium chloride hydrate, cerium acetate hydrate, cerium sulfate, cerium nitrate hydrate, cerium nitrate hexahydrate, cerium bromide, ammonium cerium nitrate, cerium acetylacetonate hydrate, cerium iodide, cerium hydroxide, ammonium cerium sulfate dihydrate, cerium sulfate tetrahydrate, cerium carbonate hydrate, or cerium sulfate hydrate.

In some cases, the ZrₛOₜ precursor comprises zirconium n-butoxide, zirconium acetylacetonate, zirconium propoxide, zirconium oxychloride, zirconium hydroxide, zirconium oxide, zirconium oxide nanofiber, zirconium ethoxide, zirconium acetate, zirconium hydroxide, zirconium trifluoroacetylacetonate, zirconium hydride, zirconium acetylacetonate, zirconium chloride, zirconium sulfate hydrate, zirconium butoxide, zirconium carboxyethyl acrylate, zirconium oxynitrate hydrate, zirconium propoxide, or zirconium fluoride.

In some embodiments, the one or more active metal precursors comprise a Ru precursor, a Ni precursor, a Rh precursor, a Ir precursor, a Co precursor, a Fe precursor, a Pt precursor, a Cr precursor, a Mo precursor, a Pd precursor, or a Cu precursor. In some instances, the ruthenium precursor comprises ruthenium iodide, ruthenium acetylacetonate, ruthenium chloride hydrate, ruthenium oxide hydrate, ruthenium chloride, bis(cyclopentadienyl)ruthenium, ruthenium nitrosyl nitrate, ruthenium iodide hydrate, triruthenium dodecacarbonyl, or any combination thereof.

In some embodiments, the catalyst comprises at least about 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 wt % of ruthenium. In some embodiments, the catalyst comprises at most about 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 wt % of ruthenium. In some embodiments, the concentration of Ru in the catalyst may comprise from about 1 to about 15, about 1 to about 10, about 1 to about 5, about 1 to about 3, about 2 to about 8, about 2 to about 6, about 2 to about 4, about 3 to about 5, about 4 to about 10, about 4 to about 8, about 4 to about 6, about 5 to about 10, about 5 to about 7, about 6 to about 10, about 6 to about 8, about 7 to about 9, or about 8 to about 10 wt %.

In some embodiments, the processing further comprises processing (iii) a promoter or a promoter precursor to produce or yield a target molar ratio of the dopant and Ce in the support. In some instances, the promoter precursor comprises an alkali metal precursor, and/or an alkaline earth metal precursor. In some embodiments, an alkali metal of the alkali metal precursor comprises Li, Na, K, Rb, or Cs. In some instances, an alkaline earth metal of the alkaline earth metal comprises Mg, Ca, Sr, or Ba.

In some cases, the promoter precursor comprises potassium methylate, potassium tetrafluoroborate, potassium hydrogen fluoride, potassium thiocyanate, potassium disulfite, potassium bisulfate, potassium sulfide, potassium methoxide, potassium trifluoroacetate, potassium dioxide, potassium persulfate, potassium formate, potassium bicarbonate, potassium sorbate, potassium hydroxide, potassium borohydride, potassium dichloroacetate, potassium iodate, potassium chlorate, potassium fluoride, potassium chloride, potassium nitrate, potassium perchlorate, potassium cyanate, or potassium hexachloroiridate.

In some embodiments, the promoter precursor is processed in an aqueous solution. In some cases, the promoter precursor is processed in an organic solution. In some instances, the promoter is co-precipitated with the Ce. In some embodiments, the promoter is K. The concentration of the promoter in the catalyst is determined by the concentration of the Ce and the desired molar ratio of promoter and Ce. The molar ratio of promoter and Ce may comprise at least about 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 3:1, or 4:1. The molar ratio of promoter and Ce may comprise no more than about 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 3:1, 4:1, or 5:1. In some embodiments, the molar ratio of the promoter and Ce may comprise from about 0.5:1 to 2:1, from about 0.5:1 to about 1.5:1, from about 0.5:1 to about 1:1, from about 0.75:1 to about 2:1, from about 0.75:1 to about 1.5:1, from about 0.75:1 to about 1.25:1, from about 1:1 to about 2:1, from about 1:1 to about 1.5:1, from about 1.25:1 to about 2.5:1, from about 1.25:1 to about 2:1, from about 1.25:1 to about 1.75:1, from about 1.5:1 to about 2.5:1, or from about 1.5:1 to 2:1.

In some embodiments, the method comprises drying the support in a vacuum according to the procedure described previously herein. In some instances, the method comprises heating the support to a first target temperature. In some embodiments, the method comprises reducing the one or more promoter precursors, the CeₓO_{y}, the ZrₛOₜ, and/or the mixed oxide on the support under an environment comprising hydrogen at a second target temperature. In some instances, the method comprises drying the impregnated support in a vacuum prior to depositing the one or more promoters or dopant precursors. In some cases, drying the impregnated support comprises vacuum drying. In some cases, the vacuum may comprise a pressure that is less than 1 bar. In some instances, the vacuum may comprise a pressure that is less than about 1, 0.1, 0.01, 0.001, 0.0001, or 0.00001 bar. In some embodiments, the heating comprises using an inert gas. In some embodiments, the heating comprises using air. In some instances, the inert gas may comprise He, Ne, Ar, Kr, Xe, or N₂.

In some embodiments, the first target temperature is at least about 600, 650, 700, 750, 800, 850, 900, 950, 1000, 1050, 1100, 1150, or 1200° C. In some embodiments, the first target temperature is at most about 650, 700, 750, 800, 850, 900, 950, 1000, 1050, 1100, 1150, or 1200° C. In some embodiments, the first target temperature ranges from about 700 to about 1100, from about 700 to about 1000, from about 700 to about 900, from about 700 to about 800, from about 750 to about 1050, from about 750 to about 950, from about 750 to about 850, from about 800 to about 1100, from about 800 to about 1000, from about 800 to about 900, from about 850 to about 1050, from about 850 to about 950, from about 900 to about 1100, from about 900 to about 1000, from about 950 to about 1050, or from about 1000 to about 1100° C. In some embodiments, the second target temperature is at least about 200, 250, 300, 350, 400, 450, 500, or 550° C. In some embodiments, the second target temperature is at most about 250, 300, 350, 400, 450, 500, 550, or 600° C. In some embodiments, the second target temperature ranges from about 250 to about 500, from about 250 to about 450, from about 250 to about 400, from about 250 to about 350, from about 250 to about 300, from about 275 to about 475, from about 275 to about 425, from about 275 to about 375, from about 275 to about 325, from about 300 to about 450, from about 300 to about 400, from about 300 to about 350, from about 325 to about 425, from about 325 to about 375, from about 350 to about 450, from about 375 to about 475, or from about 375 to about 425° C.

In some cases, one or more XRD peaks of the catalyst, when the catalyst comprises a K promoter and is processed by the heating under an inert gas, comprise a lower angle of diffraction compared to one or more corresponding XRD peaks of the catalyst not comprising the K promoter and/or not processed by the heating under the inert gas. In some instances, one or more XRD peaks of the catalyst, when the catalyst comprises a K promoter and is processed by the heating under air, comprise a higher angle of diffraction compared to corresponding XRD peak of the catalyst of the catalyst not comprising the K promoter and/or not processed by the heating under the inert gas. In some cases, the catalyst comprises a lower angle of diffraction compared to corresponding XRD peak of zirconia or ZrₓO_{y} without doping of a ceria. In some instances, the catalyst is configured to produce a XRD peak of ceria, wherein the promoter is K. In some embodiments, the processing comprises processing one or more promoter precursors to produce/yield a target molar ratio of the promoter and Ce in the support. In some instances, the promoter is reduced under hydrogen at a target temperature.

In some cases, the promoter is configured to modify the basicity of the composite oxide support. In some cases, the promoter is configured to increase the electron density of active metal to facilitate recombinative nitrogen desorption and/or N—H bond cleavage during an ammonia decomposition reaction.

In some embodiments, the catalyst may comprise nanorod supports. In some cases, the nanorods comprise a rod of material with a thickness or diameter of only a few nanometers. In some instances, the support comprises one or more nanorods comprising the CeₓO_{y}. In some instances, nanorod supports may advantageously improve ammonia conversion efficiency compared to other form factors. In some cases, immobilization or growth of CeO₂ nanorods on ZrₛOₜ might further increase efficiency of final catalyst. In some cases, the nanorod supports may be produced using hydrothermal synthesis. In some cases, processing conditions of the hydrothermal synthesis may be tuned to control the morphology of the support. For example, the morphology of the support may comprise a nanorod diameter, a nanorod length, polydispersity, aggregation, or any combination thereof. In some embodiments, the support may be produced using hydrothermal synthesis to coprecipitate an oxide with a promoter. In some embodiments, Ce(NO₃)₃ and KOH may be coprecipitated. As shown in FIG. 51, the coprecipitation (co-impregnation) of a cerium oxide precursor and a promoter precursor unexpectedly confer a high ammonia conversion efficiency (e.g., about 90% ammonia conversion efficiency at about 450° C.). Surprisingly, coprecipitation precipitation (i.e., co-impregnation) of Ce and promoter (e.g., K) onto the support surface may enable the content of active metal (e.g., Ru) to be reduced by up to 75% compared to conventional catalysts, without compromising conversion efficiency. In some embodiments, coprecipitation (co-impregnation) of a promoter and an oxide precursor (e.g., KOH and Ce(NO₃)₃) may be performed at high pH reaction conditions. In some embodiments, the high pH reaction conditions may comprise pH of at least about 8, 9, 10, 11, 12, 13, or 14. In some embodiments, the high pH reaction conditions may comprise pH of at most about 8, 9, 10, 11, 12, 13, 14, or 15.

In some instances, Ru supported on CeₓO_{y} nanorods may advantageously confer a high ammonia conversion efficiency. In some instances, immobilization or growth of ceria or CeₓO_{y} nanorods on zirconia or ZrₓO_{y} may further increase efficiency of final catalyst.

In some cases, X-Ray Photoelectron Spectroscopy (XPS) may be used to determine electron density by measuring the electron binding energy of electron states. In some cases, XPS may be used to analyze the electronic state by measuring the electron binding energy in a surface region. It is noted that a higher binding energy may indicate an increased difficulty in removing an electron. In some instances, higher binding energy may indicate a more electropositive environment. In some instances, the deconvolution of cerium feature in an XPS spectra may show relative abundances of Ce³⁺ and Ce⁴⁺. In some cases, a plurality of peaks in the XPS spectra may be considered, because the XPS features of Ce are complex. In some cases, the catalyst comprises one or more nanoparticles or nanorods comprising the ceria. In some instances, the one or more nanoparticles or nanorods are immobilized on ZrₛOₜ. In some embodiments, the one or more nanoparticles or nanorods are formed by co-impregnation of KOH and Ce(NO₃)₃.

In some instances, the present disclosure provides catalysts and methods for ammonia decomposition using any of the aforementioned catalysts and methods disclosed herein to generate at least hydrogen. For example, a catalyst comprising a zirconia support, doped with ceria, Ru as the active metal and K as the promoter may convert 98% of the ammonia to hydrogen and nitrogen at a temperature of about 500° C. (see, e.g., FIG. 47).

### Ammonia Reforming System

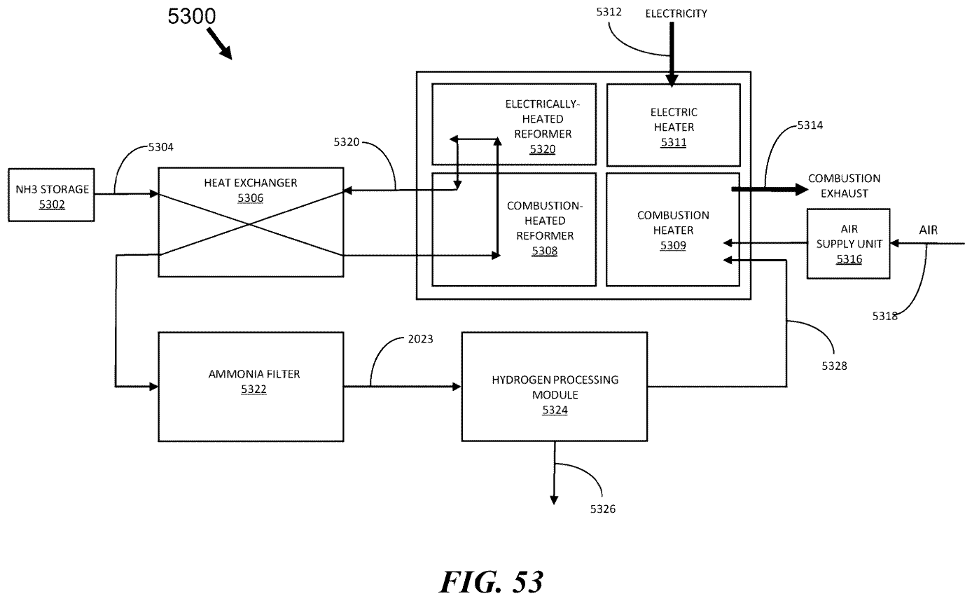

FIG. 53 is a block diagram illustrating an ammonia reforming system 5300, in accordance with one or more embodiments of the present disclosure. The ammonia reforming system 5300 comprises an NH₃ storage tank 5302, a heat exchanger 5306, one or more combustion-heated reformers 5308, a combustion heater 5309, one or more electrically-heated reformers 5310, an electric heater 5311, an air supply unit 5316, an ammonia filter 5322, and a hydrogen processing module 5324. The ammonia reforming system is described in more detail in U.S. patent application Ser. No. 17/974,885, which is incorporated by reference herein in its entirety.

The NH₃ storage tank 5302 may be configured to store NH₃ under pressure (e.g., 7-9 bars absolute) and/or at a low temperature (e.g., −30° C.). The NH₃ storage tank 5302 may comprise a metallic material that is resistant to corrosion by ammonia (e.g., steel). The storage tank 5302 may comprise one or more insulating layers (e.g., perlite or glass wool). In some cases, an additional heater may be positioned near, adjacent, at, or inside the NH₃ storage tank 5302 to heat and/or pressurize the NH₃ stored therein.

The heat exchanger 5306 may be configured to exchange heat between various input fluid streams and output fluid streams. For example, the heat exchanger 5306 may be configured to exchange heat between an incoming ammonia stream 5304 provided by the storage tank 5302 (e.g., relatively cold liquid ammonia) and a reformate stream 5320 (e.g., a relatively warm H₂/N₂ mixture) provided by the reformers 5308 and 5310. The heat exchanger 5306 may be a plate heat exchanger, a shell-and-tube heat exchanger, or a tube-in-tube heat exchanger, although the present disclosure is not limited thereto.

The reformers 5308 and 5310 may be configured to generate and output the reformate stream 5320 comprising at least a mixture of hydrogen (H₂) and nitrogen (N₂) (with a molar ratio of H₂ to N₂ of about 3:1 at a high ammonia conversion). The H₂/N₂ mixture may be generated by contacting the incoming ammonia stream 5304 with NH₃ reforming catalyst positioned inside each of the reformers 5308 and 5310. The reformers 5308 and 5310 may be heated to a sufficient temperature range to facilitate ammonia reforming (for example, of from about 400° C. to about 650° C.).

In some embodiments, the reformers 5308 and 5310 may comprise a plurality of reformers, which may fluidically communicate in various series and/or parallel arrangements. For example, an electrically-heated reformer 5310 may fluidically communicate in series or in parallel with a combustion-heated reformer 5308 (or vice versa) as a pair of reformers 5308-5310. Such a pair of reformers 5308-5310 may fluidically communicate in parallel with other reformer 5308-5310 or pairs of reformers 5308-5310 (so that pairs of reformers 5308-5310 combine their outputs into a single reformate stream 5320), or may fluidically communicate in series with other reformers 5308-5310 or pairs of reformers 5308-5310.

In some embodiments, the number of combustion-heated reformers 5308 may be the same as the number of electrically-heated reformers 5310, and the reformers 5308-5310 may fluidically communicate in various series and/or parallel arrangements. For example, two electrically-heated reformers 5310 may fluidically communicate in series with two combustion-heated reformers 5308 (or vice versa).

In some embodiments, the number of combustion-heated reformers 5308 may be different from the number of electrically-heated reformers 5310 and the reformers 5308-5310 may fluidically communicate in various series and/or parallel arrangements. For example, two electrically-heated reformers 5310 may fluidically communicate in series with four combustion-heated reformers 5308 (or vice versa).

The combustion heater 5309 may be in thermal communication with the combustion-heated reformer 5308 to heat the NH₃ reforming catalyst 5330 in the reformer 5308. The combustion heater 5309 may react at least part of the reformate stream 5320 (e.g., the H₂ in the H₂/N₂ mixture) with an air stream 5318 (e.g., at least oxygen (O₂)). The heat from the exothermic combustion reaction in the combustion heater 5309 may be transferred to the NH₃ reforming catalyst 5330 in the reformer 5308. For example, the hot combustion product gas 5314 may contact walls of the reformer 5308, and the hot combustion product gas 5314 may be subsequently output from the combustion heater 5309 as combustion exhaust 5314. The combustion heater 5309 may comprise a separate component from the reformer 5308 (and may be slidably insertable or removable in the reformer 5308). In some cases, the combustion heater 5309 is a unitary structure with the combustion-heated reformer 5308 (and both the reformer 5308 and the heater 5309 may be manufactured via 3D printing and/or casting).

The air supply unit 5316 (e.g., one or more pumps and/or compressors) may be configured to supply the air stream 5318 (which may be sourced from the atmosphere, and may comprise at least about 20% oxygen by molar fraction). The air stream 5318 may comprise pure oxygen by molar fraction, or substantially pure oxygen by molar fraction (e.g., at least about 99% pure oxygen).

The electric heater 5311 may be in thermal communication with the electrically-heated reformer 5310 to heat the NH₃ reforming catalyst 5330 in the reformer 5310. The electric heater 5311 may heat the NH₃ reforming catalyst 5330 in the electrically-heated reformer 5310 by resistive heating or Joule heating. In some cases, the electrical heater 5311 may comprise at least a heating element (e.g., nichrome or ceramic) that transfers heat to the catalyst 5330 in the electrically-heated reformer 5310. In some cases, the electrical heater 5311 may comprise metal electrodes (e.g., copper or steel electrodes) that pass a current through the catalyst 5330 to heat the catalyst 5330 in the reformer 5310.

The ammonia filter 5322 may be configured to filter or remove trace ammonia in the reformate stream 5320. The ammonia filter 5322 may be configured to reduce the concentration of NH₃ in the reformate stream 5320, for example, from greater than about 10,000 parts per million (ppm) to less than about 100 ppm. The ammonia filter 5322 may comprise a fluidized bed comprising a plurality of particles or pellets. The ammonia filter 5322 may be cartridge-based (for simple replaceability, for example, after the ammonia filter 5322 is saturated with ammonia).

The ammonia filter 5322 may comprise an adsorbent (e.g., bentonite, zeolite, clay, biochar, activated carbon, silica gel, metal organic frameworks (MOFs), and other nanostructured materials). The adsorbent may comprise pellets, and may be stored in one or more columns or towers. In some instances, the ammonia filter 5322 may comprise an absorbent, a solvent-based material, and/or a chemical solvent.

In some embodiments, the ammonia filter 5322 comprises a multi-stage ammonia filtration system (e.g., water-based) comprising a plurality of filtration stages. The replacement of water-based absorbents may be performed for continuous operation.

In some embodiments, the ammonia filter 5322 comprises a selective ammonia oxidation (SAO) reactor including oxidation catalysts configured to react the trace ammonia in the reformate stream 5320 with oxygen (O₂) to generate nitrogen (N₂) and water (H₂O). The air stream 5318 (or a separate oxygen source) may be provided to the SAO reactor to provide the oxygen for the oxidation reaction.

In some embodiments, the ammonia filter 5322 may comprise an acidic ammonia remover (for example, in addition to adsorbents), which may include an acidic solid or solution. The acidic ammonia remover may be regenerated (to desorb the ammonia captured therein) by passing an electric current through the acidic ammonia remover.

The hydrogen processing module 5324 may be a fuel cell comprising an anode, a cathode, and an electrolyte between the anode and the cathode. The fuel cell 5324 may comprise a polymer electrolyte membrane fuel cell (PEMFC), a solid oxide fuel cell (SOFC), a molten carbonate fuel cell (MCFC), a phosphoric acid fuel cell (PAFC), or an alkaline fuel cell (AFC), although the present disclosure is not limited thereto. The fuel cell 5324 may process the H₂ in the reformate stream 5320 at an anode, and process the O₂ in the air stream at a cathode, to generate electricity (to power an external electrical load). The fuel cell 5324 may be configured to receive hydrogen (e.g., at least part of the reformate stream 5320) via one or more anode inlets, and oxygen (e.g., at least part of the air stream 5318 or a separate air stream) via one or more cathode inlets.

In some embodiments, the fuel cell 5324 may output unconsumed hydrogen (e.g., as an anode off-gas) via one or more anode outlets, and/or may output unconsumed oxygen (e.g., as a cathode off-gas) via one or more cathode outlets. The anode off-gas and/or the cathode off-gas may be provided to the combustion heater 5309 as reactants for the combustion reaction performed therein.

The storage tank 5302 may be in fluid communication with the combustion-heated reformer 5308 and/or the electrically-heated reformer 5310 (e.g., using one or more lines or conduits). The storage tank 5302 may provide the incoming ammonia stream 5304 (for example, by actuating a valve). In some instances, the heat exchanger 5306 may facilitate heat transfer from the (relatively warmer) reformate stream 5320 to the (relatively cooler) incoming ammonia stream 5304 to preheat and/or vaporize the incoming ammonia stream 5304 (changing the phase of the ammonia stream 5304 from liquid to gas). The incoming ammonia stream 5304 may then enter the reformers 5308 and 5310 to be reformed into hydrogen and nitrogen.

In some embodiments, the incoming ammonia stream 5304 may first be partially reformed by the electrically-heated reformer 5310 into a partially cracked reformate stream 5320 (e.g., comprising at least about 10% H₂/N₂ mixture by molar fraction) (for example, during a start-up or initiation process). Subsequently, the partially cracked reformate stream 5320 may be further reformed in the combustion-heated reformer 5308 to generate a substantially cracked reformate stream (e.g., comprising less than about 10,000 ppm of residual or trace ammonia by volume and/or greater than about 99% H₂/N₂ mixture by molar fraction). Passing the ammonia stream 5304 through the electrically-heated reformer 5310 first, and then subsequently passing the ammonia stream 5304 through the combustion-heated reformer 5308, may advantageously result in more complete ammonia conversion (e.g., greater than about 99%).

In some embodiments, the incoming ammonia stream 5304 may first be partially reformed by the combustion-heated reformer 5308 into a partially cracked reformate stream 5320 (e.g., comprising at least about 10% H₂/N₂ mixture by molar fraction). Subsequently, the partially cracked reformate stream 5320 may be further reformed in the electrically-heated reformer 5310 to generate a substantially cracked reformate stream (e.g., comprising less than about 10,000 ppm of residual or trace ammonia by volume and/or greater than about 99% H₂/N₂ mixture by molar fraction). Passing the ammonia stream 5304 through the combustion-heated reformer 5308 first, and then subsequently passing the ammonia stream 5304 through the electrically-heated reformer 5310, may advantageously result in more complete ammonia conversion (e.g., greater than about 99%).

In some cases, the incoming ammonia stream 5304 may first be preheated by the combustion exhaust 5314 and/or the combustion heater 5309. In some cases, the preheated incoming ammonia stream 5304 may then enter the reformers 5308 and 5310 to be reformed into hydrogen and nitrogen.

In some embodiments, the incoming ammonia stream 5304 may first be reformed by the electrically-heated reformer 5310 to generate a partially or substantially cracked reformate stream 5320 (for example, during a start-up or initiation process). Subsequently, at least part of the partially or substantially cracked reformate stream 5320 generated by the electrically-heated reformer 5310 may be combusted as a combustion fuel to heat at least one combustion heater 5309 of the one or more combustion-heated reformers 5308.

In some cases, the electrically-heated reformer 5310 may be configured to preheat or vaporize the incoming ammonia stream 5304 (to avoid reforming liquid ammonia). In some cases, the electrically-heated reformer 5310 may reform or crack the incoming ammonia stream 5304 at an ammonia conversion efficiency of at least about 10, 15, 20, 25, 30, 35, 40, 45, 50, 55, 60, 65, 70, 75, 80, 85, 90, 95, 99, or 99.5%. In some cases, the electrically-heated reformer 5310 may reform or crack the incoming ammonia stream 5304 at an ammonia conversion efficiency of at most about 10, 15, 20, 25, 30, 35, 40, 45, 50, 55, 60, 65, 70, 75, 80, 85, 90, 95, 99, or 99.5%. In some cases, the electrically-heated reformer 5310 may reform or crack the incoming ammonia stream 5304 at an ammonia conversion efficiency of about 10 to about 30, about 20 to about 40, about 30 to about 50, about 40 to about 60, about 50 to about 70, about 60 to about 80, about 70 to about 90, about 80 to about 99%, or about 90 to about 99.5%.

In some cases, power input to the electric heater 5311 of the electrically-heated reformer 5310 may be reduced or entirely turned off based on a temperature of the combustion-heated reformer 5308 and/or the combustion heater 5309 being equal to or greater than a target temperature (e.g., in a target temperature range). In some cases, power input to the electric heater 5311 of the electrically-heated reformer 5310 may be reduced or entirely turned off based on a flow rate of the incoming ammonia stream 5304 being equal to or greater than a target flow rate range. In some cases, power input to the electric heater 5311 of the electrically-heated reformer 5310 may be turned on or increased during an entire operational time period of the ammonia reforming system 5300 (e.g., during the startup mode, the operation mode, and/or the hot standby mode described in the present disclosure). In some cases, power input to the electric heater 5311 of the electrically-heated reformer 5310 may be turned on or off, or increased intermittently during the operational time period of the ammonia reforming system 5300 (e.g., turned on or increased during the startup mode and/or the hot standby mode, and turned off or decreased during the operation mode).

In some cases, power input to the electric heater 5311 may be controlled so that the temperature of the electrically-heated reformer 5310 and/or the electrical heater 5311 increases or decreases at a target temperature change rate (ΔTemperature/ΔTime, e.g., ° C./minute). In some cases, the target temperature change rate is at least about 5, 10, 20, 25, 30, 35, 40, 45, 50, 60, 65, 70, 75, 80, 85, 90, 95, or 100° C./minute. In some cases, the target temperature change rate is at most about 5, 10, 20, 25, 30, 35, 40, 45, 50, 60, 65, 70, 75, 80, 85, 90, 95, or 100° C./minute.

The filtered reformate stream 5323 may be provided to the hydrogen processing module 5324 to generate electrical power 5326. An external load (e.g., an electrical motor to power a transport vehicle, or a stationary electrical grid) may utilize the electrical power 5326. The fuel cell 5324 may provide the anode off-gas 5328 (e.g., containing unconsumed or unconverted hydrogen) to the combustion heater 5309 to combust for self-heating.

In some embodiments, the ammonia reforming system 5300 includes a battery (so that the system 5300 is a hybrid fuel cell-battery system). The battery may be configured to power an external load in addition to the hydrogen processing module 5324. The hydrogen processing module 5324 may be configured to charge the battery (for example, based a charge of the battery being less than a threshold charge).

In some cases, the hydrogen processing module 5324 comprises steel or iron processing, a combustion engine, a combustion turbine, hydrogen storage, a chemical process, a hydrogen fueling station, and the like.

### Reformer Control

In some cases, ammonia may be directed to a reformer at an ammonia flow rate to generate a reformate stream comprising hydrogen and nitrogen. The reformer may include any catalyst described herein. In some cases, the catalyst may be at a temperature greater than 575° C. and less than about 725° C., and the reformate stream may be generated at an ammonia conversion efficiency of greater than about 70% and less than about 99.99%.

The first portion of the reformate stream may be combusted with oxygen at an oxygen flow rate in a combustion heater to heat the reformer. A second portion of the reformate stream may be processed in a hydrogen processing module (e.g., a fuel cell or an internal combustion engine). Based at least in part on a stimulus, at least one of the following may be performed: (i) changing (increasing or decreasing) the ammonia flow rate to the reformer, (ii) changing (increasing or decreasing) a percentage of the reformate stream that is the first portion of the reformate stream, (iii) changing (increasing or decreasing) a percentage of the reformate stream that is the second portion of the reformate stream, or (iv) changing (increasing or decreasing) the oxygen flow rate.

In some cases, the stimulus comprises a change in an amount of the hydrogen used by the hydrogen processing module (e.g., change in hydrogen demand). In some cases, the stimulus comprises a temperature of the reformer being outside of a target temperature range. In some cases, the stimulus comprises a change in an amount or concentration of ammonia in the reformate stream.

In some cases, a temperature in the reformer or the combustion heater may be measured, and, based at least in part on the measured at least one of the following may be performed: (i) changing (increasing or decreasing) the ammonia flow rate to the reformer, (ii) changing (increasing or decreasing) a percentage of the reformate stream that is the first portion of the reformate stream, (iii) changing (increasing or decreasing) a percentage of the reformate stream that is the second portion of the reformate stream, (iv) changing (increasing or decreasing) the oxygen flow rate, or (v) changing a percentage of the reformate stream that is directed out of the combustion heater.

In some cases, the second portion of the reformate stream that is processed by the hydrogen processing module may not be completely consumed or utilized by the hydrogen processing. A leftover stream or off-gas (comprising at least hydrogen) may be provided from the hydrogen processing module to the combustion heater (to combust as fuel). Therefore, increasing or decreasing a percentage of the reformate stream that is the second portion of the reformate stream may provide more or less fuel to the combustion heater (therefore a percentage of the reformate stream that is the first portion of the reformate stream may be increased or decreased).

### List of Embodiments

The following list of embodiments of the invention are to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.

Embodiment 1. A method for reforming ammonia, comprising: contacting a gas comprising ammonia in a reactor comprising a catalyst at a temperature ranging from about 400° C. to about 700° C. to generate a reformate stream comprising hydrogen (H₂) and nitrogen (N₂), at an ammonia conversion efficiency of at least about 70%, wherein the catalyst comprises: a conducting support, wherein the conducting support comprises a resistivity greater than about 50 microohm-centimeter (mohm-cm) and less than about 100 ohm-cm, wherein the catalyst is in electrical communication with a pair of electrodes; and, applying a voltage across the pair of electrodes, thereby passing an electrical current through the catalyst to heat at least a portion of the catalyst from a first temperature to a second temperature in a time period of less than about 60 minutes, wherein the second temperature is greater than about 200° C. and less than about 700° C.

Embodiment 2. The method of Embodiment 1, wherein the ammonia generates hydrogen and nitrogen at an ammonia conversion efficiency of greater than about 90%.

Embodiment 3. The method of Embodiment 1, wherein the ammonia is contacted with the catalyst at a space velocity of greater than about 1000 and less than about 100,000 milliliters NH3 per hour per milliliter of catalyst.

Embodiment 4. The method of Embodiment 1, wherein the catalyst is heated from the first temperature to the second temperature in less than about 30 minutes.

Embodiment 5. The method of Embodiment 1, wherein the first temperature is ambient temperature.

Embodiment 6. The method of Embodiment 1, wherein the first temperature is about 25° C.

Embodiment 7. The method of Embodiment 1, wherein the conducting support has a resistance greater than about 1 ohm.

Embodiment 8. The method of Embodiment 1, wherein the current passes between the electrodes and through the catalyst for a distance of greater than about 1 centimeter (cm) and less than about 10 meters.

Embodiment 9. The method of Embodiment 1, wherein a combined resistance of the catalyst and the electrodes is greater than about 0.1 ohm and less than about 100 ohm.

Embodiment 10. The method of Embodiment 1, wherein the resistivity is a resistance of the catalyst multiplied by a cross-sectional area of the catalyst and divided by a distance that the current passes between the electrodes and through the catalyst.

Embodiment 11. The method of Embodiment 1, wherein the resistivity of the conducting support is a resistivity at a temperature greater than about 15° C. and less than about 30° C.

Embodiment 12. The method of Embodiment 1, wherein the electrical current comprises an electrical power per gram of catalyst of greater than about 5 watts per gram (W/g) and less than about 500 W/g.

Embodiment 13. The method of Embodiment 1, wherein the time period begins when the electrical current begins to pass through the catalyst.

Embodiment 14. The method of Embodiment 1, wherein the catalyst is a monolith.

Embodiment 15. The method of Embodiment 1, wherein the catalyst comprises beads, pellets, or powder configured to form an electrical circuit between the electrodes.

Embodiment 16. The method of Embodiment 1, wherein the conducting support comprises a ceramic material.

Embodiment 17. The method of Embodiment 1, wherein the conducting support comprises silicon carbide (SiC), silicon (Si), or germanium (Ge).

Embodiment 18. The method of Embodiment 1, wherein the conducting support comprises a carbon-based material.

Embodiment 19. The method of Embodiment 18, wherein the carbon-based material comprises graphite or amorphous carbon.

Embodiment 20. The method of Embodiment 1, wherein the conducting support comprises NiCrAl, FeCrAl, NiFeCrAl, or NiCr.

Embodiment 21. The method of Embodiment 1, wherein the conducting support comprises a dopant comprising phosphorus (P), nitrogen (N), or boron (B).

Embodiment 22. The method of Embodiment 1, wherein the catalyst further comprises a layer adjacent to the conducting support.

Embodiment 23. The method of Embodiment 22, wherein the conducting support comprises SiC and the layer comprises alumina (Al₂O₃).

Embodiment 24. The method of Embodiment 23, wherein the Al₂O₃ comprises alpha-alumina, theta-alumina, or gamma-alumina.

Embodiment 25. The method of Embodiment 22, wherein the catalyst further comprises an active metal adjacent to the layer comprising Al₂O₃.

Embodiment 26. The method of Embodiment 25, wherein the active metal comprises Ru, Ni, Rh, Ir, Co, Fe, Pt, Cr, Mo, Pd, or Cu.

Embodiment 27. The method of Embodiment 25, wherein the active metal comprises Ru.

Embodiment 28. The method of Embodiment 27 wherein a concentration of the Ru is greater than about 0.5 wt % and less than about 3 wt % with respect to a total weight of the catalyst comprising the support and the layer.

Embodiment 29. The method of Embodiment 1, wherein a first electrode of the pair of electrodes is positioned in proximity to a first side of the reactor, wherein a second electrode of the pair of electrodes is positioned in proximity to a second side of the reactor, wherein the first side and the second side are positioned substantially opposite from each other.

Embodiment 30. The method of Embodiment 1, wherein the pair of electrodes are adjacent to each other and in proximity to a side of the reactor.

Embodiment 31. The method of Embodiment 1, further comprising reducing a voltage or ceasing to apply a voltage between the electrodes based on the catalyst reaching the second temperature.

Embodiment 32. The method of Embodiment 1, further comprising heating the reactor by combustion.

Embodiment 33. The method of Embodiment 1, further comprising electrically heating the reactor in addition to heating the catalyst by passing the current through the catalyst.

Embodiment 34. The method of Embodiment 1, wherein the reactor further comprises a second catalyst.

Embodiment 35. The method of Embodiment 34, wherein the second catalyst is mixed with the catalyst.

Embodiment 36. The method of Embodiment 34, wherein the reactor comprises at least two zones, wherein a first zone comprises the catalyst and the second zone comprises the second catalyst.

Embodiment 37. The method of Embodiment 1, wherein the voltage is provided from a battery.

Embodiment 38. The method of Embodiment 1, wherein the voltage is provided from an electrical grid.

Embodiment 39. The method of Embodiment 1, further comprising generating power by providing the H₂ to a fuel cell.

Embodiment 40. The method of Embodiment 39, wherein the fuel cell comprises a proton exchange membrane fuel cell (PEMFC), a solid oxide fuel cell (SOFC), a molten carbonate fuel cell (MCFC), an alkaline fuel cell (AFC), an alkaline membrane fuel cell (AMFC), or a phosphoric acid fuel cell (PAFC).

Embodiment 41. The method of Embodiment 1, further comprising generating power by providing the hydrogen to one or more combustion engines or turbines.

Embodiment 42. The method of Embodiment 1, wherein: the catalyst is heated to the second temperature, the second temperature being greater than about 600° C. and less than about 700° C., in a time period of less than 30 minutes; and contacting the NH₃ with the catalyst generates the H₂ and the N₂ at an ammonia conversion efficiency of greater than about 95%.

Embodiment 43. A method of manufacturing a catalyst for ammonia decomposition, wherein the catalyst comprises a conducting support, wherein the conducting support comprises a resistivity greater than about 50 microohm-cm and less than about 100 ohm-cm, wherein the method comprises:
(a) submerging the conducting support in a slurry, wherein the slurry comprises (i) a binder and (ii) alumina (Al₂O₃), to deposit a layer comprising the alumina adjacent to the conducting support,
(b) removing the catalyst, comprising the conducting support and the layer, from the slurry;
(c) drying the catalyst, comprising the conducting support and the layer;
(d) heat treating the catalyst, comprising the conducting support and the layer, in a non-reducing atmosphere at a temperature greater than about 200° C. and less than about 1400° C.;
(e) submerging the catalyst, comprising the conducting support and the layer, in a solution comprising an active metal precursor to deposit the active metal precursor adjacent to the layer; and
(f) heat treating the catalyst, comprising the conducting support, the layer and the active metal precursor, in a non-oxidizing atmosphere at a temperature greater than about 200° C. and less than about 1300° C. to convert the active metal precursor to an active metal.

Embodiment 44. The method of Embodiment 43, wherein the slurry comprises a pH greater than about 0.1 and less than about 3.

Embodiment 45. The method of Embodiment 43, wherein the catalyst is a monolith.

Embodiment 46. The method of Embodiment 43, wherein the binder is an alumina-derived sol-gel.

Embodiment 47. The method of Embodiment 43, wherein the binder comprises boehmite, bayerite, or gibbsite.

Embodiment 48. The method of Embodiment 43, wherein the binder is a hydrocarbon-based binder.

Embodiment 49. The method of Embodiment 48, wherein the hydrocarbon-based binder comprises polyvinyl alcohol (PVA), polyethylene glycol (PEG), polyurethane (PUR), or polyethylene imine (PEI).

Embodiment 50. The method of Embodiment 43, wherein the conducting support is submerged in the slurry for a time period greater than about 1 second and less than about 10 minutes.

Embodiment 51. The method of Embodiment 50, wherein the time period begins based on the conducting support being completely submerged under a surface of the slurry.

Embodiment 52. The method of Embodiment 43, wherein the drying comprises blowing air over the catalyst comprising the conducting support and the layer.

Embodiment 53. The method of Embodiment 43, wherein the drying comprises passing a flame or a combustion product gas adjacent or on the catalyst comprising the conducting support and the layer.

Embodiment 54. The method of Embodiment 43, wherein the non-reducing atmosphere comprises air, O₂, N₂, CO₂, Ar, He, Kr, or Xe.

Embodiment 55. The method of Embodiment 43, wherein the non-oxidizing atmosphere comprises N₂, H₂, Ar, NH₃, CO, CO₂, He, Kr, and Xe.

Embodiment 56. The method of Embodiment 43, wherein the alumina comprises alpha alumina, theta alumina, or gamma alumina.

Embodiment 57. The method of Embodiment 43, wherein the active metal precursor comprises Ru(NO)(NO₃)₃, Ru(NO₃)₃, RuCl₃, Ru₃(CO)₁₂, ruthenium(III) chloride hexa-ammoniate Ru(NH₃)₆Cl₃, cyclohexadiene ruthenium tricarbonyl ((CHD)Ru(CO)₃), butadiene ruthenium tricarbonyl ((BD)Ru(CO)₃), or dimethylbutadiene ruthenium tricarbonyl ((DMBD)Ru(CO)₃).

Embodiment 58. The method of Embodiment 43, wherein the active metal comprises ruthenium (Ru).

Embodiment 59. The method of Embodiment 58, wherein a concentration of the Ru comprises greater than about 0.5 wt % and less than about 3 wt % with respect to a total weight of the catalyst comprising the conducting support and the layer.

Embodiment 60. The method of Embodiment 43, wherein solids in the slurry comprise the binder and the alumina, wherein a concentration of the solids comprises greater than about 20 wt % and less than about 60 wt % with respect to a total weight of the slurry.

Embodiment 61. The method of Embodiment 43, wherein the conducting support comprises a ceramic material.

Embodiment 62. The method of Embodiment 43, wherein the conducting support comprises silicon carbide (SiC), silicon (Si), or germanium (Ge).

Embodiment 63. The method of Embodiment 43, wherein the conducting support comprises a carbon-based material.

Embodiment 64. The method of Embodiment 63, wherein the carbon-based material comprises graphite or amorphous carbon.

Embodiment 65. The method of Embodiment 43, wherein the conducting support comprises NiCrAl, FeCrAl, NiFeCrAl, or NiCr.

Embodiment 66. The method of Embodiment 43, wherein the conducting support comprises a dopant comprising phosphorus (P), nitrogen (N), or boron (B).

Embodiment 67. A catalyst for ammonia decomposition, comprising: a conducting support wherein the conducting support comprises a resistivity greater than about 50 microohm-cm and less than about 100 ohm-cm; a layer adjacent to the conducting support, wherein the layer comprises alumina, zirconia, iron oxide, magnesium oxide, manganese oxide, nickel oxide, silicon dioxide, titanium dioxide, vanadium dioxide, or zinc oxide; and active metal adjacent to the layer, wherein the active metal comprises Ru, Ni, Rh, Ir, Co, Fe, Pt, Cr, Mo, Pd, or Cu.

Embodiment 68. The catalyst of Embodiment 67, wherein the catalyst is a monolith.

Embodiment 69. The catalyst of Embodiment 67, wherein the conducting support comprises SiC, the layer comprises the alumina, and the active metal comprises the Ru.

Embodiment 70. The catalyst of Embodiment 69, wherein the alumina comprises alpha alumina, theta alumina, or gamma alumina.

Embodiment 71. The catalyst of Embodiment 69, wherein a concentration of the Ru comprises greater than about 0.5 wt % and less than about 3 wt % with respect to a total weight of the catalyst comprising the support and the layer.

Embodiment 72. The catalyst of Embodiment 67, wherein the conducting support comprises a ceramic material.

Embodiment 73. The catalyst of Embodiment 67, wherein the conducting support comprises silicon carbide (SiC), silicon (Si), or germanium (Ge).

Embodiment 74. The catalyst of Embodiment 67, wherein the conducting support comprises a carbon-based material.

Embodiment 75. The catalyst of Embodiment 74, wherein the carbon-based material comprises graphite or amorphous carbon.

Embodiment 76. The catalyst of Embodiment 67, wherein the conducting support comprises NiCrAl, FeCrAl, NiFeCrAl, or NiCr.

Embodiment 77. The catalyst of Embodiment 67, wherein the conducting support comprises a dopant comprising phosphorus (P), nitrogen (N), or boron (B).

Embodiment 78. A method of ammonia decomposition comprising:

contacting a gas comprising ammonia on a catalyst at a temperature ranging from about 400° to about 700° C. to generate a reformate stream comprising hydrogen and nitrogen, at an ammonia conversion efficiency of at least about 70%, wherein the catalyst comprises: a conducting support, wherein the conducting support comprises a resistivity greater than about 50 microohm-cm and less than about 100 ohm-cm; a layer adjacent to the conducting support, wherein the layer comprises alumina, zirconia, iron oxide, magnesium oxide, manganese oxide, nickel oxide, silicon dioxide, titanium dioxide, vanadium dioxide, or zinc oxide; and an active metal adjacent to the layer, wherein the active metal comprises Ru, Ni, Rh, Ir, Co, Fe, Pt, Cr, Mo, Pd, or Cu.

Embodiment 79. The method of Embodiment 78, wherein the catalyst is in electrical communication with a pair of electrodes and passing an electrical current through the catalyst heats the catalyst.

Embodiment 80. The method of Embodiment 78, wherein the ammonia is contacted on the catalyst at a space velocity of from about 1 to about 50 liters per hour per gram of catalyst at a temperature of from about 450° C. to about 700° C.

Embodiment 81. The method of Embodiment 78, wherein the ammonia is contacted on the catalyst at a gas hourly space velocity (GHSV) of from about 1 to about 50 liters per hour per mL of catalyst at a temperature of from about 450° C. to about 700° C.

Embodiment 82. The method of Embodiment 78, wherein contacting the catalyst with ammonia to generate the reformate stream is an auto-thermal reforming process so that at least part of the reformate stream provides heat for the auto-thermal reforming process.

Embodiment 83. The method of Embodiment 82, wherein the at least part of the reformate stream comprises: (1) combustion to generate the heat, or (2) conversion by hydrogen-to-electricity conversion to generate the heat, thereby providing the heat for the auto-thermal reforming process.

Embodiment 84. The method of Embodiment 78, wherein undecomposed ammonia in the reformate stream is removed by an ammonia filter.

Embodiment 85. The method of Embodiment 84, wherein the ammonia filter comprises an adsorbent, a membrane separation module, or an ammonia scrubber.

Embodiment 86. The method of Embodiment 78, wherein a pressure swing adsorption (PSA) module is used to remove nitrogen from the reformate stream.

Embodiment 87. The method of Embodiment 78, further comprising directing the ammonia to a first reformer comprising the catalyst to generate the reformate stream; combusting the reformate stream in a combustion heater to heat a second reformer; and directing additional ammonia to the second reformer to generate additional hydrogen for the reformate stream, wherein a first portion of the reformate stream is combusted to heat the second reformer.

Embodiment 88. The method of Embodiment 87, wherein the first reformer is heated using at least one of an electrical heater or combustion of the reformate stream.

Embodiment 89. The method of Embodiment 78, comprising: directing the ammonia to a reformer at an ammonia flow rate to generate the reformate stream; combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

Embodiment 90. The method of Embodiment 78, comprising: directing the ammonia to a reformer at an ammonia flow rate to generate the reformate stream; combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

Embodiment 91. A catalyst for ammonia decomposition, comprising: a support comprising at least one of alumina, silica, carborundum, zeolite, ceria, zirconia, graphite oxide, carbon, graphene, carbon nanofibers or carbon nanotubes; a layer adjacent to the support, wherein the layer comprises the support material doped with an oxide of at least one of an alkali metal, an alkaline earth metal, or a rare earth metal; and one or more active metal particles adjacent to the layer, wherein the one or more active metal particles comprise at least one of Ru, Ni, Rh, Ir, Co, Fe, Pt, Cr, Mo, Pd, or Cu; and wherein the concentration of the active metal particles is at least about 0.1 wt % and not more than about 15 wt %.

Embodiment 92. The catalyst of Embodiment 91, wherein the support comprises zirconium and oxygen.

Embodiment 93. The catalyst of Embodiment 91, wherein the layer comprises Ce.

Embodiment 94. The catalyst of Embodiment 91, wherein the layer comprises a tetragonal network structure of zirconium, cerium, and oxygen.

Embodiment 95. The catalyst of Embodiment 91, wherein the layer comprises oxygen vacancies of at least about 0.1 mmol/g and not more than about 10 mmol/g.

Embodiment 96. The catalyst of Embodiment 91, wherein the layer comprises a density of acid sites of at least about 10 μmol/g and not more than about 1000 μmol/g.

Embodiment 97. The catalyst of Embodiment 91, wherein the layer comprises Ce³⁺ ions and Ce⁴⁺ ions, wherein a ratio of the Ce³⁺ ions to the Ce⁴⁺ ions is at least about 0.1:1 and not more than about 1:1.

Embodiment 98. The catalyst of Embodiment 91, wherein the layer comprises one or more promoters, wherein the molar ratio of the one or more promoters to Ce in the support is at least about 1:2 and not more than about 10:1.

Embodiment 99. The catalyst of Embodiment 91, wherein the layer comprises one or more promoters selected from alkali metals and alkaline earth metals; and wherein the one or more promoters are co-impregnated with the Ce.

Embodiment 100. The catalyst of Embodiment 91, wherein the active metal particles comprise ruthenium (Ru).

Embodiment 101. The catalyst of Embodiment 100, wherein the concentration of Ru is at least about 0.5 wt % and not more than about 10 wt %.

Embodiment 102. The catalyst of Embodiment 91, wherein the one or more active metal particles comprises nanoparticles of elemental Ru.

Embodiment 103. The catalyst of Embodiment 99, wherein at least one of the support or the layer comprises one or more promoters comprising at least one of K, Cs, or Rb.

Embodiment 104. The catalyst of Embodiment 103, wherein the layer comprises oxide nanoparticles of at least one of Ce, K, Cs and Rb.

Embodiment 105. The catalyst of Embodiment 91, wherein the layer comprises annealed nanoparticles of at least one of Ce, K, Cs, or Rb.

Embodiment 106. A method of producing a catalyst for ammonia decomposition, comprising:
(a) providing a support comprising at least one of alumina, silica, carborundum, zeolite, ceria, zirconia, graphite oxide, carbon, graphene, carbon nanofibers and carbon nanotubes or precursor(s) thereof;
(b) depositing a layer adjacent to the support, to form a doped support, wherein the layer comprises at least one of an alkali metal oxide or precursors thereof, an alkaline earth metal oxide or precursors thereof, or a rare earth metal oxide or precursor(s) thereof;
(c) depositing a precursor of one or more active metal particles adjacent to the layer, wherein the one or more active metal particles comprise at least one of Ru, Ni, Rh, Ir, Co, Fe, Pt, Cr, Mo, Pd, or Cu, wherein the concentration of the active metal particles is at least 0.1 wt % and not more than about 15 wt %; and
(d) maintaining the doped support at a temperature of at least about 200° C. and not more than about 1000° C. for a duration of at least about 0.1 hours and not more than about 168 hours in an atmosphere comprising hydrogen.

Embodiment 107. The method of Embodiment 106, wherein (b) further comprises: maintaining the doped support at a temperature of at least about 20° C. and not more than about 150° C., for a duration of at least about 0.1 hours and not more than about 168 hours in vacuo, or in an atmosphere comprising air or an inert gas at a pressure below about 5 bar absolute.

Embodiment 108. The method of Embodiment 106, wherein (b) further comprises maintaining the doped support at a temperature of at least about 600° C. and not more than about 1300° C. for a duration of at least about 0.1 hours and not more than about 168 hours, in a non-reducing atmosphere, comprising at least one of: air, N₂, CO₂, Ar, He, Kr, or Xe.

Embodiment 109. The method of Embodiment 106, wherein (b) further comprises maintaining the doped support at a temperature of at least about 600° C. and not more than about 1300° C. for a duration of at least about 0.1 hours and not more than about 168 hours, in an inert, anoxic or non-oxidizing atmosphere, comprising at least one of: N₂, H₂, Ar, NH₃, CO, CO₂, He, Kr, or Xe.

Embodiment 110. The method of Embodiment 106, wherein the support comprises zirconium and oxygen.

Embodiment 111. The method of Embodiment 106, wherein the layer comprises Ce.

Embodiment 112. The method of Embodiment 106, wherein the layer comprises a tetragonal network structure of zirconium, cerium, and oxygen.

Embodiment 113. The method of Embodiment 106, wherein the catalyst comprises oxygen vacancies of at least about 0.1 mmol/g and not more than about 10 mmol/g.

Embodiment 114. The method of Embodiment 106, wherein the catalyst comprises a density of acid sites of at least about 10 μmol/g and not more than about 1000 μmol/g.

Embodiment 115. The method of Embodiment 106, wherein the layer comprises Ce³⁺ ions and Ce⁴⁺ ions, wherein a ratio of the Ce³⁺ ions to the Ce⁴⁺ ions is at least about 0.1:1 and not more than about 1:1.

Embodiment 116. The method of Embodiment 106, wherein the layer comprises one or more promoters, wherein the molar ratio of the one or more promoters to Ce in the support is at least about 1:2 and not more than about 10:1.

Embodiment 117. The method of Embodiment 106, wherein (b) further comprises incorporating one or more promoters selected from alkali metals and alkaline earth metals; and wherein the one or more promoters are co-impregnated with Ce.

Embodiment 118. The method of Embodiment 106, wherein a molar ratio of the promoter to the active metal is at least about 1:2 and not more than about 10:1.

Embodiment 119. The method of Embodiment 106, wherein the one or more promoters or promoter precursor(s) comprise at least one of K, Cs, or Rb.

Embodiment 120. The method of Embodiment 106, wherein the one or more active metal particles comprise Ru and the concentration of Ru is at least about 0.5 wt % and not more than about 10 wt %.

Embodiment 121. The method of Embodiment 106, wherein the precursor of the one or more active metal particles comprises at least one of Ru(NO)(NO₃)₃, Ru(NO₃)₃, RuCl₃, or Ru₃(CO)₁₂.

Embodiment 122. The method of Embodiment 106, wherein the support or precursor(s) thereof comprise beads or pellets; wherein the beads or the pellets comprise at least one of (i) a diameter of at least about 0.1 mm and not more than about 10 mm, or (ii) a surface area per unit mass of at least about 50 m²/g and not more than about 500 m²/g.

Embodiment 123. A method of ammonia decomposition comprising: contacting a gas comprising ammonia on a catalyst at a temperature ranging from about 400° C. to about 700° C. to generate a reformate stream comprising hydrogen and nitrogen, at an ammonia conversion efficiency of at least about 70% and no more than about 99.9%, wherein the catalyst comprises: a support comprising at least one of alumina, silica, carborundum, zeolite, ceria, zirconia, graphite oxide, carbon, graphene, carbon nanofibers, or carbon nanotubes; a layer adjacent to the support, wherein the layer comprises the support material doped with an oxide of at least one of an alkali metal, an alkaline earth metal, or a rare earth metal; and one or more active metal particles deposited adjacent to the layer, wherein the one or more active metal particles comprise at least one of Ru, Ni, Rh, Ir, Co, Fe, Pt, Cr, Mo, Pd, or Cu; and wherein the concentration of the active metal particles is at least about 0.1 wt % and not more than about 15 wt %.

Embodiment 124. The method of Embodiment 123, wherein the catalyst is brought into contact with the ammonia at a space velocity of at least about 1 liter per hour per gram of catalyst and not more than about 100 liters per hour per gram of catalyst.

Embodiment 125. The method of Embodiment 123, further comprising generating electricity by providing hydrogen produced by the catalyst to at least one fuel cell, wherein the at least one fuel cell comprises a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

Embodiment 126. The method of Embodiment 123, further comprising providing hydrogen produced by the catalyst for one or more combustion engines or turbines.

Embodiment 127. A system configured to reform ammonia using the method of Embodiment 123.

Embodiment 128. The method of Embodiment 123, wherein contacting the catalyst with ammonia to generate the reformate stream is an auto-thermal reforming process so that at least part of the reformate stream provides heat for the auto-thermal reforming process.

Embodiment 129. The method of Embodiment 128, wherein the at least part of the reformate stream is at least one of: (1) combusted to generate the heat, or (2) converted by hydrogen-to-electricity conversion to generate the heat, thereby providing the heat for the auto-thermal reforming process.

Embodiment 130. The method of Embodiment 123, wherein undecomposed ammonia in the reformate stream is removed by an ammonia filter.

Embodiment 131. The method of Embodiment 130, wherein the ammonia filter comprises at least one of an adsorbent, a membrane separation module, or an ammonia scrubber.

Embodiment 132. The method of Embodiment 123, wherein a pressure swing adsorption (PSA) module is used to remove nitrogen from the reformate stream.

Embodiment 133. The method of Embodiment 123, wherein (b) comprises directing the ammonia to a first reformer to generate the reformate stream; wherein the method comprises combusting the reformate stream in a combustion heater to heat a second reformer; and directing additional ammonia to the second reformer to generate additional hydrogen for the reformate stream, wherein a first portion of the reformate stream is combusted to heat the second reformer.

Embodiment 134. The method of Embodiment 133, wherein the first reformer is heated using at least one of an electrical heater or combustion of the reformate stream.

Embodiment 135. The method of Embodiment 123, wherein (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

Embodiment 136. The method of Embodiment 123, wherein (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

Embodiment 137. A catalyst for ammonia decomposition, comprising: a support comprising at least one of alumina, silica, carborundum, zeolite, ceria, zirconia, graphite oxide, carbon, graphene, carbon nanofibers and carbon nanotubes, and a layer adjacent to the support, wherein the layer comprises the support material doped with an oxide of at least one of an alkali metal, an alkaline earth metal, or a rare earth metal; and one or more active metal particles adjacent to the layer, wherein the one or more active metal particles comprises at least one of Ru, Ni, Rh, Ir, Co, Fe, Pt, Cr, Mo, Pd, or Cu; and wherein the concentration of the active metal particles is at least about 0.1, and not more than about 15 wt %.

Embodiment 138. The catalyst of Embodiment 137, wherein the support comprises aluminum and oxygen.

Embodiment 139. The catalyst of Embodiment 137, wherein the layer comprises at least one of theta-alumina (θ-alumina) or gamma-alumina (γ-alumina).

Embodiment 140. The catalyst of Embodiment 137, wherein the layer comprises a perovskite phase.

Embodiment 141. The catalyst of Embodiment 137, wherein the layer comprises La at a concentration of at least about 0.1, and not more than about 50 mol %.

Embodiment 142. The catalyst of Embodiment 137, wherein said layer comprises La and Ce, wherein the molar ratio of the La to the Ce is at least about 10:90, and not more than about 90:10.

Embodiment 143. The catalyst of Embodiment 137, wherein at least one of the support or the layer further comprises a promoter comprising at least one of K, Cs, or Rb.

Embodiment 144. The catalyst of Embodiment 143, wherein a molar ratio of the promoter to the active metal particles is at least about 1:2, and not more than about 10:1.

Embodiment 145. The catalyst of Embodiment 137, wherein the active metal particles comprise ruthenium (Ru).

Embodiment 146. The catalyst of Embodiment 145, wherein the concentration of Ru is at least about 0.5, and not more than about 10 wt %.

Embodiment 147. The catalyst of Embodiment 145, wherein the layer comprises nanoparticles of elemental Ru.

Embodiment 148. The catalyst of Embodiment 137, wherein the layer comprises oxide nanoparticles of at least one of La, Ce, K, Cs or Rb.

Embodiment 149. The catalyst of Embodiment 137, wherein the layer comprises annealed nanoparticles of at least one of La, Ce, K, Cs or Rb.

Embodiment 150. A method of producing a catalyst for ammonia decomposition, comprising:
(a) providing a support comprising at least one of alumina, silica, carborundum, zeolite, ceria, zirconia, graphite oxide, carbon, graphene, carbon nanofibers, or carbon nanotubes or precursor(s) thereof;
(b) depositing a layer adjacent to the support comprising at least one of an alkali metal oxide or precursors thereof, an alkaline earth metal oxide or precursors thereof, or a rare earth metal oxide or precursor(s) thereof, to form a doped support;
(c) depositing a precursor of one or more active metal particles adjacent to the layer, wherein the one or more active metal particles comprise at least one of Ru, Ni, Rh, Ir, Co, Fe, Pt, Cr, Mo, Pd, or Cu, wherein the concentration of the active metal particles is at least about 0.1 wt % and not more than about 15 wt %; and
(d) maintaining the doped support at a temperature of at least about 200° C. and not more than about 1300° C. for a duration of at least about 0.1 hour and not more than about 168 hours in an atmosphere comprising hydrogen.

Embodiment 151. The method of Embodiment 150, wherein (b) further comprises: maintaining the doped support at a temperature of at least about 20° C. and not more than about 150° C., for a duration of at least about 0.1 hour and not more than about 168 hours in vacuo, or in an inert, anoxic or non-oxidizing atmosphere below 5 bar absolute pressure.

Embodiment 152. The method of Embodiment 150, wherein (b) further comprises maintaining the doped support at a temperature of at least about 300° C. and not more than about 1300° C. for a duration of at least about 0.1 hour and not more than about 168 hours, in a non-reducing atmosphere, comprising at least one of: air, N₂, CO₂, Ar, He, Kr, or Xe.

Embodiment 153. The method of Embodiment 150, wherein (b) further comprises maintaining the doped support at a temperature of at least about 300° C. and not more than about 1300° C. for a duration of at least about 0.1 hour and not more than about 168 hours, in an inert, anoxic or non-oxidizing atmosphere, comprising at least one of: N₂, H₂, Ar, NH₃, CO, CO₂, He, Kr, or Xe.

Embodiment 154. The method of Embodiment 150, wherein the support comprises aluminum and oxygen.

Embodiment 155. The method of Embodiment 150, wherein the layer comprises at least one of theta alumina (θ-alumina) or gamma alumina (γ-alumina).

Embodiment 156. The method of Embodiment 150, wherein the layer comprises a perovskite phase.

Embodiment 157. The method of Embodiment 150, wherein the layer comprises La at a concentration of at least about 0.1 and not more than about 50 mol %.

Embodiment 158. The method of Embodiment 150, wherein the layer comprises La and Ce, wherein a molar ratio of the La to the Ce is at least about 10:90 and not more than about 90:10.

Embodiment 159. The method of Embodiment 150, wherein the layer comprises depositing one or more promoters or promoter precursor(s); wherein the one or more promoters or promoter precursor(s) comprise at least one of K, Cs, or Rb.

Embodiment 160. The method of Embodiment 23, wherein the layer further comprises a molar ratio of the one or more promoters or promoter precursor(s) to the one or more active metal particles comprising at least about 1:2 and not more than about 10:1.

Embodiment 161. The method of Embodiment 150, wherein the one or more active metal particles further comprise ruthenium (Ru).

Embodiment 162. The method of Embodiment 25, wherein a concentration of Ru comprises at least about 0.5 wt % and not more than about 10 wt %.

Embodiment 163. The method of Embodiment 161, wherein (c) the precursor of the one or more active metal particles comprises at least one of Ru(NO)(NO₃)₃, Ru(NO₃)₃, RuCl₃, Ru₃(CO)₁₂, Ru(NH₃)₆Cl₃ (ruthenium(III) chloride hexaammoniate), (CHD)Ru(CO)₃ (cyclohexadiene ruthenium tricarbonyl), (BD)Ru(CO)₃ (butadiene ruthenium tricarbonyl), or (DMBD)Ru(CO)₃ (dimethylbutadiene ruthenium tricarbonyl).

Embodiment 164. The method of Embodiment 150, wherein (a) the support or precursor(s) thereof comprise beads or pellets; wherein the beads or the pellets comprise at least one of (i) a diameter of at least about 0.1 mm and not more than about 10 mm, or (ii) a surface area per unit mass of at least about 50 m²/g and not more than about 500 m²/g.

Embodiment 165. A method of ammonia decomposition comprising: contacting a gas comprising ammonia on a catalyst at a temperature ranging from about 400° C. to about 700° C. to generate a reformate stream comprising hydrogen and nitrogen, at an ammonia conversion efficiency of at least about 70% and no more than about 99.9%, wherein the catalyst comprises: a support comprising at least one of alumina, silica, carborundum, zeolite, ceria, zirconia, graphite oxide, carbon, graphene, carbon nanofibers and carbon nanotubes, and a layer adjacent to the support, wherein the layer comprises the support material doped with an oxide of at least one of an alkali metal, an alkaline earth metal and a rare earth metal; and one or more active metal particles adjacent to the layer, wherein the one or more active metal particles comprise at least one of Ru, Ni, Rh, Ir, Co, Fe, Pt, Cr, Mo, Pd, or Cu; and wherein the concentration of the active metal particles is at least about 0.1, and not more than about 15 wt %; and

(b) bringing the catalyst in contact with ammonia at a temperature of at least about 400° C. and not more than about 700° C. to generate a reformate stream comprising hydrogen and nitrogen at an ammonia conversion efficiency of at least about 70% and at most about 99.9%.

Embodiment 166. The method of Embodiment 165, wherein the ammonia is contacted on the catalyst at a space velocity of at least about 1 and not more than about 100 liters of ammonia per hour per gram of catalyst.

Embodiment 167. The method of Embodiment 165, further comprising generating electricity by providing hydrogen produced by the catalyst to at least one fuel cell, wherein the at least one fuel cell comprises a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

Embodiment 168. The method of Embodiment 165, further comprising generating power or electricity by providing hydrogen produced by the catalyst to one or more combustion engines or turbines.

Embodiment 169. A system configured to reform ammonia using the method of Embodiment 168.

Embodiment 170. The method of Embodiment 165, wherein contacting the catalyst with ammonia to generate the reformate stream is an auto-thermal reforming process so that at least part of the reformate stream provides heat for the auto-thermal reforming process.

Embodiment 171. The method of Embodiment 170, wherein the at least part of the reformate stream is at least one of: (1) combusted to generate the heat, or (2) converted by hydrogen-to-electricity conversion to generate the heat, thereby providing the heat for the auto-thermal reforming process.

Embodiment 172. The method of Embodiment 165, wherein undecomposed ammonia in the reformate stream is removed by an ammonia filter.

Embodiment 173. The method of Embodiment 36, wherein the ammonia filter comprises at least one of an adsorbent, a membrane separation module, or an ammonia scrubber.

Embodiment 174. The method of Embodiment 165, wherein a pressure swing adsorption (PSA) module is used to remove nitrogen from the reformate stream.

Embodiment 175. The method of Embodiment 165, wherein (b) comprises directing the ammonia to a first reformer to generate the reformate stream; wherein the method comprises combusting the reformate stream in a combustion heater to heat a second reformer; and directing additional ammonia to the second reformer to generate additional hydrogen for the reformate stream, wherein a first portion of the reformate stream is combusted to heat the second reformer.

Embodiment 176. The method of Embodiment 175, wherein the first reformer is heated using at least one of an electrical heater or combustion of the reformate stream.

Embodiment 177. The method of Embodiment 165, wherein (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

Embodiment 178. The method of Embodiment 165, wherein (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

Embodiment 179. A catalyst for ammonia decomposition, comprising: a support comprising at least one of: alumina, silica, carborundum, zeolite, ceria, zirconia, graphite oxide, carbon, graphene, carbon nanofibers or carbon nanotubes, and a layer adjacent to the support, wherein the layer comprises the support material doped with an oxide comprising at least one of: an alkaline earth metal, Zn, Fe, or Mn; and one or more active metal particles in, on, or adjacent to the layer, wherein the one or more active metal particles comprise at least one of: Ru, Ni, Rh, Ir, Co, Fe, Pt, Cr, Mo, and Pd.

Embodiment 180. The catalyst of Embodiment 179, wherein the support comprises aluminum and oxygen.

Embodiment 181. The catalyst of Embodiment 179, wherein at least one of the support or the layer comprises at least one of alpha-alumina (α-alumina), theta-alumina (θ-alumina), or gamma-alumina (γ-alumina).

Embodiment 182. The catalyst of Embodiment 179, wherein the layer comprises a spinel phase.

Embodiment 183. The catalyst of Embodiment 179, wherein the concentration of the one or more active metal particles ranges from about 0.1 wt % to about 15 wt % with respect to the weight of the catalyst.

Embodiment 184. The catalyst of Embodiment 179, wherein the layer comprises at least one of Mg, Ca, Sr, Ba, Zn, Fe, or Mn, wherein a concentration of the at least one of Mg, Ca, Sr, Ba, Zn, Fe, or Mn ranges from about 0.1 mol % to about 80 mol %.

Embodiment 185. The catalyst of Embodiment 179, wherein the support and the layer comprise a modified support comprising an ASTM D7084 (determination of bulk crush strength of catalysts and catalyst carriers) crush strength of at least about 4000 psi (peak stress).

Embodiment 186. The catalyst of Embodiment 179, wherein the one or more active metal particles comprise ruthenium (Ru).

Embodiment 187. The catalyst of Embodiment 186, wherein the concentration of Ru ranges from about 0.5 to about 10 wt %.

Embodiment 188. The catalyst of Embodiment 186, wherein the one or more active metal particles comprises Ru nanoparticles.

Embodiment 189. The catalyst of Embodiment 179, wherein the layer comprises oxide nanoparticles comprising at least one of Mg, Ca, Sr, Ba, Zn, Fe, or Mn.

Embodiment 190. The catalyst of Embodiment 179, wherein the layer comprises annealed nanoparticles comprising at least one of Mg, Ca, Sr, Ba, Zn, Fe, or Mn.

Embodiment 191. The catalyst of Embodiment 179, wherein the catalyst comprises an ASTM D7084 crush strength of at least about 400 psi (peak stress).

Embodiment 192. The catalyst of Embodiment 179, wherein the catalyst is substantially free of promoter.

Embodiment 193. The catalyst of Embodiment 179, wherein the catalyst is substantially free of support surface modifier.

Embodiment 194. A method of producing a catalyst for ammonia decomposition, comprising:
(e) providing a support comprising at least one of: alumina, silica, carborundum, zeolite, ceria, zirconia, graphite oxide, carbon, graphene, carbon nanofibers and carbon nanotubes or precursor(s) thereof;
(f) depositing at least one of an alkaline earth metal oxide or precursors thereof, iron oxide or precursor(s) thereof, manganese oxide or precursor(s) thereof, or zinc oxide or precursor(s) thereof, to form a layer in, on, or adjacent to the support, so that the support comprises a doped support comprising the layer and the support;
(g) depositing an oxide or precursor of one or more active metal particles adjacent to the doped support, wherein the one or more active metal particles comprise at least one of: Ru, Ni, Rh, Ir, Co, Fe, Pt, Cr, Mo, Pd, or Cu, wherein a concentration of the one or more active metal particles ranges from about 0.1 to about 15 wt %; and
(h) maintaining the doped support at a temperature of about 300° C. to about 1300° C. for a duration of about 0.1 to about 168 hours in an atmosphere comprising hydrogen.

Embodiment 195. The method of Embodiment 194, wherein the support comprises aluminum and oxygen.

Embodiment 196. The method of Embodiment 194, wherein the layer comprises at least one of alpha-alumina (α-alumina), theta alumina (θ-alumina) or gamma alumina (γ-alumina).

Embodiment 197. The method of Embodiment 194, wherein the layer comprises a spinel phase.

Embodiment 198. The method of Embodiment 194, wherein the alkaline earth metal comprises at least one of Mg Ca, Sr or Ba, and wherein a concentration of the oxide of at least one of Mg, Ca, Sr, Ba, Zn, Fe, or Mn ranges from about 0.1 to about 80 mol %.

Embodiment 199. The method of Embodiment 194, wherein the support and the layer comprise a modified support comprising an ASTM D7084 crush strength of at least about 4000 psi (peak stress).

Embodiment 200. The method of Embodiment 194, wherein the one or more active metal particles comprise ruthenium (Ru).

Embodiment 201. The method of Embodiment 200, wherein the precursor of Ru comprises at least one of Ru(NO)(NO₃)₃, Ru(NO₃)₃, RuCl₃, or Ru₃(CO)₁₂.

Embodiment 202. The method of Embodiment 200, wherein the concentration of the Ru ranges from about 0.5 to about 10 wt %.

Embodiment 203. The method of Embodiment 194, wherein (b) further comprises: maintaining the doped support at a temperature from about 20° C. to about 150° C., for a duration of about 0.1 hours to about 168 hours in vacuo, or in an inert or a non-oxidizing atmosphere, wherein a pressure of the non-oxidizing atmosphere ranges from about 0.1 bar absolute pressure to about 5 bar absolute pressure.

Embodiment 204. The method of Embodiment 194, wherein (b) further comprises maintaining the doped support at a temperature of about 300° C. to about 1300° C. for a duration of from about 0.1 hours to about 168 hours, in a non-reducing atmosphere comprising at least one member of the group of: air, O₂, N₂, CO₂, Ar, He, Kr, or Xe.

Embodiment 205. The method of Embodiment 194, wherein (b) further comprises maintaining the doped support at a temperature of about 300° C. to about 1300° C. for a duration of from about 0.1 hours to about 168 hours, in an inert, anoxic, or non-oxidizing atmosphere comprising at least one member of the group of: N₂, CO₂, CO, H₂, Ar, He, Kr, or Xe.

Embodiment 206. The method of Embodiment 194, wherein the catalyst comprises an ASTM D7084 crush strength of at least about 400 psi (peak stress).

Embodiment 207. The method of Embodiment 194, wherein the method does not comprise adding a promoter to the catalyst.

Embodiment 208. The method of Embodiment 194, wherein the method does not comprise adding a support surface modifier to the catalyst.

Embodiment 209. The method of Embodiment 194, wherein the support or precursor(s) thereof comprise beads or pellets; wherein the beads or the pellets comprise at least one of (i) a diameter of from about 0.1 to about 10 millimeters (mm), or (ii) a surface area per unit mass of from about 50 to about 1200 m²/g.

Embodiment 210. A method of ammonia decomposition comprising: contacting a gas comprising ammonia on a catalyst at a temperature ranging from about 400° C. to about 700° C. to generate a reformate stream comprising hydrogen and nitrogen, at an ammonia conversion efficiency of at least about 70% and no more than about 99.9%, wherein the catalyst comprises: a support comprising at least one of: alumina, silica, carborundum, zeolite, ceria, zirconia, graphite oxide, carbon, graphene, carbon nanofibers, or carbon nanotubes; a layer adjacent to the support, wherein the layer comprises the support material doped with an oxide comprising at least one of: an alkaline earth metal, Zn, Fe, or Mn; and one or more active metal particles adjacent to the layer, wherein the one or more active metal particles comprise at least one of: Ru, Ni, Rh, Ir, Co, Fe, Pt, Cr, Mo, Pd, or Cu; wherein a concentration of the one or more active metal particles ranges from about 0.1 wt % to about 15 wt %.

Embodiment 211. The method of Embodiment 210, wherein the ammonia is contacted on the catalyst at a space velocity of from about 1 to about 50 liters per hour per gram of catalyst at a temperature of from about 450° C. to about 700° C.

Embodiment 212. The method of Embodiment 210, wherein the ammonia is contacted on the catalyst at a gas hourly space velocity (GHSV) of from about 1 to about 50 liters per hour per mL of catalyst at a temperature of from about 450° C. to about 700° C.

Embodiment 213. The method of Embodiment 210, wherein contacting the catalyst with ammonia to generate the reformate stream is an auto-thermal reforming process so that at least part of the reformate stream provides heat for the auto-thermal reforming process.

Embodiment 214. The method of Embodiment 213, wherein the at least part of the reformate stream is at least one of: (1) combusted to generate the heat, or (2) converted by hydrogen-to-electricity conversion to generate the heat, thereby providing the heat for the auto-thermal reforming process.

Embodiment 215. The method of Embodiment 210, wherein undecomposed ammonia in the reformate stream is removed by an ammonia filter.

Embodiment 216. The method of Embodiment 215, wherein the ammonia filter comprises at least one of an adsorbent, a membrane separation module, or an ammonia scrubber.

Embodiment 217. The method of Embodiment 210, wherein a pressure swing adsorption (PSA) module is used to remove nitrogen from the reformate stream.

Embodiment 218. The method of Embodiment 210, further comprising generating electricity by directing the hydrogen to at least one fuel cell, wherein the at least one fuel cell comprises: a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

Embodiment 219. The method of Embodiment 210, further comprising directing the hydrogen to one or more combustion engines or turbines.

Embodiment 220. The method of Embodiment 210, further comprising directing the hydrogen to one or more fuel cells, combustion engines or turbines, to generate electricity and/or motive power.

Embodiment 221. The method of Embodiment 210, wherein the catalyst is substantially free of a promoter or support surface modifier.

Embodiment 222. A system configured to reform ammonia using the method of Embodiment 210.

Embodiment 223. The method of Embodiment 210, wherein (b) comprises directing the ammonia to a first reformer to generate the reformate stream; wherein the method comprises combusting the reformate stream in a combustion heater to heat a second reformer; and directing additional ammonia to the second reformer to generate additional hydrogen for the reformate stream, wherein a first portion of the reformate stream is combusted to heat the second reformer.

Embodiment 224. The method of Embodiment 223, wherein the first reformer is heated using at least one of an electrical heater or combustion of the reformate stream.

Embodiment 225. The method of Embodiment 210, wherein (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; and based at least in part on a stimulus, performing one or more of:
(i) changing the ammonia flow rate;
(ii) changing a percentage of the reformate stream that is the first portion of the reformate stream;
(iii) changing a percentage of the reformate stream that is the second portion of the reformate stream; or
(iv) changing the oxygen flow rate.

Embodiment 226. The method of Embodiment 210, wherein (b) comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
(i) changing the ammonia flow rate;
(ii) changing the oxygen flow rate;
(iii) changing a percentage of the reformate stream that is the second portion of the reformate stream;
(iv) changing a percentage of the reformate stream that is the first portion of the reformate stream; or
(v) changing a percentage of the reformate stream that is directed out of the combustion heater.

Embodiment 227. A catalyst comprising: a support comprising alumina and a layer adjacent to the support, wherein the layer comprises the support doped with an oxide of a rare earth metal, wherein the rare earth metal comprises at least one of lanthanum (La) or cerium (Ce);
wherein the layer comprises a mixed oxide of aluminum and the rare earth metal, and a concentration of the rare earth metal is at least about 1 and not more than about 15 mol % with respect to the layer and support; wherein the layer does not include a perovskite phase; and
one or more active metals adjacent to the layer, wherein the one or more active metals comprise at least one of ruthenium (Ru), platinum (Pt), or palladium (Pd); and wherein a concentration of the one or more active metals is at least about 0.1, and not more than about 10 wt % with respect to a weight of the catalyst.

Embodiment 228. The catalyst of Embodiment 227, wherein the layer comprises theta alumina (θ-alumina) or gamma alumina (γ-alumina).

Embodiment 229. The catalyst of Embodiment 227, wherein the layer comprises the rare earth metal at a concentration of not more than about 10 mol % with respect to the layer and the support.

Embodiment 230. The catalyst of Embodiment 229, wherein the layer comprises the rare earth metal at a concentration of about 2 to about 8 mol % with respect to the layer and the support.

Embodiment 231. The catalyst of Embodiment 229, wherein the layer comprises the rare earth metal at a concentration of 3 to 7 mol % with respect to the layer and the support.

Embodiment 232. The catalyst of Embodiment 229, wherein the layer comprises the rare earth metal at a concentration of about 4 to about 6 mol % with respect to the layer and the support.

Embodiment 233. The catalyst of Embodiment 227, wherein the rare earth metal is lanthanum (La).

Embodiment 234. The catalyst of Embodiment 227, wherein the rare earth metal is cerium (Ce).

Embodiment 235. The catalyst of Embodiment 227, wherein the concentration of the one or more active metals is at least about 0.5 and not more than about 8 wt %, with respect to the weight of the catalyst.

Embodiment 256. The catalyst of Embodiment 227, wherein the concentration of the one or more active metals is at least about 0.5 and not more than about 3 wt %, with respect to the weight of the catalyst.

Embodiment 237. The catalyst of Embodiment 227, wherein the one or more active metals are nanoparticles.

Embodiment 238. The catalyst of Embodiment 237, where the nanoparticles comprise a reduced form of the one or more active metals, after the layer is contacted with a gas comprising hydrogen (H₂) at a temperature ranging from about 300° C. to about 800° C. for at least 1 hour and not more than 40 hours.

Embodiment 239. The catalyst of Embodiment 227, wherein the one or more active metals comprise Ru.

Embodiment 240. The catalyst of Embodiment 239, wherein the concentration of the Ru is not more than about 5 wt %.

Embodiment 241. The catalyst of Embodiment 227, wherein the layer does not comprise a perovskite phase.

Embodiment 242. The catalyst of Embodiment 227, wherein the catalyst does not comprise an alkali metal and an alkaline earth metal.

Embodiment 243. A method of producing a catalyst, comprising:
(a) using at least Al₂O₃ or precursors thereof to form a support comprising at least one of theta alumina (θ-alumina) or gamma alumina (γ-alumina), and (ii) using a rare earth metal comprising at least one of La₂O₃ or precursors thereof or CeO₂ or precursors thereof to produce a layer comprising a mixed oxide of aluminum and lanthanum or aluminum and cerium; and wherein a concentration of the rare earth metal is at least about 1 and not more than about 15 mol % with respect to the layer and support;
(b) depositing at least one precursor of one or more active metals adjacent to the layer, wherein the one or more active metals comprise at least one of ruthenium (Ru), platinum (Pt), or palladium (Pd), and wherein the concentration of the one or more active metals is at least about 0.1 wt % and not more than about 10 wt % with respect to a weight of the catalyst; and
(c) contacting the catalyst with a gas comprising hydrogen (Hz) at a temperature ranging from about 300° C. to about 800° C. for at least 1 hour and not more than 40 hours, to reduce the at least one precursor of the one or more active metals to an elemental state without converting the layer to form a perovskite phase.

Embodiment 244. The method of Embodiment 243, wherein (a) further comprises maintaining the support at a temperature of at least about 300° C. and not more than about 800° C. for a duration of at least about 0.1 hour and not more than about 168 hours, in a non-reducing atmosphere, comprising at least one of: air, nitrogen (N₂), carbon dioxide (CO₂), argon (Ar), helium (He), krypton (Kr), or xenon (Xe).

Embodiment 245. The method of Embodiment 243, wherein the layer comprises the rare earth metal at a concentration of not more than about 10 mol % with respect to the layer and support, and the catalyst comprises the one or more active metals at a concentration of not more than about 8 wt % with respect to the weight of the catalyst.

Embodiment 246. The method of Embodiment 243, wherein the one or more active metals are nanoparticles.

Embodiment 247. The method of Embodiment 243, wherein the one or more active metals comprise Ru, the precursor of the one or more active metals comprises ruthenium nitrosyl nitrate (Ru(NO)(NO₃)₃), and the concentration of Ru is not more than about 5 wt % with respect to the weight of the catalyst.

Embodiment 248. The method of Embodiment 243, wherein incipient wetness impregnation is used to form the layer using the rare earth metal precursors.

Embodiment 249. The method of Embodiment 243, wherein incipient wetness impregnation is used to deposit the at least one precursor of one or more active metals.

Embodiment 250. The method of Embodiment 243, wherein the Al₂O₃ or precursor(s) thereof comprise beads or pellets, and wherein the beads or the pellets comprise at least one of (i) a diameter ranging from about 0.1 millimeters (mm) to about 10 mm, or (ii) a surface area per unit mass ranging from about 50 m²/g to about 500 m²/g.

Embodiment 251. The method of Embodiment 243, wherein the catalyst does not comprise an alkali metal and an alkaline earth metal.

Embodiment 252. A method of ammonia decomposition comprising: contacting a gas comprising ammonia on a catalyst at a temperature ranging from about 450° C. to about 700° C. to generate a reformate stream comprising hydrogen and nitrogen, at an ammonia conversion efficiency from about 70% to about 99.9%, wherein the catalyst comprises:
a support comprising alumina and a layer adjacent to the support, wherein the layer comprises the support doped with an oxide of a rare earth metal; wherein the rare earth metal comprises at least one of lanthanum (La) or cerium (Ce); wherein the layer comprises a mixed oxide of aluminum and the rare earth metal, and a concentration of the rare earth metal is at least about 1 and not more than about 15 mol % with respect to the layer and support; and
one or more active metals adjacent to the layer, wherein the one or more active metals comprise at least one of ruthenium (Ru), platinum (Pt), or palladium (Pd); wherein a concentration of the one or more active metals is at least about 0.1, and not more than about 15 wt % with respect to the weight of the catalyst; and wherein the catalyst does not comprise an alkali metal or an alkaline earth metal.

Embodiment 253. The method of Embodiment 252, wherein the layer comprises theta alumina (θ-alumina) or gamma alumina (γ-alumina).

Embodiment 254. The method of Embodiment 252, wherein the layer comprises the rare earth metal at a concentration of not more than about 10 mol % with respect to the layer and support.

Embodiment 255. The method of Embodiment 252, wherein the rare earth metal is La.

Embodiment 256. The method of Embodiment 252, wherein the rare earth metal is Ce.

Embodiment 257. The method of Embodiment 252, wherein the one or more active metals are nanoparticles.

Embodiment 258. The method of Embodiment 257, where the nanoparticles comprise a reduced form of the one or more active metals, after the layer is contacted with a gas comprising hydrogen (H₂) at a temperature ranging from about 300° C. to about 800° C. for at least 1 hour and not more than 40 hours.

Embodiment 259. The method of Embodiment 252, wherein the one or more active metals comprise Ru and the concentration of Ru is not more than about 5 wt %.

Embodiment 260. The method of Embodiment 252, wherein the layer does not comprise a perovskite phase.

Embodiment 261. The method of Embodiment 252, wherein the gas comprising ammonia is contacted on the catalyst at a space velocity of not more than about 100 liters per hour per gram of catalyst.

Embodiment 262. The method of Embodiment 252, further comprising generating electricity by providing the generated hydrogen to one or more fuel cells.

Embodiment 263. The method of Embodiment 252, wherein contacting the gas comprising ammonia on the catalyst to generate the reformate stream is an auto-thermal reforming process so that at least part of the reformate stream provides heat for the auto-thermal reforming process.

Embodiment 264. The method of Embodiment 263, wherein the at least part of the reformate stream is at least one of: (1) combusted to generate the heat, or (2) converted by hydrogen-to-electricity conversion to generate the heat, thereby providing the heat for the auto-thermal reforming process.

Embodiment 265. The method of Embodiment 252, wherein contacting the gas comprising ammonia on the catalyst comprises directing the ammonia to a first reformer to generate the reformate stream; wherein the method comprises combusting the reformate stream to heat a second reformer; and directing additional ammonia to the second reformer to generate additional reformate stream, wherein a first portion of the reformate stream, the additional reformate stream, or a combination thereof is combusted to heat the second reformer.

Embodiment 266. The method of Embodiment 265, wherein the first reformer is heated using at least one of an electrical heater or combustion of the reformate stream.

Embodiment 267. The method of Embodiment 252, wherein contacting the gas comprising ammonia on the catalyst comprises directing the ammonia to a reformer at an ammonia flow rate to generate the reformate stream, wherein the method further comprises: combusting a first portion of the reformate stream with oxygen at an oxygen flow rate in a combustion heater to heat the reformer; and processing a second portion of the reformate stream in a hydrogen processing module; and based at least in part on a stimulus, performing one or more of:
i. changing the ammonia flow rate;
ii. changing a percentage of the reformate stream that is the first portion of the reformate stream;
iii. changing a percentage of the reformate stream that is the second portion of the reformate stream; or
iv. changing the oxygen flow rate.

Embodiment 268. The method of Embodiment 267, wherein the stimulus comprises:
x. a change in an amount of the hydrogen used by the hydrogen processing module;
y. a temperature of the reformer being outside of a target temperature range; or
z. a change in an amount or concentration of ammonia in the reformate stream.

Embodiment 269. The method of Embodiment 267, wherein the hydrogen processing module comprises a fuel cell and the fuel cell provides an anode off-gas comprising hydrogen to the combustion heater.

Embodiment 270. The method of Embodiment 252, wherein contacting the gas comprising ammonia on the catalyst comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
i. changing the ammonia flow rate;
ii. changing the oxygen flow rate;
iii. changing a percentage of the reformate stream that is the second portion of the reformate stream;
iv. changing a percentage of the reformate stream that is the first portion of the reformate stream; or
v. changing a percentage of the reformate stream that is directed out of the combustion heater.

Embodiment 271. The method of Embodiment 270, wherein the hydrogen processing module comprises a fuel cell and the fuel cell provides an anode off-gas comprising hydrogen to the combustion heater.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. Various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method of ammonia decomposition comprising:
contacting a gas comprising ammonia on a catalyst at a temperature ranging from about 400° C. to about 900° C. to generate a reformate stream comprising hydrogen and nitrogen, at an ammonia conversion efficiency of at least about 70%, wherein the catalyst comprises:
a support comprising alumina and a layer adjacent to the support, wherein the layer comprises the support doped with an oxide of a rare earth metal; wherein the rare earth metal comprises at least one of lanthanum (La) or cerium (Ce); wherein the layer comprises a mixed oxide of aluminum and the rare earth metal, and a concentration of the rare earth metal is at least about 1 and not more than about 15 mol % with respect to the layer and support; and
one or more active metals adjacent to the layer, wherein the one or more active metals comprise at least one of ruthenium (Ru), platinum (Pt), or palladium (Pd); wherein a concentration of the one or more active metals is at least about 0.1, and not more than about 15 wt % with respect to the weight of the catalyst.

2. The method of claim 1, wherein the layer comprises at least one of theta alumina (θ-alumina) or gamma alumina (γ-alumina).

3. The method of claim 1, wherein the layer comprises the rare earth metal at a concentration of not more than about 10 mol % with respect to the layer and support.

4. The method of claim 1, wherein the layer comprises the rare earth metal at a concentration of about 2 to about 8 mol % with respect to the layer and the support.

5. The method of claim 1, wherein the rare earth metal is La.

6. The method of claim 1, wherein the rare earth metal is Ce.

7. The method of claim 1, wherein the concentration of the one or more active metals is at least about 0.5 and not more than about 5 wt %, with respect to the weight of the catalyst.

8. The method of claim 1, wherein the one or more active metals are nanoparticles, wherein the nanoparticles comprise a reduced form of the one or more active metals, after the layer is contacted with a gas comprising hydrogen (H₂) at a temperature ranging from about 300° C. to about 800° C. for at least 1 hour and not more than 40 hours.

9. The method of claim 1, wherein the one or more active metals comprise Ru.

10. The method of claim 1, wherein the layer does not comprise a perovskite phase.

11. The method of claim 1, wherein the catalyst does not comprise an alkali metal or an alkaline earth metal.

12. The method of claim 1, wherein the ammonia is contacted on the catalyst at a temperature from about 450° C. to about 700° C.

13. The method of claim 1, wherein the ammonia is contacted on the catalyst at a space velocity of from about 1 to about 50 liters per hour per gram of catalyst.

14. The method of claim 1, wherein the ammonia is contacted on the catalyst at a gas hourly space velocity (GHSV) of from about 1 to about 50 liters per hour per mL of catalyst.

15. The method of claim 1, further comprising generating electricity by directing the hydrogen to at least one fuel cell, wherein the at least one fuel cell comprises: a Proton Exchange Membrane Fuel Cell (PEMFC), a Solid Oxide Fuel Cell (SOFC), a Molten Carbonate Fuel Cell (MCFC), an Alkaline Fuel Cell (AFC), an Alkaline Membrane Fuel Cell (AMFC), or a Phosphoric Acid Fuel Cell (PAFC).

16. The method of claim 1, further comprising directing the hydrogen to one or more combustion engines or turbines.

17. The method of claim 1, wherein contacting the gas comprising ammonia on the catalyst to generate the reformate stream is an auto-thermal reforming process so that at least part of the reformate stream provides heat for the auto-thermal reforming process.

18. The method of claim 17, wherein the at least part of the reformate stream is at least one of: (1) combusted to generate the heat, or (2) converted by hydrogen-to-electricity conversion to generate the heat, thereby providing the heat for the auto-thermal reforming process.

19. The method of claim 1, further comprising removing undecomposed ammonia in the reformate stream using an ammonia filter.

20. The method of claim 19, wherein the ammonia filter comprises at least one of an adsorbent, a membrane separation module, or an ammonia scrubber.

21. The method of claim 1, wherein a pressure swing adsorption (PSA) module is used to remove nitrogen from the reformate stream.

22. The method of claim 1, wherein contacting the gas comprising ammonia on the catalyst comprises directing the ammonia to a reformer at an ammonia flow rate to generate the reformate stream, wherein the method further comprises: combusting a first portion of the reformate stream with oxygen at an oxygen flow rate in a combustion heater to heat the reformer; and processing a second portion of the reformate stream in a hydrogen processing module; and based at least in part on a stimulus, performing one or more of:
i. changing the ammonia flow rate;
ii. changing a percentage of the reformate stream that is the first portion of the reformate stream;
iii. changing a percentage of the reformate stream that is the second portion of the reformate stream; or
iv. changing the oxygen flow rate.

23. The method of claim 22, wherein the stimulus comprises:
x. a change in an amount of the hydrogen used by the hydrogen processing module;
y. a temperature of the reformer being outside of a target temperature range; or
z. a change in an amount or a concentration of ammonia in the reformate stream.

24. The method of claim 1, wherein contacting the gas comprising ammonia on the catalyst comprises directing the ammonia to a reformer at an ammonia flow rate to generate the reformate stream, wherein the method further comprises: combusting a first portion of the reformate stream with oxygen at an oxygen flow rate in a combustion heater to heat the reformer; processing a second portion of the reformate stream in a hydrogen processing module; measuring a temperature in the reformer or the combustion heater; and based at least in part on the measured temperature being outside of a target temperature range of the reformer or the combustion heater, performing one or more of:
i. changing the ammonia flow rate;
ii. changing the oxygen flow rate;
iii. changing a percentage of the reformate stream that is the second portion of the reformate stream;
iv. changing a percentage of the reformate stream that is the first portion of the reformate stream; or
v. changing a percentage of the reformate stream that is directed out of the combustion heater.

25. A catalyst comprising: a support comprising alumina and a layer adjacent to the support, wherein the layer comprises the support doped with an oxide of a rare earth metal, wherein the rare earth metal comprises at least one of lanthanum (La) or cerium (Ce);
wherein the layer comprises a mixed oxide of aluminum and the rare earth metal, and a concentration of the rare earth metal is at least about 1 and not more than about 15 mol % with respect to the layer and support; and
one or more active metals adjacent to the layer, wherein the one or more active metals comprise at least one of ruthenium (Ru), platinum (Pt), or palladium (Pd); and wherein a concentration of the one or more active metals is at least about 0.1, and not more than about 15 wt % with respect to a weight of the catalyst.

26. The catalyst of claim 25, wherein the layer comprises the rare earth metal at a concentration of not more than about 10 mol % with respect to the layer and the support.

27. The catalyst of claim 25, wherein the concentration of the one or more active metals is at least about 0.5 and not more than about 5 wt %, with respect to the weight of the catalyst.

28. The catalyst of claim 25, wherein the one or more active metals are nanoparticles comprising a reduced form of the one or more active metals, after the layer is contacted with a gas comprising hydrogen (H₂) at a temperature ranging from about 300° C. to about 800° C. for at least 1 hour and not more than 40 hours.

29. The catalyst of claim 25, wherein the layer does not comprise a perovskite phase.

30. The catalyst of claim 25, wherein the catalyst does not comprise an alkali metal or an alkaline earth metal.
